(19) United States
(12) Patent Application Publication
(10) Pub. No.: US 2026/0307520 A1
(43) Pub. Date: Oct. 8, 2026

(54) Electric Vehicle charging and operating architectures with rentable portable redistributable Rd-P-MCS module with the goal of charging during driving and do not charge when in stationary mode

(71) Applicant: Mihai Marchidann, Berlin (DE)

(72) Inventor: Mihai Marchidann, Berlin (DE)

(21) Appl. No.: 19/171,275

(22) Filed: Apr. 6, 2025

(51) Int. Cl. B60L 53/57; B60L 53/53; B60L 53/55; B60L 53/66

(52) U.S. Cl. CPC B60L 53/57; B60L 53/53; B60L 53/55; B60L 53/665

(57) ABSTRACT

The method and apparatus provide a scalable and cheap solution to the long-distance problem of the Electrical Vehicles (EV) where the charge of the Electrical Vehicle Battery (BEV) is supplied during driving. Prior art Electrical Vehicles (EV) expects waiting charging times to continue the planned trip.

The method is based on the Portable, Rentable and Redistributable charging module with Metering and Billing functionality, module abbreviated as “redistributable Rd-P-MCS” module, as opposed to Prior art portable charging module (P-MCS) [Ref-4] [Atmaja, T. D.].

Invention vehicles names “Rd-P-MCS compatible participating EV vehicles” have a novel charging and powering architecture with the novel “Rd-P-MCS compatible BEV Battery (BEV)” design working with the portable and rentable “redistributable Rd-P-MCS” module with metering and billing functionality in providing the “charging during driving” functionality.

The solution has optimal performance, reaching the maximum potential of stated performance and avoiding the degradation in time of such performance, with respect to avoiding waiting charging times when there are enough Recharging Stations (Super Stationary Charging Stations, Super Mobile Charging Stations, or Certified Partner Service vehicles) every time one needs replacing the “redistributable Rd-P-MCS” module.

The redistribution method, combined with the incentive method, may use Nash equilibrium, and competitive equilibrium, based algorithms to balance the availability of the “redistributable Rd-P-MCS” modules within a driving circuit.

Novel algorithms for efficiently finding and accessing such Recharging Stations, at fixed locations and future order-based dynamic locations, are based on the novel Dynamic Network of Recharging Stations concept.

### FIELD OF THE INVENTION

The invention solves the prior art long-distance mobility problem, when the EV vehicles need to stop for a charging waiting time period to recharge the energy depleted EV Battery (BEV).

The invention implements the “charging during driving” functionality towards the invention goal of “never charge when in stationary mode” for the invention Rd-P-MCS compatible participating EV vehicles having a charging and powering architecture based on the novel “Rd-P-MCS compatible BEV Battery (BEV)” battery and the novel “redistributable Rd-P-MCS” module that is portable, rentable charging device with metering and billing functionality.

The method uses a novel apparatus, namely the Portable, Rentable and Redistributable Charging module, e.g., an invention module that is referred further in the disclosure as a “redistributable Rd-P-MCS” module.

The module “redistributable Rd-P-MCS” module represents a packaged redistributable amount of electric charge that has Metering and Billing functionality that when used by the invention Rd-P-MCS compatible participating EV vehicle with its novel charging and powering architecture, such invention module allows the Rd-P-MCS compatible participating EV vehicle to charge the novel “Rd-P-MCS compatible BEV Battery (BEV)” battery and to power the Electrical Motor during driving which leads to avoidance of the stationary charging waiting times.

The solution is optimal with respect to avoiding waiting charging times in continuing the planned trip as long as there is at least one of the charging stations described in the present invention every time there is a need to replace the “redistributable Rd-P-MCS” module.

The solution is optimal because the invention Rd-P-MCS compatible participating EV vehicle may drive an infinite distance with virtually no stopping time to recharge. Moreover, there is no recharge waiting time for the “redistributable Rd-P-MCS” module because such module is replaced with an already charged “redistributable Rd-P-MCS” available module.

The idea behind the invention is that there are no synchronous waiting charging times neither when an Rd-P-MCS compatible participating EV vehicle needs to recharge, nor when the “redistributable Rd-P-MCS” modules are redistributed within a driving circuit between charging stations.

Even if a Rd-P-MCS compatible participating EV vehicle orders an “redistributable Rd-P-MCS” module at a future time at a location alongside its driving plan, the Super Mobile Charging Station (Super-MCS) and/or the Certified Partner Service vehicle (serviced by AAA, Uber, but not only, kind of service providers which are defined later in the disclosure—see FIG. 52, FIG. 53, FIG. 70, FIG. 92, FIG. 93, FIG. 94, FIG. 95, and FIG. 96) may drop the charged “redistributable Rd-P-MCS” module(s) to local participating entities such as registered local stores, but not only—see FIG. 100, FIG. 101, FIG. 102, FIG. 103, FIG. 104, and FIG. 105.

Having enough of these Recharging Stations, such as Super Stationary Charging Stations (Super-SCS), Super Mobile Charging Stations (Super-MCS), or Certified Partner Service vehicles, but not only, with enough available fully charged “redistributable Rd-P-MCS” modules along the planned trip route, using the invention redistribution method and the invention payment method could lead to reaching the maximum potential of the stated performance but also could lead to avoiding the degradation in time of such performance.

Architecture of Super Mobile Charging Station (Super-MCS) can be seen in figures FIG. 40, FIG. 41, FIG. 42.

Architecture of Super Stationary Charging Station (Super-SCS) can be seen in figures FIG. 38, and FIG. 39.

The invention disclosure assumes that the Recharging Stations mentioned above may also include, as distinct embodiments, local services and local stores with indirect transfer and/or with exchange of “redistributable Rd-P-MCS” modules, even if such example is not included in the enumeration of embodiments for Recharging Stations.

Optimized placement and movement of such Recharging Stations, such as Super Stationary Charging Stations, Super Mobile Charging Stations, or Certified Partner Service vehicles, but not only, together with novel algorithms for efficiently finding and accessing such Recharging Stations, at fixed locations or at future order-based determined dynamic locations, open a new theoretical and practical framework for optimizing and achieving the goal of avoiding the stationary waiting charging times with a minimum number of resources.

The method and apparatus not only allow rented automotive components to be used for the functioning of Rd-P-MCS compatible participating EV vehicles, the closest thing in Prior art standard gas-powered vehicles would be the gas filled in the fuel tank, but such the functioning is optimal if the right conditions are met.

While the Prior art in EV vehicle charging, aside the existing Mobile Charging Station (MCS) [Ref-4] [Atmaja, T. D.] concept which is limited in efficiency for large scale charging in a small amount of time, uses a static network of locations where EV vehicles can possible charge themselves, the present invention disclosure uses a dynamic network of charging locations and solutions where the “redistributable Rd-P-MCS” modules can be delivered and/or picked-up by using such module transfers or module swaps, but not only, in almost no time. This is the reason why the current state of the art is not entirely applicable for finding the optimal time and place where a charged “redistributable Rd-P-MCS” module could replace a currently discharged “redistributable Rd-P-MCS” module already used in the vehicle.

The invention allows charging stations to be placed outside the road lines' proximity with a dynamic placement that can be algorithmically optimized for such charging stations.

These charging stations may be stationary, ON-Grid or OFF-Grid, just like the neighborhood ice cream trucks or burger trucks, but this is not a requirement. They may stay all day in the same place or they may move from place to place based on their own schedule and business method.

The invention uses at least an additional “redistributable Rd-P-MCS” module in its charging and powering architecture rather than replacing the native Battery of Electrical Vehicle (BEV) as done by Nio and other companies.

This way the invention has flexibility in regard to the size of the “redistributable Rd-P-MCS” module, in regard to the electrical charge of the “redistributable Rd-P-MCS” module.

As opposed to the Prior art standardization of the BEV batteries which is quite hard since it affects other components and manufacturing processes, the invention “redistributable Rd-P-MCS” module is easier to be standardized and to be adopted across the industry.

The invention allows the functioning of an automobile to use a plurality of rented modules such as the “redistributable Rd-P-MCS” module and based on the charging and Electric Motor powering architecture more than one “redistributable Rd-P-MCS” module may be used during driving.

The invention solution is both scalable and without waiting time under conditions that are specified in the disclosure as opposed to the Prior art represented by the Mobile Charging Station (MCS) or by Nio EV Battery (BEV) replacement methods.

The invention provides several ways to recharge “redistributable Rd-P-MCS” modules that energy depleted:
a) at the standard Charging Stations, such as Super Stationary Charging Stations (Super-SCS) in a stationary mode,
b) at mobile chargers such as Super Mobile Charging Stations (Super-MCS) either in stationary mode (ON_GRID) or during driving (OFF-GRID).
c) At home, at work, but not only, as with the prior tar charging of rescue banks.

Both Super Stationary Charging Stations (Super-SCS) and Super Mobile Charging Stations (Super-MCS) are designed to be able to simultaneously recharge dozens of the invention “redistributable Rd-P-MCS” modules, allowing thus the scalability of the business method.

The invention solution scalability is partly due to the small size of the “redistributable Rd-P-MCS” module but also due to its features.

Because of the small size of the “redistributable Rd-P-MCS” module this leads to multiple such modules being recharged at the same time by the same charging station, or multiple such modules being transported between charging stations.

Prior art for fixed charging stations has the following characteristics:
a. only with stationary charging stations
b. the vehicle and driver wait to recharge
c. the Nio change of BEV battery is not scalable

The invention scalability is based by the small size of the “redistributable Rd-P-MCS” module, e.g., the size of a suitcase, that allows easier maneuverability and a high number of such modules, possibly in the number of several dozen if not hundreds, may be recharged by the same charging station such as Super Stationary Charging Station (Super-SCS), Super Mobile Charging Station (Super-MCS), but not only.

A “redistributable Rd-P-MCS” module may be used by multiple vehicles during a single day depending on the traffic and the needs of the Rd-P-MCS participating compatible EV vehicles.

Also, the driver of a Rd-P-MCS participating compatible EV vehicle may rent more than one “redistributable Rd-P-MCS” module at the same time, either to have backup modules when the driver enters an area with no service, or when the architecture of the Battery Charging and of the Electric Motor operation allows usage of multiple “redistributable Rd-P-MCS” modules.

Rd-P-MCS participating compatible EV vehicles allow rental of automotive components to be used in the functioning of such vehicles. This is similar with “renting” gas filled in the fuel tank at the gas stations, albeit without the possibility to return the excess gas.

The invention business method has the purpose of supporting the main goals of the invention:
a) charging while driving for the Rd-P-MCS compatible participating EV vehicles, but also other embodiments and variants:
   a. for example, see the charging and powering architecture presented in FIG. 111 with the support presented in FIG. 115,
b) every “redistributable Rd-P-MCS” module is charging with each opportunity:
   a. the “redistributable Rd-P-MCS” are charged when they are connected to ON-GRID Super Stationary Charging Stations (Super-SCS), when they are connected to ON-GRID Super Mobile Charging Stations (Super-MCS), when they are connected to OFF-GRID stationary Super Mobile Charging Stations (Super-MCS), and when they are connected to OFF-GRID driving Super Mobile Charging Stations (Super-MCS),
c) reaching the optimal performance goal of driving indefinitely without waiting recharge times (reaching the performance goals for each subscribed Rd-P-MCS compatible participating Electrical Vehicle (EV) vehicle in particular, based on the priority of the subscription plans)
d) avoiding the degradation of the performance of the driving circuit (avoiding the degradation of the performance for each subscribed Rd-P-MCS compatible participating Electrical Vehicle (EV) vehicle in particular, based on the priority of the subscription plans)

Note that ideally all the above business method goals mentioned above should be achieved entirely without exception.

However, whenever the resources in the driving circuit are not enough to maintain all these goals in their entirety, these goals are used as main guidelines and the target goals on how to improve the functionality of the driving circuit, including at the algorithmic level, but also on how to define statistical deviations from the ideal goals that are still able to provide a valuable and functional driving circuit: for example, that every driver with a subscription plan is guaranteed the performance goals for a certain percentage of the time with various cost and performance levels of the subscription.

The invention business method consists of several (sub)methods such as:
a. The subscription method
b. The redistribution method
d. The performance method
e. The rental method
e. The payment method
f. The cost method
g. The order method (the order placement method)
h. The dispatching method
i. The coverage method
j. The incentive method
k. The quality method
l. The repair method
m. The decision-making methods

The charging while driving method related to the invention introducing the novel concept of charging during driving or charging while driving where a Rd-P-MCS participating compatible EV vehicle may operate the vehicle from the Electrical Vehicle Battery (BEV) while BEV is also charged while driving from the rented “redistributable Rd-P-MCS” module.

Other use cases of operation with using “redistributable Rd-P-MCS” module are available and are explained in the present invention disclosure, for example when BEV has its electric charge exhausted, the Electric Motor(s) may become operated by a charged rented “redistributable Rd-P-MCS” module.

Other embodiments may include using two or more “redistributable Rd-P-MCS” modules where one such module is actively charging while driving the BEV: the BEV may operate the Electric Motor(s) while being charged by a rented “redistributable Rd-P-MCS” module or the operation of the Electric Motor(s) is handled by another rented “redistributable Rd-P-MCS” module.

Operating of the Electric Moto(s) can be switched between the standard BEV and one or more of the invention's “redistributable Rd-P-MCS” modules.

The invention disclosure presents several Battery Charging and Electric Motor(s) operation architectures.

The modus operandi of the invention that every “redistributable Rd-P-MCS” module in the driving circuit is charging with each opportunity: at the participating Charging Stations regardless if they are stationary, mobile stationary, or mobile driving.

The “redistributable Rd-P-MCS” module may be recharged by a Super Mobile Charging Station (Super-MCS) that is relocating it to another location in need thus reducing or avoiding altogether the time to be recharged while it waits for customers to rent it.

This functionality allows the invention to minimize, or to optimize with performance goals in mind, the “idle” time of such “redistributable Rd-P-MCS” modules when they cannot be rented because they are not charged.

The subscription method allows signing up owners of Rd-P-MCS participating compatible EV vehicles to enter into subscription contracts that allows them to pick-up a rented “redistributable Rd-P-MCS” modules without the wait time required to prepare and agree on a contract over and over again while they are driving in the circuit. This feature is required for minimizing and even eliminating the waiting time to pick-up or to exchange a “redistributable Rd-P-MCS” module because such actions represent renting a “redistributable Rd-P-MCS” modules.

The redistribution method allows the business method operator to maintain the commercial sustainability of the driving circuit against the degradation of the business operations when the energy depleted “redistributable Rd-P-MCS” modules start accumulating at the end points of the roads of the driving circuit.

Prior art has no redistribution method.

Invention redistribution method allows transfers between pairs of charging stations, including between pairs of mobile charging stations.

When the performance of the driving circuit is degraded and there is a lack of available “redistributable Rd-P-MCS” modules, the Rd-P-MCS participating compatible EV vehicle may recharge their BEV battery using Prior art stationary charging with Prior art waiting charging time.

Examples of the redistribution method are shown in figures FIG. 54, FIG. 55, FIG. 56, FIG. 57, FIG. 58 as below:
a) the exchange of “redistributable Rd-P-MCS” module(s) between a Super Stationary Charging Station (Super-SCS) and a Super-Mobile Charging Station (Super-MCS)
b) a Super-Mobile Charging Station (Super-MCS) that brings/transfers “redistributable Rd-P-MCS” module(s) to a Super Stationary Charging Station (Super-SCS), but also that swap/exchange “redistributable Rd-P-MCS” module(s)
c) a Super-Mobile Charging Station (Super-MCS) that transfers/gets “redistributable Rd-P-MCS” module(s) from a Super Stationary Charging Station (Super-SCS), but also that swap/exchange “redistributable Rd-P-MCS” module(s)
d) a Certified Partner Service vehicle (truck) that brings/transfers “redistributable Rd-P-MCS” module(s) to a Super Stationary Charging Station (Super-SCS)
e) a Certified Partner Service vehicle (truck) that gets/transfers “redistributable Rd-P-MCS” module(s) from a Super Stationary Charging Station (Super-SCS)

Other examples of the redistribution method are shown in figures FIG. 59, FIG. 60, FIG. 61, FIG. 62, FIG. 63, FIG. 64 as below:
the Swap/Exchange of Super-Mobile Charging Station (Super-MCS) Fully Discharged “redistributable Rd-P-MCS” modules with Super-Mobile Charging Station (Super-MCS) Fully Charged “redistributable Rd-P-MCS” modules
the Swap/Exchange of Super-Mobile Charging Station (Super-MCS) Fully Charged “redistributable Rd-P-MCS” modules with Super-Mobile Charging Station (Super-MCS) Fully Charged “redistributable Rd-P-MCS” modules
the Swap/Exchange of Super-Mobile Charging Station (Super-MCS from Servicing Area #1)'s Fully Charged “redistributable Rd-P-MCS” modules with Super-Mobile Charging Station (Super-MCS from Servicing Area #2)'s Fully Charged “redistributable Rd-P-MCS” modules
the Transfer of Super-Mobile Charging Station (Super-MCS from Servicing Area #1)'s Fully Charged “redistributable Rd-P-MCS” modules to Super-Mobile Charging Station (Super-MCS from Servicing Area #2), with also swapping/exchange of “redistributable Rd-P-MCS” module(s)
the Transfer of Super-Mobile Charging Station (Super-MCS)'s Fully Charged “redistributable Rd-P-MCS” modules to a Certified Partner Service vehicle, with also swapping/exchange of “redistributable Rd-P-MCS” module(s)
the Transfer of a Certified Partner Service vehicle's Fully Charged (or not) “redistributable Rd-P-MCS” modules to a Super Mobile Charging Station (Super-MCS), with also swapping/exchange of “redistributable Rd-P-MCS” module(s)

The performance method defines transparent performance goals for each Rd-P-MCS participating compatible EV vehicle depending on the level of their subscription plan.

The performance can be optimal when there are “enough” resources, e.g., enough charging stations with enough “redistributable Rd-P-MCS” modules in the proximity of a Rd-P-MCS participating compatible EV vehicle in need for recharge.

Approximation and optimizations based on heuristics, but not only, may be used when less resources are available in the driving circuit.

The availability of flexible ways to provide “redistributable Rd-P-MCS” modules, as described in the disclosure, including when the Rd-P-MCS participating compatible EV vehicle goes away from the main driving circuit, provides an increased level of performance for the invention.

The use of mobile charging stations, such as Super Mobile Charging Stations (Super-MCS), Certified Provider Station vehicles, but not only, can further add value to the driving circuit and its performance.

Prior art cannot define performance methods to find an optimal time and place for an exchange of charging devices.

The invention is able to define a Performance goal with its Performance method.

Moreover, with the invention subscription method the subscribers that own Rd-P-MCS participating compatible EV vehicles are able to select different levels of Performance Goals that the operator of the invention driving circuit with “redistributable Rd-P-MCS” modules guarantee under subscription contract terms.

Prior art is not able to provide performance plans and policies that would guide the business operators to fine tune their business methods' algorithms.

Since more expensive subscription plans are expected to guarantee better access to “redistributable Rd-P-MCS” modules, the subscribers with better subscription contracts may have priority in accessing such “redistributable Rd-P-MCS” modules when the availability of the module in the driving circuit decreases.

When the driving circuit has enough resources, for example when there are an unlimited number of charged “redistributable Rd-P-MCS” modules and an unlimited number charging station, e.g., the Rd-P-MCS participating compatible EV vehicles can find a charging station with enough charged “redistributable Rd-P-MCS” modules at any time it needs one, the invention provides an optimal solution with respect:
A. The distance: the Rd-P-MCS participating compatible EV vehicle can drive an unlimited distance with an almost zero waiting time for charging
B. The charging waiting time: the Rd-P-MCS participating compatible EV vehicle can recharge almost instantly by picking up a plurality of charged “redistributable Rd-P-MCS” module, swapping a plurality of discharged “redistributable Rd-P-MCS” modules with a plurality of charged “redistributable Rd-P-MCS modules, drop discharged “redistributable Rd-P-MCS” modules.

Please note that one could drop a charged “redistributable Rd-P-MCS” module or a partially discharged “redistributable Rd-P-MCS” module.

The goals of the performance method include:
a. reaching maximum potential of the performance stated in the subscription plan.
b. avoiding the performance degradation which is inevitable at some point in time if the redistribution method is not implemented.

However, whenever the resources are scarcer, for example during rush hour, the guarantees may be become more relaxed as defined in the subscription contracts.

One such subscription may define performance goals such as having available “redistributable Rd-P-MCS” modules in 95% of the time, or having available “redistributable Rd-P-MCS” modules in 85% of the time, or having available “redistributable Rd-P-MCS” modules in 75% of the time, but not only.

Also, whenever there is no available “redistributable Rd-P-MCS” modules the performance goal define in the subscription plan may also define a maximum time within an emergency “redistributable Rd-P-MCS” module will be provided.

A “rental method” that allows the following rental transactions of the “redistributable Rd-P-MCS” modules, as depicted in the figures FIG. 66, FIG. 67, FIG. 68, FIG. 69, FIG. 70, and FIG. 71, as follows without any limitation:
a) Multiple Choices for Swapping/Exchange or a Drop-off of a “redistributable Rd-P-MCS” module
b) SIMULTANEOUS multiple Swapping/Exchange of “redistributable Rd-P-MCS” modules between several EV vehicles and a Super Stationary Charging Station (Super-SCS)
c) SIMULTANEOUS Swapping/Exchange of “redistributable Rd-P-MCS” modules between several EV vehicles and an ON-GRID Super-Mobile Charging Station (Super-MCS)
d) SIMULTANEOUS Swapping/Exchanging of “redistributable Rd-P-MCS” modules between several EV vehicles and an OFF GRID Super-Mobile Charging Station (Super-MCS)
e) SIMULTANEOUS Swapping/Exchanging of “redistributable Rd-P-MCS” modules between several EV vehicles and a Certified Partner Service vehicle
f) Swapping/Exchange and Transferring “redistributed Rd-P-MCS” modules between an EV vehicle and an OFF GRID Super-Mobile Charging Station (Super-MCS), with extra “redistributed Rd-P-MCS” module(s)

Including but without any limitation the following rental goals:
a. A Rd-P-MCS compatible participating EV vehicle picks-up (rents) a charged “redistributable Rd-P-MCS” module from a Super Stationary Charging Station,
b. A Rd-P-MCS compatible participating EV vehicle drops-off (rents) a discharged “redistributable Rd-P-MCS” module to a Super Stationary Charging Station,
c. A Rd-P-MCS compatible participating EV vehicle swaps (by renting) a discharged “redistributable Rd-P-MCS” module for a charged “redistributable Rd-P-MCS” module with a Super Stationary Charging Station, e.g., the EV vehicle transfers a discharged “redistributable Rd-P-MCS” module from itself to the Super Stationary Charging Station, and the EV vehicle transfers to itself a charged “redistributable Rd-P-MCS” module from the Super Stationary Charging Station,
d. A Rd-P-MCS compatible participating EV vehicle picks-up (rents) a charged “redistributable Rd-P-MCS” module from a Super Mobile Charging Station (ON GRID or OFF GRID),
e. A Rd-P-MCS compatible participating EV vehicle drops-off (rents) a discharged “redistributable Rd-P-MCS” module to a Super Mobile Charging Station (ON GRID or OFF GRID),
f. A Rd-P-MCS compatible participating EV vehicle swaps/exchanges (rents) a discharged “redistributable Rd-P-MCS” module for a charged “redistributable Rd-P-MCS” module with a Super Mobile Charging Station (ON GRID or OFF GRID), e.g., the EV vehicle transfers a discharged “redistributable Rd-P-MCS” module from itself to the Super Mobile Charging Station (ON GRID or OFF GRID), and the EV vehicle transfers to itself a charged “redistributable Rd-P-MCS” module from the Super Mobile Charging Station (ON GRID or OFF GRID),
g. A Rd-P-MCS compatible participating EV vehicle picks-up (rents) a charged “redistributable Rd-P-MCS” module from a Certified Partner Service vehicle,
h. A Rd-P-MCS compatible participating EV vehicle drops-off (rents) a discharged “redistributable Rd-P-MCS” module to a Certified Partner Service vehicle,
i. A Rd-P-MCS compatible participating EV vehicle swaps/exchanges (rents) a discharged “redistributable Rd-P-MCS” module for a charged “redistributable Rd-P-MCS” module with a Certified Partner Service vehicle, e.g., the EV vehicle transfers a discharged “redistributable Rd-P-MCS” module from itself to the Certified Partner Service vehicle, and the EV vehicle transfers to itself a charged “redistributable Rd-P-MCS” module from the Certified Partner Service vehicle,

The payment method allows the business operations to become stable even if the customers do not know when to return the rented “redistributable Rd-P-MCS” modules.

The invention payment method allows transactions related to the rental of the “redistributable Rd-P-MCS” modules to be open ended at the moment when the driver picks up rented “redistributable Rd-P-MCS” modules either using:
a) the feature of “Billing and Metering” of a “redistributable Rd-P-MCS” module or through
b) the connection of the Point of Sale (POS) devices connected to a distributed database application implementing and managing such open sale transactions that close when the “redistributable Rd-P-MCS” module is returned in another charging station location or at an entity certified to receive “redistributable Rd-P-MCS” modules with an existing POS or a scan device that helps to conclude the rental transaction.

Note that with the feature of “Billing and Metering” of a “redistributable Rd-P-MCS” module there is no need to have a POS that concludes the transaction as long as returning the module by placing it in a business method certified recharging slot triggers its status in the distributed system that may take care of the transaction completion with the POS functionality implemented remotely in the system.

The cost method allows the business method, besides the standard cost method reasons, to optimize the stability of the driving circuit.

The small size of the “redistributable Rd-P-MCS” module allows scalability at the charging stations, both for recharging but also for transportation related to the redistribution method.

The driver of a Rd-P-MCS participating compatible EV vehicle may rent more than one “redistributable Rd-P-MCS” module even if only one can be used during driving.

However, this is a non-optimal use case that the invention cost method discourages through a higher cost imposed due to the lost efficiency that hurts the rest of the Rd-P-MCS participating compatible EV vehicle present in the driving circuit because makes such resources unavailable.

For the greater good of the driving circuit the cost method penalizes the non-optimal usage of “redistributable Rd-P-MCS” modules.

One would observe that such cost method aligns the optimization of the business method that wants as many as possible “redistributable Rd-P-MCS” modules available to the existing Rd-P-MCS participating compatible EV vehicles with the optimization of the goal of reducing rental costs for the driver of a Rd-P-MCS participating compatible EV vehicle.

Note: However, sometimes the trip advisor software may suggest that you need such non-optimal usage of “redistributable Rd-P-MCS” modules when the vehicle enters an area where the service is not good.

When returning a rented “redistributable Rd-P-MCS” module the driver will be charged a payment that may include the following:
a. fixed payment
b. payment based entirely on the “used” electric charge
c. a mixture of the above: a fixed payment and a payment related to the “used” electric charge

The order method, or the order placement method, consists of a plurality of “redistributable Rd-P-MCS” module orders to a future time and service location which are being served by the Remote Monitoring and Dispatching entity, through dispatching such Rd-P-MCS modules with the help of the mobile charging stations such as (OFF GRID) Super Mobile Charging Station and/or an (OFF GRID) Certified Partner Service vehicles.

The dispatching method uses queues of such Rd-P-MCS requests for future service executions, this would provide better optimized solutions, including with respect to used service resources and service predictability, leading to better cost savings and customer satisfaction.

The coverage method relates to relocating an OFF GRID Super Mobile Charging Station and/or an OFF GRID Certified Partner Service vehicles in order to maintain the service coverage in its service area in relation to certain policies, heuristics, and/or rules, defined by certain constraints, where the mentioned service coverage may be defined, for example, without any limitation, as the minimum number of “redistributable Rd-P-MCS” modules that serve a service area by their carrying charging stations (such as ON GRID Super Stationary Charging Stations, ON GRID and/or OFF GRID Super Mobile Charging Stations (Super-MCS), and OFF GRID Certified Partner Service vehicles).

The incentive method allows the drivers of Rd-P-MCS compatible participating EV vehicles to become redistribution agents, with a renumeration, of the “redistributable Rd-P-MCS” modules they rent in a localized way in the proximity of their travel plan, for example to drop-off a “redistributable Rd-P-MCS” module at a bit more inconvenient location for the driver, but with potential cost savings or other advantage for the business method.

The quality method for a driving circuit monitors the customer feedback of the rental service with respect to the entities participating in the redistribution method as well as the reliability of the system.

The quality method needs to implement a historic association between the “redistributable Rd-P-MCS” modules rented by the customers providing feedback and the entities participating into the redistribution method that had handled these rented modules.

It is useful therefore to monitor and maintain the quality of the “redistributable Rd-P-MCS” module at every step in the chain of distributing and renting such “redistributable Rd-P-MCS” modules.

The repair method uses a plurality of “spare redistributable Rd-P-MCS” modules from a Pool of spare “redistributable Rd-P-MCS” modules that are used to replace the “faulty redistributable Rd-P-MCS” modules when the Health Monitoring functionality of the “redistributable Rd-P-MCS” and/or of the supporting apparatus alerts about the presence of such modules in the Driving Circuit.

The decision-making methods, using Game Theory decision-making methods, may be used in order to optimize the cost of operating the driving circuit according to the overall performance model and the individual subscription performance guarantees, in particular related to the redistribution method, and including in relation to the incentive method, based on algorithms used to balance the availability of the “redistributable Rd-P-MCS” modules within a driving circuit.

The invention provides an embodiment where the optimization of the business costs and the optimization of the driver's costs are aligned in the sense that when one party tries to optimize their costs this will also lead to an optimization for the costs of the other party.

For example, the driving circuit operator has the goal of maintaining as many “redistributable Rd-P-MCS” modules being available to as many customers as possible, hence any inefficient rental of “redistributable Rd-P-MCS” modules is penalized, e.g., if a driver rents a “redistributable Rd-P-MCS” module that is not used efficiently the cost of such unused module increases in a non-linear way, including rental cost for the unused time, but not only. This sensible cost method model encourages the participating drivers to not over-rent the “redistributable Rd-P-MCS” modules.

Conversely, when the participating driver abstains from over-renting “redistributable Rd-P-MCS” modules that may not be used efficiently, this behavior maintains a better availability of “redistributable Rd-P-MCS” modules for the rest of the drivers; the responsible driver spends less money while the business operator is able to provide better coverage of “redistributable Rd-P-MCS” modules for the rest of the participating drivers.

Another example of alignment of goals between the business operator and the participating drivers/customers, is that because the drivers are encouraged with discounts to participate in distributing their depleted “redistributable Rd-P-MCS” modules to specific recommended charging locations, the lower the cost for such participating drivers is simultaneous with the greater availability of “redistributable Rd-P-MCS” modules into the driving circuit.

With such policies embedded into the business methods of the invention everybody wins: business operator and the customers.

The “redistributable Rd-P-MCS” module may be distributed thorough reputable local distributors, such as AAA, ADAC (Germany), Uber, Lyft, but not only, but also through asynchronous distribution via reputable local businesses such as Netto (Germany), Aldi, etc, that may receive a dropped “redistributable Rd-P-MCS” module until the driver that has ordered such module arrives and picks it up.

For flexibility, the “redistributable Rd-P-MCS” module may also be exchanged between mobile charging stations not involving any Rd-P-MCS participating compatible EV vehicles.

The “redistributable Rd-P-MCS” module may be seen as an electric charge unit used for commercial purposes within a business method provided by the present invention.

The “redistributable Rd-P-MCS” module has the important feature of “Metering and Billing” that allows the invention to be distinct and novel from the Prior art.

The “redistributable Rd-P-MCS” module may also be designed as a compact product or as a distributed product with multiple partitions of its subcomponents that belong either to a modified “redistributable Rd-P-MCS” module or to the Rd-P-MCS participating compatible EV vehicle.

Prior art is focused on replacing the whole standard BEV battery which increases the complexity and the cost of the technology involved in such Prior art embodiments. The invention does not require high cost in technology since all is required to manually take out the “redistributable Rd-P-MCS” module from a charging cradle, or to manually place in the invention “redistributable Rd-P-MCS” module into a charging cradle. This way of operation is present both in relation to operating the Rd-P-MCS participating compatible EV vehicle but also in relation to charging and/or transporting the “redistributable Rd-P-MCS” module withing the business method of the driving circuit.

Prior art is not scalable in case that there are a lot of driver requests to replace their BEV battery since the business operator needs to simultaneously charge depleted dropped-by BEV batteries which have a congestion point at the station exchange apparatus. Moreover, the charging station needs a large space to deposit the Prior art EV batteries.

Scalability is limited as seen above but also it is useless to take more than one BEV on the remaining trip plan since the extra BEV is of no use and the driver cannot exchange such extra BEV outside the service exchange locations.

The Prior art BEV cannot be charged in transit.

There is no concept of Prior art Mobile Charging Station that is able to recharge a BEV.

Even if the Prior art may be able to quickly exchange multiple BEV batteries for several customers in a short time, at some point the whole Prior art exchange system will become blocked because it is not sustainable and therefore not scalable:

Prior art does not have the redistribution method to avoid the waiting time to recharge the large pile of depleted BEV batteries the way the invention does with bringing already charged “redistributable Rd-P-MCS” modules to the charging stations in need. Prior art system does not have scalable parallel recharge of the BEV batteries the same way as the invention has a scalable recharging system, both stationary and mobile, because of the smaller size of the “redistributable Rd-P-MCS” module when compared with Prior art BEV battery and because of the additional features of the “redistributable Rd-P-MCS” module.

The scalability breaking point of Prior art is quite low when compared with the invention scalability breaking point.

The charging stations in need continuously advertise their status with how many “redistributable Rd-P-MCS” modules are depleted and how many already charged “redistributable Rd-P-MCS” module are needed. Please note that charging stations in need may be mobile with a changing of its location if needed.

Even with Prior art business methods that use the BEV exchange process there is a difference in the fact that:
a. the Prior art BEV exchange process does not use a modified battery from Prior art
b. the Prior art payment method is related to the exchange process which is synchronous
c. the Prior art payment method transaction ends at the location of exchange as opposed to the invention where the payment method transaction ends where the rented “redistributable Rd-P-MCS” module is returned to the driving circuit at a charging station but not only.
d. the Prior art method does not involve rental but only the exchange/replacement of the BEV
e. the Prior art return of an exchanged BEV may happen only at a charging station that has the apparatus to exchange BEV batteries. The Prior art return represents an exchange of BEV batteries, while the invention just returns the previously rented “redistributable Rd-P-MCS” module
f. The Prior art has only one battery at any time, while the invention may have the BEV and a plurality of “redistributable Rd-P-MCS” modules.

The invention makes use of a novel theoretical construct named “dynamic graphs” that have as nodes the possible locations, modeled and named as “virtual nodes”, where a mobile charging station may find itself as needed.

The dynamic graphs have nodes for each existing charging stations and for each virtual node and the edges of the dynamic graph represent the roads and their length between any of the dynamic graph's nodes.

A virtual node in such a dynamic graph may also be a “real node” if at the possible location associated with the virtual node there is a real mobile charging station.

However, only a few of such virtual nodes are real nodes too.

Since the mobile charging stations migrate on the dynamic graph from virtual node to virtual node, the real nodes representing such stations are also changing their position in the dynamic graph.

Algorithms that aim to optimize the availability of “redistributable Rd-P-MCS” modules in areas with a scarcity of charging stations may need to use optimizations involving such dynamic graphs and may need to take into account that such real nodes may have different positions at different times.

Algorithms need to take into account that when there is an on-demand order for a of “redistributable Rd-P-MCS” module, the placement of the mobile charging station modeled with a real node in the dynamic graph may change either to optimize the above said order, or it may change in order to optimize the service of a previous order or to optimize the service of a higher priority order.

Global optimization algorithm “redistributable Rd-P-MCS” modules as for a set of simultaneous/outstanding requests may be available.

The service of simultaneous multiple orders from multiple Rd-P-MCS participating compatible EV vehicles may be served using the NP-complete Traveler Salesman Problem (TSP) where the cities are Rd-P-MCS participating compatible EV vehicles that have ordered at least a redistributable Rd-P-MCS” module and the salesman is the mobile charging station.

Since there may be multiple mobile charging stations serving the same area, if each such mobile charging stations is modeled as a salesman, the usage of algorithms for the Multiple Traveling Salesman Problem (MTSP) would be useful.

One skilled in the art my observe that since the Traveling Salesman Problem (TSP) or Multiple Traveling Salesman Problem (TSP) involves a dynamic graph which is reconfigurable in time with respect to the location of the “real modes”, there is an open field for study the algorithms for the Traveling Salesman Problem (TSP) and the Multiple Traveling Salesman Problem (TSP) involving dynamic graphs.

Algorithms for searching available “redistributable Rd-P-MCS” modules in the driving circuit, both ON-GRID and OFF-GRID, may be based on the parameters used by the driver in the search:
a. radius area of the search
b. types of desired charging stations
c. feedback performance (minimum number of stars, etcetera)
d. number of available “redistributable Rd-P-MCS” modules
e. cost

The algorithms are based on the fixed locations and in future order based dynamic locations.

A mobile charging station may be involved in serving multiple orders at the same time, therefore Multiple Traveling Salesman Problem (MTSP) algorithms as well as other subclasses of the Traveling Salesman Problem (TSP) may be used.

Sometimes the optimization algorithms used to serve orders placed for “redistributable Rd-P-MCS” modules may need to factor in multiple steps in advance which opens a field for complex algorithms with dynamic graphs.

The performance method should employ algorithms that are based on the current traffic state as well as based on the current shared trip plans as well as based on the performance of each performance requirements for each subscribed Electric Vehicle (EV) present in the driving circuit.

The algorithms need to monitor the feasibility of maintaining the performance plan and the requirements for each EV vehicle with the current resources.

If there is a danger that the performance indicators may drop under the required performance, them the system shall requests additional “redistributable Rd-P-MCS” modules.

If the system detects redundant or unnecessary “redistributable Rd-P-MCS” modules then the excess of modules will be redirected to driving circuits in more need.

The driving circuit and its pool of “redistributable Rd-P-MCS” modules may be modelled with Petri Net where:
a. the dots represent the “redistributable Rd-P-MCS” modules,
b. the nodes are the charging stations,
c. the edges are the roads linking the charging stations, and the
d. transitions of dots inside such a Petri Net are either Rd-P-MCS participating compatible EV vehicles carrying rented “redistributable Rd-P-MCS” modules, either Super Mobile Charging Stations carrying and recharging “redistributable Rd-P-MCS” modules according to the redistributing method, or Certified Partner Service vehicles carrying “redistributable Rd-P-MCS” modules to vehicle in need that have placed an order, but not only.

For this reason, simulations and the theory and practice results from Petri Net and simulation Prior art could be used to device models and algorithms.

The more Rd-P-MCS participating compatible EV vehicle share with the driving circuit their travel plans, the more predictable and more optimized the driving circuit algorithms become.

Such algorithms may be devised for Optimized Placement of the mobile charging stations such as Super Mobile Charging Stations (Super-MCS), Certified Partner Services, but not only, as well as ad-hoc approved and incentivized Rd-P-MCS participating compatible EV vehicles.

The approval of the ad-hoc Rd-P-MCS participating compatible EV vehicles for distributing “redistributable Rd-P-MCS” modules may be limited when there is a danger that the Certified Partner Service program would be endangered or that the quality of the service is in danger to decrease.

### BACKGROUND OF THE INVENTION

According with Wikipedia: “An electric vehicle battery (BEV, also known as a traction battery) is a rechargeable battery used to power the electric motors of a battery electric vehicle (BEV) or hybrid electric vehicle (HEV). [ . . . ] Smaller, lighter batteries are desirable because they reduce the weight of the vehicle and therefore improve its performance”.

A paper describing “power converter-based chargers and power interfaces” in the topic of Electrical Charging Stations (ECS) shows “system configuration of a grid-connected ECS with RE power generation, a stationary ESS and a portable ESS”: https://www.mdpi.com/1996-1073/12/21/4201 which shows “system configuration of ECSs embedded with ESSs” and how “Stationary ESS or HESS” could potentially charge Portable ESS (PESS) that could be used in a car, where ESSs are “energy storage systems”, and HESS is a “hybrid energy storage system”, e.g., hybrid ESS.

HESSs with different architectures were proposed ways that may extend the life of a HESS, and how to apply a HESS to a Mobile Charging Station (MCS):
a. Deng, J.; Shi, J.; Liu, Y.; Tang, Y. Application of a hybrid energy storage system in the fast-charging station of electric vehicles. IET Gener. Transm. Distrib. 2016, 10, 1092-1097, https://ietresearch.onlinelibrarv.wilev.comidoi/epdf/10.1049/iet-dtd.2015.0110
b. Atmaja, T. D. Energy Storage System Using Battery and Ultracapacitor on Mobile Charging Station for Electric Vehicle. Energy Procedia 2015, 68, 429-437, https://core.ac.uk/download/pdf/82774674.pdf,

The paper, Energy Storage System Using Battery and Ultracapacitor on Mobile Charging Station for Electric Vehicle. Energy Procedia 2015, 68, 429-437, https://core.ac.uk/download/pdf/82774674.pdf, describes Mobile Charging System (MCS) for ON-GRID and OFF-GRID charging.

The Mobile Charging System (MCS) could be dispatched in two different charging modes i.e. OFF-GRID charging mode and ON-GRID charging mode. When MCS was stationed in certain FCS, it was connected to the power mid and can charge nearby EV.

In this state, MCS was in on-grid charging mode because it charges the nearby EV using its connection with the power grid. When the MCS was deployed to charge EV outside FCS, MCS will use its energy storage and invoke off-grid charging mode because this MCS utilize its energy storage without connected to the GRID. The paper shows the illustration for ON-GRID charging and OFF-GRID charging.

An architecture and a representation for the prior art Mobile Charging System (MCS) [Ref-4] [Atmaja, T. D.] are presented in FIG. 2 for the Top view, in FIG. 3 for the Side view, which both aggregate into the Complete view, and in FIG. 4 for the ESS Architecture for Mobile Charging Station (MCS).

FIG. 1 shows an impossible usage of prior art Mobile Charging System (MCS) [Ref-4] [Atmaja, T. D.], use case that becomes possible if one would replace the two (2) depicted Mobile Charging System (MCS) with two (2) invention “redistributable Rd-P-MCS” modules.

The Prior art Mobile Charging Station (MCS) concept was needed to provide on-grid charging or off-grid charging for EV. While on the off-grid charging mode, MCS power source comes from the energy storage mounted on the back compartment.

Lithium-iron phosphate (LiFePO4) was the most suitable battery for MCS application because this battery has superior thermal and chemical stability and, most importantly, this battery has higher discharge current than other batteries. In ultracapacitor consideration, the most appropriate ultracapacitor is electric double-layer capacitor (EDLC) because of having high power density. The combination of those two-energy storage could conduct all four charging levels as the DC/DC converter was needed to conduct level 4 charging and DC/AC inverter was needed to conduct level 1, 2, and 3 charging. This MCS was equipped with AC charger so it can charge the energy storage.

When MCS is connected to the power grid MCS also equipped with a battery monitoring system to control and monitor the using of the energy storage. ESS should be installed in a truck type vehicle and utilize the back compartment, side panel, and the dashboard. The battery pack, ultracapacitor, DC/DC converter, DC/AC inverter, and AC Charger should be mounted in back compartment. AC charger outlet, DC charger outlet, AC charger inlet, and metering and billing display will be mounted in the middle of the side panel. The dashboard will show the whole control and monitoring system via general user interface. Hopefully, installing battery and ultracapacitor on the MCS unit could facilitate smarter transportation system that supports future electricity distribution system like smart grid and V2G concept.

Another paper, https://www.researchgate.net/figure/RES-connected-DC-MG-for-EV-charging-with-ESU_fig3_353741277, presents depictions of charging stations and the EV vehicle Charging System architectures, describing on-board-charging and off-board-charging.

The paper https://www.mdpi.com/1996-1073/16/3/1031 shows a sketch of an “ultra-fast charger” and how this could be integrated into the DC micro-grid.

For controlling the voltage and current profiles of the charger output during the charging process, the electric vehicle must be equipped with a Battery Management System (BMS).

As presented in FIG. 3, this system monitors the voltage of each cell and the temperature, and it gives current and voltage references to the electric vehicle ultra-fast charger controller.

Another paper, “Iterative Design of a 60 kW All-Si Modular LLC Converter for Electric Vehicle Ultra-Fast Charging”, Davide Cittanti, Enrico Vico, Matteo Gregorio, Fabio Mandrile and Radu Bojoi, shows a schematic Overview of the Ultra-Fast DC Charger.

In FIG. 5 (the ESS grid) from the cited paper “Grid Impact of Electric Vehicle Fast Charging Stations: Trends, Standards, Issues and Mitigation Measures—An Overview”, LU WANG, ZIAN QIN, TIM SLANGEN, PAVOL BAUER, AND THIS VAN WIJK [Ref-1] [Lu Wang], shows how to use BESS in Fast-Charging Systems (FCS) where “battery energy storage systems” (BESS) providing support to existing charging infrastructures, e.g., during peak hours, when electricity demand is high, BESS can provide additional power to charging stations.”: https://www.evdesignandmanufacturing.com/news/revolutionizing-ev-charging-battery-energy-storage-systems-bess-powering-future-electric-vehicles-evs/.

Note that the “distributed ESS” and the “concentrated ESS” are part of the stationary charging infrastructure, hence they are not mobile like the present invention disclosure concept of “redistributable Rd-P-MCS” module.

Current state of the art in charging an EV vehicle using portable charging devices is limited in multiple ways:
a) such portable charging devices are thought to be used in emergency only situations,
b) the limited charge of such portable P-MCS charging modules is supposed to allow the EV vehicle reach a standard Prior art charging station.

As opposed to Prior art portable charging devices, if a portable ESS module is used inside the EV vehicle it cannot be charged while driving as in the present invention disclosure.

Briefly, the Prior art portable P-MCS charging devices has the following features and characteristics:
a) The charging is using a limited charge, as opposed to the present invention disclosure where a “redistributable Rd-P-MCS” module may hold a charge of up to hundreds of KWh.
b) The Prior art portable P-MCS charging device is externally positioned in relation to the EV vehicle when it is charging the vehicle.
c) The Prior art EV vehicle in need of recharge is stationary while being charged by a Prior art P-MCS emergency charging module, wherever for the present invention disclosure the recharge takes place during driving.
d) The Prior art P-MCS charging device is used in emergency situations only and not as a business method that gives assurances with regard to the service availability of charging the EV vehicle and its Battery (BEV).
e) The Prior art portable P-MCS charging device is used in emergency situations and not as a business method that gives assurances with regard to the performance of the service of charging the EV vehicle, with respect to the waiting time while stationary and with respect to how many times can recharge, or how much distance the EV vehicle can cover during such recharges, with the EV vehicle avoiding any significant stationary recharge waiting time.
f) The Prior art portable P-MCS charging device has no associated business method that would guarantee a reasonable performance nor that it would guarantee to avoid the degradation of such performance in time.
g) The Prior art service of charging is stationary and with significant waiting time.
h) The Prior art performance, e.g. stationary waiting time, but not only, is strongly if not entirely, dependent on the speed of the charging the EV vehicle from a Prior art charging station, as opposed to the present invention disclosure method and apparatus where the performance is improved, to an optimal level nonetheless, regardless of the speed of the charging.
i) The Prior art Mobile Charging Station (MCS) can charge only at most two vehicles and it is stationary for the whole duration of the charging before the MCS can go and service other EV vehicles in need to be recharged.
j) The Prior art EV vehicles are sold with all their components fully owned by the vehicle owner while the present invention disclosure uses an architecture that accommodates the use and the operation of at least a rentable, portable, and “redistributable Rd-P-MCS” module that is not owned by the EV vehicle owner.

While one can still own a portable, redistributable Rd-P-MCS module, the extend of the performance improvement is limited, in time and distance covered, if not using rentable “redistributable Rd-P-MCS” modules as part of a business method for short periods of times after which the driver is forced to relinquish/drop-off to another charging station after using its charge.
k) The Prior art EV vehicles are using:
   a. either unpacked electric charge from standard charging stations using an external charging cable or
   b. a Prior art P-MCS emergency module with a limited usefulness,
l) The Prior art EV vehicles' business method is to charge in stationary mode and pay for the service before driving again, while the present invention disclosure uses the concept of charging during driving and the payment method that starts when a “redistributable Rd-P-MCS” module is picked up and/or swapped from an invention disclosure Charging Station and that ends when the “redistributable Rd-P-MCS” module is dropped-off and/or swapped with another “redistributable Rd-P-MCS” module.
m) With the exception of the Prior art Mobile Charging Stations (MCS) which have their limitations with respect to high scale charging requests, the Prior art Charging Stations network is static, as opposed to the present invention disclosure where at least a part of the Charging Stations, see the Super Mobile Charging Station (Super-MCS) and the Certified Partner Service vehicles are dynamic with respect to their location.
n) With the exception of the Prior art Mobile Charging Stations (MCS) which have their limitations with respect to high scale charging requests, the Prior art Charging Stations network is static, as opposed to the present invention disclosure where the “redistributable Rd-P-MCS” module are moving (being redistributed) continuously in order to maintain the performance guarantees, where the redistribution algorithms use dynamic Charging Stations networks,
o) The Prior art EV vehicles' Electric Motor, or the plurality of Electric Motors, are connected directly to the EV Battery (BEV), while the represent invention disclosure proposes the decoupling from BEV of the Electric Motor, or the plurality of Electric Motors
   The current invention disclosure proposes that the EV vehicle to be powered on from a plurality of charging devices, such as BEV, “redistributable Rd-P-MCS” module, “Light Rd-P-MCS” module as part of the “Split Rd-P-MCS” design, see the architectures depicted in FIG. 87, and in figures FIG. 108, FIG. 109, FIG. 110, FIG. 111, and FIG. 112.
p) Prior art cannot work with the present invention disclosure described performance with:
   a. the total driving time of a trip much longer that the range of the BEV,
   b. the no recharge waiting time from departure to destination with the present invention disclosure method and apparatus,
   c. the readiness waiting time from call to the present invention disclosure's Super Mobile Charging Stations as compared to readiness waiting time in the case of the prior art Mobile Charging Station (MCS),
   d. the flexibility of using Mobile Charging Station (MCS) as Recharging Stations but without a big initial investment other than the cost of the Super Mobile Charging Stations (Super-MCS) and its “redistributable Rd-P-MCS” modules, participating cars' adaptations into embodiments of the Rd-P-MCS compatible participating EV vehicles, as well as the normal business costs)
q) Prior art cannot attain the present invention disclosure performance without using the added to the present invention disclosure concept of “redistributable Rd-P-MCS” module with “Metering and Billing” functionality added to the “redistributable Rd-P-MCS” module(s).

NOTE: Please note that “Rechargeable Stations”, “Recharging Stations” and “Recharge Stations” are used interchangeably in the present disclosure.

Even with Prior art business methods that use the BEV exchange process there is a difference in the fact that:
a. the Prior art BEV exchange process does not use a modified battery from Prior art
b. the Prior art payment method is related to the exchange process which is synchronous
c. the Prior art payment method transaction ends at the location of exchange as opposed to the invention where the payment method transaction ends where the rented “redistributable Rd-P-MCS” module is returned to the driving circuit at a charging station but not only.
d. the Prior art method does not involve rental but only the exchange/replacement of the BEV
e. the Prior art return of an exchanged BEV may happen only at a charging station that has the apparatus to exchange BEV batteries. The Prior art return represents an exchange of BEV batteries, while the invention just returns the previously rented “redistributable Rd-P-MCS” module
f. The Prior art has only one battery at any time, while the invention may have the BEV and a plurality of “redistributable Rd-P-MCS” modules.

The present invention disclosure envisions the design and manufacturing of such “redistributable Rd-P-MCS” modules by taking as reference the high-performance battery packs, such as those used in Formula E, that are rated for several hundred kWh, thus being enough performant to charge a normal EV vehicle's BEV, while driving.

The paper [Ref-7] [Melangon, S.] highlights the following: “Unlike other battery pack designs, EV batteries are full-sized batteries made to supply the entire range of the vehicle including the traction motor end accessories. Current EV batteries offer between 20 and 130 WM of energy and can use between 90% and 95% of that energy-a much higher Percentage than other types of batteries The Mercedes EQS is the electric car with the highest range, offering 485 miles of autonomy (780 km).

EV batteries represent a significant portion of the vehicle's weight and volume. They can weigh up to 450 kg [ . . . ] representing one-fourth of the cars total weight.

Different designs come with high voltage going from 400V to 900V. In the most recent designs, they are being integrated as part of the vehicle's structure.

High Performance Battery Packs High performance battery packs are batteries designed for Formula E races. They are divided in two categories: hybrid and pure EV. They are made with composite materials to obtain an ultra-light structure. Some high-performance batteries are removable to they can be replaced during races.

Even though they are small, these batteries can deliver ultra-high power. More precisely, they can deliver several hundred kW of power which is enough to output power for an entire neighborhood. Their cooling system is oversized due to the aggressive power demand.

High-performance battery packs are more energy efficient than other types of batteries. For example, they can recover a larger portion of lost energy during braking (regen braking).”

The present invention disclosure considers further to lower the cost and the size of such high-performance battery packs to make them available to most of the customers and not only for the rich people and their expensive super-luxury cars. Mercedes-Benz EV cars (EQS model) are rated best in terms of available energy, but at least for now they are not above 250 kWh or above the already mentioned Formula-E high-performance battery packs, that are lighter, that are more energy efficient, that are removable and therefore portable, and that deliverer more energy that are required for standard EV cars.

### BRIEF DESCRIPTION OF DRAWINGS

FIG. 1: Charging from two Mobile Charging Stations (MCS) trucks is not known in prior art

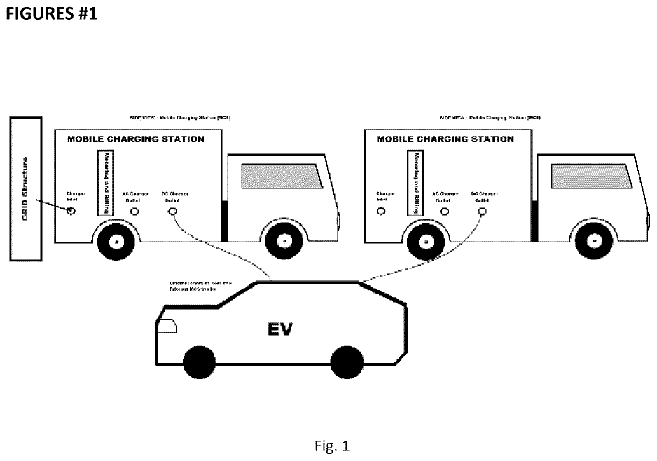

FIG. 2: The Mobile Charging Station (MCS) truck Side View from [Ref-4] [Atmaja, T. D.]

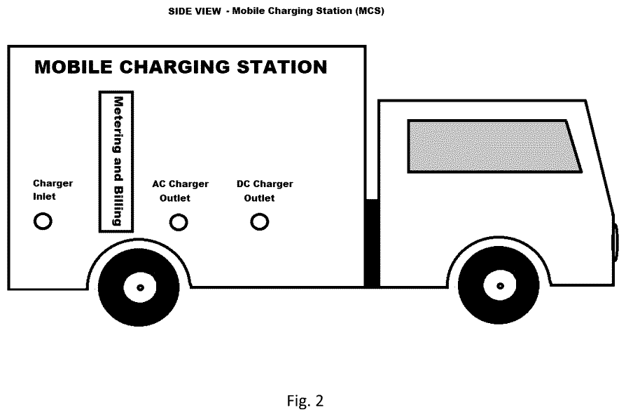

FIG. 3: The Mobile Charging Station (MCS) truck Top View from [Ref-4] [Atmaja, T. D.]

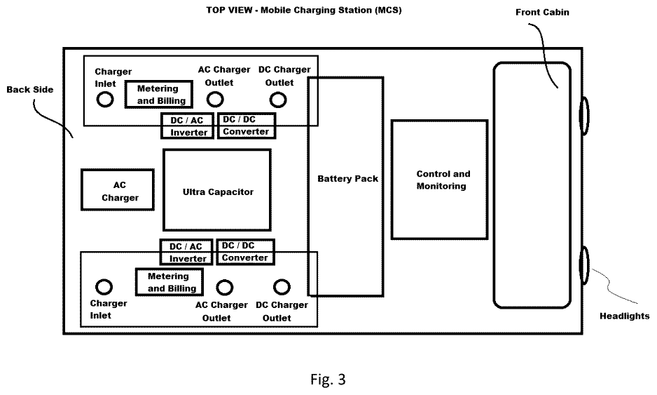

FIG. 4: The ESS Architecture for Mobile Charging Station (MCS) from [Ref-4] [Atmaja, T. D.]

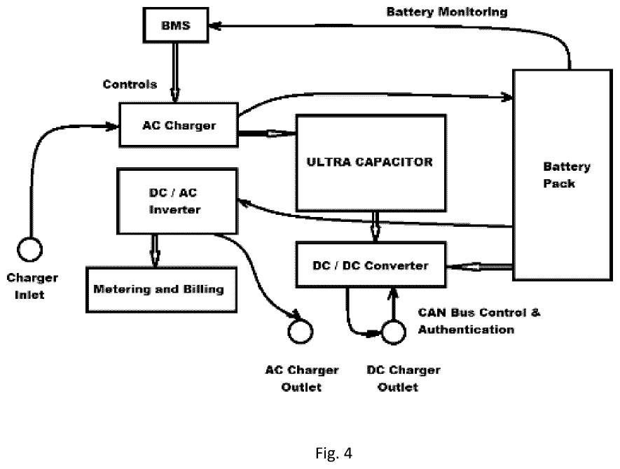

FIG. 5: The ESS Grid from [Ref-1] [Lu Wang]

FIG. 6: The ESS Grid Core from [Ref-1] [Lu Wang]

FIG. 7: The EV vehicle with an OFF-GRID portable, rentable, and redistributable Rd-P-MCS module, e.g., “redistributable Rd-P-MCS” module

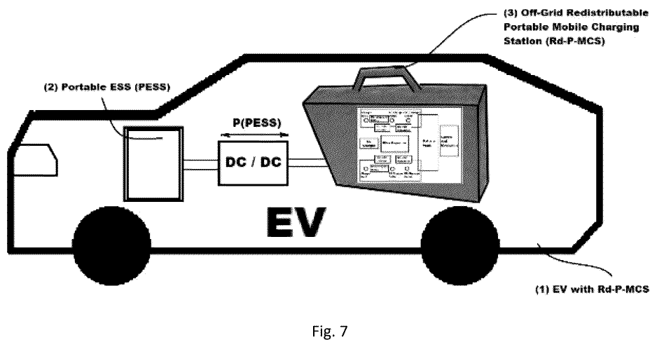

FIG. 8: The EV vehicle with On-Board portable, rentable, and redistributable Rd-P-MCS module, e.g., “redistributable Rd-P-MCS” module

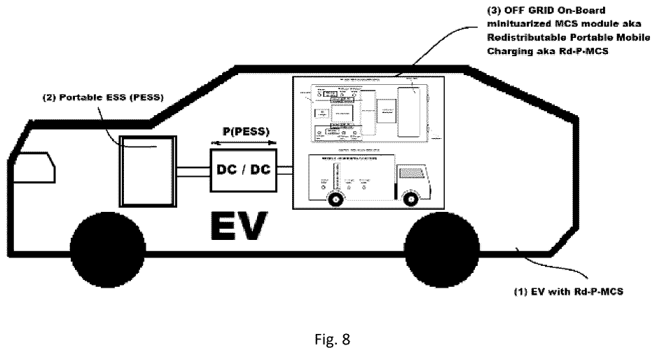

FIG. 9: The EV vehicle with an OFF-GRID On-Board portable, rentable, and redistributable Rd-P-MCS module, e.g., “redistributable Rd-P-MCS” module

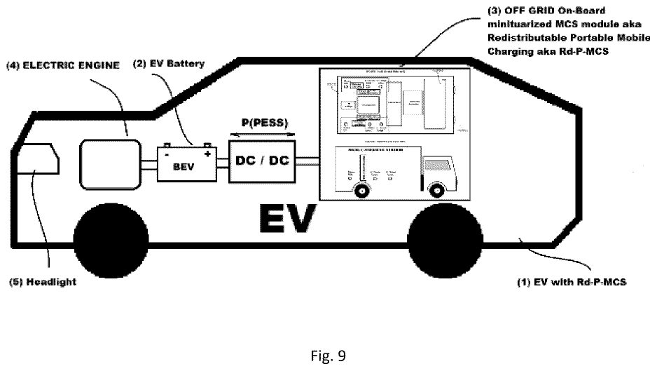

FIG. 10: The EV vehicle with an OFF-GRID portable, rentable, and redistributable Rd-P-MCS module, e.g., “redistributable Rd-P-MCS” module

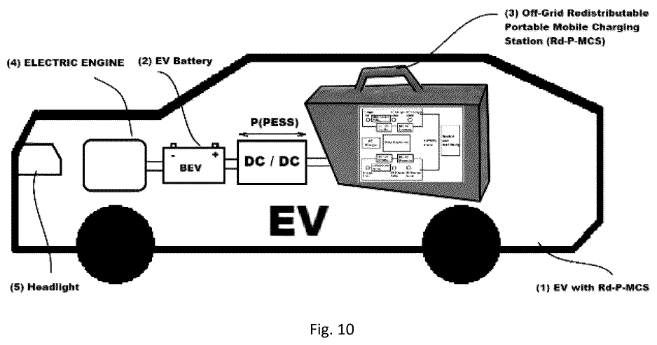

FIG. 11: The EV vehicle with an OFF-GRID On-Board portable, rentable, and redistributable Rd-P-MCS module, e.g., “redistributable Rd-P-MCS” module, with distributed ESS and Speed is not ZERO (0)

FIG. 12: The EV vehicle with OFF-GRID On-Board portable, rentable, and redistributable Rd-P-MCS module, e.g., “redistributable Rd-P-MCS” module, with distributed ESS and Speed is ZERO (0)

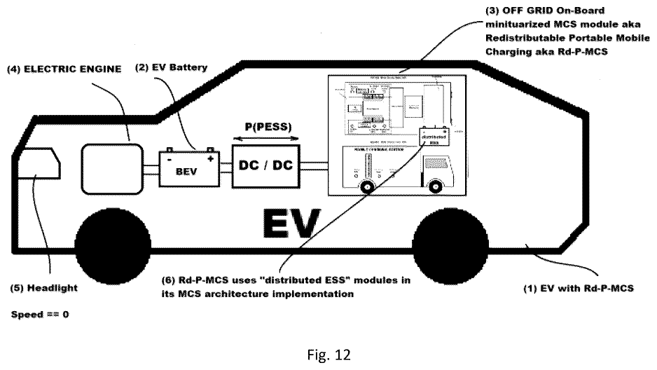

FIG. 13: The EV vehicle with an OFF-GRID portable, rentable, and redistributable Rd-P-MCS module, e.g., “redistributable Rd-P-MCS” module, with distributed ESS and Speed is ZERO (0)

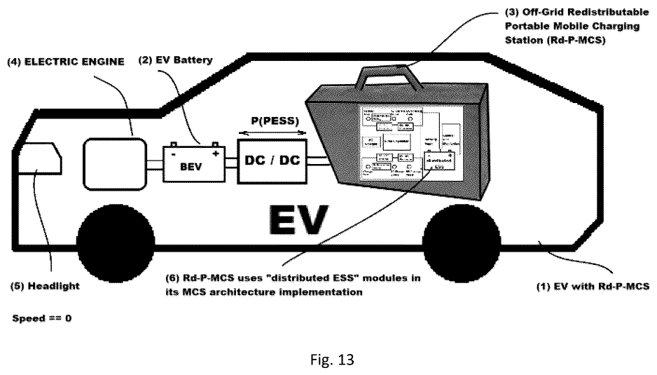

FIG. 14: The EV vehicle with OFF-GRID portable, rentable, and redistributable Rd-P-MCS module, e.g., “redistributable Rd-P-MCS” module, with distributed ESS and Speed is NOT ZERO

FIG. 15: EV vehicle with an External portable, rentable, and redistributable Rd-P-MCS module, e.g., “redistributable Rd-P-MCS” module, at Non-Zero Speed (external usage of Rd-P-MCS module is dangerous and non-patentable, same for prior-art P-MCS module)

FIG. 16: EV vehicle with an External portable, rentable, and redistributable Rd-P-MCS module, e.g., “redistributable Rd-P-MCS” module, at Zero Speed (similar with prior art)

FIG. 17: EV vehicle with an External portable, rentable, and redistributable Rd-P-MCS module, e.g., “redistributable Rd-P-MCS” module, at Non-Zero Speed (external usage of “redistributable Rd-P-MCS” module is dangerous and non-patentable, same for prior-art P-MCS module)

FIG. 18: EV vehicle with an External portable, rentable, and redistributable Rd-P-MCS module, e.g., “redistributable Rd-P-MCS” module, at Zero Speed (similar with prior art)

FIG. 19: The EV vehicle with multiple OFF-GRID On-Board portable, rentable, and redistributable Rd-P-MCS module, e.g., “redistributable Rd-P-MCS” module, with distributed ESS when Speed is non-Zero (Safe)

FIG. 20: EV vehicle charging from two prior art Mobile Charging Stations (MCS) with Speed is Zero (not predicted and/or thinkable in Prior art)

FIG. 21: A Super Mobile Charging Station (Super-MCS) that is Stationary and ON-GRID

FIG. 22: A Super Mobile Charging Station (Super-MCS) that is Stationary and ON-GRID

FIG. 23: A Super Mobile Charging Station (Super-MCS) that is OFF-GRID and Stationary

FIG. 24: A Super Mobile Charging Station (Super-MCS) that is OFF-GRID and DRIVING

FIG. 25: Genesys of the Invention Idea—Mobile-Charging-Station (MCS) changed into a Super Mobile Charging Station (Super-MCS) with an Array of portable, rentable, and Redistributable Rd-P-MCS modules, e.g., “redistributable Rd-P-MCS” module, (ON GRID, Stationary)

FIG. 26: Genesys of the Invention Idea—Mobile-Charging-Station (MCS) changed into a Super Mobile Charging Station (Super-MCS) with an Array of portable, rentable, and Redistributable Rd-P-MCS modules, e.g., “redistributable Rd-P-MCS” modules, (OFF GRID and Stationary)

FIG. 27: Genesys of the Invention Idea—Mobile-Charging-Station (MCS) changed into a Super Mobile Charging Station (Super-MCS) with an Array of portable, rentable, and Redistributable Rd-P-MCS modules, e.g., “redistributable Rd-P-MCS” modules, (OFF GRID and Driving)

FIG. 28: Invention Idea—Mobile-Charging-Station (MCS) changed into a Super Stationary Charging Station (Super-SCS) with an Array of portable, rentable, and Redistributable Rd-P-MCS modules, e.g., “redistributable Rd-P-MCS” modules, (OFF GRID and Stationary)

FIG. 29: Transforming prior art Mobile Charging Station (MCS) into the redistributable Rd-P-MCS module, e.g., “redistributable Rd-P-MCS” module

FIG. 30: Portable, rentable, and Redistributable “Rd-P-MCS” charging module, e.g., “redistributable Rd-P-MCS” module

FIG. 31: Portable, rentable, and Redistributable “Rd-P-MCS” charging module, e.g., “redistributable Rd-P-MCS” module

FIG. 32: Portable, rentable, and Redistributable “Rd-P-MCS” charging module, e.g., “redistributable Rd-P-MCS” module

FIG. 33: Portable, rentable, and Redistributable “Rd-P-MCS” charging module, e.g., “redistributable Rd-P-MCS” module

FIG. 34: Mounting the portable, rentable, and redistributable Rd-P-MCS module, e.g., “redistributable Rd-P-MCS” module, to the Grid (1st-part)

FIG. 35: Mounting the portable, rentable, and redistributable Rd-P-MCS module, e.g., “redistributable Rd-P-MCS” module, ON Grid (2nd-part)

FIG. 36: State of the art P-MCS and the Grid

FIG. 37: Mounting the Portable, rentable, and redistributable Rd-P-MCS module, e.g., “redistributable Rd-P-MCS” module, ON Grid (1st-part)

FIG. 38: Architecture of Super Stationary Charging Stations (Super-SCS) ON GRID with scalable number of “redistributable Rd-P-MCS” modules (2nd-part)

FIG. 39: Architecture of Super Stationary Charging Stations (Super-SCS) ON GRID with scalable number of “redistributable Rd-P-MCS” modules (3rd-part)

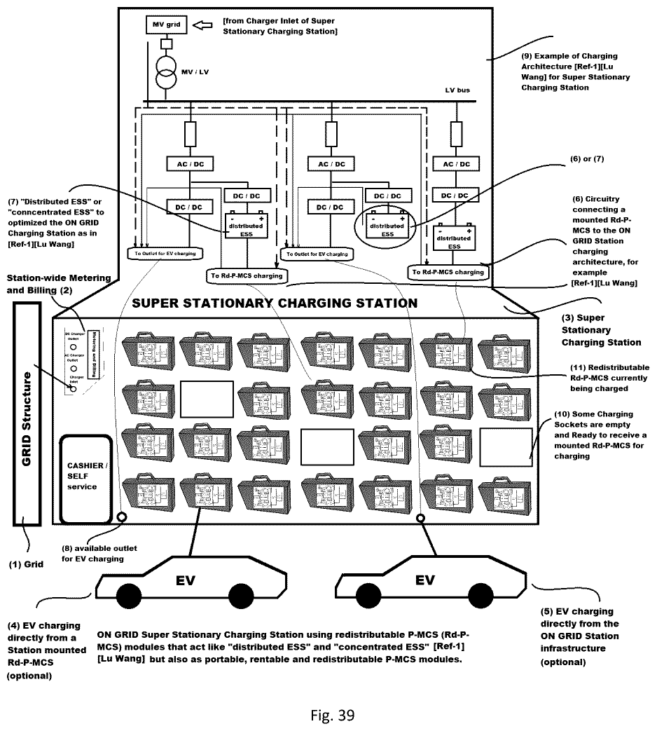

FIG. 40: Architecture of Super Mobile Charging Station (Super-MCS) ON GRID with a scalable number of “redistributable Rd-P-MCS” modules and Prior art EV vehicles charging from prior art outlet (1st-part)

FIG. 41: Architecture of Super Mobile Charging Station (Super-MCS) OFF GRID with a scalable number of “redistributable Rd-P-MCS” modules in Stationary mode (2nd-part)

FIG. 42: Architecture of Super Mobile Charging Station (Super-MCS) OFF GRID with a scalable number of “redistributable Rd-P-MCS” modules while Driving (3rd-part)

FIG. 43: Swapping “redistributable Rd-P-MCS” module(s) between an EV vehicle and a Super Stationary Charging Station (Super-SCS)

FIG. 44: Swapping “redistributable Rd-P-MCS” module(s) between an EV vehicle and an ON GRID Super Mobile Charging Station (Super-MCS)

FIG. 45: Swapping “redistributable Rd-P-MCS” module(s) between an EV vehicle and an OFF GRID Super Mobile Charging Station (Super-MCS)

FIG. 46: Mounting a “redistributable Rd-P-MCS” module into the EV vehicle

FIG. 47: Mounting a “Light redistributable Rd-P-MCS” module with “Ultracapacitor” and with “Control and Monitoring” module into the EV vehicle (v2)

FIG. 48: Mounting a “Light redistributable Rd-P-MCS” module without “Ultracapacitor” and without “Control and Monitoring” module into the EV vehicle (v2)

FIG. 49: A “Light redistributable Rd-P-MCS” module without “Ultracapacitor” and with “Control and Monitoring” module (v1)

FIG. 50: A “Light redistributable Rd-P-MCS” module (v1)—with annotations

FIG. 51: A “Light redistributable Rd-P-MCS” module with “Ultracapacitor” and with “Control and Monitoring” module (v2)

FIG. 52: Certified Partner Service truck with “redistributable Rd-P-MCS” modules

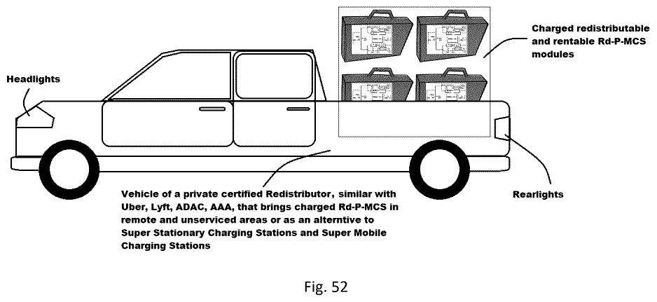

FIG. 53: Certified Partner Service truck with “redistributable Rd-P-MCS” modules (not fully loaded)

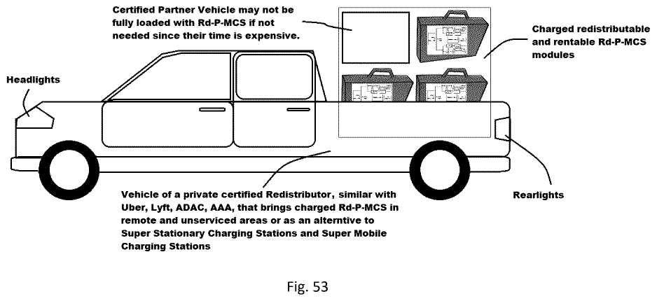

FIG. 54: Exchange of “redistributable Rd-P-MCS” module(s) between a Super Stationary Charging Station (Super-SCS) and a Super-Mobile Charging Station (Super-MCS)

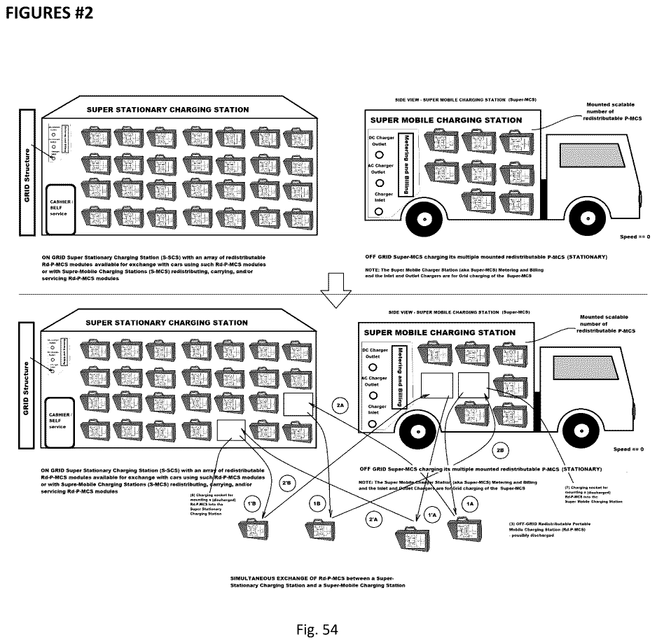

FIG. 55: Super-Mobile Charging Station (Super-MCS) brings/transfers “redistributable Rd-P-MCS” module(s) to a Super Stationary Charging Station (Super-SCS), also swapping/exchange of “redistributable Rd-P-MCS” module(s)

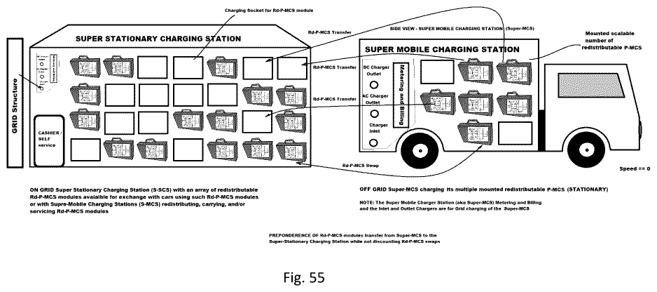

FIG. 56: Super-Mobile Charging Station (Super-MCS) transfers/gets “redistributable Rd-P-MCS” module(s) from a Super Stationary Charging Station (Super-SCS), also swapping/exchange of “redistributable Rd-P-MCS” module(s)

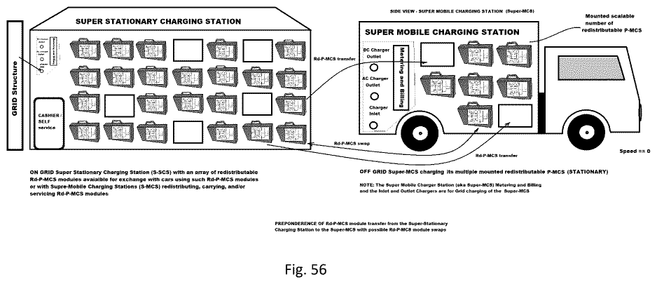

FIG. 57: A Certified Partner Service vehicle brings/transfers “redistributable Rd-P-MCS” module(s) to a Super Stationary Charging Station (Super-SCS)

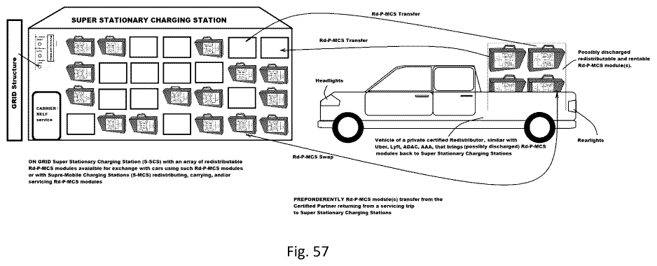

FIG. 58: A Certified Partner Service vehicle gets/transfers “redistributable Rd-P-MCS” module(s) from a Super Stationary Charging Station (Super-SCS)

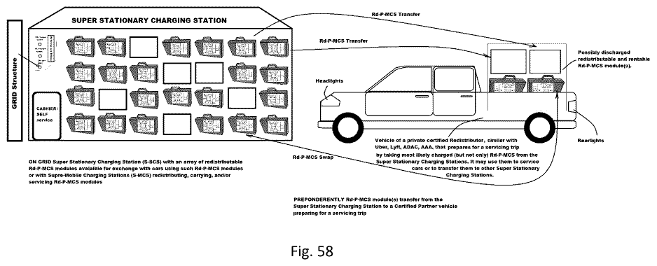

FIG. 59: Swap/Exchange of Super-MCS Fully Discharged “redistributable Rd-P-MCS” modules with Super-MCS Fully Charged “redistributable Rd-P-MCS” modules

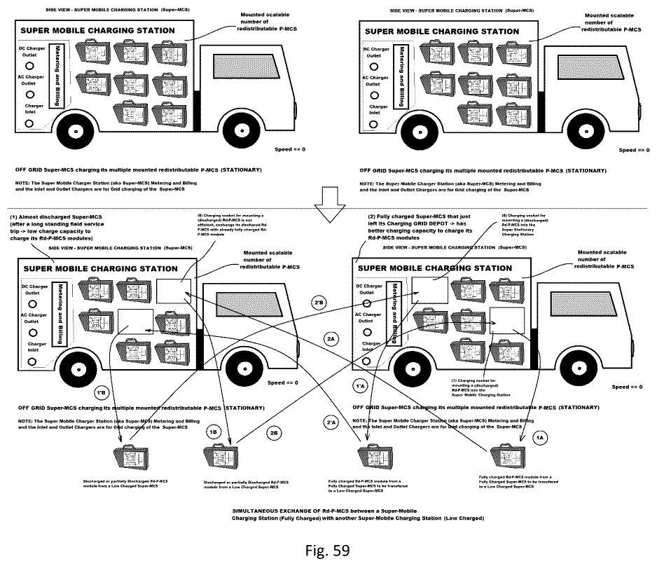

FIG. 60: Swap/Exchange of Super-MCS Fully Charged “redistributable Rd-P-MCS” modules with Super-MCS Fully Charged “redistributable Rd-P-MCS” modules

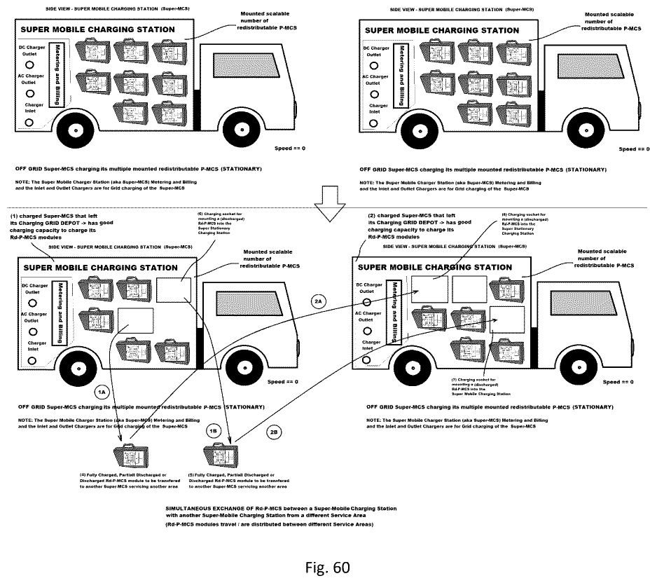

FIG. 61: Swap/Exchange of Super-MCS (from Servicing Area #1) Fully Charged “redistributable Rd-P-MCS” modules with Super-MCS (from Servicing Area #2) Fully Charged “redistributable Rd-P-MCS” modules

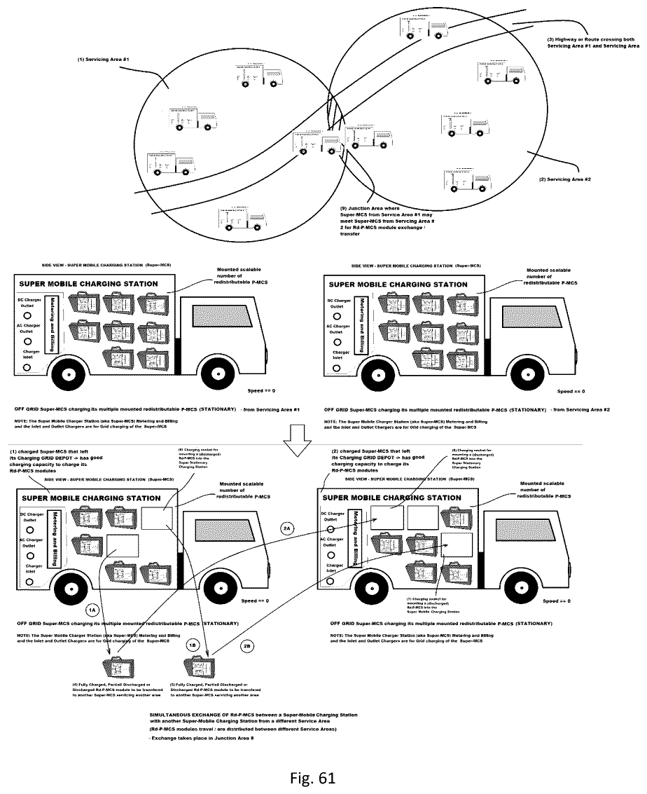

FIG. 62: Transfer of Super-MCS (from Servicing Area #1) Fully Charged “redistributable Rd-P-MCS” modules to Super-MCS (from Servicing Area #2), also swapping/exchange of “redistributable Rd-P-MCS” module(s)

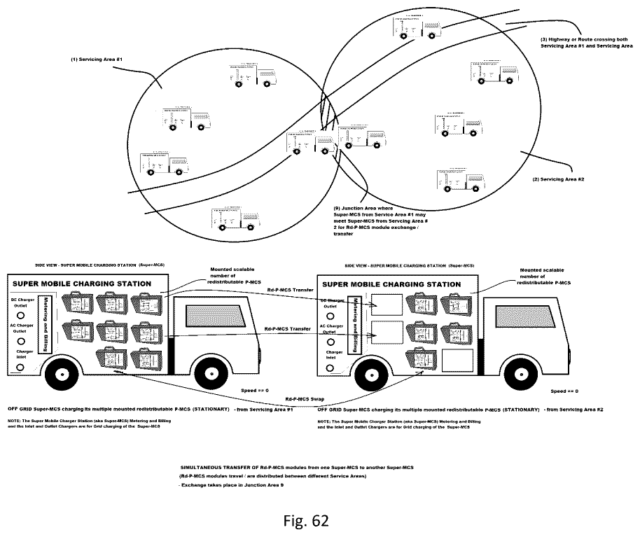

FIG. 63: Transfer of Super-MCS Fully Charged “redistributable Rd-P-MCS” modules to Certified Partner Service vehicle, also swapping/exchange of “redistributable Rd-P-MCS” module(s)

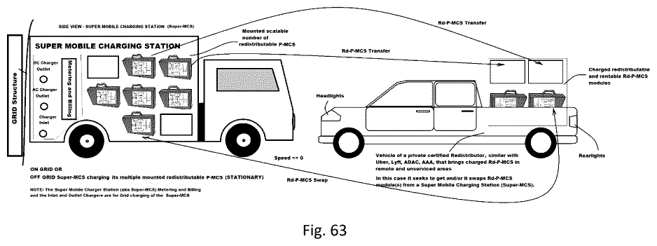

FIG. 64: Transfer of Certified Partner Service vehicle (Fully Charged, or not) “redistributable Rd-P-MCS” modules to Super Mobile Charging Station (Super-MCS), also swapping/exchange of “redistributable Rd-P-MCS” module(s)

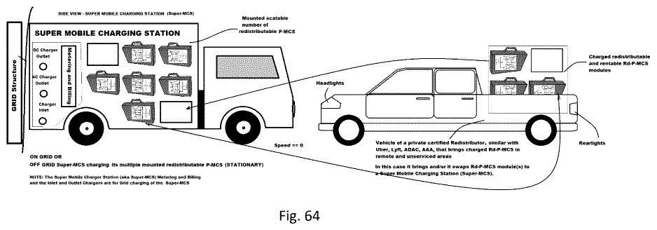

FIG. 65: Location Grid's Graph bounded and unbounded nodes (time specific)

FIG. 66: Multiple Choices for Swapping/Exchange or a Drop-off of a “redistributable Rd-P-MCS” module

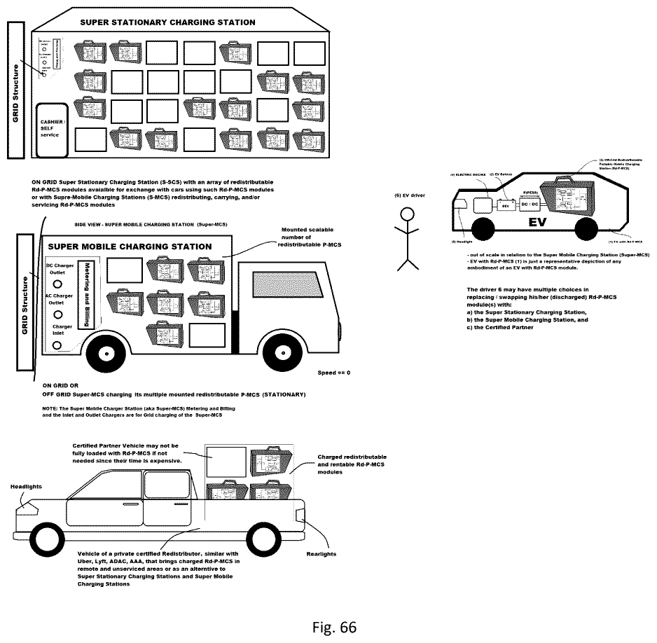

FIG. 67: SIMULTANEOUS multiple Swapping/Exchange of “redistributable Rd-P-MCS” modules between several EV vehicles and a Super Stationary Charging Station (Super-SCS)

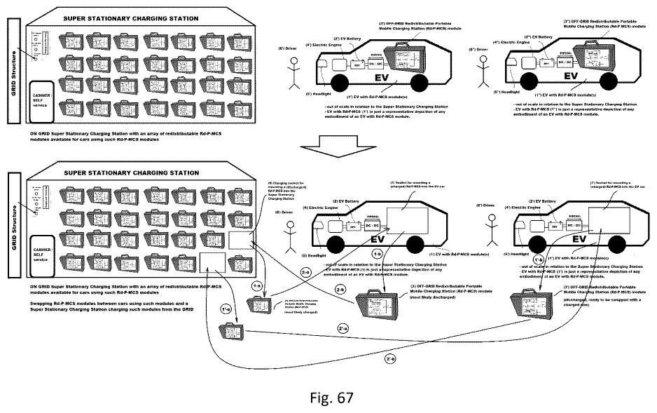

FIG. 68: SIMULTANEOUS Swapping/Exchange of “redistributable Rd-P-MCS” modules between several EV vehicles and an ON-GRID Super-Mobile Charging Station (Super-MCS)

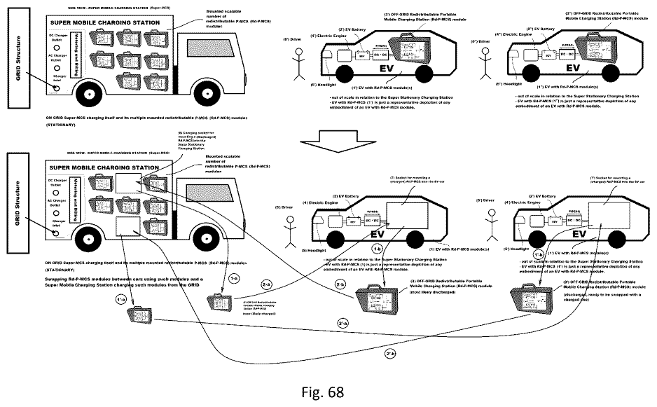

FIG. 69: SIMULTANEOUS Swapping/Exchanging of “redistributable Rd-P-MCS” modules between several EV vehicles and an OFF GRID Super-Mobile Charging Station (Super-MCS)

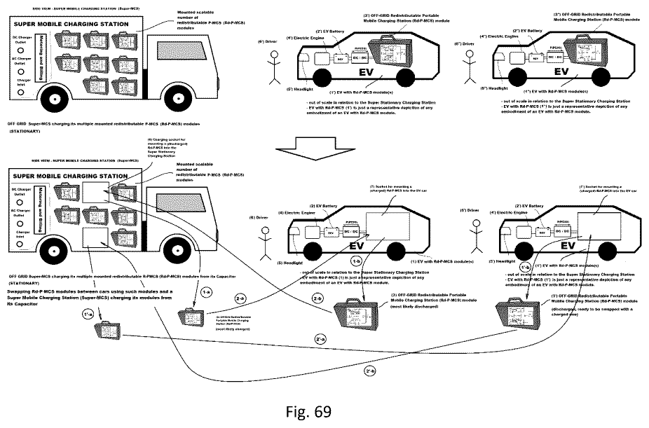

FIG. 70: SIMULTANEOUS Swapping/Exchanging of “redistributable Rd-P-MCS” modules between several EV vehicles and a Certified Partner Service vehicle

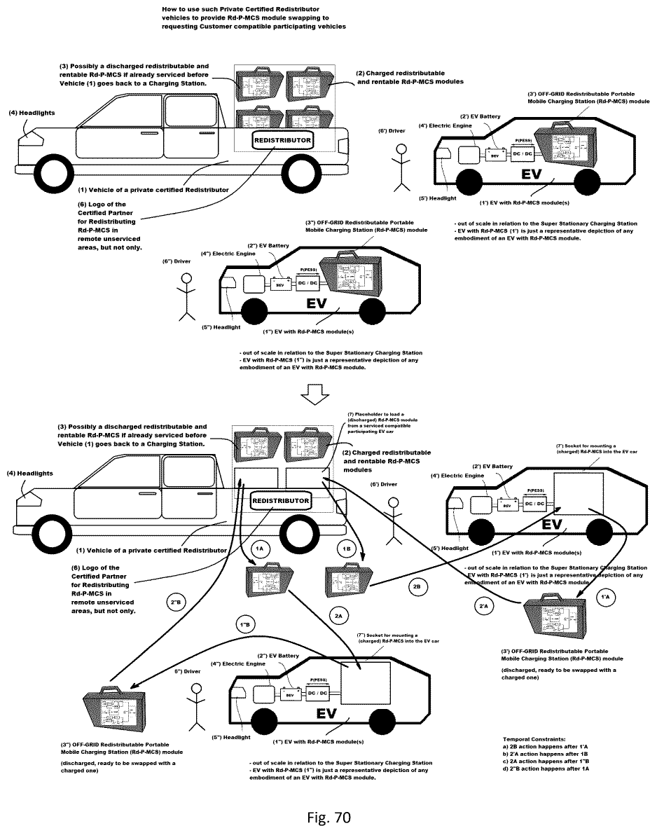

FIG. 71: Swapping/Exchange and Transferring “redistributed Rd-P-MCS” modules between an EV vehicle and an OFF GRID Super-Mobile Charging Station (Super-MCS), with extra “redistributed Rd-P-MCS” module(s)

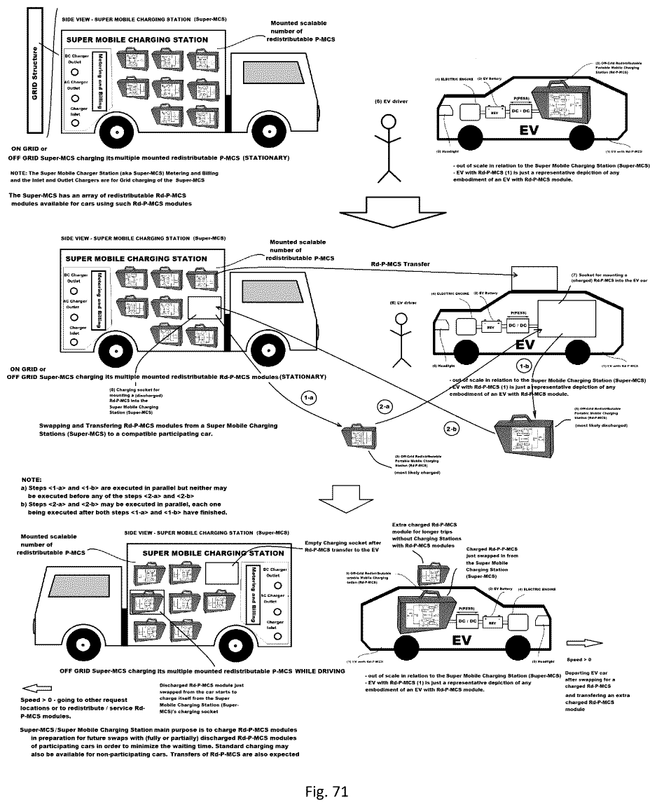

FIG. 72: Depictions of equivalent EV vehicles with “redistributed Rd-P-MCS” module (version 1)

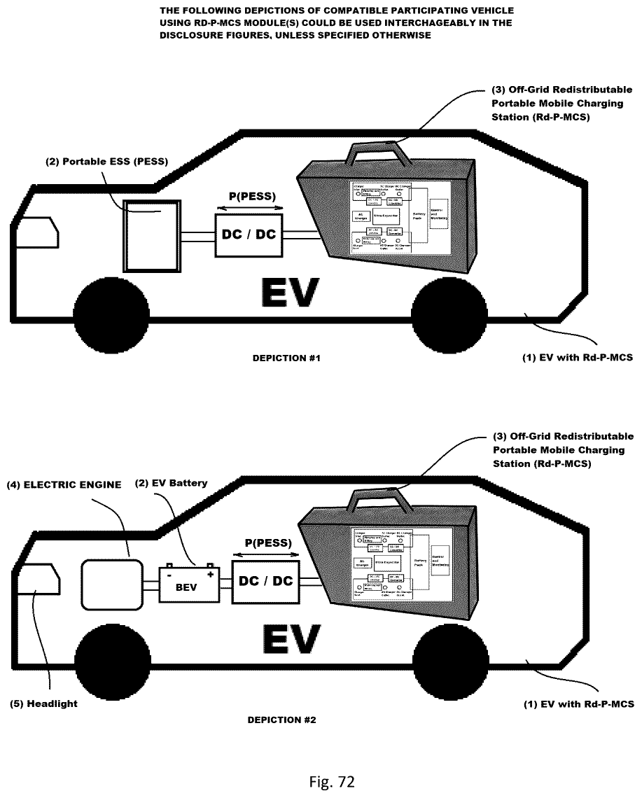

FIG. 73: Depictions of equivalent EV vehicles with “redistributed Rd-P-MCS” module (version 2)

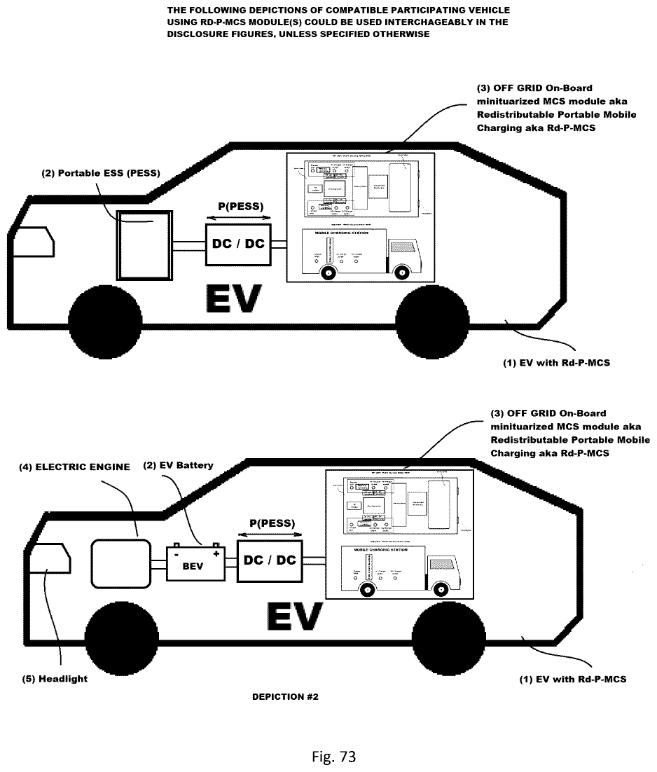

FIG. 74: Disclosure Idea of transforming a prior art Mobile Charging Station (MCS) into an ON GRID Super Mobile Charging Station (Super-MCS) with a scalable array of portable, rentable, and “redistributable Rd-P-MCS” modules

FIG. 75: Disclosure Idea of transforming a prior art Mobile Charging Station (MCS) into an OFF GRID Super Mobile Charging Station (Super-MCS) with a scalable array of portable, rentable, and “redistributable Rd-P-MCS” modules

FIG. 76: Disclosure Idea of transforming a prior art Driving Mobile Charging Station (MCS) into an OFF GRID Driving Super Mobile Charging Station (Super-MCS) with a scalable array of portable, rentable, and “redistributable Rd-P-MCS” modules

FIG. 77: Depiction of a portable, rentable, and “redistributable Rd-P-MCS” module (abstract labeling for FIG. 30, FIG. 31, FIG. 32, and FIG. 33)

FIG. 78: OFF-GRID and Driving Rd-P-MCS participating compatible EV vehicle charging its BEV with a “Split” redistributable Rd-P-MCS module (“Light redistributable Rd-P-MCS” module)

FIG. 79: OFF-GRID and Driving Rd-P-MCS participating compatible EV vehicle charging its BEV with a “Split” redistributable Rd-P-MCS module (“Light redistributable Rd-P-MCS” module)

FIG. 80: OFF-GRID and Driving Rd-P-MCS participating compatible EV vehicle charging its BEV with a “Split” redistributable Rd-P-MCS module (“Light redistributable Rd-P-MCS” module)

FIG. 81: OFF-GRID and Driving Rd-P-MCS participating compatible EV vehicle charging its BEV with a “Split” redistributable Rd-P-MCS module (“Light redistributable Rd-P-MCS” module)

FIG. 82: OFF-GRID and Driving Rd-P-MCS participating compatible EV vehicle charging its BEV with a “Split” redistributable Rd-P-MCS module (“Light redistributable Rd-P-MCS” module)

FIG. 83: OFF-GRID and Driving Rd-P-MCS participating compatible EV vehicle charging its BEV with a “Split” redistributable Rd-P-MCS module (“Light redistributable Rd-P-MCS” module)

FIG. 84: OFF-GRID and Driving Rd-P-MCS participating compatible EV vehicle charging its BEV with a “Split” redistributable Rd-P-MCS module (“Light redistributable Rd-P-MCS” module)

FIG. 85: OFF-GRID and Driving Rd-P-MCS participating compatible EV vehicle charging its BEV with a “Split” redistributable Rd-P-MCS module (“Light redistributable Rd-P-MCS” module)

FIG. 86: Architecture of Rd-P-MCS participating compatible EV vehicle charging its BEV with a “Split” redistributable Rd-P-MCS module (“Light redistributable Rd-P-MCS” module)

FIG. 87: Architecture of Rd-P-MCS participating compatible EV vehicle charging its BEV with a “Split” redistributable Rd-P-MCS module (“Light redistributable Rd-P-MCS” module)

FIG. 88: EV vehicle with an OFF-GRID On-Board portable, rentable and “redistributable Rd-P-MCS” module

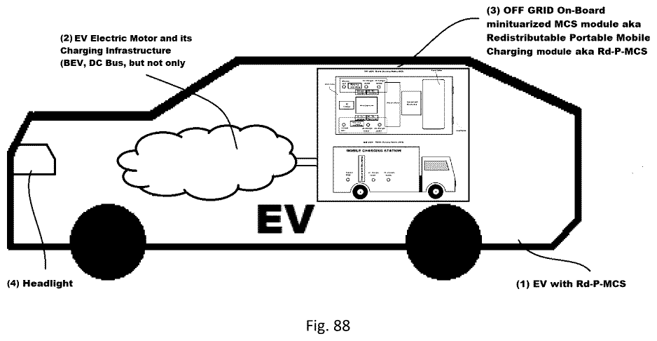

FIG. 89: A Super Stationary Charging Station (Super-SCS)

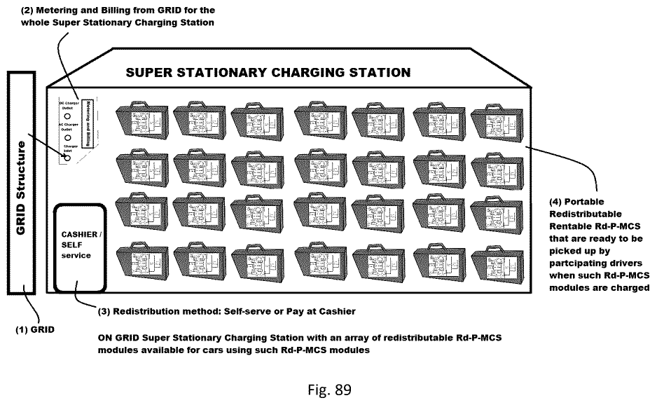

FIG. 90: A stationary ON-GRID Super Mobile Charging Station (Super-MCS)

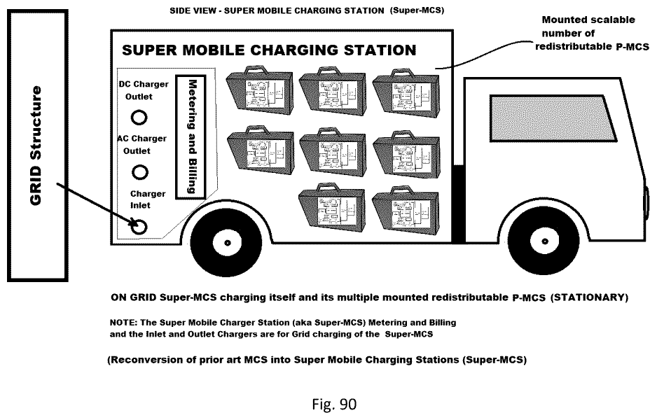

FIG. 91: An OFF-GRID Super Mobile Charging Station (Super-MCS)—either Stationary or Driving

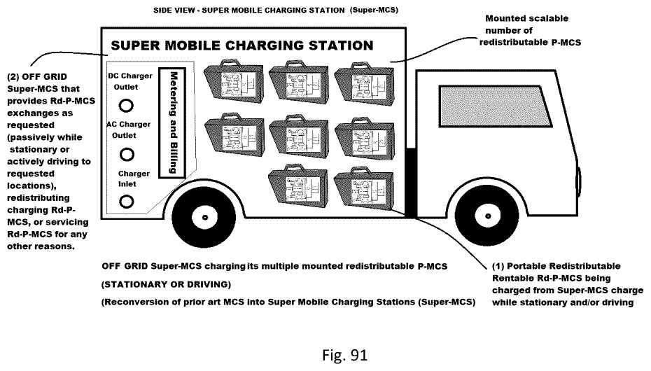

FIG. 92: A participating Certified Partner Service truck servicing portable, rentable, and “redistributable Rd-P-MCS” modules

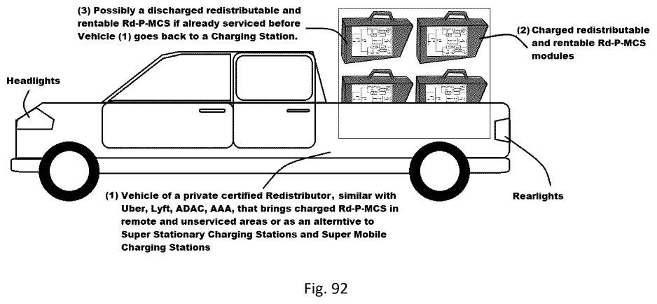

FIG. 93: A Certified Partner Service truck participating in servicing “redistributable Rd-P-MCS” modules (AAA variant)

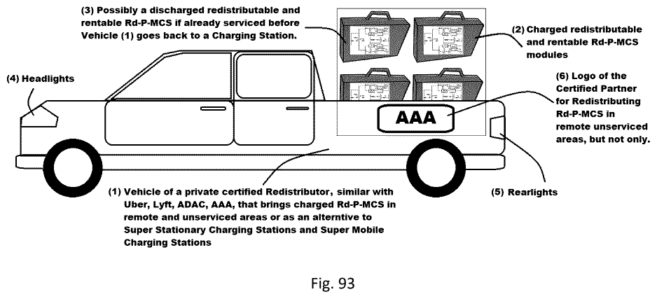

FIG. 94: A Certified Partner Service truck participating in servicing “redistributable Rd-P-MCS” modules (ADAC variant)

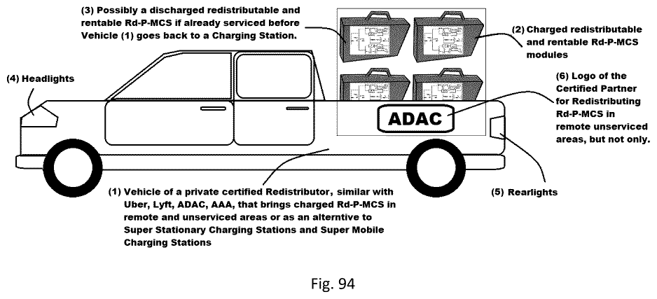

FIG. 95: A Certified Partner Service truck participating in servicing “redistributable Rd-P-MCS” modules (Lyft variant)

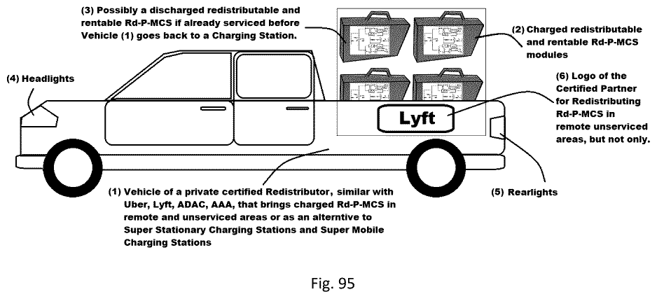

FIG. 96: A Certified Partner Service truck participating in servicing “redistributable Rd-P-MCS” modules (Uber variant)

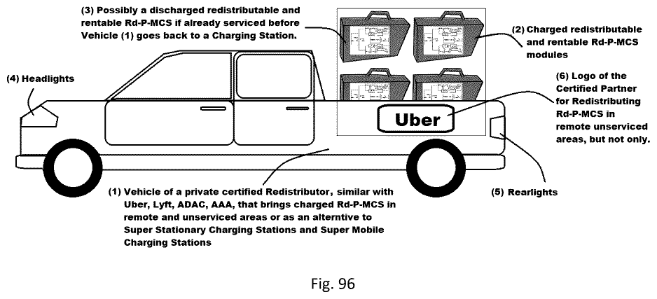

FIG. 97: Decoupling the Electrical Motor from the EV Battery (BEV)—the Electrical Motor may be powered directly from the on-board “redistributable Rd-P-MCS” module alternatively to the BEV

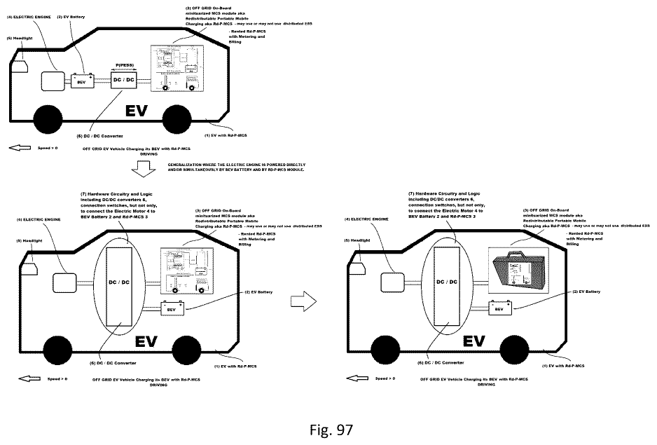

FIG. 98: Decoupling the Electrical Motor from the EV Battery (BEV)—the Electrical Motor may be powered directly from the on-board “redistributable Rd-P-MCS” module alternatively to the BEV (2nd embodiment)

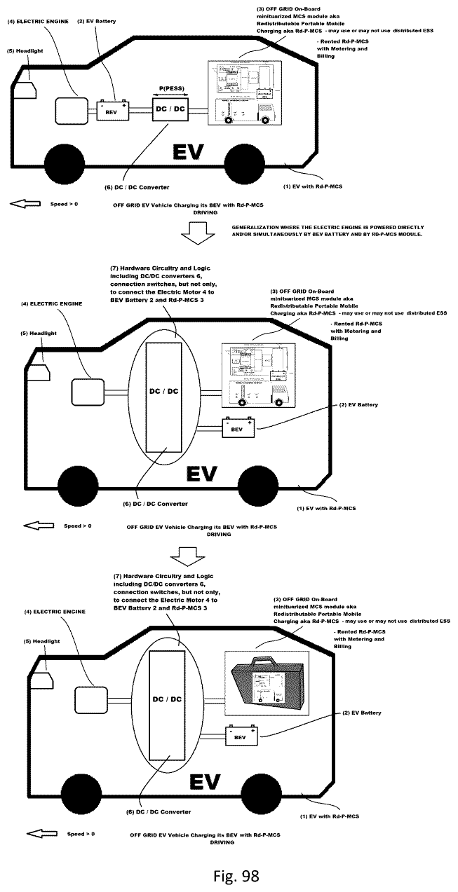

FIG. 99: Decoupling the Electrical Motor from the EV Battery (BEV)—the Electrical Motor may be powered directly from multiple on-board “redistributable Rd-P-MCS” modules alternatively to the BEV

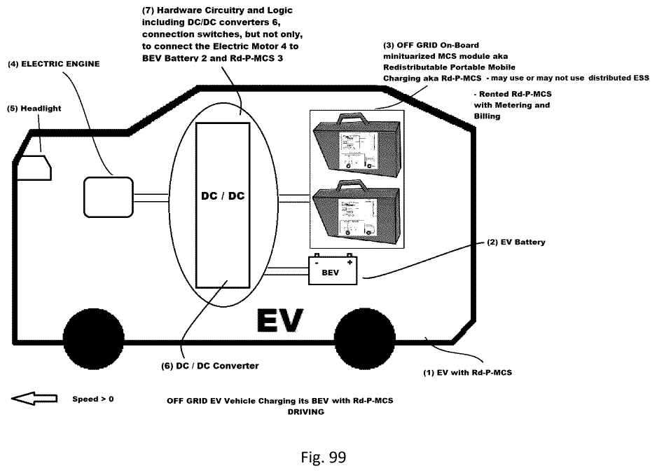

FIG. 100: Rd-P-MCS participating compatible EV vehicle picking up a “redistributable Rd-P-MCS” module that was previously dropped off by a Super Mobile Charging Station (Super-MCS)

FIG. 101: Certified Partner Service vehicle picking up a “redistributable Rd-P-MCS” module that was previously dropped off by a Super Mobile Charging Station (Super-MCS)

FIG. 102: Rd-P-MCS participating compatible EV vehicle picking up a “redistributable Rd-P-MCS” module that was previously dropped off by a Certified Partner Service vehicle

FIG. 103: Super Mobile Charging Station (Super-MCS) picking up a “redistributable Rd-P-MCS” module that was previously dropped off by a Certified Partner Service vehicle

FIG. 104: Super Mobile Charging Station (Super-MCS) picking up a “redistributable Rd-P-MCS” module that was previously dropped off by a Rd-P-MCS participating compatible EV vehicle

FIG. 105: Certified Partner Service vehicle picking up a “redistributable Rd-P-MCS” module that was previously dropped off by a Rd-P-MCS participating compatible EV vehicle

FIG. 106: Variant Implementation of alternate powering of the Electric Motor from either BEV Battery or from the “redistributable Rd-P-MCS” module. Electric Motor can be decoupled via DC Bus

FIG. 107: Variant Implementation of alternate powering of the Electric Motor from either BEV Battery or from the “redistributable Rd-P-MCS” module. Electric Motor can be decoupled via DC Bus

FIG. 108: New BEV Charging and Electric Motor Powering Architecture (1st embodiment)

FIG. 109: New BEV Charging and Electric Motor Powering Architecture (2nd embodiment with multiple Electric Motors)

FIG. 110: New BEV Charging and Electric Motor Powering Architecture (3rd embodiment with multiple Electric Motors and multiple “redistributable Rd-P-MCS” modules and one BEV)

FIG. 111: New BEV Charging and Electric Motor Powering Architecture (4th embodiment with multiple Electric Motors and multiple “redistributable Rd-P-MCS” modules and one BEV with two parts)

FIG. 112: New BEV Charging and Electric Motor Powering Architecture (5th embodiment with multiple Electric Motors and multiple “redistributable Rd-P-MCS” modules and multiple BEVs)

FIG. 113: Variant Implementation of alternate powering of the Electric Motor from two distinct BEV Batteries: one powering the Electric Motor while the other is charged by a “redistributable Rd-P-MCS” module, that could be part of the architecture from FIG. 112.

Electric Motor can be decoupled via DC Bus

FIG. 114: Variant Implementation of alternate powering of the Electric Motor from a BEV Battery and from a “redistributable Rd-P-MCS” module: one powering the Electric Motor while the other is charged by a “redistributable Rd-P-MCS” module, that could be part of any charging architecture with one BEV battery and at least two (2) “redistributable Rd-P-MCS” module, see figures FIG. 110, and FIG. 112. Electric Motor can be decoupled via DC Bus

FIG. 115: Electric Motor powered from a BEV Battery that has two battery parts: one battery part powering the Electric Motor while the other battery part is charged by a “redistributable Rd-P-MCS” module, that could be part of the architecture from FIG. 111. Electric Motor can be decoupled via DC Bus

FIG. 116: Simplified diagram from FIG. 115 to show that BEV may operate the Electric Motor while being charged by a “redistributable Rd-P-MCS” module, that could be part of the architecture from FIG. 111

FIG. 117: Use cases for the “redistributable Rd-P-MCS” module: operating an Electric Motor, charging a BEV Battery, charging another “redistributable Rd-P-MCS” module, being recharged from a Super Mobile Charging System (Super-MCS), and being charged from a Super Stationary Charging System (Super-SCS)

NOTE: The invention concepts and entities related to apparatus and methods, or part of thereof, such as the “Rd-P-MCS compatible participating EV vehicles”, the “Rd-P-MCS compatible BEV Battery (BEV)” battery, the “redistributable Rd-P-MCS” portable and rentable charging module, etcetera, or small variations of such, that are part of the charging and powering architecture proposed in the disclosure, that are referred in the figures, claims, methods, and description, but not only, are related and they support one another. Using terminology that uses quotations and bold text is used to highlight such standardized and related concepts and entities.

### FIGURES

Check the complementary files containing list of figures with titles: Figures #1, Figures #2, and Figures #3.

### SUMMARY OF THE INVENTION

The invention provides a solution for the long-distance driving that in Prior art requires at some point to recharge and therefore to stop the driving until the Electrical Vehicle Battery (BEV) becomes fully charged. The recharge waiting time and the scarcity of expensive to establish Prior art EV Charging Stations creates anxiety and reticence toward Electrical Vehicle (EV) wide adoption.

The invention method and apparatus claims that the Electrical Vehicle Battery (BEV) may be charged during driving which avoids waiting charging times from expensive to establish with limited availability EV Charging Stations solving the long-distance issues of the Electrical Vehicles (EV).

The invention adds a new battery device and a new charging architecture that are flexible and general enough to support the concept of charging during driving.

New EV architecture embodiments are proposed alongside with the novel Portable, Rentable and Redistributable charging module that has Metering and Billing functionality within the charging module that support the “charging during driving” feature with the invention payment method; the proposed module is named “redistributable Rd-P-MCS” module in order to differentiate it from Prior art portable charging modules (P-MCS).

The “redistributable Rd-P-MCS” module, as a concept of movable and billable energy unit, allows to minimize and even to eliminate the waiting times for recharging an Electric Vehicle (EV).

A multi-partite variant of the “redistributable Rd-P-MCS” module, named “Light redistributable Rd-P-MCS” module, is also described in the invention disclosure. Whenever we refer to “redistributable Rd-P-MCS” module and its related apparatus it is assumed that we also refer to the “Light redistributable Rd-P-MCS” module variant and its related apparatus.

The “redistributable Rd-P-MCS” module has a unique identity, geolocation functionality, metering and billing, etcetera, and has an electric charge that is comparable with a Prior art BEV, allows driving indefinitely with no recharging waiting time, e.g., with only “Rd-P-MCS redistributable” module swapping time, as long as the driving plan is aligned with a circuit that provides enough Recharging Stations.

The “redistributable Rd-P-MCS” modules are a partition of electrical energy into a packaging of electrical energy for “charging to go” just as we do with storing fossil fuel in Prior art vehicle's fuel tank.

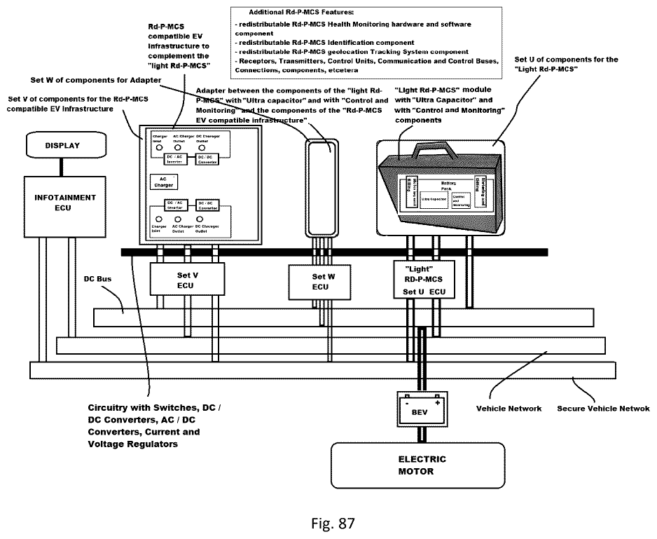

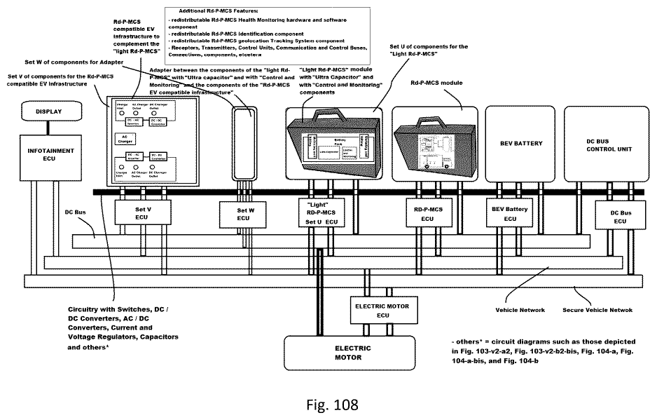

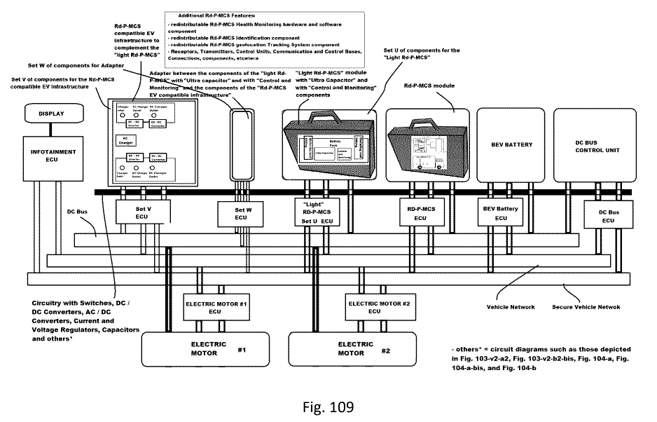

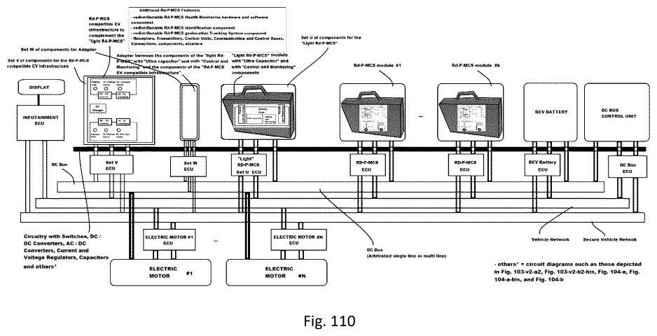

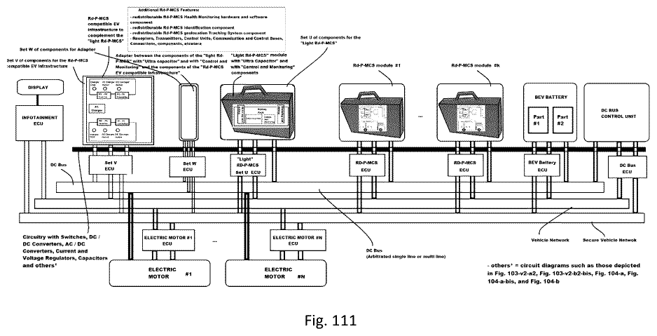

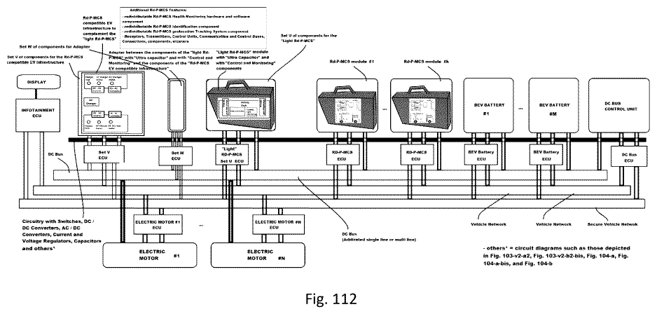

The new invention EV vehicle, named “Rd-P-MCS compatible participating EV vehicle”, with novel charging and powering architectures pictured in FIG. 87 and FIG. 108 (see all the embodiments, e.g. FIG. 108, FIG. 109, FIG. 110, FIG. 111, and FIG. 112), is able to use a plurality of “redistributable Rd-P-MCS” modules concept in providing the “charging during driving” functionality thus providing an optimal performance from the point of view of recharge waiting times in the conditions presented in the disclosure, supporting the described behavior and supporting the business method goals.

In FIG. 110, but also for all embodiments FIG. 108, FIG. 109, FIG. 110, FIG. 111, and FIG. 112, the embodiment of such invention architecture shows that a Rd-P-MCS compatible participating EV vehicle may have multiple “redistributable Rd-P-MCS” modules, including “Light redistributable Rd-P-MCS” modules, charging a plurality of Electric Motors.

The skilled in the art would note that using the invention “redistributable Rd-P-MCS” module would not work with Prior art vehicles without extensive adaptation, thus the “redistributable Rd-P-MCS” modules are designed to work together with Rd-P-MCS compatible participating EV vehicles.

While customer owned variants of the “redistributable Rd-P-MCS” module may be available as after-market rescue charge device, such usage may not use all the features of the “redistributable Rd-P-MCS” module during the commercial usage enabled by the invention business method.

Rather, the “redistributable Rd-P-MCS” modules are designed to be used in a sound and valid commercial environment and with a business method that supports the business goals declared in the present disclosure: meeting the full potential of reaching its optimal performance goals and the avoidance of degradation of such performance goals, but not only.

The “redistributable Rd-P-MCS” modules are not owned by the owners of the Rd-P-MCS compatible participating EV vehicles, but rather they are used as short-term rental service, as this is the whole point of the invention: transferring such modules, e.g., picking-up, dropping-off, swapping/exchanging, with the goal of acquiring packaged energy without any wait time.

The Rd-P-MCS participating compatible EV vehicles may have an architecture and a design that may involve a mix of owned components that are part of the vehicle contract purchase transaction, and rented components such as the “redistributable Rd-P-MCS” modules, while still be able to function without the rented components, which is different from the Nio business model.

The invention provides a Participating Driving Circuit mapped on high density driving routes such as highways, busy roads and major cities, extended to remote areas serviced based on request as described in the disclosure, consisting of a Pool of-Redistributable P-MS” may be charged at any of the plurality of Recharging Stations such as Stationary Portable Charging Stations (Super-SCS), Stationary Super Mobile Charging Stations (Super-MCS), driving Super Mobile Charging Stations (Super-MCS) with operations as described in disclosure, Power wall from home, Participating Certified Partner Services such as ADAC, AAA, as shown in disclosure), such “redistributable Rd-P-MCS” module being shared between participating compatible vehicles and being swapped between any pairs of Recharging Stations (Stationary Portable Charging Stations, Stationary Super Mobile Charging Stations (Super-MCS), Driving Super Mobile Charging Stations (Super-MCS) with operations as described in disclosure, Power wall from home, Participating Certified Partner Service vehicles from ADAC, AAA, etcetera, as shown in disclosure) involving at most one vehicle and at most one Stationary Portable Charging Stations (Super-SCS) in such swap, the Participating Driving Circuit having a pool of “Rd-P-MCS Dispatcher coordinator” entities (human and/or automated) to distribute “redistributable Rd-P-MCS” modules using Super Mobile Charging Stations (Super-MCS), Certified Participating Partners vehicles from ADAC, AAA, but not only, the Participating Driving Circuit having a Repair Auto Stations to repair the FAULTY redistributable Rd-P-MCS, Pool of standby NEW and/or REPAIRED.

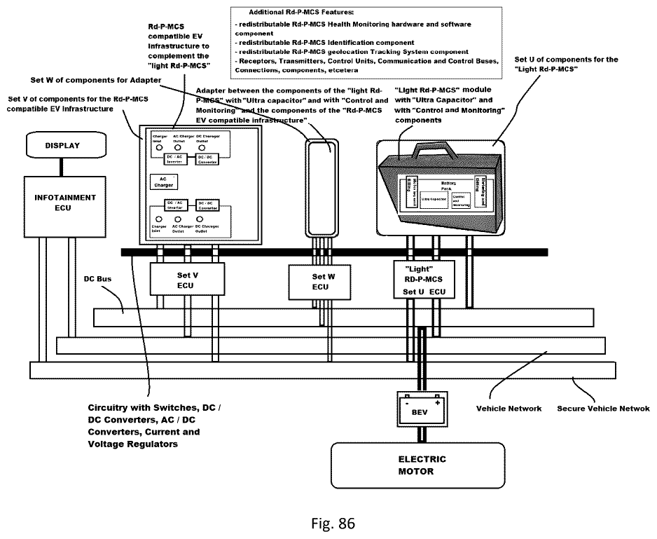

The “redistributable Rd-P-MCS” modules that are READY to be introduced into the Driving Circuit when needed, hardware and software to implement and to support the above mentioned entities of the invention apparatus and the business method and a pool of Super Mobile Charging Stations (Super-MCS) and Participating Certified Partner Service vehicles that are distributing “redistributable Rd-P-MCS” modules between Recharging Stations, responding and delivering to requests from participating drivers/compatible cars, removing faulty “redistributable Rd-P-MCS” modules from the Circuit Pool of such devices, adding WORKING (NEW and/or REPAIRED) “redistributable Rd-P-MCS” modules into the Circuit Pool of such devices, hardware and software to monitor the health of the participating “redistributable Rd-P-MCS” modules and the status of such devices, to monitor the needs for “redistributable Rd-P-MCS” modules at Charging Stations, methods and apparatus for metering, billing and payment, participating certified Payment Entities such as VISA, MasterCard, etcetera, the participating compatible vehicles may have an Infotainment System to monitor and control the active “redistributable Rd-P-MCS” (full or partial) participating to the charging architecture system as in FIG. 86, FIG. 87, and in figures FIG. 108, FIG. 109, FIG. 110, FIG. 111, and FIG. 112, please note that Regulators stand also for DC/DC converters.

The rental method of “redistributable Rd-P-MCS” modules define a transaction that takes place between a “starting Recharge Station” and a “destination Recharge Station” with effect to metering, billing, and payment.

Billing requires two locations: starting (pick-up location) and ending (drop-off location).

As opposed to renting a prior art vehicle, the renting of a “redistributable Rd-P-MCS” module is open ended, as opposed to the renting of a vehicle, in order to allow flexibility in returning the module to the pool of “redistributable Rd-P-MCS” modules available in the driving circuit for the rest of the subscribed drivers.

The Electric Motor may avoid being charged directly only from BEV but also from other charging devices, see the architecture from figures FIG. 108, FIG. 109, FIG. 110, FIG. 111, and FIG. 112, but not only, while State of art is BEV that is charged stationary—there is no access to the Electrical Motor with bypassing the BEV by a Rd-P-MCS.

Even when the Electric Motor is still charged directly from BEV, or other Charging device such as the “redistributable Rd-P-MCS” module, the BEV may still be charged from DC Bus or other Charging devices such as “redistributable Rd-P-MCS” module(s), but not only.

The DC bus can be maintained/charged with a variety of charging technologies: Prior art BESS, Electrical Vehicle Battery (BEV), “redistributable Rd-P-MCS” module, Prior art Mobile Charging Station, Super Mobile Charging Station (Super-MCS), Super Stationary Charging Station.

The Electrical Motor is decoupled from the Electrical Vehicle Battery (BEV), thus being connected to a DC Bus and supporting circuitry (including a plurality of ECUs—see the FIG. 86, FIG. 87, and figures FIG. 108, FIG. 109, FIG. 110, FIG. 111, and FIG. 112.

All charging entities may contribute at the same time to the DC Bus and its “charge reservoir” (Capacitor) to which the BEV is connected, but there is also the need of the availability of the use case when BEV is also charged while driving in order to minimize the rental time of “redistributable Rd-P-MCS” module and therefore to minimize the rental price.

The mobility, until the next Recharging Station, of such compatible participating cars is defined by the charge of its “BEV and rented Rd-P-MCS modules”.

Charging is asynchronous between car needing “redistributable Rd-P-MCS” module(s) and Super Mobile Charging Stations (Super-MCS), because the “redistributable Rd-P-MCS” module is transportable. The synchronous re-charge is happening only between Super Mobile Charging Stations (Super-MCS) and its mounted “redistributable Rd-P-MCS” modules while driving.

The “redistributable Rd-P-MCS” module becomes the unit of “fueling” the new Rd-P-MCS compatible participating EV vehicles.

Metering and Billing modules/circuits could be part of the “redistributable Rd-P-MCS” module which gives flexibility and more independence from the design and implementation of the Charging Stations (Super Stationary Charging Stations and/or Super Mobile Charging Stations), but the Metering (and) Billing could be split between the Rd-P-MCS and one or more Charging Stations (Stationary and/or Super Mobile Charging Stations), e.g., the Start Charging Stations (where the pick-up happens) and the Stop Charging Station (where the drop-off happens), including in an exclusive matter with a global distributed systems and databases that register, monitor and search/find such open transactions (including partial active transactions) from any such participating Charging Stations—this way a transaction may be handled by multiple Charging Stations.

Because the “redistributable Rd-P-MCS” module may be used by several times during the same day by different EV vehicles, the “redistributable Rd-P-MCS” module needs to give an assurance of performance (both mobility and range) in order to empower the drivers' driving plans that they could count on a Guarantee MINIMUM performance.

Because exchanging a “redistributable Rd-P-MCS” module between a Rd-P-MCS compatible participating EV vehicle and a Super Mobile Charging Station takes a short time, the Super Mobile Charging Station becomes more efficient when called by EV vehicles needing a “redistributable Rd-P-MCS” module: the Super Mobile Charging Station just drops-off a “redistributable Rd-P-MCS” module and then it goes to service other dispatch orders.

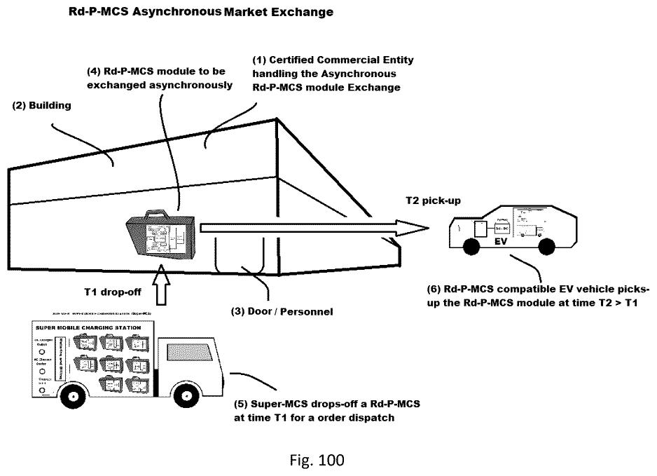

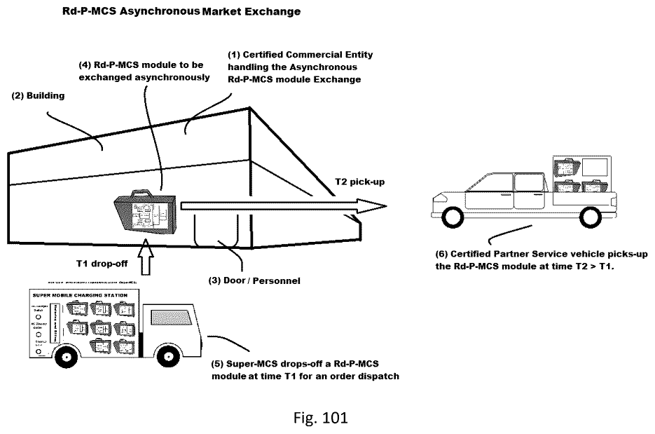

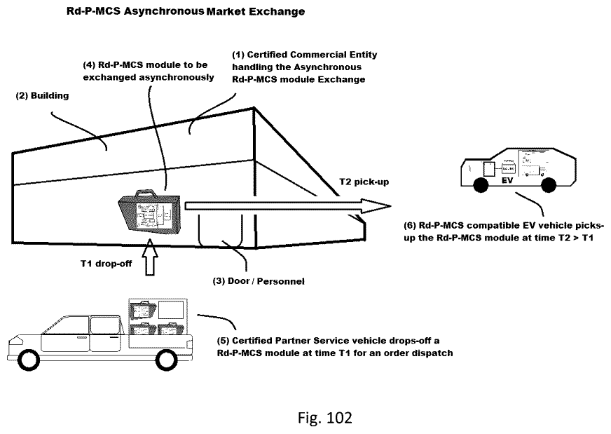

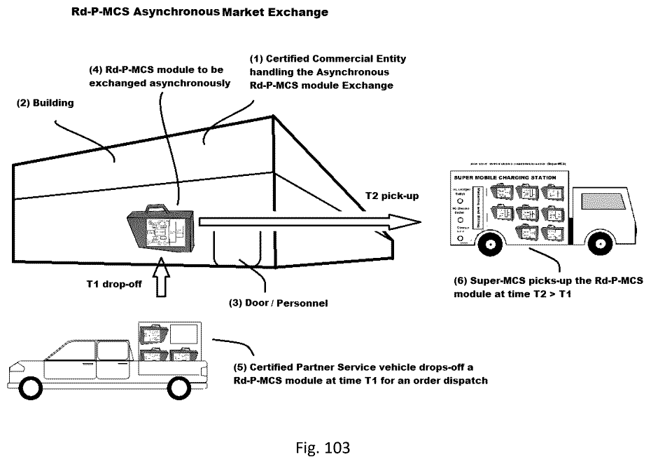

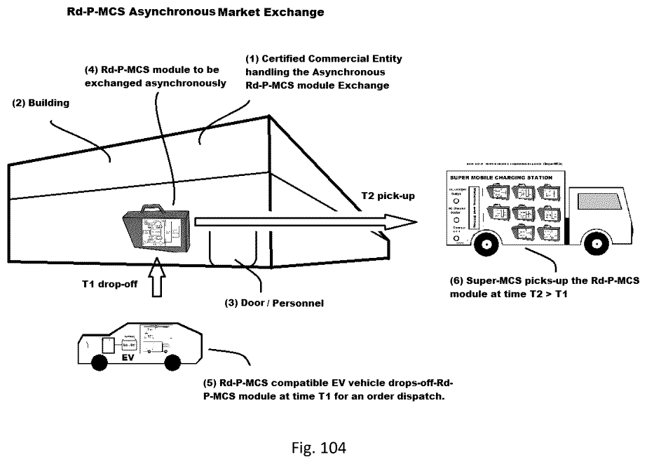

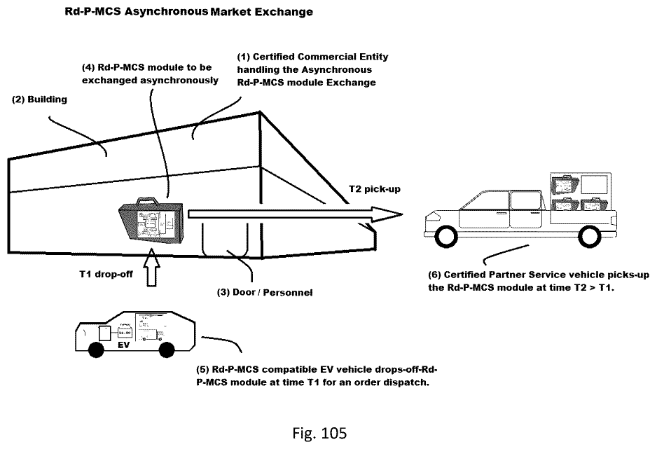

The “redistributable Rd-P-MCS” could be delivered (specifically reserved/bound to the driver to pick-up it up) even in absentia to certified participating businesses, such as EDEKA, Aldi, Gas/Fuel Stations, but also Auto Service units, without any limitation, between the Super Mobile Charging Stations, Certified Partner Service vehicles, and Rd-P-MCS compatible participating EV vehicles, see figures FIG. 100, FIG. 101, FIG. 102, FIG. 103, FIG. 104, and FIG. 105.

A “redistributable Rd-P-MCS” module may be self-contained with respect to supporting the “charging while driving” invention goal when using fully functional “redistributable Rd-P-MCS” module, also called complete “redistributable Rd-P-MCS” module.

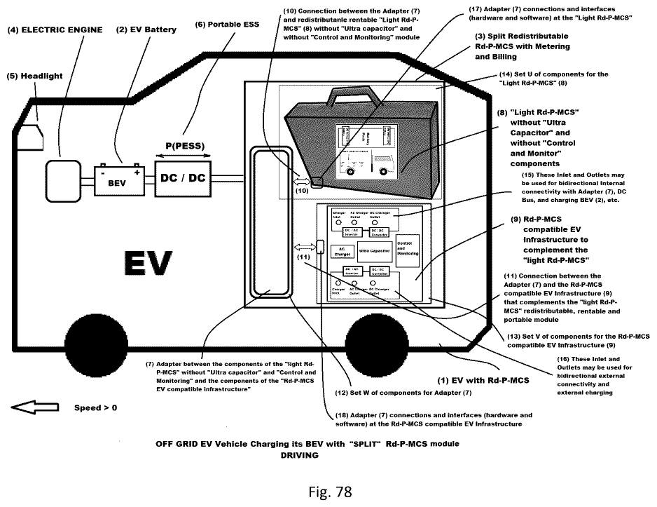

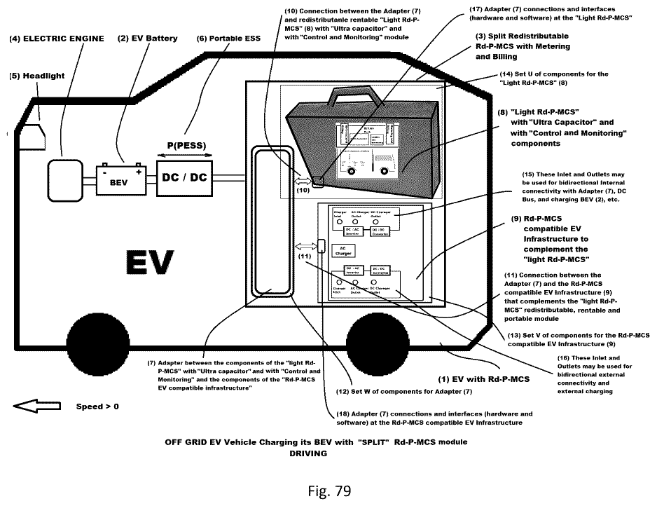

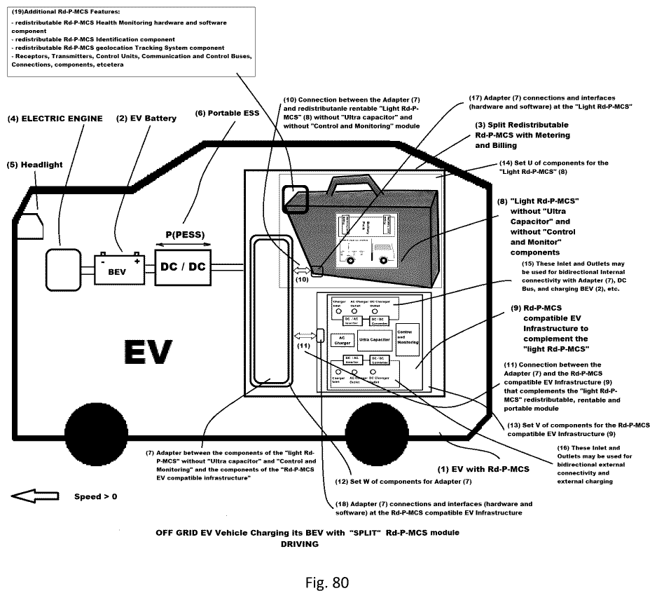

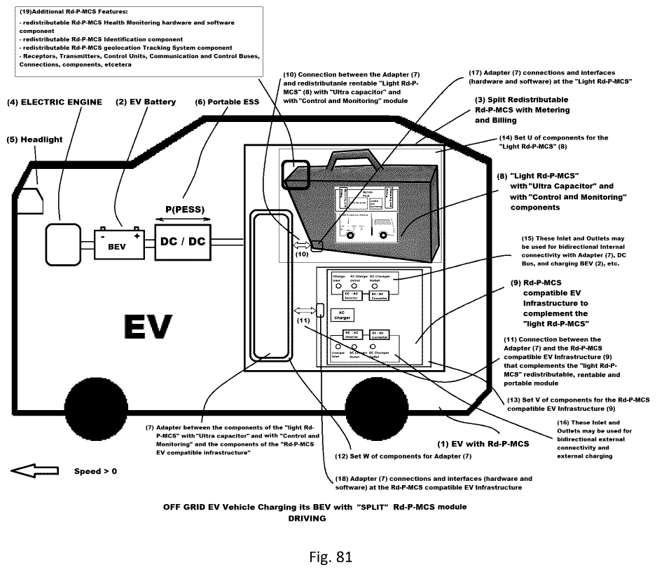

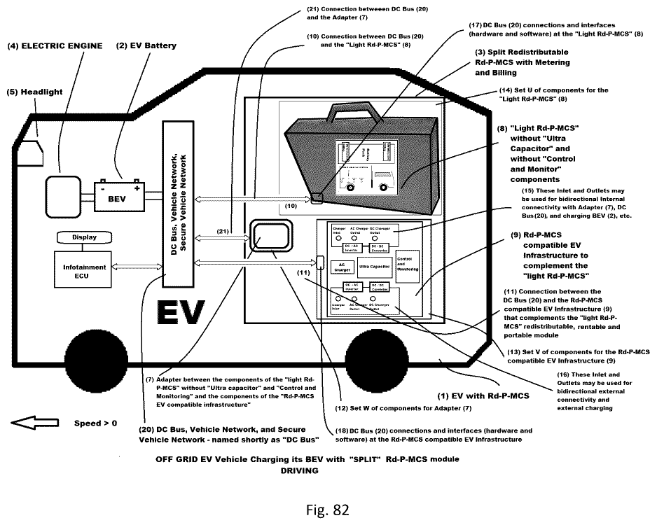

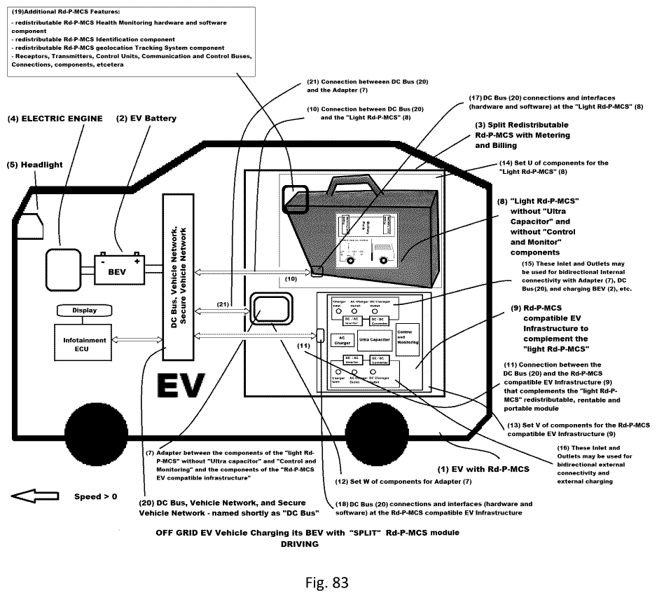

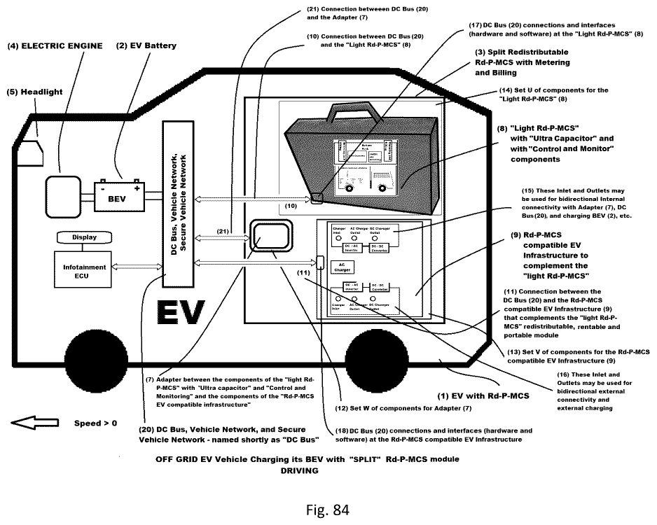

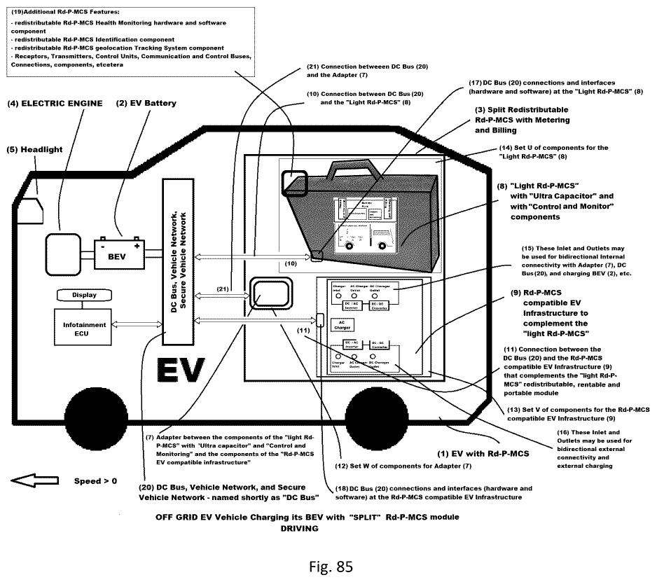

The same “charging while driving” invention goal could be attained using a bipartite or a multi-partite “redistributable Rd-P-MCS” module split shown in figures FIG. 78, FIG. 79, FIG. 80, FIG. 81, FIG. 82, FIG. 83, FIG. 84, FIG. 85, and in the diagrams from FIG. 86 and FIG. 87.

The present invention disclosure adds the concept of ordering a “charging service in the future and at a certain location”, such that with the support of the Infotainment System (or other) one could plan and order a “redistributable Rd-P-MCS” module rental in the future to a location and time that could be brought to the future rental location by a Super Mobile Charging Station vehicle, or a Certified Partner Service vehicle.

In order to extend the mobility when driving in remote areas, such a “redistributable Rd-P-MCS” module may be dropped-off to certified participating local businesses such as EDEKA, Aldi, Gas and/or Fuel Stations, Auto Service units, but not only, from where they can be picked-up later without making the delivery entities to wait for the Rd-P-MCS compatible participating EV vehicle.

Considering the above, the mobility of the Rd-P-MCS compatible participating EV vehicles depends on the total charge provided by the initial charge of the EV Battery (BEV) and the total charge of the rented “redistributable Rd-P-MCS” modules.

The present invention disclosure uses a portable and rentable available “redistributable Rd-P-MCS” module.

The invention disclosure presents, independently from Prior art, the concept of a “redistributable Rd-P-MCS” module based on the concept of “packaging energy into detachable Rd-P-MCS modules” for “commercial re-distribution” of such Rd-P-MCS modules for “charging the Electrical Vehicle Battery (BEV) while driving”.

The present invention disclosure adds the following concepts:
a) charging during driving,
b) a “redistributable Rd-P-MCS” module capable to charge a partial or a full BEV charge as opposed to being just a “portable rescue power bank”,
c) continue driving without stopping for charging but rather swapping standard “redistributable Rd-P-MCS” modules,
d) avoiding recharge wait times,
e) adding metering and billing to the “redistributable Rd-P-MCS” module, but not only, which can also be split between the start and end of the rental Recharge Stations alongside a distributed software/database and multiple/bipartite and/or multi-partite GPS devices,
f) cars designed with Rd-P-MCS in mind, see figures FIG. 108, FIG. 109, FIG. 110, FIG. 111, and FIG. 112.

The access of the participating vehicle's driver to the “redistributable Rd-P-MCS” modules when swapping them is “direct access” as opposed with the “sequential access” characteristic to a queue of EV vehicles waiting to obtain a spot to charge synchronously or to swap the whole prior art BEV battery hence almost instantaneous if using a self-serving “Recharging Station” or there are less (fewer) waiting vehicles than the employees.

The performance model proposed by the present invention disclosure apparatus and business method uses a closed loop with enough Recharging Stations and enough loop length that leaving a depleted “redistributable Rd-P-MCS” module at a participating Recharge Station will find it fully charged when arriving at the same Recharge Station after one full loop.

Simply renting a Prior art P-MCS device is not enough, you need a network of supporting Recharging Stations (in all forms) such that the participating cars can have a series of “redistributable Rd-P-MCS” module swaps.

The business method from the disclosure uses short term rental of mostly a few hours of driving, the goal would be to optimize (instead of wasting) the time when the Rd-P-MCS is aways from the qualified locations where it can be used further by other cars.

The invention provides Rd-P-MCS participating compatible EV vehicles embodiments that have parts that are optional, exchangeable and rentable with the name of “redistribution Rd-P-MCS” modules that are certified to be subjected to meeting minimum quality parameters.

The business method from the disclosure uses the “redistributable Rd-P-MCS” modules just like one would fill fossil fuel into the tank of a fuel driven car.

The invention embodiments use the “redistributable Rd-P-MCS” modules to drive Rd-P-MCS participating compatible EV vehicles just as you would get fuel/gas to drive your gas driven vehicle.

Please note that using the “redistributable Rd-P-MCS” module does not mean that they are always swapped/exchanged, because you may also pick-up, and drop-off such “redistributable Rd-P-MCS” modules.

Spare owned after-market Rd-P-MCS module could be charged from “redistributable Rd-P-MCS” modules.

A “redistributable Rd-P-MCS” module may be rented fully charged (or if it is rented partially charged it needs to show the remaining charge so that the driver may evaluate the usefulness of renting—this use case being less useful if it will shorten the charging lifetime).

Pool of “redistributable Rd-P-MCS” modules in driving circuits, defined based on stationary recharging at ON-GRID Super Stationary Charging Stations (Super-SCS), dynamic charging in Super Mobile Charging Stations (Super-MCS), Super Mobile Charging Station (Super-MCS) with the infrastructure with BESS just as the stationary (ON-GRID) Recharging Stations.

The “redistributable Rd-P-MCS” modules are “shared” by multiple cars in short periods of time on various driving paths used by the lenders.

How the “redistributable Rd-P-MCS” modules are redistributed in a good valid business method way.

The “redistributable Rd-P-MCS” modules are partitioned units of electrical charge when time is of essence or desired extending thus the active life of the driver, e.g., the driver has the option to save the Prior art charging time and use it for purposes that are considered more important.

The “redistributable Rd-P-MCS” modules may be serviced even in remote areas, extending the mobility and the range of the subscribed compatible cars, e.g., the Rd-P-MCS compatible participating EV vehicles.

Rather than charging the BEV with energy as in Prior art, the renting of a “redistributable Rd-P-MCS” module is similar with buying energy that is packed and amendable to be taken away for charge while driving, with the rented “redistributable Rd-P-MCS” module being amenable to be swapped with another rented “redistributable Rd-P-MCS” module.

The cost of a “redistributable Rd-P-MCS” module could be very high, see the reference to the reference to the high-performance battery packs used in Formula E that are rated for several hundred kWh, but such cost may be balanced and amortized by the rental of such “redistributable Rd-P-MCS” module in a participating business method—which could be franchised and/or licensed.

Prior art charging stations owned by Tesla, but not only, are where current cars are coming to charge stationary and synchronously their BEV batteries before continuing their trip, while the invention “redistributable Rd-P-MCS” modules are just swapped.

Prior art MCS charging trucks that come to an EV in need to re-charge, could serve recharging maximum two (2) cars at the same time, using a synchronous stationary charging, while in the invention Super Mobile Charging Stations (Super-MCS) delivering a plurality of “redistributable Rd-P-MCS” modules may need to stop just for a minute to distribute such a “redistributable Rd-P-MCS” module and then go to serve in short time another Rd-P-MCS compatible participating EV vehicle in need, optimizing the serving and waiting times.

One skilled in the art may note that rather than the Prior art EV vehicle waiting for a stationary charging of raw energy needed by the EV vehicle to continue its long-distance trip into EV vehicle's internal energy storage components, the business method provided by the present disclosure makes available to the Rd-P-MCS compatible participating EV cars the already charged and pre-packaged units of electrical energy embodied by the “redistributable Rd-P-MCS” modules.

ALL “charge while driving” for both the cars and the actively redistributed “redistributable Rd-P-MCS” modules themselves, use the concept of “charge while driving” across all use cases of the business method, including when a new “redistributable Rd-P-MCS” module enters the Driving Circuit pool of “redistributable Rd-P-MCS” modules when driven and transported by a Super Mobile Charging Stations (Super-MCS).

The “redistributable Rd-P-MCS” module “travels” with the car so that the “synchronous” part of charging from “redistributable Rd-P-MCS” modules connected to the EV car through its internal charging adapters is happening during driving, thus avoiding stationary charging waiting times.

The rental transactions involving “redistributable Rd-P-MCS” modules have their start/pick-up and end/drop-off locations are (mostly) different which empowers the business method. However, such condition it is not a requirement.

Because the traveled distance may be more than the direct distance between the transition end points (like driving back and forth between the endpoints), a metering system could be provided for both traveled distance and rental time with the latter counting how much time a rented “redistributable Rd-P-MCS” module cannot be used by other drivers. The traveled distance metering is less important.

The Dispatcher may run a monitoring the status of all entities involved in the Participating Driving Circuit and this includes, without an exhaustive enumeration the following:
a. Health of the charging stations such as the Super Stationary Charging Stations (Super-SCS), Super Mobile Charging Stations (Super-MCS), but not only.
b. Health of the recharging slots and their components from any of the charging stations such as the Super Stationary Charging Stations (Super-SCS), Super Mobile Charging Stations (Super-MCS), but not only.
c. Health of any of the “redistributable Rd-P-MCS” module that is mounted to any of the charging stations such as Super Stationary Charging Stations (Super-SCS), Super Mobile Charging Stations (Super-MCS), but not only.

The use of the existing available automotive clubs to supplement the availability of “redistributable Rd-P-MCS” modules in remote areas, etcetera, with already available scalable commercial infrastructure and processes, may allow a faster growth and the scalability of the business method.

The “redistributable Rd-P-MCS” module provides a scalable and distributed solution to the recharging problem even without the “charge while driving”.

The invention “Charge while driving” concept optimizes time, when the “redistributable Rd-P-MCS” modules are charged during the redistribution driving by Super Mobile Charging Stations (Super-MCS), reduces the necessary size of the pool of “redistributable Rd-P-MCS” modules because they are used more efficiently, thus reducing also the cost of operating the business method.

The invention “Charge while driving” concept saves time of the EV drivers and improves the acceptance of the new technology, solving the long-distance travel problem.

The invention allows a low cost of starting a francize that implements the invention business method due to the flexibility of the charging stations that do not need Prior art charging stations.

The most important need of the invention is the availability of the Electrical Grid Infrastructure that would power the ON-GRID Super Stationary Charging Stations (Super-SCS), the ON-GRID Super Mobile Charging Stations (Super-MCS), not only.

The driver of a Rd-P-MCS participating compatible EV vehicle that needs to recharge may see the participating charging stations, such as Super Stationary Charging Stations (Super-SCS), the Super Mobile Charging Stations (Super-MCS), Certified Partner Stations, but not only, and the availability of the “redistributable Rd-P-MCS” modules with their pricing options.

The Super Stationary Charging Stations are ON-GRID, the Super Mobile Charging Stations may be both ON-GRID and OFF-GRID, while the “redistributable Rd-P-MCS” modules may be transported while charging and powering the BEV according to the figures FIG. 108, FIG. 109, FIG. 110, FIG. 111, and FIG. 112, or while being charged itself in a Super Mobile Charging Station, or while being charged stationary (ON-GRID) while mounted to a Super Stationary Charging Station.

The “charging while driving” concept may also mean “charging BEV while driving”, “powering a driving EV”, “powering EV and charging BEV”, “powering BEV”, but not only, without excluding “charging BEV with stationary EV” from the implemented features of the Rd-P-MCS compatible and participating and EV vehicle.

Using “redistributable Rd-P-MCS” modules that are uniquely Identifiable and distributed data bases operating all the entities that are part of the apparatus and business method, the present disclosure does not allow the introduction of or non-certified “redistributable Rd-P-MCS” modules into the circuit and its Pool of “redistributable Rd-P-MCS” modules in order to guarantee a minimum standard for the operating parameters, thus maintaining the Health, Safety and Efficiency of the Pool of “redistributable Rd-P-MCS” modules.

The Transparency with respect of the availability of the “redistributable Rd-P-MCS” modules, including pricing wise, along the driving trip plans, allows the car system may plan brief stops for renting such “redistributable Rd-P-MCS” modules in order to automate the support for the driver.

The “redistributable Rd-P-MCS” modules and the Prior art Battery of Electric Vehicle (BEV) are designed in such a way that the Rd-P-MCS compatible participating EV vehicles are able to drive using BEV but at the same time BEV is charged by one or more “redistributable Rd-P-MCS” modules.

By themselves, the “redistributable Rd-P-MCS” module and the Rd-P-MCS compatible participating EV vehicle are not able sustain the optimal performance related to recharge waiting times.

The sustainability of the optimal performance is highly dependent on the business method of the driving circuit operator as described by the invention disclosure.

The driving circuit may be modeled with Petri nets where:
a. the Petri nets places represent Recharging Stations and Rd-P-MCS compatible participating EV vehicles present at such Recharging Stations,
b. the Petri nets tokens represent the “redistributable Rd-P-MCS” modules available in the driving circuit, either being available and fully charged or being recharged in Recharging Stations, or being transported (either charged or recharging) in driving Super Mobile Charging Station (Super-MCS) or just being transported in Certified Partner Station vehicles.
c. the Petri nets transitions represent the events when:
   i. a Rd-P-MCS compatible participating EV vehicle that drives from one place with a Recharging Station to another place with a Recharging Station.
   Assuming that such vehicle needs to fully use the electrical charge of a “redistributable Rd-P-MCS” module rented at the starting place' Recharging Station, and to drop-off the energy depleted “redistributable Rd-P-MCS” module at the destination place's Recharging Station, then the corresponding transition moves a token from the Petri nets' starting place (and consequently picking up a “redistributable Rd-P-MCS” module from the starting place's Recharging Station) to the Petri nets' destination place (and consequently dropping off a “redistributable Rd-P-MCS” module to the destination place's Recharging Station).
   ii. a Super Mobile Charging Station (Super-MCS) or a Certified Partner Station vehicle transfers “redistributable Rd-P-MCS” modules from one place with Recharging Station to another place with a Recharging Station.
   Assuming that the Super Mobile Charging Station (Super-MCS) and/or the Certified Partner Station vehicle pick up for transferring a plurality of “redistributable Rd-P-MCS” modules from the starting place's Recharging Station to the destination place's Recharging Station, then the corresponding transition moves the said plurality of tokens from the Petri nets' starting place (and consequently picking up such plurality of “redistributable Rd-P-MCS” modules from the starting place's Recharging Station) to the Petri nets' destination place (and consequently dropping off such plurality of “redistributable Rd-P-MCS” modules to the destination place's Recharging Station).

The invention provides a solution that is optimal from a performance point of view with respect to avoiding waiting charging times in continuing the planned trip as long as there is at least an available Recharging Stations (for example, Super Stationary Charging Stations, Super Mobile Charging Stations (Super-MCS), or Certified Partner Service vehicles) every time there is a need to replace an energy depleted “redistributable Rd-P-MCS” module.

One should note that when mentioning Recharging Stations in embodiments that include Super Stationary Charging Stations (Super-SCS) and Super Mobile Charging Stations (Super-MCS), depending on the context, such enumeration may also include Certified Partner Service vehicles, but not only, even if they are not explicitly enumerated.

The invention Recharging Stations, if placed properly around the driving routes, alongside with the redistribution method and the payment method, but not only, allow reaching the maximum potential of the stated performance and allow to avoid the degradation in time of such performance.

The redistribution method, which may also involve the invention EV vehicle themselves through incentive offers, may use Nash equilibrium, and competitive equilibrium, based algorithms in order to balance the availability of the “redistributable Rd-P-MCS” modules within a driving circuit.

Novel algorithms for efficiently finding and accessing such Recharging Stations, at fixed locations and future order-based determined dynamic locations, are based on the novel Dynamic Network of Recharging Stations concept.

Novel charging architectures and Electric Motor powering architectures are also provided.

Moreover, the present invention disclosure provides a scalable solution for Electrical Vehicles charging when compared with the Prior art scarcity of charging stations whose availability is aligned only with the current number of registered electrical vehicles that do not impose yet a strain on the charging services.

### DETAILED DESCRIPTION

### Overview—Invention Concepts and Goals

The invention solves the prior art long-distance mobility problem, when the EV vehicles need to stop for a charging waiting time period to recharge the energy depleted EV Battery (BEV).

The invention implements the “charging during driving” functionality towards the invention goal of “never charge when in stationary mode” for the invention Rd-P-MCS compatible participating EV vehicles having a charging and powering architecture based on the novel “Rd-P-MCS compatible BEV Battery (BEV)” battery and the novel “redistributable Rd-P-MCS” module that is portable, rentable charging device with metering and billing functionality.

### Note:

While the invention proposes several embodiments for charging and powering architectures for the Rd-P-MCS compatible participating EV vehicles where the invention “Rd-P-MCS compatible BEV Battery (BEV)” battery is decoupled from the Electric Motor(s)—in the sense that the invention “Rd-P-MCS compatible BEV Battery (BEV)” battery is not anymore, the only power source component monopolizing the operation of the Electric Motor(s)—the apparatus components and methods described in the invention disclosure, including those implementing the “Charging during Driving” concept, can still be used by the skilled in the art also in EV vehicle embodiments where BEV battery is the only power source component operating the Electric Motor(s).

The method uses a novel apparatus, namely the Portable, Rentable and Redistributable Charging module, e.g., an invention module that is referred further in the disclosure as a “redistributable Rd-P-MCS” module.

The “redistributable Rd-P-MCS” module is based on the concept of partitioning and packaging the bulk energy, contained in a Prior art Mobile Charging Station (MCS), for easy swapping and distribution.

The module “redistributable Rd-P-MCS” module represents a packaged redistributable amount of electric charge that has Metering and Billing functionality that when used by the invention Rd-P-MCS compatible participating EV vehicle with its novel charging and powering architecture, such invention module allows the Rd-P-MCS compatible participating EV vehicle to charge the novel “Rd-P-MCS compatible BEV Battery (BEV)” battery and to power the Electrical Motor during driving which leads to avoidance of the stationary charging waiting times.

The invention is based and driven on the concept of “charging while driving” and on the goal of “never charge while stationary”, or otherwise “no stationary charging waiting time”.

They are the seed of the invention apparatus and method development. A commercial implementation of the invention is expected as part of a business plan.

Using the invention apparatus, e.g., the “Rd-P-MCS participating compatible EV” vehicles with “redistributable Rd-P-MCS” module(s) and “Rd-P-MCS compatible BEV Battery (BEV)” batteries provide an early achievement of the stated goals of the invention with the initial pool of “redistributable Rd-P-MCS” modules in the driving circuit.

However, after a while one would observe that the performance goals would degrade over time as the “redistributable Rd-P-MCS” modules become less and less available.

When there are no more available “redistributable Rd-P-MCS” modules in the driving circuit, the commercial activity related to renting “redistributable Rd-P-MCS” modules cannot continue anymore until more “redistributable Rd-P-MCS” modules are brought into the driving circuit.

One would observe that the used and energy depleted “redistributable Rd-P-MCS” modules have not leaved the driving circuit but rather they are accumulated down the driving circuit paths where they were previously used.

A solution to this situation is to redistribute the “redistributable Rd-P-MCS” modules in the driving circuit where they are needed most.

This is what the redistribution method is concerned with: take the used and depleted “redistributable Rd-P-MCS” modules and returned them to the location where they were initially allocated. However, this may not be feasible and rather a global approach to the redistribution of such modules.

Also, returning them still depleted to their new charging stations would start the charging process only when they have reached their new destination.

Another goal of the invention is to make available as many as fully charged “redistributable Rd-P-MCS” modules, which may be achieved by Increase scalability by creating charging stations with a lot of charging slots (dozens or even hundreds of such slots) that would be able to recharge in parallel a high number of “redistributable Rd-P-MCS” modules.

However, the invention solves this problem that goes beyond increasing scalability: by adding a supporting apparatus based on the following goal: “distributing redistributable Rd-P-MCS modules to other locations while charging them”:
a. Adding Super Mobile Charging Station (Super-MCS) trucks that are able to transport large numbers of “redistributable Rd-P-MCS” modules to their new destination.
b. The Super Mobile Charging Station (Super-MCS) trucks are able to recharge a large number of “redistributable Rd-P-MCS” modules that are mounted in the truck's charging slots as opposed as prior art Mobile Charging Station (MCS) that could only charge simultaneously at most two stationary vehicles. Even more, the invention Super Mobile Charging Station (Super-MCS) trucks are able to recharge their mounted “redistributable Rd-P-MCS” modules while the trucks are driving to the destination places of these modules.
c. As opposed to a Super Stationary Charging Station (Super-SCS), the Super Mobile Charging Station (Super-MCS) trucks can be mobile and reach customers in remote areas.
d. The Super Stationary Charging Station (Super-SCS) can implement the concept of swapping “redistributable Rd-P-MCS” modules between different Super Mobile Charging Station (Super-MCS), when a support Super Mobile Charging Station (Super-MCS) comes to another Super Mobile Charging Station (Super-MCS) acting temporarily as a Super Stationary Charging Station (Super-MCS) on standard covered locations (such as Gas/Power stations on the highway or with high traffic)
e. The Super Stationary Charging Station (Super-SCS) can implement the concept of swapping “redistributable Rd-P-MCS” modules between different Super Mobile Charging Station (Super-MCS), when both Super Mobile Charging Stations (Super-MCS) drive both a common meeting location for performing the swap.
f. The Super Stationary Charging Station (Super-SCS) can implement the concept of swapping “redistributable Rd-P-MCS” modules between a Super Mobile Charging Stations (Super-MCS) and a Super Stationary Charging Station (Super-SCS), aside from the actions of “redistributable Rd-P-MCS” module pick-up and drop-off.
g. The Super Stationary Charging Station (Super-SCS) uses the concept of easy swapping a “redistributable Rd-P-MCS” module as opposed to the BEV swapping method from Nio,
h. Easy replacement of “redistributable Rd-P-MCS” modules in case of technical problems.
i. Easy insertion of Super Mobile Charging Stations (Super-MCS) into the “driving circuit” depending on peak demand in order to replenish with “redistributable Rd-P-MCS” modules the Recharging Stations depleted of their “redistributable Rd-P-MCS” modules.
j. Easy relocation of Super Mobile Charging Stations (Super-MCS) into the “driving circuit” depending on peak demand.
k. There is a need to have the redistribution of the “redistributable Rd-P-MCS” modules as balanced as possible based on the live demand or based on planed demand if the subscribed drivers share their travel plans and the business method algorithms have enough information for better global solutions.
l. Other shown and described in the invention disclosure

The present invention disclosure provides an apparatus and a business method that uses a portable charging device named “redistributable Rd-P-MCS”, module that together with novel supporting ways of redistributing the Rd-P-MCS modules defines a framework for optimization with the scope of minimization and even elimination of the waiting times for recharging an EV vehicle.

The “redistributable Rd-P-MCS” module apparatus adds the core features of metering and billing to a Prior art P-MCS charging module, albeit the discovery of the Rd-P-MCS concept came from a different background.

The present disclosure “redistributable Rd-P-MCS” module apparatus has been discovered as a concept of “packaging electric energy into detachable Rd-P-MCS modules” for commercial (rental) redistribution of such Rd-P-MCS modules for “charging while driving” the Electrical Vehicle Battery (BEV).

The disclosure shows the transformation of the Mobile Charging Station (MCS) concept into several supporting concepts, the most important being the “redistributable Rd-P-MCS” module concept for packaging the raw electric energy into a partitioned unit of energy that is packaged, portable, transferable, and rentable, but not only, as part of a business method that allows the “redistributable Rd-P-MCS” module to reach the full potential of its performance as claimed in the disclosure.

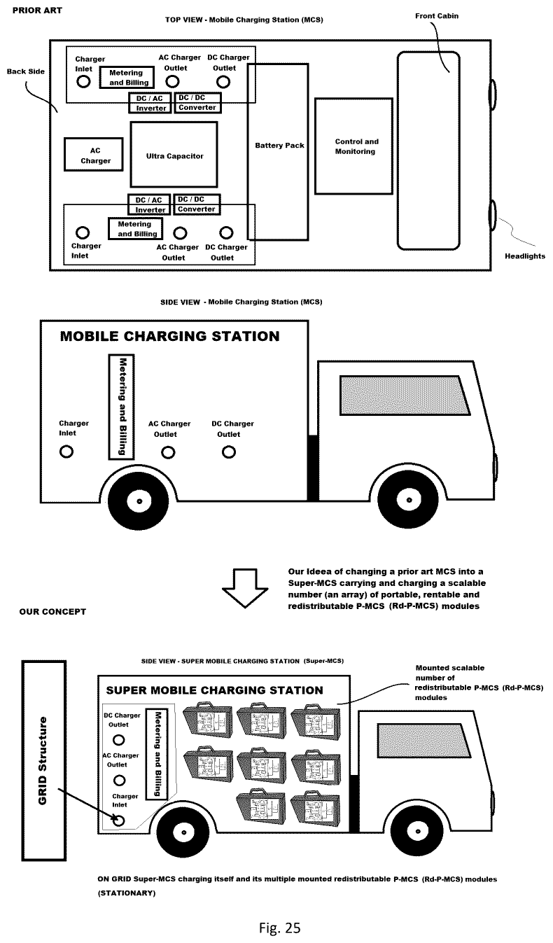

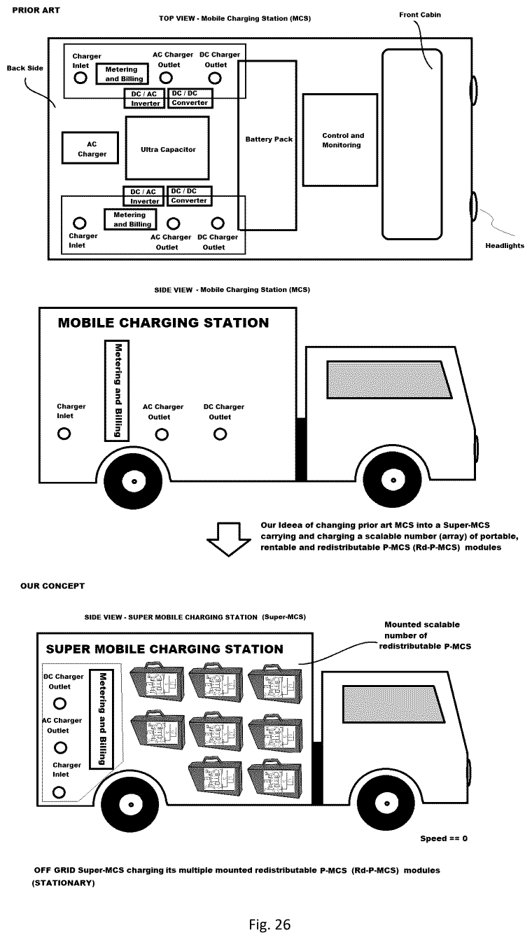

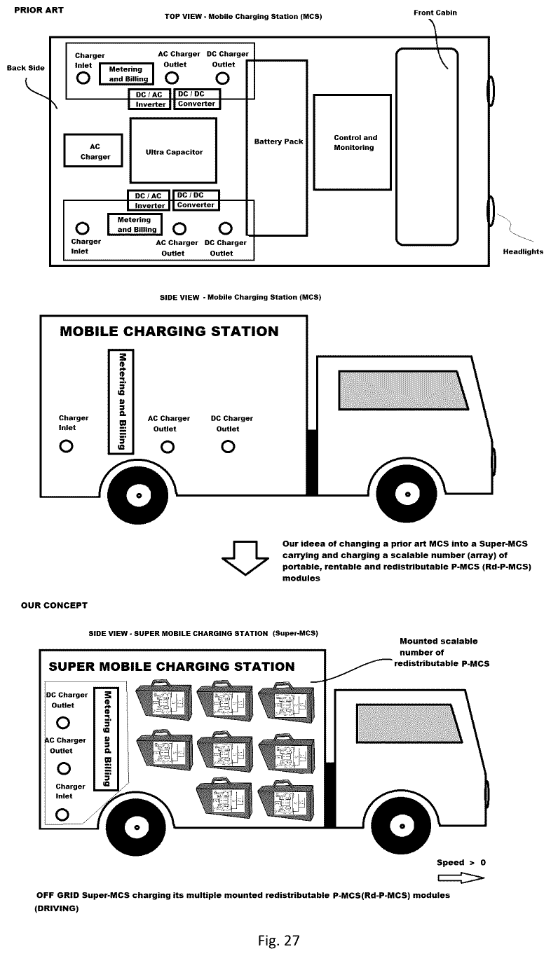

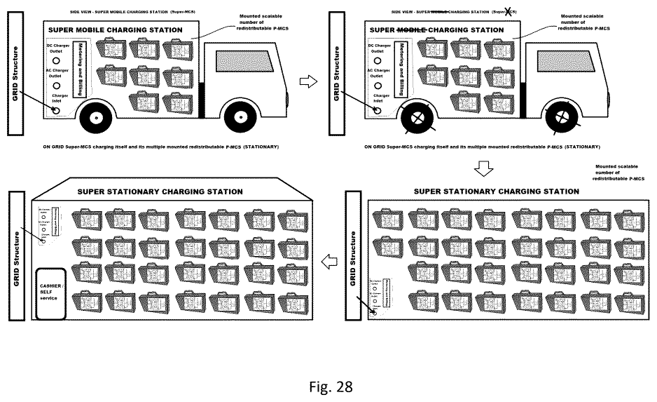

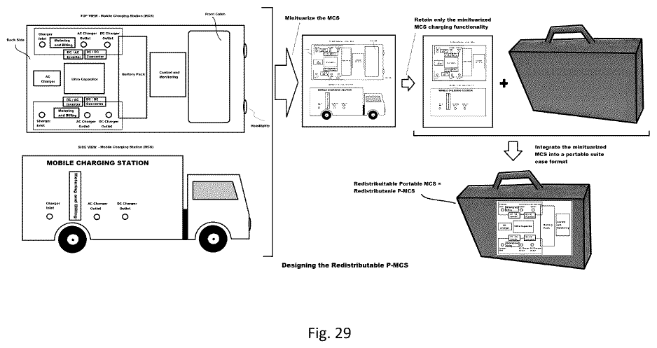

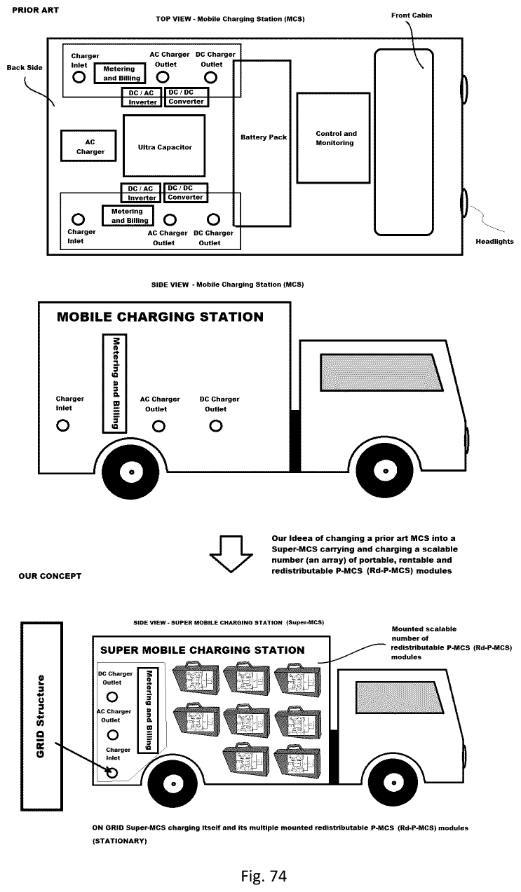

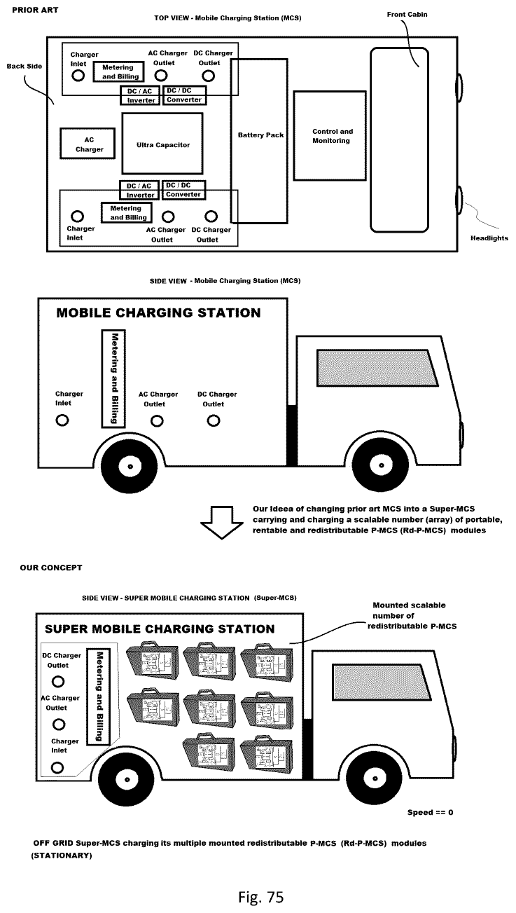

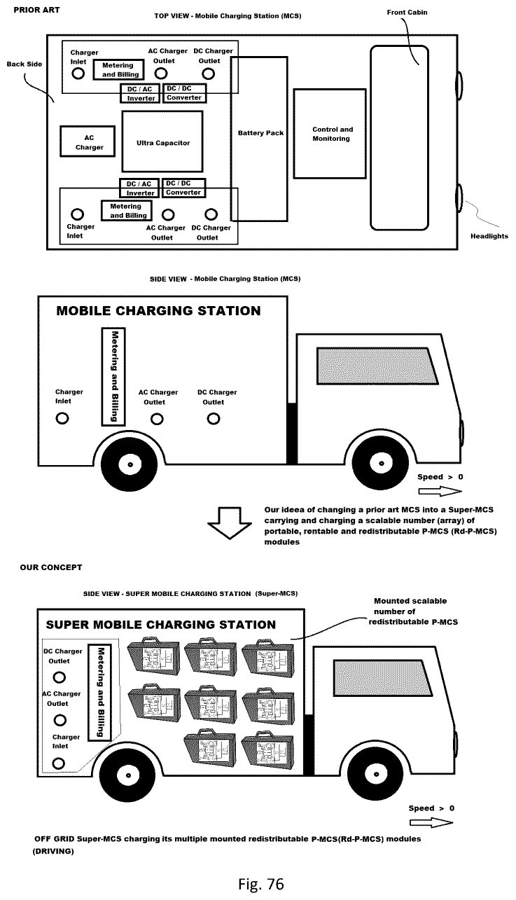

Such transformations from Prior art Mobile Charging Station (MCS) to the novel apparatus of the present invention can be seen in FIG. 25, FIG. 26, FIG. 27, FIG. 28, FIG. 29, FIG. 74, FIG. 75, and FIG. 76.

The business method described in the present disclosure is essential for devising an integrated supporting apparatus around the core technology represented by the “redistributable Rd-P-MCS” module and the “Rd-P-MCS compatible BEV Battery (BEV)” battery in order to solve the long-distance mobility problem of the Electrical vehicles independently of the range of its Battery (BEV).

The range of the EV vehicle Battery (BEV), as defined by Prior art, does influence the amount of supporting apparatus provided by the business method for reaching and maintaining the operational goals (charging the “redistributable Rd-P-MCS” modules only while driving) and the performance goals such as an almost inexistent stationary charging waiting time for the whole duration of the planned long trip.

The present invention disclosure changes the narrative of the long-distance mobility from the maximization of the range of the Electrical Vehicle Battery (BEV), which may have reached a technological plateau, to the minimization of the waiting time for recharging the Electrical Vehicle to allow it to continue the driving session, minimization problem that defines the invention disclosure's performance method and its performance goals.

Because of the above, the invention disclosure's business method with its component methods is strongly tied with the performance model proposed in the disclosure, therefore the business method with its components is an integral part of this disclosure.

The “redistributable Rd-P-MCS” modules are used by multiple cars during the day and depending on the availability of such modules the competition to such resources may lead to the degradation of the expected performance from the operation of the Rd-P-MCS compatible participating EV vehicles if a minimum of such “redistributable Rd-P-MCS” modules is not provided by the business method or if the business method algorithms are not optimized with the performance goal in mind.

The cost method that defines the importance of rental time into the rental cost, but also other business method components, act as generators of optimization goals that help define and bring efficiency and a business operating around the “redistributable Rd-P-MCS” module concept.

The “redistributable Rd-P-MCS” module apparatus has been obtained through downsizing the Prior art Mobile Charging Station (MCS) described in paper [Ref-4] [Atmaja, T. D.] in a portable format that retains the main features of the Mobile Charging Station such as the:
a) “Battery Pack” component,
b) “Metering and Billing” component,
c) “Ultracapacitor” component,
d) “Control and Monitoring” component,
e) Other features of Prior art Mobile Charging Station (MCS),

with the added feature of being portable, rentable and used by Rd-P-MCS compatible participating EV vehicle owners as part of a redistribution business method that is claimed to be both novel and useful when relying on the “redistributable Rd-P-MCS” concept, transformation process which is seen in figures FIG. 29, where the end result of such transformation that is part of the present invention disclosure is the portable and rentable “redistributable Rd-P-MCS” charging module, also referred in the disclosure as the “redistributable Rd-P-MCS” module.

The “redistributable Rd-P-MCS” module is a packed electric energy within a portable format which may be a suitcase format since the suitcase size and the suitcase handler project to the viewer such portability attribute, but such suitcase format is not limiting to the skilled in the art.

The “redistributable Rd-P-MCS” module has the property of bidirectional charging:
a) The “redistributable Rd-P-MCS” module can be charged while mounted to the following:
   a. Super Mobile Charging Station that is stationary and connected to the GRID Infrastructure (ON-GRID),
   b. Super Mobile Charging Station—either when connected to the Grid (ON-GRID) or when it is NOT connected to the Grid (OFF-GRID) while stationary or while driving.
b) The “redistributable Rd-P-MCS” module can charge the Electrical Vehicle Battery (BEV) in various architectures and embodiments presented in the current invention disclosure, “during driving” or when stationary.

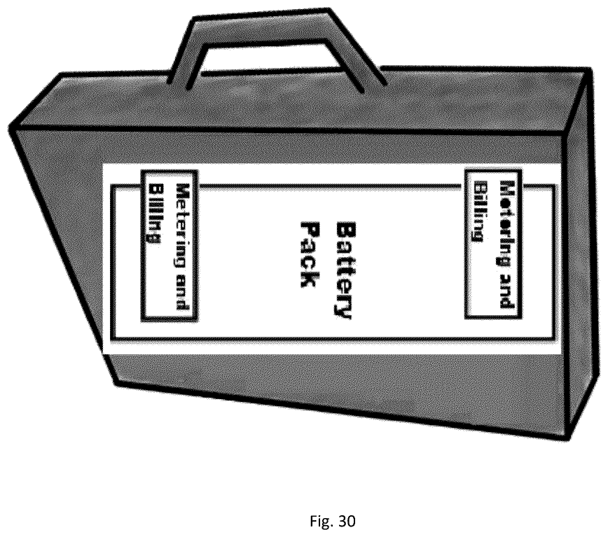

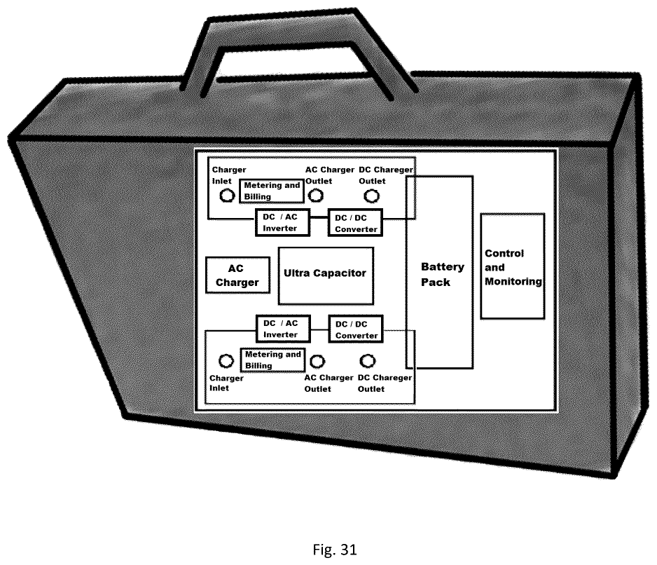

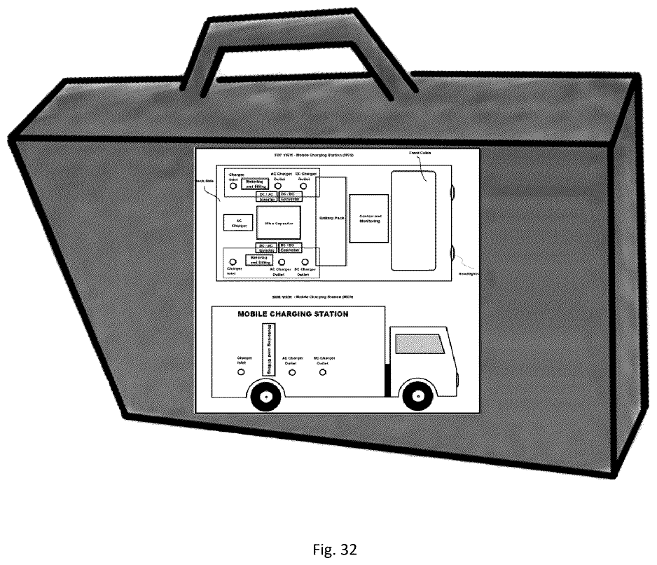

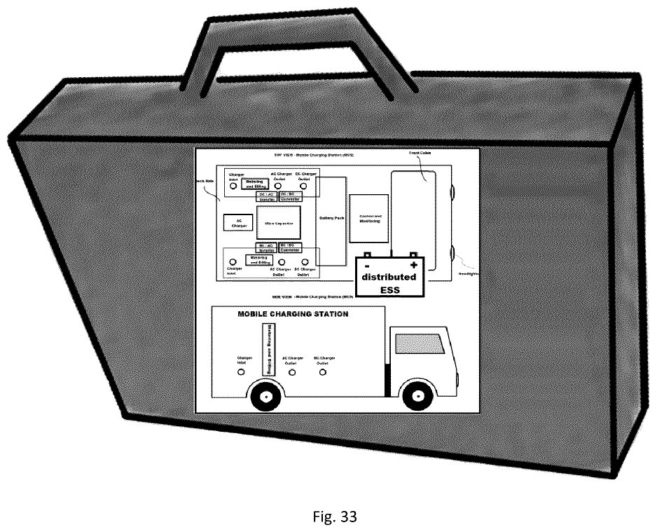

The “redistributable Rd-P-MCS” module apparatus has several graphical representations in the form of a portable suitcase that are used in the present invention disclosure as seen in the figures FIG. 30, FIG. 31, FIG. 32, and FIG. 33.

The “redistributable Rd-P-MCS” module may be referred to as portable, rentable “redistributable Rd-P-MCS” module, as portable “redistributable Rd-P-MCS” module, as rentable “redistributable Rd-P-MCS” module, as “redistributable Rd-P-MCS” charging module, as “Rd-P-MCS” charging module, as Rd-P-MCS module, as Rd-P-MCS charging device, as Rd-P-MCS device, or simply as Rd-P-MCS.

Any graphical representation of the “redistributable Rd-P-MCS” module comprises also a drawing applied on the portable suitcase representation which either shows the Prior art Mobile Charging Station (MCS) architecture or the Mobile Charging Station (MCS) vehicle representation thus representing the fact that the “redistributable Rd-P-MCS” module represents an implementation of the Mobile Charging Station (MCS) architecture features in a portable and rentable package format.

The present invention disclosure adds the idea of changing the Prior art Mobile Charging Station (MCS) into an array of portable and rentable “redistributable Rd-P-MCS” modules, see FIG. 29, such that:
1. The “redistributable Rd-P-MCS” module is packaged as a portable suitcase,
2. The label with the architecture of Prior art Mobile Charging Station (MCS) on a suitcase represents the implementation of the Mobile Charging Station (MCS) features in a portable and rentable small factor of this concept of “redistributable Rd-P-MCS” module.
3. The “redistributable Rd-P-MCS” module concept is different from Prior art P-MCS portable device as shown in the present invention disclosure.

The “redistributable Rd-P-MCS” module with its architecture features inherited from Prior art Mobile Charging Station (MCS) is the core technology of the present invention disclosure goal of “charging and/or powering while driving” that allows such “redistributable Rd-P-MCS” module to charge the “Rd-P-MCS compatible BEV Battery (BEV)” battery and/or power the Electric Motor during operation and/or driving.

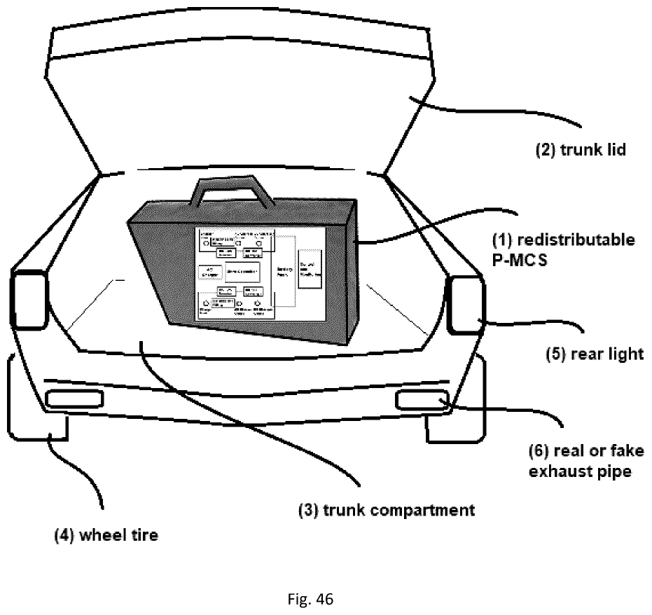

The “redistributable Rd-P-MCS” module can be placed in the trunk of the EV vehicle as shown in the FIG. 46 in case of the complete “redistributable Rd-P-MCS” module.

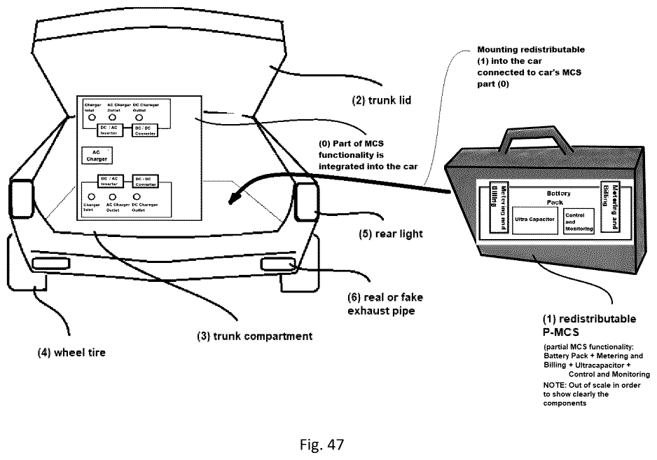

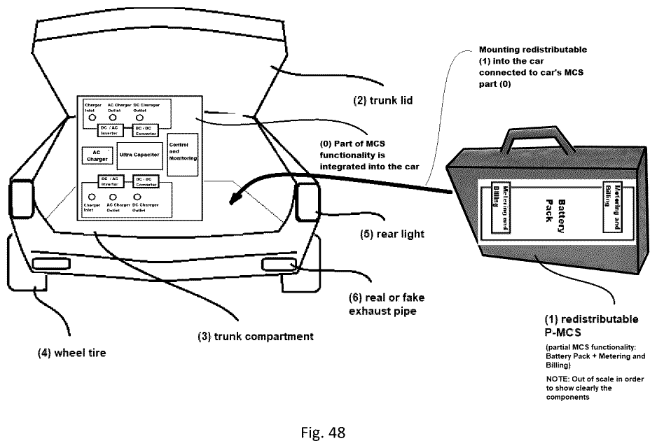

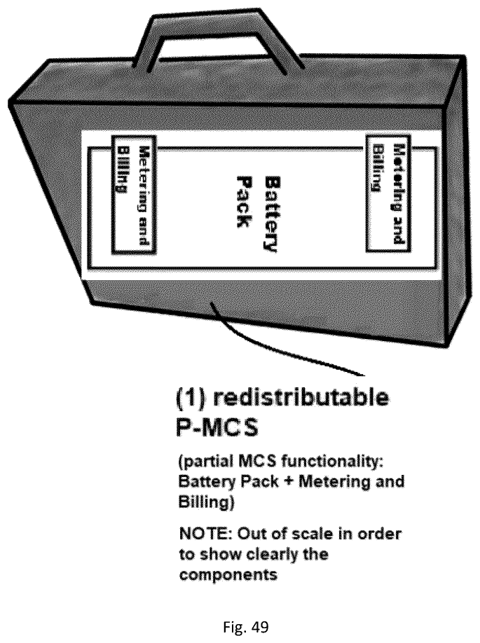

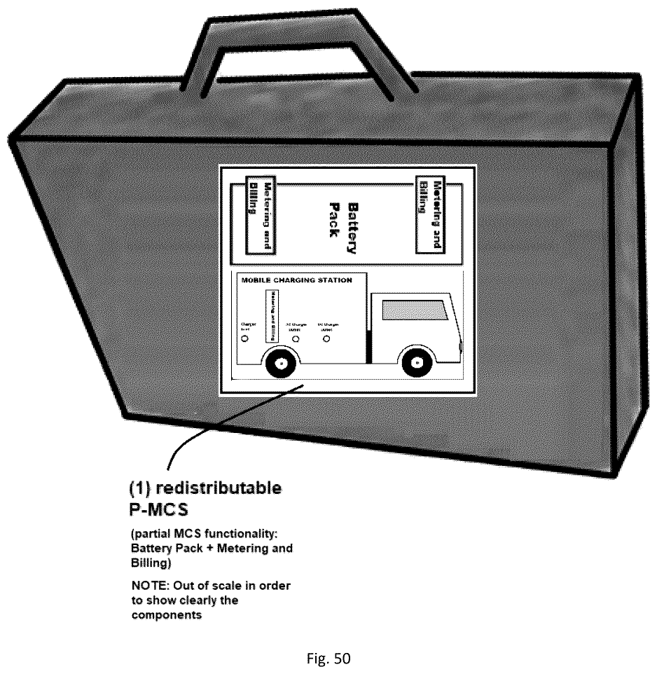

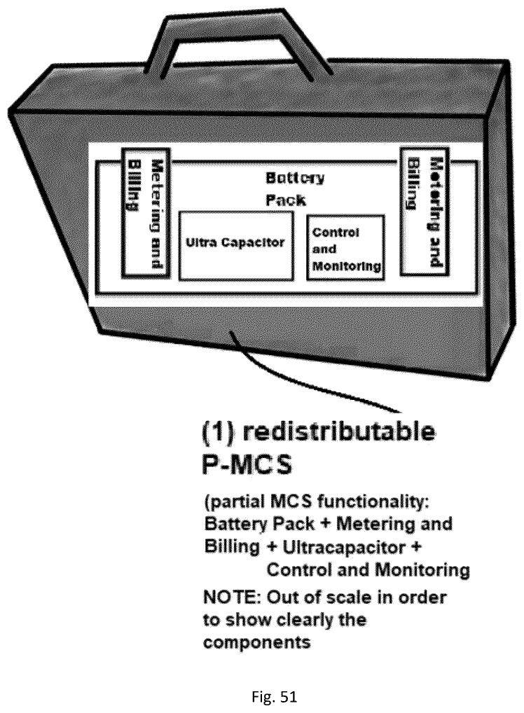

In case of a “Rd-P-MCS split” design which is defined in the present disclosure, the resulting “Light redistributable Rd-P-MCS” module represented as in figures FIG. 48, FIG. 49, FIG. 51, can be mounted in a Rd-P-MCS compatible participating EV vehicles and connected to the resulting Rd-P-MCS compatible participating electrical vehicle (EV) Infrastructure component, but also to other possible additional components obtained from a multi-partite “Rd-P-MCS split” design, as seen in figures FIG. 47, and FIG. 50.

In cases of a “Rd-P-MCS split” design as described above, the Prior art Mobile Charging Station (MCS) functionality is split between a partial “redistributable Rd-P-MCS” module functionality implemented within a “Light redistributable Rd-P-MCS” module with or without the “Ultracapacitor” component and with or without the “Control and Monitoring” module, and a Rd-P-MCS compatible participating electrical vehicle (EV) Infrastructure component implemented in the Rd-P-MCS compatible participating EV vehicle, as seen in figures FIG. 47, FIG. 48, FIG. 49, FIG. 50, and FIG. 51.

The present invention disclosure idea of changing the Prior art Mobile Charging Station (MCS) into a mobile station comprising an array of portable and rentable “redistributable Rd-P-MCS” modules, simply referred as “redistributable Rd-P-MCS” or “Rd-P-MCS” in this disclosure, show that the genesis of the “redistributable Rd-P-MCS” concept did not come from the Prior art portable charging device P-MCS concept (used as a rescue power bank) as described in US 2022/0371462 A1. Moreover, the author of the present disclosure was not aware of the Prior art P-MCS concept at the time of the discovery.

One could easily the differences of the present disclosure “redistributable Rd-P-MCS” module from the Prior art rescue bank P-MCS device:
a. The “redistributable Rd-P-MCS” module retains the main features (such as the “Metering and Billing” features) of the Prior art Mobile Charging Station (MCS) concept, features that are not present in Prior art P-MCS rescue bank device nor expected to be added to Prior art P-MCS rescue bank device without using the Mobile Charging Station (MCS) concept.
b. The Prior art P-MCS rescue bank device has nothing in common, either from a genesis or functionality point of view, with the Mobile Charging Station (MCS) concept.
c. The Prior art P-MCS rescue bank device is used as an exception use case outside of a commercial environment; hence it cannot be extended to such a business method by the skilled in the art.
d. The Prior art P-MCS rescue bank device does not use a novel payment method such as the one described in the present disclosure.
e. The Prior art P-MCS rescue bank device does not have the “Metering and Billing” features present in the present disclosure “redistributable Rd-P-MCS” module, therefore it cannot carry by itself an open-ended payment transaction.
f. The Prior art P-MCS rescue bank device does not use a redistribution method such as the one described in the present disclosure.
g. The Prior art P-MCS rescue bank device uses an EV vehicle external charge inlet connector; hence it does not implement the present disclosure concept and use case of “charging and/or powering while driving”.
h. The Prior art P-MCS rescue bank device does not eliminate the stationary charging wait times.
i. The EV vehicle charging architecture described in US 2022/0371462 A1 does not use a removable, portable and rentable charging device as in the case with the present disclosure “redistributable Rd-P-MCS” module.
j. other

Even if another invention disclosure may improve the Prior art P-MCS rescue bank device as a distributable charging device without “metering and billing” features, but with “metering and billing” available information and features at the “participating charging stations” (in all the embodiments from the present disclosure), such a novel P-MCS rescue bank device (augmented with such charging station functionality) would need that the charging station where the novel P-MCS rescue bank device would be dropped-off or exchanged to have such “metering and billing” available information and features.

The present invention disclosure does provide such “metering and billing” features at all the “participating charging stations” (in all the embodiments from the present disclosure) as an alternate feature to the “redistributable Rd-P-MCS” module “metering and billing” features and as a fallback feature in case that the “redistributable Rd-P-MCS” module starts to have technical problems.

The present invention disclosure does provide such “metering and billing” features at all the “participating charging stations” (in all the embodiments from the present disclosure) as an alternate feature to the “redistributable Rd-P-MCS” module if the “metering and billing” features are disabled or are unavailable, for any reasons, use case embodiment that is equivalent with the Prior art P-MCS rescue bank device being used in relation to “participating charging stations” (in all the embodiments from the universe of all Prior art and future invention disclosures) that have such “metering and billing” features.

The skilled in the art would see that the “redistributable Rd-P-MCS” module “metering and billing” features, once they establish at pick-up all the required information related to the “metering and billing”, but also for the payment method, do not require that the “metering and billing” features be present at the “participating charging stations” (in all the embodiments from the present disclosure), nor at the drop-off charging station, nor at a Certified Partner Service vehicle (as defined in the present disclosure) picking-up the module, nor at a drop-off location which may not be necessarily a charging station.

The “redistributable Rd-P-MCS” module “metering and billing” features are designed and implemented in such a way that all the information needed for billing and for the payment method are collected withing the “redistributable Rd-P-MCS” module from the pick-up moment until the drop-off and/or exchange moment.

Because the “redistributable Rd-P-MCS” module “metering and billing” features need all the information needed for billing and for the payment method, the “redistributable Rd-P-MCS” module may support and/or implement the following additional supporting features:
a. Timer that is used to determine how much time the “redistributable Rd-P-MCS” module was used by a customer and thus how much time the “redistributable Rd-P-MCS” module could not be used by other customer. The timer could be implemented directly by counting the time that has passed since the pick-up moment until the drop-off moment,
b. Clock time that could be used for computing the time that has passed since the pick-up moment until the drop-off and/or exchange moment of the “redistributable Rd-P-MCS” module in order to determine the time spent with the customer and therefore the time spent away from other customers (motivation for time-based cost component).
c. Computational resources needed for computing the time that has passed since the pick-up moment until the drop-off and/or exchange moment of the “redistributable Rd-P-MCS” module as previously seen above.

Such computational resources could be based on hardware and software, including those based on Classic AUTOSAR and Adaptive AUTOSAR, described in the DE 10 2023 003 362 A1/2023.10.05.
d. Identity of the “redistributable Rd-P-MCS” module that can be implemented using at least a cryptographic key, possibly using secure handshake protocols, possibly using encrypted graphical representations that can be scanned and decoded at pick-up and at drop-off and/or exchange, thus supporting a “security method” or “identification method”. The information can also be used directly during physical manipulation of the “redistributable Rd-P-MCS” module (unplug and/or plug-in) but also in connection with tracking the module using distributed software that is available at all “participating charging stations” (in all the embodiments from the present disclosure) and Certified Partner Service vehicles, at all business method entities and at any office computational resources used in with the business method.
e. Geolocation tracking hardware and software (GPS but not only) in order to provide Billing information needed by the payment method since the service rental fees depend on the pick-up and drop-off locations.
f. Communication resources and links, hardware and software, together with network subscriptions required to transmit and to collect remote data and information needed in for the billing and for the payment method, for example, the “redistributable Rd-P-MCS” module may inquire remotely by connecting to a business method server what are the current daily rates for the service rental fees, but not only.

A “redistributable Rd-P-MCS” module, also referred as a “complete redistributable Rd-P-MCS” module, or “self-sustained redistributable Rd-P-MCS”, may be comprised of the following main components:
a) “Battery Pack” component,
b) “Metering and Billing” component,
c) “Ultracapacitor” component,
d) “Control and Monitoring” component,
e) “Hardware and Software” interfaces,
f) DC/DC converter,
g) DC/AC inverter,
h) AC charger,
i) AC charger outlet,
j) DC charger outlet,
k) AC charger inlet,
l) Socket connector and/or connections,
m) DC bus interfaces,
n) Cooling system,
o) Other parts,
p) NOTE: The plurality of AC charger, DC charger, AC charger outlets, DC charger outlets, AC charger inlet, and DC charger inlet, may be available either external, either internal or both external and internal to the vehicle.

The disclosure defines a business method which optimizes the usage of the “redistributable Rd-P-MCS” modules in such a way that the later reaches its full performance potential of the goal of the invention: no Rd-P-MCS compatible participating EV vehicle using such Rd-P-MCS modules during their long trips, but not only, will ever wait stationary for charging.

In practice, there will be a very short waiting time to pick up, to exchange (swap), or to drop-off one or more such P-MCS module at the defined “participating charging stations”.

However, beyond such very short waiting time, it is just matter of resources combined with a well-run business method, mostly dependent on its optimization algorithms applied to the supporting apparatus, that would make the ideal performance goal described above a matter of reality.

The present invention disclosure has already shown the transformation of the Mobile Charging Station (MCS) concept into the “redistributable Rd-P-MCS” module concept for packaging the raw electric energy into a partitioned unit of energy that is packaged, portable, transferable, and rentable, but not only, as part of the business method that allows the “redistributable Rd-P-MCS” module to reach the full potential of its performance as claimed in the disclosure.

Also starting from the Mobile Charging Station (MCS) concept the present disclosure shows, just as in the case of devising the “redistributable Rd-P-MCS” module, how one could devise a supporting apparatus that is part of the business method that maximizes and that maintains the performance goals of the disclosure.

### The “Rd-P-MCS Compatible BEV Battery (BEV)” Battery

The invention implements the “charging during driving” functionality towards the invention goal of “never charge when in stationary mode” for the invention Rd-P-MCS compatible participating EV vehicles having a charging and powering architecture based on the novel “Rd-P-MCS compatible BEV Battery (BEV)” battery and the novel “redistributable Rd-P-MCS” module that is portable, rentable charging device with metering and billing functionality.

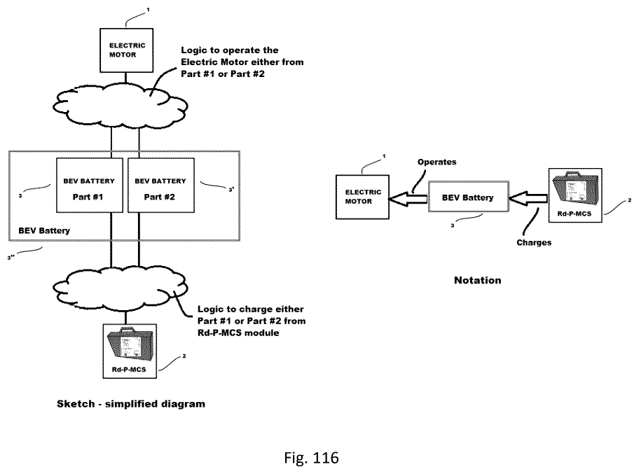

The “charging during driving” functionality can be depicted as a notation or depicted as a simplified diagram in FIG. 116. From the simplified diagram of the figure, one could see that one such embodiment of the invention “Rd-P-MCS compatible BEV Battery (BEV)” battery may be composed of two battery parts, Part #1 and Part #2, which are alternatively power the Electric Motor(s) and are charged also alternatively from the “redistributable Rd-P-MCS” module: when one battery part is powering the Electric Motor(s) the other part is being charged.

When one battery part is depleted of energy, the circuitry switches the battery parts goals: the depleted battery part stops powering the Electric Motor(s) and starts to be charged while the other battery part stops being charged and starts powering the Electric Motor(s).

As a principle, powering state and charging state are mutual exclusive as seen in FIG. 116.

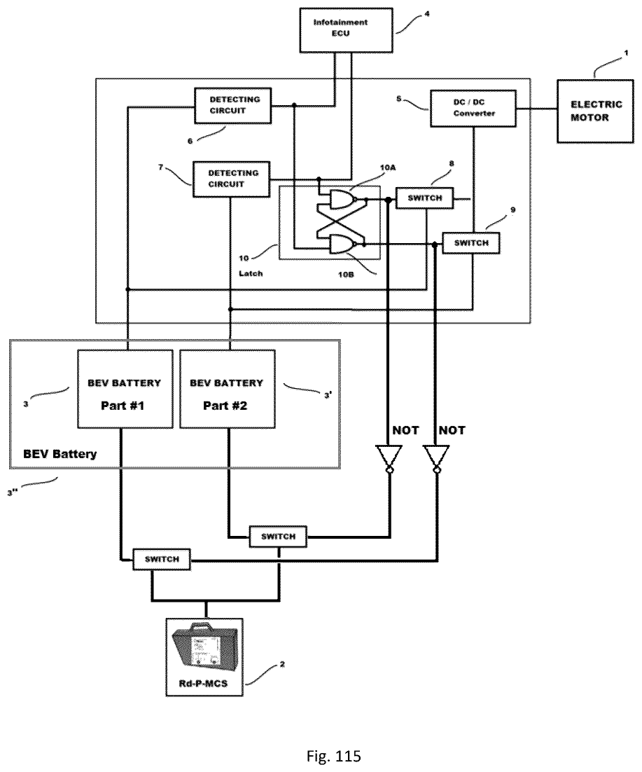

A more detailed schematic diagram of the implementation of the “charging during driving” functionality seen in FIG. 116 is shown in FIG. 115 and in the FIG. 111.

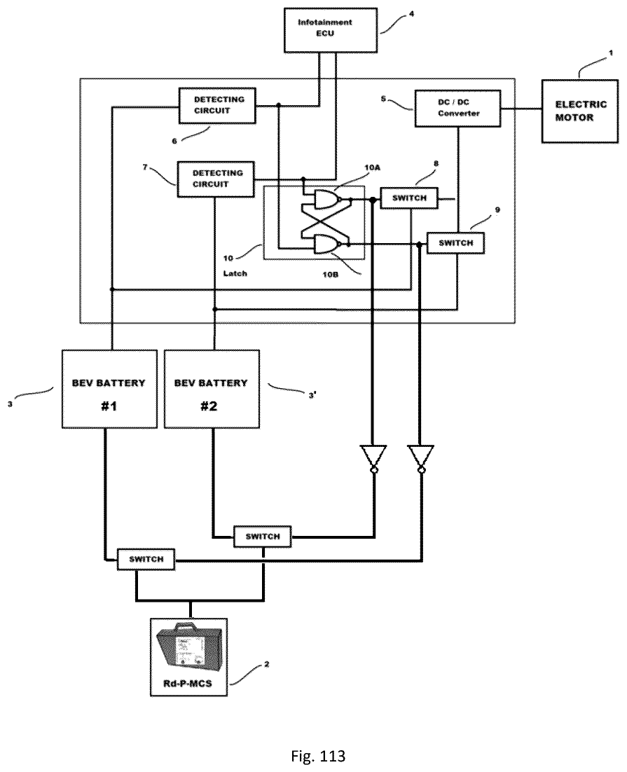

FIG. 113 shows a similar embodiment in which instead of an “Rd-P-MCS compatible BEV Battery (BEV)” battery, the “redistributable Rd-P-MCS” module charges either of the “Rd-P-MCS compatible BEV Battery (BEV)” batteries: when one such invention battery powers the Electric Motor(s), the other invention battery is being charged by the “redistributable Rd-P-MCS” module, alternatively. This embodiment can be applied to the architecture diagram from FIG. 112.

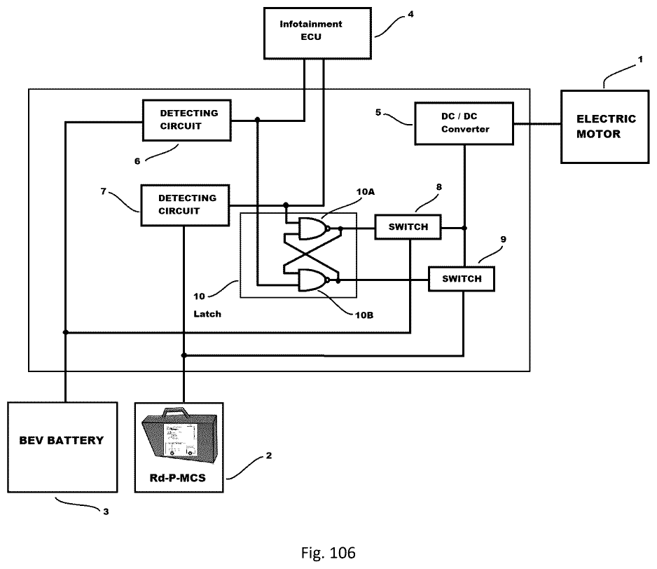

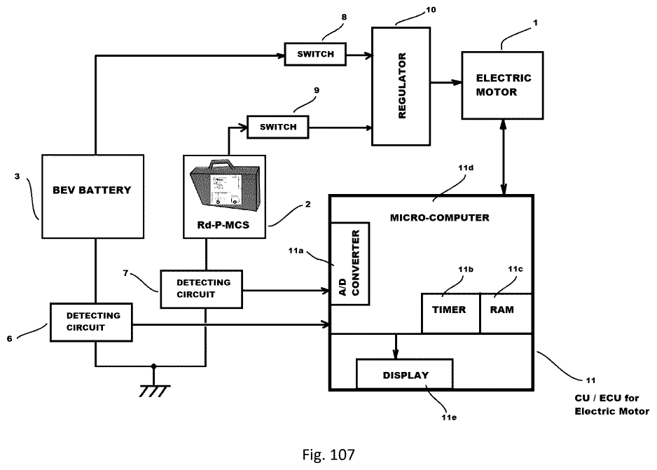

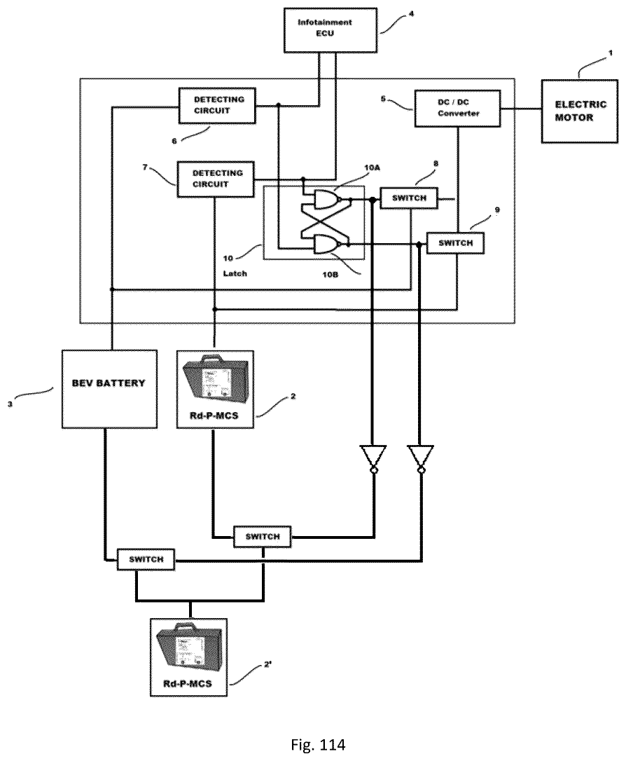

Similarly with the diagram shown in FIG. 114, the invention “Rd-P-MCS compatible BEV Battery (BEV)” battery and the invention “redistributable Rd-P-MCS” module may alternate in powering the Electric Motor(s), but as opposed to figures FIG. 106 and FIG. 107, in the case depicted in FIG. 114, the battery that is not powering the Electric Motor(s) is being charged from another “redistributable Rd-P-MCS” module.

Multiple “Rd-P-MCS compatible BEV Battery (BEV)” batteries may be designed to be present in a Rd-P-MCS participating compatible EV vehicles.

When mentioning Rd-P-MCS participating compatible EV vehicles it is assumed that such embodiments include in their design a plurality of “Rd-P-MCS compatible BEV Battery (BEV)” batteries and a plurality of “redistributable Rd-P-MCS” modules.

The concepts of powering the Electric Motor and operating the Electric Motor are interchangeable.

### Note:

Whenever we invention disclosure mention either of “Rd-P-MCS compatible BEV Battery (BEV)” battery or the “redistributable Rd-P-MCS” module in relation to implementing and achieving the “charging during driving” functionality, the invention “Rd-P-MCS compatible BEV Battery (BEV)” battery and the “redistributable Rd-P-MCS” module can be used interchangeable.

### The “Redistributable Rd-P-MCS” Module

The invention solves the prior art long-distance mobility problem, when the EV vehicles need to stop for a charging waiting time period to recharge the energy depleted EV Battery (BEV).

The invention implements the “charging during driving” functionality towards the invention goal of “never charge when in stationary mode” for the invention Rd-P-MCS compatible participating EV vehicles having a charging and powering architecture based on the novel “Rd-P-MCS compatible BEV Battery (BEV)” battery and the novel “redistributable Rd-P-MCS” module that is portable, rentable charging device with metering and billing functionality.

The “redistributable Rd-P-MCS” module is based on the concept of partitioning and packaging the bulk energy, contained in a Prior art Mobile Charging Station (MCS), for easy swapping and distribution.

The “redistributable Rd-P-MCS” module is a Portable, Rentable and Redistributable Charging module.

The “charging during driving” functionality can be depicted as a notation or depicted as a simplified diagram in FIG. 116. From the simplified diagram of the figure, one could see that one such embodiment of the invention “Rd-P-MCS compatible BEV Battery (BEV)” battery may be composed of two battery parts, Part #1 and Part #2, which are alternatively power the Electric Motor(s) and are charged also alternatively from the “redistributable Rd-P-MCS” module: when one battery part is powering the Electric Motor(s) the other part is being charged.

When one battery part is depleted of energy, the circuitry switches the battery parts goals: the depleted battery part stops powering the Electric Motor(s) and starts to be charged while the other battery part stops being charged and starts powering the Electric Motor(s).

As a principle, powering state and charging state are mutual exclusive as seen in FIG. 116.

A more detailed schematic diagram of the implementation of the “charging during driving” functionality seen in FIG. 116 is shown in FIG. 115 and in the FIG. 111.

FIG. 113 shows a similar embodiment in which instead of an “Rd-P-MCS compatible BEV Battery (BEV)” battery, the “redistributable Rd-P-MCS” module charges either of the “Rd-P-MCS compatible BEV Battery (BEV)” batteries: when one such invention battery powers the Electric Motor(s), the other invention battery is being charged by the “redistributable Rd-P-MCS” module, alternatively. This embodiment can be applied to the architecture diagram from FIG. 112.

Similarly with the diagram shown in FIG. 114, the invention “Rd-P-MCS compatible BEV Battery (BEV)” battery and the invention “redistributable Rd-P-MCS” module may alternate in powering the Electric Motor(s), but as opposed to figures FIG. 106 and FIG. 107, in the case depicted in FIG. 114, the battery that is not powering the Electric Motor(s) is being charged from another “redistributable Rd-P-MCS” module.

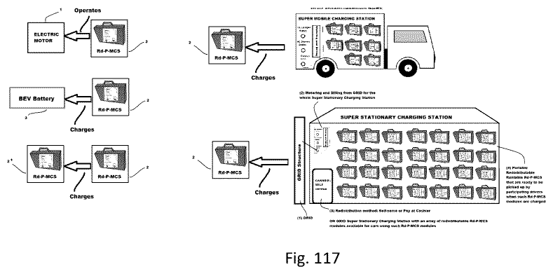

Besides the use cases when the “redistributable Rd-P-MCS” module operates together with the invention “Rd-P-MCS compatible BEV Battery (BEV)” battery with the goal to support and implement the concept of “charging during driving” as shown in the previous section, the “redistributable Rd-P-MCS” module has additional functionality that is depicted in the FIG. 117:
a) The “redistributable Rd-P-MCS” module can power/operate the Electric Motor(s)
b) The “redistributable Rd-P-MCS” module can charge the novel “Rd-P-MCS compatible BEV Battery (BEV)” battery, including when the “Rd-P-MCS compatible BEV Battery (BEV)” battery powers/operates the Electric Motor(s).
c) The “redistributable Rd-P-MCS” module can charge another “redistributable Rd-P-MCS” module.
d) The “redistributable Rd-P-MCS” module can be charged from a Super Mobile Charging Station (Super-MCS)
e) The “redistributable Rd-P-MCS” module can be charged from a Super Stationary Charging Station (Super-SCS) When mentioning Rd-P-MCS participating compatible EV vehicles it is assumed that such embodiments include in their design a plurality of “Rd-P-MCS compatible BEV Battery (BEV)” batteries and a plurality of “redistributable Rd-P-MCS” modules.

The concepts of powering the Electric Motor and operating the Electric Motor are interchangeable.

In all the above-mentioned use cases, the apparatus of the invention should implement the required hardware and software for such goals.

The “redistributable Rd-P-MCS” modules are the main object of the redistribution method its supporting apparatus and method as described later in the disclosure.

The “redistributable Rd-P-MCS” modules, in their normal embodiment, as seen in the figures FIG. 30, FIG. 31, FIG. 32, and FIG. 33 are part of the general charging and powering architecture this shown in the figures FIG. 108, FIG. 109, FIG. 110, FIG. 111, and FIG. 112, but not only.

The “redistributable Rd-P-MCS” modules may be an alternative option to the EV Battery (BEV)—including to the “Rd-P-MCS compatible BEV Battery (BEV)” battery—in powering the Electric Motor(s) as shown in figures FIG. 106 and FIG. 107.

The split “redistributable Rd-P-MCS” module, or otherwise “Light redistributable Rd-P-MCS” module, as depicted in FIG. 82, FIG. 83, FIG. 84, FIG. 85, and FIG. 86 and FIG. 87, is a variant of the “redistributable Rd-P-MCS” module that has some of its components embedded in the Rd-P-MCS participating compatible EV vehicles, hence the characterization of being “split”.

The “Light redistributable Rd-P-MCS” modules may also be part of the general charging and powering architecture, as shown in the figures FIG. 108, FIG. 109, FIG. 110, FIG. 111, and FIG. 112, in conformity with the disclosure statement that mentions that all use cases referring to “redistributable Rd-P-MCS” modules are also applicable to the “Light redistributable Rd-P-MCS” modules.

More properties and use cases related to the “redistributable Rd-P-MCS” modules and to the “Light redistributable Rd-P-MCS” modules are described elsewhere in the disclosure.

Note that in the case of the “Light redistributable Rd-P-MCS” module variant the Rd-P-MCS participating compatible EV vehicles, the recharging and/or mounting slots from Super Stationary Charging Stations (Super-SCS) and Super Mobile Charging Stations (Super-MCS), but not only, need to have the complementary parts that would complete a “Light redistributable Rd-P-MCS” module into a full “redistributable Rd-P-MCS” module.

### The Rd-P-MCS Participating Compatible EV Vehicles

Any mentioning of Rd-P-MCS participating compatible EV vehicles assumes that such embodiments include in their design a plurality of “Rd-P-MCS compatible BEV Battery (BEV)” batteries and a plurality of “redistributable Rd-P-MCS” modules.

The charging and the powering architecture of the Rd-P-MCS participating compatible EV vehicles is shown, in multiple embodiments, in the figures FIG. 108, FIG. 109, FIG. 110, FIG. 111, and FIG. 112, FIG. 82, FIG. 83, FIG. 84, FIG. 85, and FIG. 86, and FIG. 87, but not only.

### Supporting Apparatus for the Redistribution Method—Super Stationary Charging Station (Super-SCS), Super Mobile Charging Station (Super-MCS), and Certified Partner Station Vehicles

The invention supports the redistribution method to reach the full potential and to avoid the degradation of the performance goals, as well as to achieve the concepts of “distributing redistributable Rd-P-MCS modules to other locations while charging them”, and “never charge while stationary”, but not only:
a. A plurality of Super Stationary Charging Stations (stationary—ON GRID), as described in the present disclosure,
b. A plurality of Super Mobile Charging Stations (Super-MCS)—that are stationary (ON GRID or OFF GRID) or that are driving (OFF GRID), as described in the present disclosure,
c. Super Mobile Charging Stations (Super-MCS) vehicles that allow, as part of the “redistribution method”, OFF-Grid transportation of “redistributable Rd-P-MCS” modules in Operational state for redistribution to other Super Stationary Charging Stations (stationary—ON GRID), and Super Mobile Charging Stations (Super-MCS)—while stationary (ON GRID, in all embodiments described in the disclosure,
d. A plurality of Super Mobile Charging Stations (Super-MCS) vehicles that allow, as part of the “redistribution method”, the transportation of “redistributable Rd-P-MCS” modules in Operational state for redistribution to other Super Mobile Charging Stations (Super-MCS) (OFF GRID), or other Certified Partner Service vehicles, in all embodiments described in the disclosure,
e. A plurality of Super Mobile Charging Stations (Super-MCS) vehicles that allow, as part of the “redistribution method”, the transportation of “redistributable Rd-P-MCS” modules in Operational state for redistribution to locations for Rental Delivery at meeting Order Calls by Rd-P-MCS compatible participating EV vehicles anticipating such location alongside their travel plan, in all embodiments described in the disclosure,
f. A plurality of mobile Super Mobile Charging Station (Super-MCS) containing an array of “redistributable Rd-P-MCS” modules that may be charged while stationary or during driving the Super Mobile Charging Station (Super-MCS),
g. A plurality of Super Mobile Charging Stations (Super-MCS) mounted “redistributable Rd-P-MCS” units, whose cardinality may reach numbers up fifty (50) “redistributable Rd-P-MCS” units, if not more, possibly hundreds, in the case of mobile Super Mobile Charging Stations (Super-MCS) and/or Super Stationary Charging Stations (Super-SCS).
h. A plurality of Certified Partner Service vehicles that allow, as part of the “redistribution method”, OFF-Grid transportation of “redistributable Rd-P-MCS” modules in Operational state for redistribution to other Super Stationary Charging Stations (stationary—ON GRID), and Super Mobile Charging Stations (Super-MCS)—while stationary (ON GRID, in all embodiments described in the disclosure,
i. Others described in the present disclosure

The supporting apparatus includes the Super Mobile Charging Station, aka Super-MCS, concept which redistributes Rd-P-MCS modules from places where they are less useful to places where there is a more need for the Rd-P-MCS modules. This is needed because the Rd-P-MCS modules are moving only one way in a non-looped and/or open driving circuit in both opposite driving paths, for example in the case of a highway.

The present disclosure shows how the Prior art Mobile Charging Station (MCS) concept is transformed into the business method supporting apparatus referred to as Super Mobile Charging Station (Super-MCS), in order to distinguish it from Mobile Charging Station (MCS), where rather than holding a large raw electric energy stored into a large apparatus comprising an Ultracapacitor and Battery Packs, besides other, the Super Mobile Charging Station (Super-MCS) holds a scalable high number (up to twenty five (25), if not more) of mounted “redistributable Rd-P-MCS” modules.

One could see that the Mobile Charging Station (MCS) Ultracapacitor has already been split into smaller scale Ultracapacitors at each “redistributable Rd-P-MCS” module in the case of the Super Mobile Charging Station (Super-MCS).

However, the Super Mobile Charging Station (Super-MCS) still retains the Ultracapacitor and Battery Packs, among other Mobile Charging Station (MCS) features, thus the Super Mobile Charging Station (Super-MCS) is capable of charging “redistributable Rd-P-MCS” modules even when NOT connected to GRID, but also when DRIVING, including possibly powering its own Electric Motor in case of a fully Electric Super Mobile Charging Station (Super-MCS), but not only.

As seen further in the disclosure, all such “redistributable Rd-P-MCS” modules are mounted in their own charging sockets, possibly with their own socket cooling systems, so that the “redistributable Rd-P-MCS” modules can be charged by the Super Mobile Charging Station, aka Super-MCS, in any of its phases of operation: while stationary connected to the GRID, while stationary while NOT connected to the GRID, and while DRIVING.

FIG. 25, FIG. 26, and FIG. 27 show the transformation from Mobile Charging Station (MCS) to Super Mobile Charging Station (Super-MCS) in all its three main embodiments:
a. A stationary Super Mobile Charging Station (Super-MCS) that is connected to the GRID, hence labeled with “ON GRID”, where it is charging its own Ultracapacitor and Battery Packs apparatus alongside charging all the mounted “redistributable Rd-P-MCS” modules, as seen in the FIG. 25.
b. A stationary Super Mobile Charging Station (Super-MCS) that is NOT connected to the GRID, hence labeled with “OFF GRID”, where it is charging all the mounted “redistributable Rd-P-MCS” modules from its own Ultracapacitor and Battery Packs, as seen in the FIG. 26. This could be happening at a temporary stationary location used by the Super Mobile Charging Station (Super-MCS) where EV vehicles come to collect and/or drop-off “redistributable Rd-P-MCS” modules or it could happen at a meet location part of servicing a dispatched request in near or more distant scheduled in the future,
c. A stationary Super Mobile Charging Station (Super-MCS) that is NOT connected to the GRID, hence labeled with “OFF GRID”, where it is charging all the mounted “redistributable Rd-P-MCS” modules from its own Ultracapacitor and Battery Packs, during DRIVING, as seen in the FIG. 27.

Any Super Mobile Charging Station has the property of charging its mounted “redistributable Rd-P-MCS” modules during its operation and its own Ultracapacitor when it is stationary connected to the GRID Infrastructure and but also charging its mounted Rd-P-MCS modules from its own Ultracapacitor and Battery Packs that are similar with the one used in a Prior art Mobile Charging Station (MCS) architecture.

The supporting apparatus includes also the Super Stationary Charging Station which is always connected to the Grid and that charges a number, that could be a large number—up to fifty (50) such modules per station—if not more, of “redistributable Rd-P-MCS” modules mounted into specially devised “charging sockets”, that are readily available, when charged, to be picked-up and rented by participating owners of Rd-P-MCS compatible participating EV vehicles.

The present disclosure also shows how the Prior art Mobile Charging Station (MCS) concept holding a large raw electric energy stored is transformed into the business method supporting apparatus called Super Stationary Charging Station, aka Super-SCS, which may hold a scalable high number of mounted “redistributable Rd-P-MCS” modules, see FIG. 28.

The “Super Stationary Charging Station” is also referred to as the “Super Stationary Recharging Station”, “Super Stationary Recharge Station”, “Stationary Charging Station”, “Stationary Recharging Station”, “Stationary Recharge Station”, “Stationary Recharge Station”, “Super Recharge Stationary Station”, or “Recharge Stationary Station”, but not only, interchangeably.

Because the “redistributable Rd-P-MCS” modules are meant to be rented by Rd-P-MCS compatible participating EV vehicles, the Super Stationary Charging Station may have at times, if not most of the times, charging sockets that are available for mounting discharged “redistributable Rd-P-MCS” modules—in case of a drop-off action—or even charged “redistributable Rd-P-MCS” modules—in case of a redistribution transfer action.

A Super Stationary Charging Station that is stationary connected to the GRID Infrastructure that could be viewed to be similar, without limitation, with a Super Mobile Charging Station that is always stationary and connected to the GRID Infrastructure, e.g., like a Super Mobile Charging Station.

For the reasons mentioned above, the Super Stationary Charging Station may have a similar architecture with a Super Mobile Charging Station but:
k. without the wheels,
l. without the BEV Battery and its charging components if Super Mobile Charging Station is an EV vehicle,
m. without the Fuel Tank and the fueling components if the Super Mobile Charging Station is fossil fuel powered vehicle, and
n. without the engine,
o. without other mobility components.

Another supporting apparatus is implemented by the Certified Partner Service vehicles that improve the availability of the Rd-P-MCS distribution service where the service infrastructure is not available for multiple reasons, such as low demand and insufficient business reasons for expansion, the location is not yet serviced by the more expensive supporting apparatus even if it will be serviced sometime in the near and/or distant future, remote areas, but not only.

The present invention disclosure refers to a Recharging Station as any of the Super Stationary Charging Station, Super Mobile Charging Station, or Certified Partner Service vehicle.

The totality of the Super Stationary Charging Stations, to other Super Mobile Charging Stations, or to Certified Partner Service vehicles, but not only, represents what is called the “participating charging stations”, or the “Recharging Stations”, of a Driving Circuit.

The Super Mobile Charging Station (Super-MCS), may redistribute Rd-P-MCS modules to Super Stationary Charging Stations, to other Super Mobile Charging Stations, or to Certified Partner Service vehicles, but not only, for balancing the availability in the Driving Circuit, but also for other types of service such as responding to EV vehicles requests for “redistributable Rd-P-MCS” module delivery.

The Super Mobile Charging Station (Super-MCS), may dispatch “redistributable Rd-P-MCS” modules based on Rd-P-MCS compatible participating EV vehicle Rd-P-MCS orders that specify the desired time and the location for the delivery as well as the number of desired charged “redistributable Rd-P-MCS” modules.

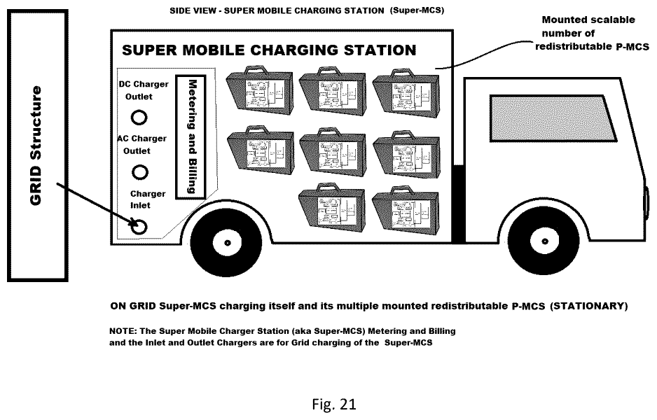

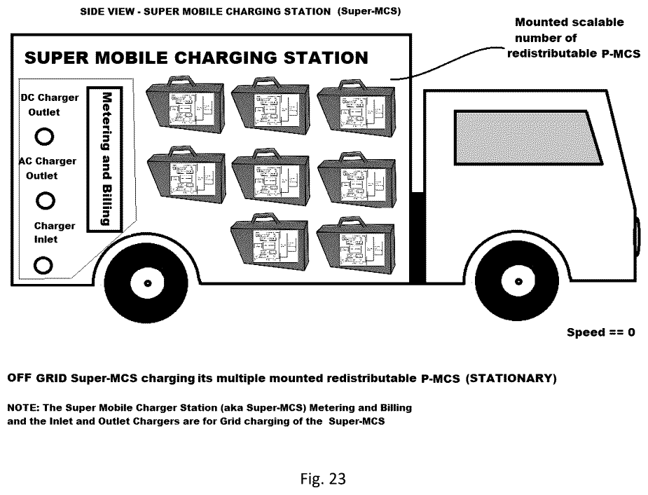

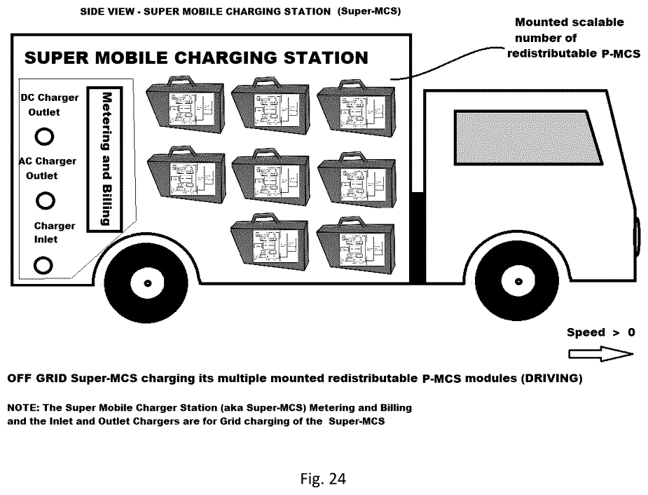

The concept of “packaging energy” into charged “redistributable Rd-P-MCS” modules mentioned above is actually a partitioning of the Prior art Mobile Charging Station (MCS) concept's “hardware, software and it's functionality” into the concept of a scalable array of portable and rentable “redistributable Rd-P-MCS” modules with such Mobile Charging Station (MCS) concept's “hardware, software and it's functionality”, e.g., into an array of commercially “redistributable Rd-P-MCS” modules as seen in the figures FIG. 25, FIG. 26, FIG. 27, and FIG. 28 with the results shown in figures FIG. 21, FIG. 23, and FIG. 24.

Prior Art Transformations that LED to the Invention, Differences Between Prior Art and the Invention, and Properties of the “Redistributable Rd-P-MCS” Module

The present invention disclosure provides the following transformations from Prior art Mobile Charging Station (MCS), see also FIG. 25, FIG. 26, FIG. 27, FIG. 28, FIG. 29, FIG. 74, FIG. 75, and FIG. 76:
a. the Prior art Mobile Charging Station (MCS) concept is transformed into a miniaturized “redistributable Rd-P-MCS” module concept with similar functionality,
b. the Prior art Mobile Charging Station (MCS) concept is transformed into a scalable number of (or array of) above miniaturized “redistributable Rd-P-MCS” module concept, similar with the cell division where Mobile Charging Station (MCS) is the parent cell and the scalable number of above miniaturized “redistributable Rd-P-MCS” module are the daughter cells.
c. the Prior art Mobile Charging Station (MCS) concept is transformed into a Super Mobile Charging Station service vehicle that maintains some, if not most, of the functions of MCS, but with the added feature of having a scalable number of charging sockets, each one with its own cooling system, such that each such charging socket is capable to keep mounted a “redistributable Rd-P-MCS” module and to charge such “redistributable Rd-P-MCS” module even when OFF-GRID and/or during driving as depicted in FIG. 23 and FIG. 24.
d. The scalable number of miniaturized “redistributable Rd-P-MCS” modules mentioned above at lit. b, may be mounted on and charged from the charging sockets of the Super Mobile Charging Station service vehicle, as mentioned above at lit. c;
e. The charging of the “redistributable Rd-P-MCS” modules of a Super Mobile Charging Station service vehicle could be charged alternatively from the GRID (when the Super Mobile Charging Station service vehicle is connected to the GRID) or from the Super Mobile Charging Station vehicle's own Ultracapacitor and Battery Pack retained from the architecture of the Prior art Mobile Charging Station (MCS) concept when the Super Mobile Charging Station is OFF-GRID.
f. the Prior art Mobile Charging Station (MCS) concept is transformed into a Stationary Mobile Charging Station construct always connected to the Electrical GRID, construct in the form of a building, but not only, similarly with the transformation process for the Super Mobile Charging Station service vehicle, but without the wheels, the driver's cabin, and any other mobility parts. Although not necessarily, the Stationary Mobile Charging Station construct may have its own Ultracapacitor and Battery Pack, for failover in case of GRID failures, either in monolithic form or in a distributive form as designed

In Prior art the charging time is not a transparent main dependency on the charging cost or on a “performance method”.

In Prior art the concern of providing access to “participating charging stations” are mostly EV vehicle manufacturer bound, with possible multi-manufacturer consolidations, with a location coverage performance method but without any stress models from the point of view of simultaneous charging requests as opposed to the performance methods of the present invention disclosure.

The present invention disclosure replaces the problem of minimization of the charging time with the EV vehicle being stationary which most of the time represents wasted time and increased operational costs for both private and commercial customers, but not only, with the problem of minimizing the rental time of the “redistributable Rd-P-MCS” modules which leads to both a decreased rental cost (a customer's performance goal) and a higher availability of “redistributable Rd-P-MCS” modules in the Driving Circuit, which represents a fortunate alignment between the customers' interests and the service providers' interests.

In the present invention disclosure, the charging time from a “redistributable Rd-P-MCS” module is still an important factor to the charging cost due to the fact that the more rapidly the EV vehicle Battery (BEV) is charged during driving by the rented “redistributable Rd-P-MCS” module, the faster the Rd-P-MCS compatible participating EV vehicle will be able to drop-off the “redistributable Rd-P-MCS” module to one of the “participating charging stations” or other collection business partners.

The Super Mobile Charging Station supporting apparatus shown in figures FIG. 21, FIG. 23, and FIG. 24, is innovative both from the point of view of the scalable number of “redistributable Rd-P-MCS” modules, thus leading to the fact that the “redistribution method” has value from a business method point of view.

Moreover, Super Mobile Charging Stations can charge during driving all the mounted “redistributable Rd-P-MCS” modules transferred between locations of interest, leading to further optimization improvements in operational costs, level of availability of “redistributable Rd-P-MCS” modules within the driving circuit, thus providing further minimization of customer rental costs and minimization of charging waiting time that is part of the performance method.

The “redistributable Rd-P-MCS” module may have an identity feature, based on security certificates, bar codes, but not only, in order to enable the payment method that starts at the pickup location and concludes at the drop-off location of the “redistributable Rd-P-MCS” module, similarly to renting a car.

Because of the anticipated high price of the “redistributable Rd-P-MCS” module and because the scope of the invention disclosure is to practically eliminate waiting times with charging the EV vehicle, in their various embodiments described in the disclosure, a subscription to the business method would be preferable considering one's experience with the time-consuming steps needed when renting a car.

Moreover, renting such “redistributable Rd-P-MCS” modules may be needed several times during a day in case of longer trips which the present invention disclosure targets as application, a further motive for the owners of the compatible EV vehicles to participate within a subscription program which prescreens the subscribers from a credit history, already provided security deposit, and an insurance point of view (both financial and driving related), but not only.

While other features described in the present disclosure are also important for the overall scope of the invention and for attaining its full performance potential—the Rd-P-MCS compatible participating EV vehicle will never stop for stationary charging—the presence of the “metering and billing” and the “identity” features together with the briefly described payment method are the essential parts of building a business method that allows the implementation of the “charging while driving” concept.

The “redistributable Rd-P-MCS” module is a partitioned and a packed unit of energy that is rentable, movable and billable as defined in the present invention disclosure.

The “redistributable Rd-P-MCS” module, or simply “Rd-P-MCS”, is sometimes called in the present invention disclosure a “portable, rentable, and redistributable Rd-P-MCS”, with the same understanding.

Using the concept of mobile Rd-P-MCS providers (Super Mobile Charging Stations, and/or Certified Partner Service vehicles) the business method may offer Rd-P-MCS module services not only at the current location of the Rd-P-MCS compatible participating EV vehicle or at the location of such mobile Rd-P-MCS providers but also in the future, based on a Rd-P-MCS service plan, at a predetermined time and location, where the customer EV vehicle and the mobile Rd-P-MCS provider could meet for the service execution.

The “dispatching method” uses queues of such Rd-P-MCS requests for future service executions, this would provide better optimized solutions, including with respect to used service resources and service predictability, leading to better cost savings and customer satisfaction.

Allocating dedicated parts of the business method from the available Rd-P-MCS modules and from the available mobile Rd-P-MCS providers to such future Rd-P-MCS service orders, as part of a premium (and more expensive) subscription plan, improves predictability and performance guarantees of the service execution.

The “redistributable Rd-P-MCS” is the equivalent of an amount of fuel (Gasoline and/or Diesel) that fills the tank of a standard fossil fuel-based vehicle with the difference that the Rd-P-MCS is a packed amount of energy that can be transported outside of the electrical grid, in this case to be used for “charging during driving”.

The main performance goal of any EV vehicle compatible with the Rd-P-MCS module, as described above, with no stationary charging waiting charging times during the trip, is mostly supported by the concept of “charge during driving” supported by the Rd-P-MCS module architecture, by the Rd-P-MCS compatible participating EV vehicles with their Battery Charging and Engine Powering novel architecture (the Electric Motor decoupled from the Prior art exclusive connectivity with the EV Battery) together with the supporting charging, payment method and redistribution method apparatus (Super Mobile Charging Stations, but not only) as long as there is an infinite number of available Rd-P-MCS modules in the driving circuit alongside the planned trip route.

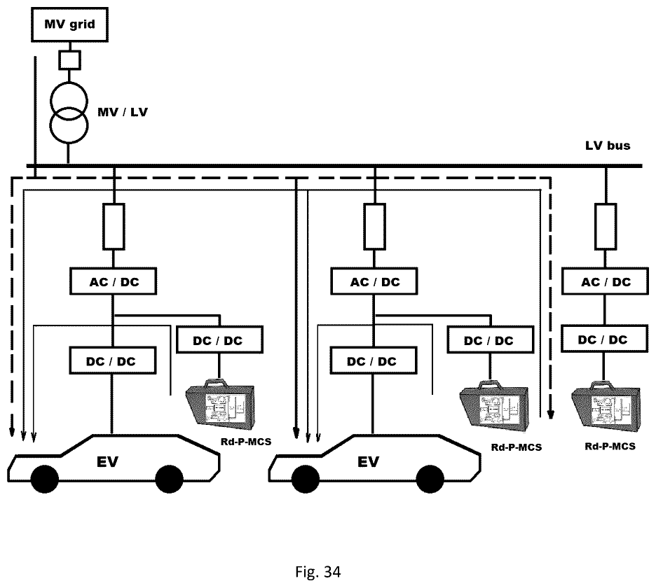

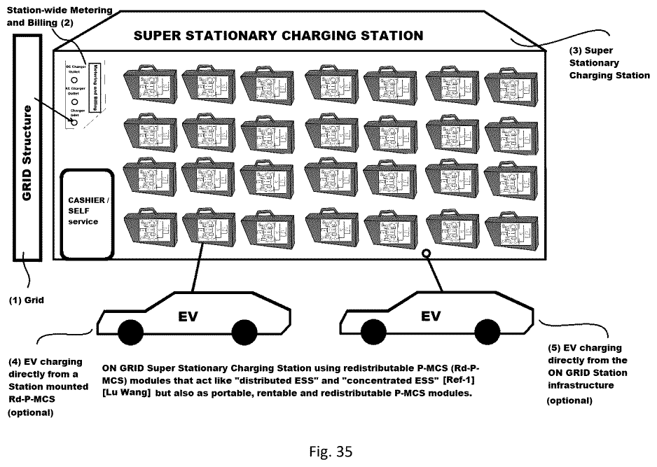

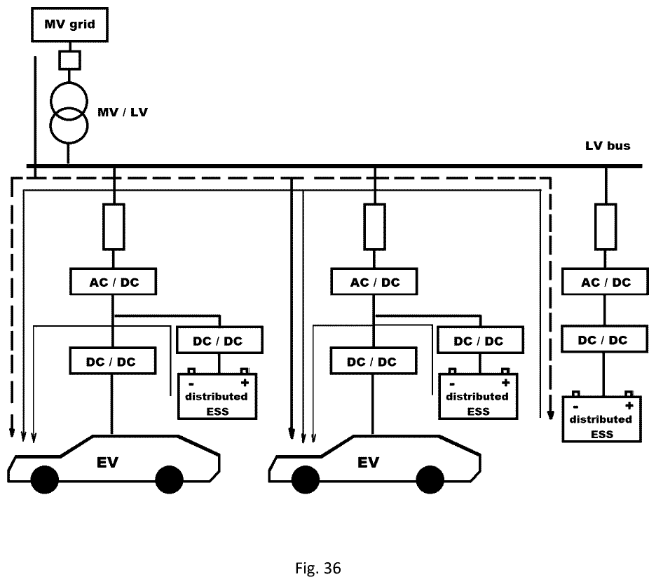

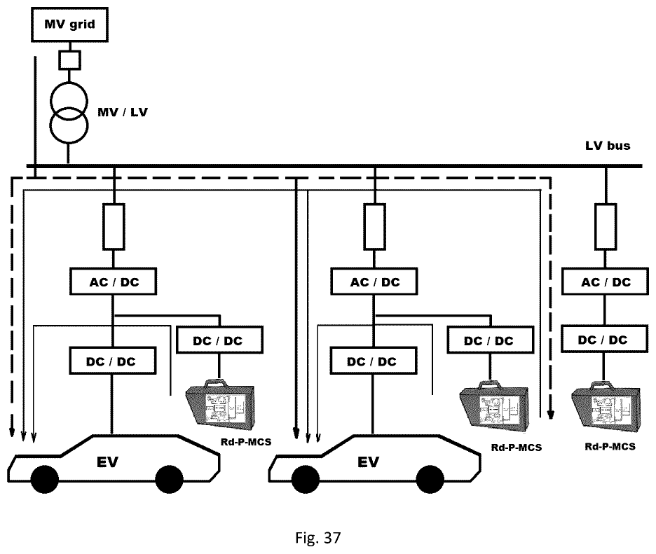

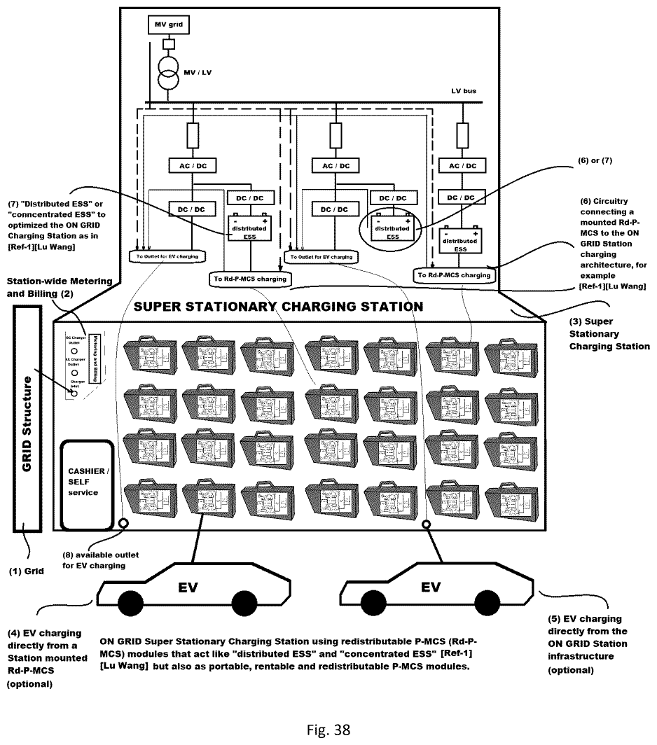

The supporting apparatus includes the Super Stationary Charging Station (Super-SCS) which is always connected to the Grid and is charging the mounted Rd-P-MCS modules that are readily available to be picked up and rented by the owners of Rd-P-MCS compatible participating EV vehicles as depicted in the FIG. 34, FIG. 35, FIG. 36, FIG. 37, and FIG. 38 as obtained from the transformation process from Prior art Mobile Charging Station (MCS) depicted in FIG. 28 together with any charging architecture, for example the architecture presented in [Ref-1] [Lu Wang], compatible with the disclosure goal of using portable, rentable “redistributable Rd-P-MCS” modules.

Another supporting apparatus is the Super Mobile Charging Station (Super-MCS), which redistributes Rd-P-MCS modules from places where they are less useful to places where there is a more need for the Rd-P-MCS modules. This is needed because the Rd-P-MCS modules are moving only one way in a non-looped and/or open driving circuit in both opposite driving paths, for example in the case of a highway.

The present invention disclosure claims that starting to implement the described business method with reasonable performance guarantees is relatively easy and inexpensive once the production of the Rd-P-MCS core apparatus, Rd-P-MCS compatible participating EV vehicles, the supporting apparatus of charging, payment method and redistribution method (Super Mobile Charging Stations, but not only), together with any required business contracts are signed with the qualifying certified partner services, described in the disclosure, are in place.

The redistribution method may rely solely on the Super Mobile Charging Stations since when connected to the GRID they would act just like the Super Stationary Charging Station but without location restrictions of the latter, thus providing much needed flexibility.

Super Mobile Charging Stations may also act, albeit with more operational costs in some cases, as the qualified Certified Partner Station vehicles that provide a cheap and flexible redistribution of Rd-P-MCS, in emergency cases or just in planned service calls in remote areas without Super Stationary Charging Stations and Super Mobile Charging Stations coverage.

With an “incentive method” as described in the present disclosure, even the drivers of Rd-P-MCS compatible participating EV vehicles could become redistribution agents, in fact they are more agile redistribution agents of the “redistributable Rd-P-MCS” modules in a more localized way but with potential cost savings for the business method.

The Driving Circuit may be comprised of at least a service area, or servicing area, that could be represented, for example—without any limitation—by a bi-directional highway or expressway.

If the Driving Circuit is comprised of just a highway with one entry point and one exit point, for simplification purposes, and if all the rented “redistributable Rd-P-MCS” modules should remain within the Driving Circuit, e.g., any rented “redistributable Rd-P-MCS” module must be dropped-off within a Driving Circuit's drop-off location before the Rd-P-MCS compatible participating EV vehicle leaves the Driving Circuit, then there would be an accumulation of such dropped-off “redistributable Rd-P-MCS” modules at the exit points on both traffic directions.

An example of implementation of the “redistribution method” for the “redistributable Rd-P-MCS” modules that have been transferred within the Driving Circuit (highway, but not only) could be that the dropped-off “redistributable Rd-P-MCS” modules near the exit points of the Driving Circuit in one direction could be transferred with minimal effort and cost by Super Mobile Charging Stations or by qualified Certified Partner Station vehicles, but not only, to the participating (possibly depleted) charging stations near the entry points of the Driving Circuit in the other direction.

The “redistribution method” could recommend the Rd-P-MCS compatible participating EV vehicles the best locations for dropping-off their used and already energy depleted “redistribution Rd-P-MCS” module(s) based on a variety criteria and associated discount cost.

This feature could use the Geolocation tracking feature (GPS) of the “redistribution Rd-P-MCS” module and a suite of various optimization algorithms with different goals that are transparent to the customers.

Because the total rented time is a key factor in the cost of rental, the customer has the interest to drop-off the rented “redistributable Rd-P-MCS” module at the nearest available participating charging stations.

### Rental Method and Payment Method

The invention allows the rental of “redistributable Rd-P-MCS” modules via rental transactions involving such “redistributable Rd-P-MCS” modules between the invention subscribed Rd-P-MCS compatible participating EV vehicles and Recharging Stations such as Stationary Portable Charging Stations, Stationary Super Mobile Charging Stations (Super-MCS), Driving Super Mobile Charging Stations (Super-MCS), Participating Certified Partner Service vehicles, including embodiments with incentive method and asynchronous transfer of “redistributable Rd-P-MCS” modules.

The rental method may involve, for example:
1. A Rd-P-MCS compatible participating EV vehicle picks-up (rents) a charged “redistributable Rd-P-MCS” module from a Super Stationary Charging Station,
2. A Rd-P-MCS compatible participating EV vehicle drops-off (rents) a discharged “redistributable Rd-P-MCS” module to a Super Stationary Charging Station,
3. A Rd-P-MCS compatible participating EV vehicle swaps (rents) a discharged “redistributable Rd-P-MCS” module for a charged “redistributable Rd-P-MCS” module with a Super Stationary Charging Station, e.g., the EV vehicle transfers a discharged “redistributable Rd-P-MCS” module from itself to the Super Stationary Charging Station, and the EV vehicle transfers to itself a charged “redistributable Rd-P-MCS” module from the Super Stationary Charging Station,
4. A Rd-P-MCS compatible participating EV vehicle picks-up (rents) a charged “redistributable Rd-P-MCS” module from a Super Mobile Charging Station (ON GRID or OFF GRID),
5. A Rd-P-MCS compatible participating EV vehicle drops-off (rents) a discharged “redistributable Rd-P-MCS” module to a Super Mobile Charging Station (ON GRID or OFF GRID),
6. A Rd-P-MCS compatible participating EV vehicle swaps/exchanges (rents) a discharged “redistributable Rd-P-MCS” module for a charged “redistributable Rd-P-MCS” module with a Super Mobile Charging Station (ON GRID or OFF GRID), e.g., the EV vehicle transfers a discharged “redistributable Rd-P-MCS” module from itself to the Super Mobile Charging Station (ON GRID or OFF GRID), and the EV vehicle transfers to itself a charged “redistributable Rd-P-MCS” module from the Super Mobile Charging Station (ON GRID or OFF GRID),
7. A Rd-P-MCS compatible participating EV vehicle picks-up (rents) a charged “redistributable Rd-P-MCS” module from a Certified Partner Service vehicle,
8. A Rd-P-MCS compatible participating EV vehicle drops-off (rents) a discharged “redistributable Rd-P-MCS” module to a Certified Partner Service vehicle,
9. A Rd-P-MCS compatible participating EV vehicle swaps/exchanges (rents) a discharged “redistributable Rd-P-MCS” module for a charged “redistributable Rd-P-MCS” module with a Certified Partner Service vehicle, e.g., the EV vehicle transfers a discharged “redistributable Rd-P-MCS” module from itself to the Certified Partner Service vehicle, and the EV vehicle transfers to itself a charged “redistributable Rd-P-MCS” module from the Certified Partner Service vehicle,

A “payment method” associates a monetary transaction with a rental process of one or more “redistributable Rd-P-MCS” module(s) which is necessary to make the invention to be business viable and to attain the potential of the performance in regard to the main goals of the invention: obtaining the “charge while driving” (including embodiments related to decoupling the EV Battery (BEV) from the Electric Motor(s)) and avoiding “stationary charging waiting times”.

The payment method:
a. starts a new Open-ended payment transaction when a Rd-P-MCS compatible participating EV vehicle picks-up (rent) a charged “redistributable Rd-P-MCS” module(s) from a (ON GRID) Super Stationary Charging Stations, a (ON GRID and/or OFF GRID) Super Mobile Charging Stations (Super-MCS), or from a (OFF GRID) Certified Partner Service vehicle,
b. finalizes a previously started Open-ended payment transaction when a Rd-P-MCS compatible participating EV vehicle drops-off (rent) at least a charged “redistributable Rd-P-MCS” module(s) from a (ON GRID) Super Stationary Charging Stations, a (ON GRID and/or OFF GRID) Super Mobile Charging Stations (Super-MCS), or from a (OFF GRID) Certified Partner Service vehicle,
c. finalizes a previously started Open-ended payment transaction and starts a new Open-ended payment transaction when a Rd-P-MCS compatible participating EV vehicle swaps/exchanges a discharged previously rented “redistributable Rd-P-MCS” module for a charged rented “redistributable Rd-P-MCS” module with a (ON GRID) Super Stationary Charging Stations, with a (ON GRID and/or OFF GRID) Super Mobile Charging Stations (Super-MCS), or with a (OFF GRID) Certified Partner Service vehicle,
d. When a Rd-P-MCS compatible participating EV vehicle picks-up (rent) multiple charged “redistributable Rd-P-MCS” module there is created separate one Open-ended payment transaction for each such “redistributable Rd-P-MCS” module.
e. Uses the “Metering and Billing” core feature of the “redistributable Rd-P-MCS” module that provides the information necessary for renting and for the payment of the service provided by such a “redistributable Rd-P-MCS”.
f. An alternate “Metering and Billing” feature of the “redistributable Rd-P-MCS” could be moved to the both the starting charging station (Super Stationary Charging Stations, a (ON GRID and/or OFF GRID) Super Mobile Charging Stations (Super-MCS), or from a (OFF GRID) Certified Partner Service vehicle) which creates an open-ended payment transaction and the ending charging station (Super Stationary Charging Stations, a (ON GRID and/or OFF GRID) Super Mobile Charging Stations (Super-MCS), or from a (OFF GRID) Certified Partner Service vehicle) which finalizes the previously created open-ended payment transaction with the materialization of the actual payment order to the payment service suppliers,
g. Has the rental service cost fees dependent on rented time, the used energy charge, location of pick-up and drop-off, but not only.

### Incentive Method Details

The “redistribution method” may use the also the Rd-P-MCS compatible participating EV vehicles as redistribution agents for their rented, used and discharged “redistributable Rd-P-MCS” modules.

Depending on the redistribution needs within the driving circuit, the “redistribution method” may offer cost incentives to the Rd-P-MCS compatible participating EV vehicles that are seeking locations to drop-off already used and depleted “redistributable Rd-P-MCS” modules in order to contribute to the overall “redistribution method” goal.

There is another example where the goal of the customer, e.g., minimizing the rental cost—including the incentives for acting as a drop-off redistribution agent—and the goal of the driving circuit service provider, e.g., minimizing the operational cost of the redistribution method, are aligned. Moreover, minimizing the operational cost of the redistribution method may also lead to further benefits in decreasing the base rental cost.

When a Rd-P-MCS compatible participating EV vehicle seeks to pick-up a “redistributable Rd-P-MCS” module, to exchange a “redistributable Rd-P-MCS” module, or to drop-off a “redistributable Rd-P-MCS” module, such intentions are shared with the driving circuit and its apparatus and algorithms.

Upon the receival of the alternate locations and their associated “on the fly” discount (which may include different incentives based on the selected location) the driver selects such location that best suits his/her needs as part of an incentive method contract.

Allowing and proposing total rental cost discounts to the Rd-P-MCS compatible participating EV vehicles that are sharing their driving plan so that they will become pick-up redistribution agents or drop-off redistribution agents is called the incentive method.

Through the incentive method, the driving circuit and its apparatus allow the extension of the execution of cooperative “redistribution method” that seeks a greater good than the sum of the disconnected and isolated particular interests of the participating Rd-P-MCS compatible participating EV vehicles and drivers.

Formalizations that include Game Theory decision-making methods in games involving two or more players: Nash Equilibrium, Competitive Equilibrium, Correlated Equilibrium, but not only, may be devised and used in order to optimize the cost of operating the driving circuit according to the overall performance model and the individual subscription performance guarantees.

Any deviation alongside with everything it entails (data and algorithms involved, distributed databases and software, incentive proposals, selection of such proposals, but not only) of such participating EV vehicles from their shared driving plan, such that such EV vehicles become limited redistribution agents, is part of the incentive method.

The “incentive method” may propose to the Rd-P-MCS compatible participating EV vehicles that they undertake at least one of the following actions during their (shared) planned trip:
a. A driver may pick-up a “redistributable Rd-P-MCS” module earlier that it may be needed: the rental time may increase doing such action because such module is not yet needed, but the incentive may surpass in cost saving what would be the case without the incentive.
b. A driver may slightly deviate from the planned trip in order to pick-up a “redistributable Rd-P-MCS” module: the rental time may increase doing such voluntary supporting action, but the incentive may surpass in cost saving what would be the case without incentive and without planned trip deviation.
c. A driver may drop-off a “redistributable Rd-P-MCS” module later that it may be normally considered: the rental time would increase doing such action at the cost of keeping a now useless “redistributable Rd-P-MCS” module with standard rental time still accumulating, but the incentive may surpass in cost saving what would be the case without the incentive.
d. A driver may slightly deviate from the planned trip in order to drop-off a “redistributable Rd-P-MCS” module: the rental time may increase doing such voluntary supporting action, but the incentive may surpass in cost saving what would be the case without incentive and without planned trip deviation.
e. A driver may exchange a “redistributable Rd-P-MCS” module earlier or later that it may be normally considered: the rental time would increase doing such action, but the incentive may surpass in cost saving what would be the case without the incentive.
f. A driver may slightly deviate from the planned trip in order to exchange one or more “redistributable Rd-P-MCS” modules: the rental time may increase doing such voluntary supporting action, but the incentive may surpass in cost saving what would be the case without incentive and without planned trip deviation.

The driver receives a monetary incentive to perform an action that is slightly inconvenient for the driver that are benefiting the business method with providing a useful task for the greater good of operating the driving circuit and improvement of the driving circuit performance which may provide further additional indirect benefits to the driver.

The business method triggered cooperative behavior applied at the level of the participating Rd-P-MCS compatible participating EV vehicles may benefit everybody if the performance and operating cost gains are partly transferred to the participating drivers.

### Coverage Method and the Dynamic Multi-Dimensional Graph

The Certified Partner Service vehicles improve the availability of the Rd-P-MCS distribution service where the service infrastructure is not available for multiple reasons, such as low demand and insufficient business reasons for expansion, the location is not yet serviced by the more expensive infrastructure even if it will be serviced sometime in the near and/or distant future, remote areas, but not only.

A distinctive feature of the present disclosure is the scalability the Rd-P-MCS distribution service in the field to demanding Rd-P-MCS compatible participating EV vehicles as well as minimizing the service time (with much improved performance, cost saving, and customer satisfaction) in such cases.

Prior art Mobile Charging Station (MCS) could only serve at most two (2) vehicles at a time, also Mobile Charging Station (MCS) would be pinned to a single location for significant time while the serviced vehicles are charging themselves.

Such limitations of the Prior art Mobile Charging Station, e.g., limited number of simultaneous serviced vehicles, and high service times, drive up the operational costs and customer waiting charging times, with lower availability in a business environment and with low customer satisfaction, leading in the end to a limited acceptance of the Electrical Vehicles in real life.

Super Mobile Charging Stations may distribute and/or reallocate a scalable (large) number of “redistributable Rd-P-MCS” modules between certain charging stations to other charging stations, in various use cases: increasing the pool of “redistributable Rd-P-MCS” modules in a driving circuit and/or servicing area with additional modules during peak hours, moving “redistributable Rd-P-MCS” modules to other servicing areas with more demand, but not only.

The Super Mobile Charging Stations, maybe just a subset of them from the Pool of such Super Mobile Charging Stations in a Driving Circuit, may have assignments with respect to a schedule parametrized based on a time series or based on a time period series:
a. Super Mobile Charging Station S-MCS-1 may be assigned from time period Tp-1 from 08:00 AM to 12:00 PM to location area Loc-1 (a location grid graph node with geolocation position GPS-1)
b. Super Mobile Charging Station S-MCS-1 may be assigned from time period Tp-2 from 12:30 PM to 16:30 PM to location area Loc-2 (a location grid graph node with geolocation position GPS-2)
c. Super Mobile Charging Station S-MCS-1 may be scheduled from time period Tp-3 from 16:30 PM to 11:30 PM to provide support for “redistributable Rd-P-MCS” module reassignment between various Super Stationary Charging Stations, but not only, or to provided support for responding to dispatched orders from Rd-P-MCS compatible participating EV vehicles.
d. Super Mobile Charging Station S-MCS-2 may be assigned from time period Tp-1 from 08:00 AM to 12:00 PM to location area Loc-3 (a location grid graph node with geolocation position GPS-3)
e. Super Mobile Charging Station S-MCS-2 may be scheduled from time period Tp-2 from 12:30 PM to 16:30 PM to provide support for “redistributable Rd-P-MCS” module reassignment between various Super Stationary Charging Stations, but not only, or to provided support for responding to dispatched orders from Rd-P-MCS compatible participating EV vehicles.
f. Super Mobile Charging Station S-MCS-2 may be assigned from time period Tp-3 from 16:30 PM to 11:30 PM to location area Loc-4 (a location grid graph node with geolocation position GPS-4)
g. Super Mobile Charging Station S-MCS-3 may be scheduled from time period Tp-1 from 08:00 AM to 12:00 PM to provide support for “redistributable Rd-P-MCS” module reassignment between various Super Stationary Charging Stations, but not only, or to provided support for responding to dispatched orders from Rd-P-MCS compatible participating EV vehicles.
h. Super Mobile Charging Station S-MCS-3 may be assigned from time period Tp-2 from 12:30 PM to 16:30 PM to location area Loc-5 (a location grid graph node with geolocation position GPS-5)
i. Super Mobile Charging Station S-MCS-3 may be assigned from time period Tp-3 from 16:30 PM to 11:30 PM to location area Loc-6 (a location grid graph node with geolocation position GPS-6)
j. Others

The above incentive method proposed actions could be devised by the Driving Circuit business method and its algorithms based on the following:
a) A selected location grid with its associated graph nodes position at various geolocation positions identified by GPS like supporting apparatus,
b) Supermarkets such as ALDI, EDEKA, Kaufmann, Rewe, Finast, Cosco, but not only, that can support the invention business goals.

Since having an infinite number of available Rd-P-MCS modules is not feasible, the present invention disclosure and its business method uses several supporting apparatuses in order to implement a redistribution method that makes certain performance guarantees to the subscribed owners and their Rd-P-MCS compatible participating EV vehicles.

The more the size of the pool of available Rd-P-MCS modules is decreased and the more the size of the pool of supporting charging and redistribution stations, such as Super Stationary Charging Stations, Super Mobile Charging Stations, Certified Partner Service vehicles, and the supporting participating asynchronous exchange points in the driving circuit implementing the business method is decreased, then the more challenging is to attain and to maintain the performance guarantees.

However, the most important thing is that the apparatus and the method described in the present invention disclosure allow in aggregate the following: injecting enough resources (“Rd-P-MCS redistributable modules”, Super Stationary Charging Stations, Super Mobile Charging Stations, Certified Partner Service vehicles, local businesses acting as Rd-P-MCS module transfer and/or exchange points, personnel, etcetera), as described above (with a theoretical upper bound of infinite such a number of resources), to support the above-described business method then the full potential of the described ideal performance goal can be attained and maintained.

It therefore remains to find a balance between invested resources, redistribution algorithm(s) optimization and efficiency, based on the dynamics of Rd-P-MCS requests in the driving circuit, and multi-level satisfactory performance guarantees.

The ideal performance goal, revealed as the full performance potential of the disclosure that could be reached when enough resources are available, is a differentiating factor from Prior art, but also unlocks a real purpose drive towards providing and/or defining such performance goals together with a framework where the business operation and theoretical pursuit towards solving practical solutions are working hand in hand.

Moreover, the present disclosure claims to be able to formulate a framework of business operation with at least a performance goal in mind, from which an entire specter of optimization problems could be defined, solved and implemented, but the Prior art is not even able to define similar performance goals that would give a real purpose, both theoretical and business wise, in the real world, or a technological innovation drive.

Prior art in charging device redistribution and charging location finding is focused on traditional graph algorithms which applies to stationary charging stations such as those from Prior art and the Super Stationary Charging Stations from the present disclosure.

The present invention disclosure opens also a new theoretical and practical problem: how to find and therefore offer Rd-P-MCS module service in the context of a continuously changing infrastructure (location wise, but not only) in a serviced area.

A dynamic multi-dimensional graph in relation to the time dimension, to the bound locations' dimension (for Super Stationary Charging Stations), to the instant “movable” locations' dimension (Super Mobile Charging Stations, and/or Certified Partner Service vehicles), to the Rd-P-MCS availability per location dimension (see bound locations and instant “movable” locations), to at least a specified location grid where mobile Rd-P-MCS providers (Super Mobile Charging Stations, and/or Certified Partner Service vehicles) could be assigned or transferred for service, to the unbound locations' dimension where mobile Rd-P-MCS providers (Super Mobile Charging Stations, and/or Certified Partner Service vehicles) could be assigned or transferred in time for service but are not currently assigned at a specific time, but also in relation to at least a Rd-P-MCS service request that may share its planned driving route.

Such a planned driving route of a Rd-P-MCS service request may be mapped to specific expected locations within the above-mentioned location grid at the specific times when the Rd-P-MCS compatible participating EV vehicle is expected to reach such locations. Therefore, such Rd-P-MCS service requests will be serviced in relation to a time-based expected location assignment of mobile Rd-P-MCS providers (Super Mobile Charging Stations, and/or Certified Partner Service vehicles). This may need to be recomputed in real time due to a continuous incoming flux of requests.

When there is an active request for Rd-P-MCS module(s) and there is a mobile Rd-P-MCS provider (Super Mobile Charging Stations, and/or Certified Partner Service vehicles) responding to the request thereby it is changing its current location, the other mobile Rd-P-MCS providers (Super Mobile Charging Stations, and/or Certified Partner Service vehicles) may, or may not, change their location in order to maintain certain predefined service area coverage rules.

All the above locations, such as the bound locations for Super Stationary Charging Stations, the instant “movable” locations for Super Mobile Charging Stations and Certified Partner Service vehicles, the unbound locations' dimension where mobile Rd-P-MCS providers (Super Mobile Charging Stations, and/or Certified Partner Service vehicles) could be assigned or transferred in time for service, are part of the nodes of the specified location grid mentioned above and viewed as a Graph for a specific time.

The “Graph State” concept for such a dynamic multi-dimensional graph for a specific time and for a specific selected location grid is the grid viewed as a graph where its nodes are the nodes of the grid alongside with the resources allocated to each such node through the supporting apparatus alongside with the rules for transferring and/or exchanging the resources between different components of the supporting apparatus enumerated above.

A Rd-P-MCS compatible participating EV vehicle should expect to be serviced usually on the nodes of a location grid viewed as service meet-points: “redistributable Rd-P-MCS” module pick-up points, the “redistributable Rd-P-MCS” module swap/exchange points, the “redistributable Rd-P-MCS” module drop-off points, or the “redistributable Rd-P-MCS” module transfer points.

The above-mentioned service meet points are either static service meet-points, represented by Super Stationary Charging Stations connected to the Electrical GRID, or by Super Mobile Charging Stations that are connected long term to the Electric GRID, or dynamic service meet-points.

For a specific selected location grid, the nodes (associated with real GPS coordinates and place for mobile charging station temporary parking) of the corresponding location grid—viewed as a graph—define and represent all the service meet-point locations, other than locations covered by the Super Stationary Charging Stations, where mobile charging stations, such as the Super Mobile Charging Stations and the Certified Partner Service vehicles, are able and willing, according to the business method algorithms, to cover and support dispatching orders raised by Rd-P-MCS compatible participating EV vehicles.

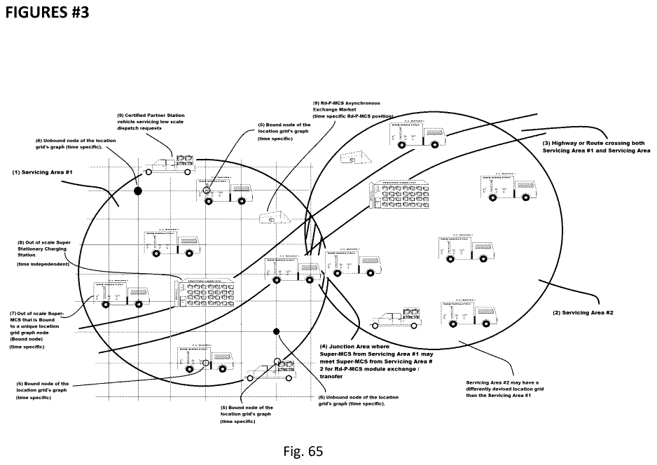

For a specific selected location grid, for a specific moment in time, aside from the location grid's graph nodes where there are already Super Stationary Charging Stations, all the other nodes of the location grid's graph are said to be and/or to have the following, see also FIG. 65:
a. Unbounded, if no participating mobile charging station is available to provide “redistributable Rd-P-MCS” module service at the specific moment in time.
b. Bounded, if there is at least one participating mobile charging station that is available to provide “redistributable Rd-P-MCS” module service at the specific moment in time,
c. NOTE: It is assumed that there is at most one such mobile charging station that is available for each node of the location grid's graph. In the situation that in the real case there are several such mobile charging station service vehicles, then it is assumed that each such service vehicle has its own associated location grid graph node.
d. NOTE: At any given time, for a selected location grid, aside from the location grid graph's nodes associated and covered by the SuperStationary Charging Stations, there are an Unbounded number of location grid graph's nodes, referred with “Number-of-Unbounded-Nodes”, and a Bounded number of location grid graph's nodes, referred with “Number-of-Bounded-Nodes”,
e. NOTE: At any given time, for a selected location grid, aside from the location grid graph's nodes associated and covered by the Super Stationary Charging Stations, it is that the number of the remaining location grid graph's nodes is equal with “Number-of-Unbounded-Nodes” plus “Number-of-Bounded-Nodes”.

With the above assumptions and definitions, when there is no distinction between the mobile charging station service vehicles, then the total number of possibilities to assign mobile charging station service vehicles to a previously “unbounded location grid graph node” is given by the combinations of (“Number-of-Unbounded-Nodes” plus “Number-of-Bounded-Nodes”) taken by (“Number-of-Bounded-Nodes”), e.g.,
<(“Number-of-Unbounded-Nodes” plus “Number-of-Bounded-Nodes”)C(“Number-of-Bounded-Nodes”)>, or
(“Number-of-Unbounded-Nodes” plus “Number-of-Bounded-Nodes”)!/((“Number-of-Unbounded-Nodes”)!*(“Number-of-Bounded-Nodes”)!), using factorial numbers.

Using the above formula interpretations and the following notations:
a. N is (“Number-of-Unbounded-Nodes” plus “Number-of-Bounded-Nodes”),
b. n is (“Number-of-Unbounded-Nodes”),
c. r is (“Number-of-Bounded-Nodes”),

then the combination formula for the total number of possibilities to assign mobile charging station service vehicles to a previously “unbounded location grid graph node” is:

$$\begin{matrix}{}^{N} Cr = N ! / ( r ! * ( n - r ) ! ) , or \\ C ( N , r ) = N ! / ( r ! * n ! ) , which is a large number .\end{matrix}$$

With the above assumptions and definitions when there is no distinction between the mobile charging station service vehicles, then the total number of possibilities to assign mobile charging station service vehicles to a previously “unbounded location grid graph node” is given by the permutations of (“Number-of-Unbounded-Nodes” plus “Number-of-Bounded-Nodes”) taken by (“Number-of-Bounded-Nodes”), e.g.,
<(“Number-of-Unbounded-Nodes” plus “Number-of-Bounded-Nodes”)P(“Number-of-Bounded-Nodes”)>, or
(“Number-of-Unbounded-Nodes” plus “Number-of-Bounded-Nodes”)!/(“Number-of-Unbounded-Nodes”)!, using factorial numbers.

The permutation formula for the total number of possibilities to assign distinct mobile charging station service vehicles to a previously “unbounded location grid graph node” is:

$${}^{N} Pr = N ! / ( ( n - r ) ! ) , which is a large number .$$

Using the “coverage method” that seeks a distribution balance for the mobile charging station, and their number of available charged “redistribution Rd-P-MCS” modules for area units of the covered servicing area in the driving circuit, heuristics and algorithms could be devised in order to reduce the total number of possibilities to assign mobile charging station service vehicles to a previously “unbounded location grid graph node”.

Each such assignment of a mobile charging station to a previously “unbounded location grid graph node” is a standard problem that may be finally solved using Prior art algorithms.

The present invention disclosure should aggregate and/or take into consideration all the solutions of such Prior art algorithms for each of the possibilities to assign mobile charging station service vehicles to a previously “unbounded location grid graph node” which may require novel techniques and algorithms.

To complicate things even further, a finer grained location grid—with the motivation of a faster provided service—leads to even more are the possibilities to assign mobile charging station service vehicles to a previously “unbounded location grid graph node”.

Any algorithm that uses such dynamic multi-dimensional graph for various purposes may have to take into consideration the present qualified service requests for “redistributable Rd-P-MCS” modules.

Performance, cost, but not only, attributed for the supporting resources available in the location grid are also to be considered as part of the problem and part of the solution.

Since there are time constraints with servicing the “redistributable Rd-P-MCS” module orders depending on the expected time and location for the Rd-P-MCS service execution, such an order may be serviced by multiple mobile Rd-P-MCS providers (Super Mobile Charging Stations, and/or Certified Partner Service vehicles) that would coordinate themselves in fulfilling the Rd-P-MCS service request.

One would observe that multiple Super Stationary Charging Stations may also be involved in such service plans, thus providing a better optimized solution for such plan, both in time of service, cost of service, but not only.

One could see that the optimizations are targeting the business method own goals, the customer own specific expectation goals, or both business and customer goals. While some goals are not common, certain goals are aligned towards satisfaction of both the business owner and the customers.

If a charging service operation by one of the support mobile charging stations changes the service coverage in a service area in relation to certain policies, heuristics, and/or rules, defined by certain constraints, then the contributing support mobile charging stations may change their location, ad-hoc by decision of the drivers or through an algorithm, in order to re-establish again the original constraints with respect to the service coverage.

Such a coverage constraint could be that each specific local service area to be serviced in its proximity, through the charging stations (such as ON GRID Super Stationary Charging Stations, ON GRID and/or OFF GRID Super Mobile Charging Stations (Super-MCS), and OFF GRID Certified Partner Service vehicles) assigned to that specific dimension service area by a defined minimum of “redistributable Rd-P-MCS” modules. Such reconfiguration of the supporting mobile charging stations is called the coverage method.

It is important to mention that both the Super Stationary Charging Stations and the Super Mobile Charging Stations may use large number of “redistributable Rd-P-MCS” modules during their operation, possibly with a configurable such number of “redistributable Rd-P-MCS” modules depending on the business needs of a serviced area.

Consequently, the Super Stationary Charging Stations and the Super Mobile Charging Stations with a larger number of serviced “redistributable Rd-P-MCS” modules may be larger and the Super Stationary Charging Stations and the Super Mobile Charging Stations with a smaller number of serviced “redistributable Rd-P-MCS” modules may be smaller.

To allow flexibility, a Stationary Charging Station and/or a Super Mobile Charging Station configured to service a smaller number of “redistributable Rd-P-MCS” modules may have the same size as a larger Stationary Charging Station and/or a Super Mobile Charging Station, respectively, but with a smaller number of mounted “redistributable Rd-P-MCS” modules than they could support.

The present invention disclosure thus provides a sound business method that involves managing a Driving Circuit previously defined, with various method subcomponents, such as the charging while driving method (see the figures FIG. 115 and FIG. 112, but not only), the subscription method, the redistribution method, the performance method, the rental method, the payment method, the cost method, the order method, the dispatching method, the coverage method, the incentive method, the quality method, the repair method, and the decision-making methods, but not only, that use the core technological apparatus—the “Rd-P-MCS compatible BEV Battery (BEV)” battery, the “redistributable Rd-P-MCS” module with “Metering and Billing” functionality- and the supporting apparatus—the Super Stationary Charging Stations, the Super Mobile Charging Stations, the Certified Partner Service vehicles, the qualified business exchange points, but not only—with the GOAL of attaining and maintaining the ideal optimal performance goal mentioned above, and/or other predefined performance guarantees, or provide at least an optimization improvement towards such performance goals and guarantees.

Any method subcomponent whose removal does not lead to the degradation of the performance goals and guarantees, including in relation to resource requirements for such performance, is not part of the business method. In short, the business method and its method subcomponents have the main goal of optimizing and ultimately reaching the performance full potential of the apparatus.

The Driving Circuit with Methods

With the above Preamble, the present invention disclosure provides a Driving Circuit apparatus, designed to support the “charging while driving method”, that includes, implements and supports the following:
10. A plurality of “redistributable Rd-P-MCS” modules, where each such module:
   a. defines and supports the concept of partitioning and packaging of bulk raw electric energy, as provided by a Prior art Mobile Charging Station (MCS), for easy distribution, transferring and swapping/exchange or energy units embodied by such Rd-P-MCS modules within a valid and sound business method that provides certain performance guarantees.
   b. have the “Metering and Billing” core features, besides other features described in the present disclosure, that provide the information necessary for renting and for the payment method of the service provided by such a “redistributable Rd-P-MCS”:
      i. The Metering feature provides the information regarding the level of charge of a “redistributable Rd-P-MCS” module at any moment in time, but also provides the used energy charge during a rent session from the pick-up to the drop-off and/or swap or exchange of such “redistributable Rd-P-MCS” module.
      ii. The Billing feature provides the billing information to be used by the payment devices in relation to the cost of the service during a rent session from the pick-up to the drop-off and/or swap or exchange of such “redistributable Rd-P-MCS” module.
      iii. The “redistributable Rd-P-MCS” may have several variants, including the bi-partite and multi-partite split versions described in the present disclosure where part of the “redistributable Rd-P-MCS” module hardware and functionality is transferred to the Rd-P-MCS compatible participating electrical vehicle (EV) Infrastructure component.
      iv. Such splitting and allocating of such parts and/or components are also a claim.
      v. There are other embodiments in which variants of the concept of “Light Rd-P-MCS” module leads to other variants of the architecture from FIG. 87.
11. A plurality of Super Stationary Charging Stations connected to the Grid Infrastructure (ON GRID) and containing a scalable large number (up to 100 units, or more) of “redistributable Rd-P-MCS” modules that are charged from the station's charging architecture.
12. A plurality of Super Mobile Charging Stations (Super-MCS) containing a scalable large number (up to 20-50 units, or more) of “redistributable Rd-P-MCS” modules that may be charged while stationary (ON GRID and/or OFF GRID) or during driving (OFF GRID) of such Super Mobile Charging Stations.
13. A plurality of Certified Partner Service vehicles transporting a limited number (most likely under 10) of “redistributable Rd-P-MCS” in remote and under-served areas. Such Certified Partner Service vehicles may respond to direct requests for “redistributable Rd-P-MCS” that allows flexibility of the Rd-P-MCS redistribution service coverage in areas where large infrastructure investments are not viable from a business point of view.
14. A plurality of “Rd-P-MCS Dispatcher coordinator” entities, human and/or automated, named Dispatchers, to redistribute Rd-P-MCS modules using the present invention disclosure supporting apparatus.
15. An overlapped geolocation of the network of the (ON GRID), the (ON GRID and/or OFF GRID) Super Mobile Charging Stations (Super-MCS), and the (OFF GRID) Certified Partner Service vehicles, with an already established network of Prior art EV Power stations, and with other locations with high traffic where there is enough demand for a sustainable business method,
16. The concept of “charging while driving method” where a compatible participating EV vehicle can drive during a long-distance trip without stationary charging waiting time other than the time spent for transferring and swapping/exchanging of “redistributable Rd-P-MCS” modules when it takes advantage of the apparatus and the method of the present disclosure.
   Multiple cars may swap their “redistributable Rd-P-MCS” module(s) at the same time with the same Recharging Station. The swapping and the access allow also concurrent swapping.
17. A plurality of Rd-P-MCS compatible participating EV vehicles, that are designed and manufactured with a new battery charging architecture and a new electric motor powering architecture, as described in the present disclosure, in order to support and to take advantage of the present invention disclosure apparatus and method, implementing thus the “charging while driving method”.
18. A plurality of “peak redistributable Rd-P-MCS” modules from a Pool of peak “redistributable Rd-P-MCS” modules that may be used to be inserted into the Driving Circuit, alongside additional Super Mobile Charging Stations and additional Certified Partner Service vehicles, whenever the higher traffic of Rd-P-MCS compatible participating EV vehicles lead to renting away a larger number of the redistributable Rd-P-MCS” modules from the (ON GRID) Super Stationary Charging Stations, the (ON GRID and/or OFF GRID) Super Mobile Charging Stations (Super-MCS), and the (OFF GRID) Certified Partner Service vehicles, thus increasing the chance for a drop in the guaranteed performance levels. After the peak traffic subsides, the additional number of “peak redistributable Rd-P-MCS” may be withdrawn from the Driving Circuit for cost optimizations.
19. A “subscription method” with a plurality of subscriptions for the Rd-P-MCS compatible participating EV vehicles that are designed to streamline the process of transferring and swapping/exchanging the “redistributable Rd-P-MCS” modules with the goal of reaching the optimal performance potential of the “redistributable Rd-P-MCS” modules and their supporting apparatus, but also to maintain the subscribed performance levels of the method, with the scope of eliminating and/or minimizing the renting and payment time (payment method) during the activity of transferring and swapping/exchanging of “redistributable Rd-P-MCS” modules.
   A Rd-P-MCS compatible EV vehicle with a subscription associated with a performance goal and/or with a performance guarantee is named a Rd-P-MCS compatible participating EV vehicle.
20. A “redistribution method” that consists of a plurality of “redistribution operations” that involve the “redistributable Rd-P-MCS” modules as follows:
   a. Transferring charged Rd-P-MCS from a Super Stationary Charging Station to a Super Mobile Charging Station, for example, when a Super Mobile Charging Station starts a service trip,
   b. Transferring discharged Rd-P-MCS from a Super Mobile Charging Station to a Super Stationary Charging Station, for example, when a Super Mobile Charging Station returns from a service trip,
   c. When a Super Mobile Charging Station travels to a location (corresponding to a node of the location grid) providing direct connection to an Electric Grid where such Super Mobile Charging Station would connect itself to the Electric Grid in order to recharge its own Ultracapacitor and all of its mounted/“redistributable Rd-P-MCS” modules, for example, when a Super Mobile Charging Station returns from, or travels during, a service trip,
   d. Transferring charged Rd-P-MCS from an ON GRID Super Mobile Charging Station to an OFF GRID Super Mobile Charging Station, for example, when an OFF GRID Super Mobile Charging Station starts a service trip,
   e. Transferring a discharged Rd-P-MCS to a ON GRID Super Mobile Charging Station from an OFF GRID Super Mobile Charging Station, for example, when an OF GRID Super Mobile Charging Station returns from a service trip,
   f. Transferring charged Rd-P-MCS from an ON GRID Super Stationary Charging Station to a Certified Partner Service vehicle, for example, when a Certified Partner Service vehicle starts a service trip,
   g. Transferring discharged Rd-P-MCS from a Certified Partner Service vehicle to an ON GRID Super Stationary Charging Station, for example, when a Certified Partner Service vehicle returns from a service trip,
   h. Transferring charged Rd-P-MCS from an OFF GRID Super Stationary Charging Station to a Certified Partner Service vehicle, for example, when a Certified Partner Service vehicle starts a service trip,
   i. Transferring discharged Rd-P-MCS from a Certified Partner Service vehicle to an OFF GRID Super Stationary Charging Station, for example, when a Certified Partner Service vehicle returns from a service trip,
   j. Relocating an OFF GRID Super Mobile Charging Station in order to transfer and/or exchange “redistributable Rd-P-MCS” modules, as shown above, for various business needs as described in the present disclosure.
   k. Relocating an OFF GRID Certified Partner Service vehicle in order to transfer and/or exchange “redistributable Rd-P-MCS” modules, as shown above, for various business needs as described in the present disclosure.
21. A performance method that defines transparent performance goals for each Rd-P-MCS participating compatible EV vehicle depending on the level of their subscription plan.
   The performance can be optimal when there are “enough” resources, e.g., enough charging stations with enough “redistributable Rd-P-MCS” modules in the proximity of a Rd-P-MCS participating compatible EV vehicle in need for recharge. Approximation and optimizations based on heuristics, but not only, may be used when less resources are available in the driving circuit.
   The availability of flexible ways to provide “redistributable Rd-P-MCS” modules, as described in the disclosure, including when the Rd-P-MCS participating compatible EV vehicle goes away from the main driving circuit, provides an increased level of performance for the invention.
   The use of mobile charging stations, such as Super Mobile Charging Stations (Super-MCS), Certified Provider Station vehicles, but not only, can further add value to the driving circuit and its performance.
   The invention is able to define a Performance goal with its Performance method. Moreover, with the invention subscription method the subscribers that own Rd-P-MCS participating compatible EV vehicles are able to select different levels of Performance Goals that the operator of the invention driving circuit with “redistributable Rd-P-MCS” modules guarantee under subscription contract terms.
   Since more expensive subscription plans are expected to guarantee better access to “redistributable Rd-P-MCS” modules, the subscribers with better subscription contracts may have priority in accessing such “redistributable Rd-P-MCS” modules when the availability of the module in the driving circuit decreases.
   When the driving circuit has enough resources, for example when there are an unlimited number of charged “redistributable Rd-P-MCS” modules and an unlimited number charging station, e.g., the Rd-P-MCS participating compatible EV vehicles can find a charging station with enough charged “redistributable Rd-P-MCS” modules at any time it needs one, the invention provides an optimal solution with respect:
      A. The distance: the Rd-P-MCS participating compatible EV vehicle can drive an unlimited distance with an almost zero waiting time for charging
      B. The charging waiting time: the Rd-P-MCS participating compatible EV vehicle can recharge almost instantly by picking up a plurality of charged “redistributable Rd-P-MCS” module, swapping a plurality of discharged “redistributable Rd-P-MCS” modules with a plurality of charged “redistributable Rd-P-MCS modules, drop discharged “redistributable Rd-P-MCS” modules.
         Please note that one could drop a charged “redistributable Rd-P-MCS” module or a partially discharged “redistributable Rd-P-MCS” module.
         The goal of the performance method include:
         a. reaching maximum potential of the performance stated in the subscription plan.
         b. avoiding the performance degradation which is inevitable at some point in time if the redistribution method is not implemented.
         However, whenever the resources are scarcer, for example during rush hour, the guarantees may be become more relaxed as defined in the subscription contracts.
         One such subscription may define performance goals such as having available “redistributable Rd-P-MCS” modules in 95% of the time, or having available “redistributable Rd-P-MCS” modules in 85% of the time, or having available “redistributable Rd-P-MCS” modules in 75% of the time, but not only.
         Also, whenever there is no available “redistributable Rd-P-MCS” modules the performance goal define in the subscription plan may also define a maximum time within an emergency “redistributable Rd-P-MCS” module will be provided.
22. A “rental method” that allows the following rental transactions of the “redistributable Rd-P-MCS” modules, without any limitation:
   a. A Rd-P-MCS compatible participating EV vehicle picks-up (rents) a charged “redistributable Rd-P-MCS” module from a Super Stationary Charging Station,
   b. A Rd-P-MCS compatible participating EV vehicle drops-off (rents) a discharged “redistributable Rd-P-MCS” module to a Super Stationary Charging Station,
   c. A Rd-P-MCS compatible participating EV vehicle swaps (rents) a discharged “redistributable Rd-P-MCS” module for a charged “redistributable Rd-P-MCS” module with a Super Stationary Charging Station, e.g., the EV vehicle transfers a discharged “redistributable Rd-P-MCS” module from itself to the Super Stationary Charging Station, and the EV vehicle transfers to itself a charged “redistributable Rd-P-MCS” module from the Super Stationary Charging Station,
   d. A Rd-P-MCS compatible participating EV vehicle picks-up (rents) a charged “redistributable Rd-P-MCS” module from a Super Mobile Charging Station (ON GRID or OFF GRID),
   e. A Rd-P-MCS compatible participating EV vehicle drops-off (rents) a discharged “redistributable Rd-P-MCS” module to a Super Mobile Charging Station (ON GRID or OFF GRID),
   f. A Rd-P-MCS compatible participating EV vehicle swaps/exchanges (rents) a discharged “redistributable Rd-P-MCS” module for a charged “redistributable Rd-P-MCS” module with a Super Mobile Charging Station (ON GRID or OFF GRID), e.g., the EV vehicle transfers a discharged “redistributable Rd-P-MCS” module from itself to the Super Mobile Charging Station (ON GRID or OFF GRID), and the EV vehicle transfers to itself a charged “redistributable Rd-P-MCS” module from the Super Mobile Charging Station (ON GRID or OFF GRID),
   g. A Rd-P-MCS compatible participating EV vehicle picks-up (rents) a charged “redistributable Rd-P-MCS” module from a Certified Partner Service vehicle,
   h. A Rd-P-MCS compatible participating EV vehicle drops-off (rents) a discharged “redistributable Rd-P-MCS” module to a Certified Partner Service vehicle,
   i. A Rd-P-MCS compatible participating EV vehicle swaps/exchanges (rents) a discharged “redistributable Rd-P-MCS” module for a charged “redistributable Rd-P-MCS” module with a Certified Partner Service vehicle, e.g., the EV vehicle transfers a discharged “redistributable Rd-P-MCS” module from itself to the Certified Partner Service vehicle, and the EV vehicle transfers to itself a charged “redistributable Rd-P-MCS” module from the Certified Partner Service vehicle,
23. A “payment method” that:
   a. starts a new Open-ended payment transaction when a Rd-P-MCS compatible participating EV vehicle picks-up (rent) a charged “redistributable Rd-P-MCS” module(s) from a (ON GRID) Super Stationary Charging Stations, a (ON GRID and/or OFF GRID) Super Mobile Charging Stations (Super-MCS), or from a (OFF GRID) Certified Partner Service vehicle,
   b. finalizes a previously started Open-ended payment transaction when a Rd-P-MCS compatible participating EV vehicle drops-off (rent) at least a charged “redistributable Rd-P-MCS” module(s) from a (ON GRID) Super Stationary Charging Stations, a (ON GRID and/or OFF GRID) Super Mobile Charging Stations (Super-MCS), or from a (OFF GRID) Certified Partner Service vehicle,
   c. finalizes a previously started Open-ended payment transaction and starts a new Open-ended payment transaction when a Rd-P-MCS compatible participating EV vehicle swaps/exchanges a discharged previously rented “redistributable Rd-P-MCS” module for a charged rented “redistributable Rd-P-MCS” module with a (ON GRID) Super Stationary Charging Stations, with a (ON GRID and/or OFF GRID) Super Mobile Charging Stations (Super-MCS), or with a (OFF GRID) Certified Partner Service vehicle,
   d. When a Rd-P-MCS compatible participating EV vehicle picks-up (rent) multiple charged “redistributable Rd-P-MCS” module there is created separate one Open-ended payment transaction for each such “redistributable Rd-P-MCS” module.
   e. Uses the “Metering and Billing” core feature of the “redistributable Rd-P-MCS” module that provides the information necessary for renting and for the payment of the service provided by such a “redistributable Rd-P-MCS”.
   f. An alternate “Metering and Billing” feature of the “redistributable Rd-P-MCS” could be moved to the both the starting charging station (Super Stationary Charging Stations, a (ON GRID and/or OFF GRID) Super Mobile Charging Stations (Super-MCS), or from a (OFF GRID) Certified Partner Service vehicle) which creates an open-ended payment transaction and the ending charging station (Super Stationary Charging Stations, a (ON GRID and/or OFF GRID) Super Mobile Charging Stations (Super-MCS), or from a (OFF GRID) Certified Partner Service vehicle) which finalizes the previously created open-ended payment transaction with the materialization of the actual payment order to the payment service suppliers,
   g. Has the rental service cost fees dependent on rented time, the used energy charge, location of pick-up and drop-off, but not only.
24. A “cost method” that allows the business method, besides the standard cost method reasons, to optimize the stability of the driving circuit.
   The small size of the “redistributable Rd-P-MCS” module allows scalability at the charging stations, both for recharging but also for transportation related to the redistribution method.
   The driver of a Rd-P-MCS participating compatible EV vehicle may rent more than one “redistributable Rd-P-MCS” module even if only one can be used during driving.
   However, this is a non-optimal use case that the invention cost method discourages through a higher cost imposed due to the lost efficiency that hurts the rest of the Rd-P-MCS participating compatible EV vehicle present in the driving circuit because makes such resources unavailable. For the greater good of the driving circuit the cost method penalizes the non-optimal usage of “redistributable Rd-P-MCS” modules.
   One would observe that such cost method aligns the optimization of the business method that wants as many as possible “redistributable Rd-P-MCS” modules available to the existing Rd-P-MCS participating compatible EV vehicles with the optimization of the goal of reducing rental costs for the driver of a Rd-P-MCS participating compatible EV vehicle.
   Note: However, sometimes the trip advisor software may suggest that you need such non-optimal usage of “redistributable Rd-P-MCS” modules when the vehicle enters an area where the service is not good.
   When returning a rented “redistributable Rd-P-MCS” module the driver will be charged a payment that may include the following:
      a. fixed payment
      b. payment based entirely on the “used” electric charge
      c. a mixture of the above: a fixed payment and a payment related to the “used” electric charge
25. An “order method”, or “order placement method”, consisting of a plurality of “redistributable Rd-P-MCS” module orders to a future time and service location which are being served by the Remote Monitoring and Dispatching entity, through dispatching such Rd-P-MCS modules with the help of the mobile charging stations such as (OFF GRID) Super Mobile Charging Station and/or an (OFF GRID) Certified Partner Service vehicles.
26. A “dispatching method” uses queues of such Rd-P-MCS requests for future service executions, this would provide better optimized solutions, including with respect to used service resources and service predictability, leading to better cost savings and customer satisfaction.
   Allocating dedicated parts of the business method from the available “redistributable Rd-P-MCS” modules and from the available mobile Rd-P-MCS providers, such as the Super Mobile Charging Stations (Super-MCS) and Certified Partner Services, to such future Rd-P-MCS service orders, as part of a premium (and more expensive) subscription plan, improves predictability and performance guarantees of the service execution.
   Moreover, the predictability and the performance guarantees are easier to be attained if the subscribed drivers are sharing their travel plans, allowing thus the business method algorithms, including the dispatching method algorithms, to anticipate future orders for “redistributable Rd-P-MCS” modules.
27. A “coverage method” related to relocating an OFF GRID Super Mobile Charging Station and/or an OFF GRID Certified Partner Service vehicles in order to maintain the service coverage in its service area in relation to certain policies, heuristics, and/or rules, defined by certain constraints, where the mentioned service coverage may be defined, for example, without any limitation, as the minimum number of “redistributable Rd-P-MCS” modules that serve a service area by their carrying charging stations (such as ON GRID Super Stationary Charging Stations, ON GRID and/or OFF GRID Super Mobile Charging Stations (Super-MCS), and OFF GRID Certified Partner Service vehicles).
28. A “incentive method” that allows the drivers of Rd-P-MCS compatible participating EV vehicles to become redistribution agents, with a renumeration, of the “redistributable Rd-P-MCS” modules they rent in a localized way in the proximity of their travel plan, for example to drop-off a “redistributable Rd-P-MCS” module at a bit more inconvenient location for the driver, but with potential cost savings or other advantage for the business method.
   Depending on the redistribution needs within the driving circuit, the “redistribution method” may offer cost incentives to the drivers of Rd-P-MCS compatible participating EV vehicles that are seeking locations to drop-off already used and depleted “redistributable Rd-P-MCS” modules in order to contribute to the overall “redistribution method” goal.
   This is another example where the goal of the customer, e.g., minimizing the rental cost—including the incentives for acting as a drop-off redistribution agent—and the goal of the driving circuit service provider, e.g., minimizing the operational cost of the redistribution method, are aligned. Moreover, minimizing the operational cost of the redistribution method may also lead to further benefits in decreasing the base rental cost.
   When a Rd-P-MCS compatible participating EV vehicle seeks to pick-up a “redistributable Rd-P-MCS” module, to exchange a “redistributable Rd-P-MCS” module, or to drop-off a “redistributable Rd-P-MCS” module, such intentions are shared with the driving circuit and its apparatus and algorithms.
   Upon the receival of the alternate locations and their associated “on the fly” discount (which may include different incentives based on the selected location) the driver selects such location that best suits his/her needs as part of an incentive method contract.
   Allowing and proposing total rental cost discounts to the Rd-P-MCS compatible participating EV vehicles that are sharing their driving plan so that they will become pick-up redistribution agents or drop-off redistribution agents is called the incentive method.
   Through the incentive method, the driving circuit and its apparatus allow the extension of the execution of cooperative “redistribution method” that seeks a greater good than the sum of the disconnected and isolated particular interests of the participating Rd-P-MCS compatible participating EV vehicles and drivers.
   Any deviation alongside with everything it entails (data and algorithms involved, distributed databases and software, incentive proposals, selection of such proposals, but not only) of such participating EV vehicles from their shared driving plan, such that such EV vehicles become limited redistribution agents, is part of the incentive method.
   The “incentive method” may propose to the Rd-P-MCS compatible participating EV vehicles that they undertake at least one of the following actions during their (shared) planned trip:
      a. A driver may pick-up a “redistributable Rd-P-MCS” module earlier that it may be needed: the rental time may increase doing such action because such module is not yet needed, but the incentive may surpass in cost saving what would be the case without the incentive.
      b. A driver may slightly deviate from the planned trip in order to pick-up a “redistributable Rd-P-MCS” module: the rental time may increase doing such voluntary supporting action, but the incentive may surpass in cost saving what would be the case without incentive and without planned trip deviation.
      c. A driver may drop-off a “redistributable Rd-P-MCS” module later that it may be normally considered: the rental time would increase doing such action at the cost of keeping a now useless “redistributable Rd-P-MCS” module with standard rental time still accumulating, but the incentive may surpass in cost saving what would be the case without the incentive.
      d. A driver may slightly deviate from the planned trip in order to drop-off a “redistributable Rd-P-MCS” module: the rental time may increase doing such voluntary supporting action, but the incentive may surpass in cost saving what would be the case without incentive and without planned trip deviation.
      e. A driver may exchange a “redistributable Rd-P-MCS” module earlier or later that it may be normally considered: the rental time would increase doing such action, but the incentive may surpass in cost saving what would be the case without the incentive.
      f. A driver may slightly deviate from the planned trip in order to exchange one or more “redistributable Rd-P-MCS” modules: the rental time may increase doing such voluntary supporting action, but the incentive may surpass in cost saving what would be the case without incentive and without planned trip deviation.
      The driver receives a monetary incentive to perform an action that is slightly inconvenient for the driver that are benefiting the business method with providing a useful task for the greater good of operating the driving circuit and improvement of the driving circuit performance which may provide further additional indirect benefits to the driver.
   The business method triggered cooperative behavior applied at the level of the participating Rd-P-MCS compatible participating EV vehicles may benefit everybody if the performance and operating cost gains are partly transferred to the participating drivers.
29. A “quality method” for the driving circuit that monitors the customer feedback of the rental service with respect to the entities participating in the redistribution method as well as the reliability of the system.
   The quality method needs to implement a historic association between the “redistributable Rd-P-MCS” modules rented by the customers providing feedback and the entities participating into the redistribution method that had handled these rented modules.
   It is useful therefore to monitor and maintain the quality of the “redistributable Rd-P-MCS” module at every step in the chain of distributing and renting such “redistributable Rd-P-MCS” modules.
30. A “repair method” uses a plurality of “spare redistributable Rd-P-MCS” modules from a Pool of spare “redistributable Rd-P-MCS” modules that are used to replace the “faulty redistributable Rd-P-MCS” modules when the Health Monitoring functionality of the “redistributable Rd-P-MCS” and/or of the supporting apparatus alerts about the presence of such modules in the Driving Circuit.
31. A plurality of Decision-making methods that are formalizations that include, for example, Game Theory decision-making methods in games involving two or more players: Nash Equilibrium, Competitive Equilibrium, Correlated Equilibrium, but not only, may be devised and used in order to optimize the cost of operating the driving circuit according to the overall performance model and the individual subscription performance guarantees.

### Properties of the “Redistributable Rd-P-MCS” Module

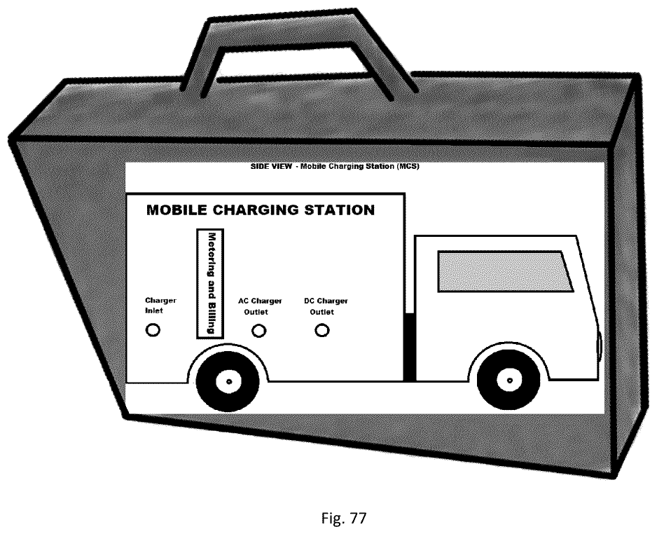

The “redistributable Rd-P-MCS” module, together with the “Rd-P-MCS compatible BEV Battery (BEV)” batteries, represents the core of the present invention disclosure technical apparatus and business method, with the depiction from embodiments of the FIG. 77, that may have the following properties of the “redistributable Rd-P-MCS” modules:
a. The “redistributable Rd-P-MCS” module is a Packed Unit of EV Electrical Energy that is part of the newly devised EV Driving Circuit, as described in the present disclosure,
b. When talking further of a “redistributable Rd-P-MCS” module it is assumed that such “redistributable Rd-P-MCS” module belongs to an EV Driving Circuit.
c. The “redistributable Rd-P-MCS” module is a Packed Unit of EV Electrical Energy that sustains, in certain conditions an depending certain parameters, the charging station to which it belongs, e.g., the Super Stationary Charging Stations (stationary—ON GRID), and Super Mobile Charging Stations (Super-MCS)—while stationary (ON GRID or OFF GRID) or while driving (OFF GRID), just as the “distributed ESS” modules may sustain the charging architecture used for charging EV vehicles in the Prior art sense in [Ref-1] [Lu Wang],
d. The “redistributable Rd-P-MCS” module is a Packed Unit of EV Electrical Energy that is mobile and transportable,
e. The “redistributable Rd-P-MCS” module is a Packed Unit of EV Electrical Energy that is identifiable, using at least a cryptographic key, but not only.
f. The “redistributable Rd-P-MCS” module is a Packed Unit of EV Electrical Energy that is billable and metered, based on used electrical charge, rental time, season, rental distance, pick-up location, drop-off location, deposit amount, credit history, availability at pick up location, availability at drop-off location, driving plan transparency (commitment for a previously disclosed trip plan which allows global optimizations in the Driving Circuit), payment method, subscription level, vehicle model and/or compatibility, efficiency of the EV vehicle charging system, etcetera,
g. The “redistributable Rd-P-MCS” module is a Packed Unit of EV Electrical Energy that has a timer that can determine the total time when such a module has been rented.
h. The “redistributable Rd-P-MCS” module is a Packed Unit of EV Electrical Energy that may have a computational node capable to compute the total time when such a module has been rented, but also to compute any other operational needs.
i. The “redistributable Rd-P-MCS” module is a Packed Unit of EV Electrical Energy that may have communication resources and links that would be used in order to communicate with the servers and the distributed software needed for the management of the business method, be it the charging while driving method (see the figures FIG. 115 and FIG. 112, but not only), the subscription method, the redistribution method, the performance method, the rental method, the payment method, the cost method, the order method, the dispatching method, the coverage method, the incentive method, the quality method, the repair method, and the decision-making methods, but not only,
j. The “redistributable Rd-P-MCS” module is a Packed Unit of EV Electrical Energy that is exchangeable between compatible Driving Circuits from the Franchise.
k. The “redistributable Rd-P-MCS” module is a Packed Unit of EV Electrical Energy that is exchangeable between compatible Driving Circuits of one Franchise and Driving Circuits of another Franchise.
l. The “redistributable Rd-P-MCS” module is a Packed Unit of EV Electrical Energy that is geolocation trackable, via GPS and/or other geolocation tracking devices and technologies, in order to detect the location of pick-up and drop-off which are needed for computing the final cost of the rental session.
m. The “redistributable Rd-P-MCS” module is a Packed Unit of EV Electrical Energy that is dispatchable, by the Remote Monitoring and Dispatching entity, in order to satisfy orders to a future time and service location.
n. The “redistributable Rd-P-MCS” module is a Packed Unit of EV Electrical Energy that is versioned with respect to its development,
o. The “redistributable Rd-P-MCS” module is a Packed Unit of EV Electrical Energy that is part of a Pool of “redistributable Rd-P-MCS” modules,
p. The “redistributable Rd-P-MCS” module is a Packed Unit of EV Electrical Energy that is Health Monitored, via local circuitry for logic and display,
q. The “redistributable Rd-P-MCS” module is a Packed Unit of EV Electrical Energy that is Health Monitored, via the hardware and logic of charging stations to which it belongs, e.g., the Super Stationary Charging Stations (stationary—ON GRID), and Super Mobile Charging Stations (Super-MCS)—while stationary (ON GRID or OFF GRID) or while driving (OFF GRID),
r. The “redistributable Rd-P-MCS” module is a Packed Unit of EV Electrical Energy that is Health Monitored, via hardware and logic of a Remote Monitoring and Dispatching entity, with hardware and logic at the “redistributable Rd-P-MCS”, at charging stations to which it belongs, e.g., the Super Stationary Charging Stations (stationary—ON GRID), and Super Mobile Charging Stations (Super-MCS)—while stationary (ON GRID or OFF GRID) or while driving (OFF GRID), or at both,
s. The “redistributable Rd-P-MCS” module may be transferred, e.g., picked-up or dropped-off, according to the “rental method” described in the present disclosure, between a Rd-P-MCS compatible participating EV vehicle and any of the supporting apparatus for redistributing “redistributable Rd-P-MCS” modules such as Super Stationary Charging Stations (stationary—ON GRID), Super Mobile Charging Stations (Super-MCS)—while stationary (ON GRID or OFF GRID) or while driving (OFF GRID), and Certified Partner Service vehicles (OFF GRID).
t. The “redistributable Rd-P-MCS” module may be swapped or exchanged, according to the “rental method” described in the present disclosure, between a Rd-P-MCS compatible participating EV vehicle and any of the supporting apparatus for redistributing “redistributable Rd-P-MCS” modules such as Super Stationary Charging Stations (stationary—ON GRID), Super Mobile Charging Stations (Super-MCS)—while stationary (ON GRID or OFF GRID) or while driving (OFF GRID), and Certified Partner Service vehicles (OFF GRID).
u. The “redistributable Rd-P-MCS” module may be transferred according to the “redistribution method” described in the present disclosure, between any pair of the supporting apparatus for redistributing “redistributable Rd-P-MCS” modules such as Super Stationary Charging Stations (stationary—ON GRID), Super Mobile Charging Stations (Super-MCS)—while stationary (ON GRID or OFF GRID) or while driving (OFF GRID), and Certified Partner Service vehicles (OFF GRID) where there is involved at most one Super Stationary Charging Stations (stationary—ON GRID).
v. The “redistributable Rd-P-MCS” module may be swapped or exchanged, according to the “redistribution method” described in the present disclosure, between any pair of the supporting apparatus for redistributing “redistributable Rd-P-MCS” modules such as Super Stationary Charging Stations (stationary—ON GRID), Super Mobile Charging Stations (Super-MCS)—while stationary (ON GRID or OFF GRID) or while driving (OFF GRID), and Certified Partner Service vehicles (OFF GRID) where there is involved at most one Super Stationary Charging Stations (stationary—ON GRID).
w. The “redistributable Rd-P-MCS” module is a Packed Unit of EV Electrical Energy that has associated Algorithms and Metrics that allow the evaluation of its Monitored Health, allowing the decision (automated and/or human decided) of being classified as in Operational state or as in Malfunctioned state,
x. The “redistributable Rd-P-MCS” module is a Packed Unit of EV Electrical Energy that is to be excluded from the Driving Circuit to which it belongs in case of errors and malfunction, e.g., when being in Malfunctioned state.
y. The “redistributable Rd-P-MCS” module is a Packed Unit of EV Electrical Energy that is to be replaceable from the Driving Circuit to which it belongs in case of errors and malfunction, e.g., when being in Malfunctioned state.
z. The “redistributable Rd-P-MCS” module is a Packed Unit of EV Electrical Energy that is repairable, after being replaced from the Driving Circuit to which it belongs in case of errors and malfunction, e.g., when being in Malfunctioned state and being dispatched to a Repair Facility,
aa. The “redistributable Rd-P-MCS” modules in Malfunctioned state may be transported and transferred to the Repair facilities for Repair reassignment by Super Mobile Charging Stations (Super-MCS).
bb. The “redistributable Rd-P-MCS” modules in Malfunctioned state may be transported and transferred to the Repair facilities for Repair reassignment by Certified Partner Service vehicles.
cc. The “redistributable Rd-P-MCS” module is a Packed Unit of EV Electrical Energy that cannot be exchanged and/or transferred to other EV vehicles or to other Rd-P-MCS compatible participating EV vehicles. Regulatory legislation and rules about such exchanges may be available.
dd. An Open-ended rental transaction for a “redistributable Rd-P-MCS” module may allow such module to be used only in one specific Rd-P-MCS compatible participating EV vehicles (specified in the rental transaction) on the basis of one rental session lived cryptographic key.
ee. The “redistributable Rd-P-MCS” module is a Packed Unit of EV Electrical Energy that can recharge the “EV Battery (BEV)”, while stationary or while driving,
ff. The “redistributable Rd-P-MCS” module is a Packed Unit of EV Electrical Energy that allows charging the EV Battery (BEV) while driving,
gg. The “redistributable Rd-P-MCS” module is a Packed Unit of EV Electrical Energy that can power directly the “Electric Motor”,
hh. The “redistributable Rd-P-MCS” module is a Packed Unit of EV Electrical Energy that allows the EV operation (driving) even with a depleted EV Battery (BEV),
ii. The “redistributable Rd-P-MCS” module is a Packed Unit of EV Electrical Energy that can power directly the “Electric Motor” while recharging simultaneously the “EV Battery (BEV)”,
jj. The “redistributable Rd-P-MCS” module is a Packed Unit of EV Electrical Energy that can be charged (even during driving) by a Rd-P-MCS compatible charging station such as Super Stationary Charging Stations (stationary—ON GRID), and Super Mobile Charging Stations (Super-MCS)—while stationary (ON GRID or OFF GRID) or while driving (OFF GRID), each of the latter supporting apparatus holding an array of such “redistributable Rd-P-MCS” modules.
kk. The “redistributable Rd-P-MCS” module is a Packed Unit of EV Electrical Energy that is rechargeable during transportation by a Super Mobile Charging Stations (Super-MCS) during driving (OFF GRID) while being on the Rd-P-MCS modules hold by the Super-MCS, see also above.
ll. The “redistributable Rd-P-MCS” may charge the redesigned EV Battery (BEV) while the latter powers the redesigned EV Electric Motor during driving.
mm. The “redistributable Rd-P-MCS” may provide electricity to power the redesigned EV Electric Motor either directly or indirectly, while driving.
nn. The EV Electric Motor may be powered during driving from a common EV vehicle internal DC bus that is powered by the “adapted Prior art EV Battery (BEV)” and by a plurality of “redistributable Rd-P-MCS” modules.
oo. The “redistributable Rd-P-MCS” module is a Packed Unit of EV Electrical Energy that is transactional and could be rented.
pp. The “redistributable Rd-P-MCS” module is a Packed Unit of EV Electrical Energy that is moved around (hence the “redistributable” characterization) a Driving Circuit, mostly inside its own assigned service area, by the Rd-P-MCS compatible participating EV vehicles that are renting it, by the Super Mobile Charging Stations (Super-MCS) while driving (OFF GRID), and by the Certified Partner Service vehicles (OFF GRID) in under-serviced and/or remote areas.
qq. The “redistributable Rd-P-MCS” module is a Packed Unit of EV Electrical Energy that is Mass Operational, e.g., it can be operated, transported, swapped and/or exchanged, picked-up, dropped-off, retired from operation from a Driving Circuit, inserted for operation into a Driving Circuit, but not only, in quantities that are scalable to mass operational levels, e.g., high cardinalities for any of the operational activities defined in the present disclosure,
rr. The “redistributable Rd-P-MCS” module is a Packed Unit of EV Electrical Energy that is Rentable, e.g., subjected to being Rented, based on prior Subscription, Signed Contract, On the Fly Contract at the Supporting Apparatus Recharging Stations (simply referred as Recharging Stations) and/or Delivery, or based on any Acceptable Agreement and/or Contract that supports the business method within the guaranteed performance levels proposed by the disclosure, but not only,
ss. The “redistributable Rd-P-MCS” module is a Packed Unit of EV Electrical Energy that may communicate remotely, using various communication protocols, with various entities supporting the present invention disclosure business method, such as Remote Monitoring and Dispatching entity, but not only, with the support of Receptors, Transmitters, Controller Units, Communication, and Control Buses and Connections, but not only.
tt. The “redistributable Rd-P-MCS” module is a Packed Unit of EV Electrical Energy that may communicate locally, using a wired connection, but not only, using various communication protocols, with various entities supporting the present invention disclosure business method, such as Super Stationary Charging Stations (stationary—ON GRID), and Super Mobile Charging Stations (Super-MCS)—while stationary (ON GRID or OFF GRID) or while driving (OFF GRID), to which they are connected, but not only, with the support of Receptor, Transmitters, Controller Units, Communication and Control Buses and Connections, but not only.
uu. The “redistributable Rd-P-MCS” module, including in its “Light redistributable Rd-P-MCS” module embodiment described in the present disclosure, may be connected through the Vehicle Network bus, the Secure Vehicle Network bus, but not only, with the Electric Control Units (ECU) of other supporting apparatus concepts such as the “Rd-P-MCS Adapter(s)” component, and the “Rd-P-MCS compatible participating electrical vehicle (EV) Infrastructure” component, but also with the other EV vehicle's ECUs, and at the DC bus level.
vv. The “redistributable Rd-P-MCS” module, including in its “Light redistributable Rd-P-MCS” module embodiment described in the present disclosure, may be connected through the DC Bus, but not only, with the other supporting apparatus concepts such as the “Rd-P-MCS Adapter(s)” component, and the “Rd-P-MCS compatible participating electrical vehicle (EV) Infrastructure” component, but also with the other EV vehicle's components.
ww. The behavior of the “redistributable Rd-P-MCS” module, including its “Light redistributable Rd-P-MCS” module embodiment, and of any other supporting concepts such as the “Rd-P-MCS Adapter(s)” component, and the “Rd-P-MCS compatible participating electrical vehicle (EV) Infrastructure” component may be influenced and changed by the communication on the Vehicle Network bus, Secure Vehicle Network bus, but not only, between the ECU of the “redistributable Rd-P-MCS”, including its “Light redistributable Rd-P-MCS” module embodiment, and the other EV vehicle's ECUs and the other supporting apparatus concepts (e.g., “Rd-P-MCS Adapter(s)” component, “Rd-P-MCS compatible participating electrical vehicle (EV) Infrastructure” component) ECUs,
xx. The “redistributable Rd-P-MCS” has connectivity with the DC Bus, with the Vehicle Network bus and/or Secure Vehicle Network bus, and/or with other supporting apparatus, such as the “EV Battery (BEV)”, the “Electric Motor”, the “Rd-P-MCS Adapter(s)” component, the “Rd-P-MCS compatible participating electrical vehicle (EV) Infrastructure” component, but not only.
yy. The driver and the passengers may monitor with the help of the Infotainment System ECU the health status, and the charge status, but not only, of the “redistributable Rd-P-MCS” module(s) activated in the Rd-P-MCS compatible participating EV vehicle.
zz. The driver and the passengers may control with the help of the Infotainment System ECU the “redistributable Rd-P-MCS” module(s) activated in the Rd-P-MCS compatible participating EV vehicle.
aaa. The driver and the passengers may monitor with the help of the Infotainment System ECU the health status, and the charge status of the subcomponents of the “Split redistributable Rd-P-MCS” components obtained as part of a “Rd-P-MCS split”, such as the “Light redistributable Rd-P-MCS” and its supporting components, parts and modules, such as the “Rd-P-MCS Adapter(s)” component, the “Rd-P-MCS compatible participating electrical vehicle (EV) Infrastructure” component, of the “redistributable Rd-P-MCS” module(s) activated in the Rd-P-MCS compatible participating EV vehicle.
bbb. The driver and the passengers may control with the help of the Infotainment System ECU the subcomponents of the “Split redistributable Rd-P-MCS” components obtained as part of a “Rd-P-MCS split”, such as the “Light redistributable Rd-P-MCS” and its supporting components, parts and modules, such as the “Rd-P-MCS Adapter(s)” component, the “Rd-P-MCS compatible participating electrical vehicle (EV) Infrastructure” component, of the “redistributable Rd-P-MCS” module(s), activated in the Rd-P-MCS compatible participating EV vehicle.
ccc. The “redistributable Rd-P-MCS” module is a Packed Unit of EV Electrical Energy that may be Backward Compatible with respect to participating Driving Circuit.
ddd. The “redistributable Rd-P-MCS” module is a Packed Unit of EV Electrical Energy that may be Forward Compatible with respect to participating into the Driving Circuit.
eee. The “redistributable Rd-P-MCS” module is a Packed Unit of EV Electrical Energy that may NOT be Backward Compatible with respect to participating Driving Circuit.
fff. The “redistributable Rd-P-MCS” module is a Packed Unit of EV Electrical Energy that may NOT be Forward Compatible with respect to participating into the Driving Circuit.
ggg. The “redistributable Rd-P-MCS” module is a Packed Unit of EV Electrical Energy that shares hardware and software Interfaces, as well as properties, with backward and forward compatibility, without limitation to such compatibility, between all the technological concepts supporting the underlying business method of the present invention disclosure, such as:
   i. “Redistributable Rd-P-MCS” module,
   ii. Metering and Billing components,
   iii. Health Monitoring components,
   iv. Diagnostics hardware and software for each main apparatus and supporting apparatus described in the present disclosure,
   v. Electric Control Unit (ECU) and compatible hardware and software for the “redistributable Rd-P-MCS” for each main apparatus and supporting apparatus described in the present disclosure,
   vi. Electric Control Unit (ECU) and compatible hardware and software for the “redistributable Rd-P-MCS” for each main apparatus and supporting apparatus described in the present disclosure, implemented using Classic AUTOSAR and/or Adaptive AUTOSAR.
   vii. Electric Control Unit (ECU) and compatible hardware and software for each component seen as an independent set of subcomponent parts (in a multi-partite model) resulting, after performing a “Rd-P-MCS split” action on the “redistributable Rd-P-MCS” module, into the “Light redistributable Rd-P-MCS” module, the “Rd-P-MCS Adapter(s)” component, and the “Rd-P-MCS compatible participating electrical vehicle (EV) Infrastructure” component, but not only, see the discussion regarding the sub-components allocation, that are designed to be connected to the Vehicle Network bus and Secure Vehicle Network bus in order to communicate with each other, but also to communicate with the rest of the automotive ECU topology eco-system,
   viii. Electric Control Unit (ECU) and compatible hardware and software for each component seen as an independent set of subcomponent parts (in a multi-partite model) resulting, after performing a “Rd-P-MCS split” action on the “redistributable Rd-P-MCS” module, into “Light redistributable Rd-P-MCS” module, the “Rd-P-MCS Adapter(s)” component, and the “Rd-P-MCS compatible participating electrical vehicle (EV) Infrastructure” component, but not only, see the discussion regarding the sub-components allocation, that are designed to be connected to the Vehicle Network bus and Secure Vehicle Network bus in order to communicate with each other, but also to communicate with the rest of the automotive ECU topology eco-system, implemented using Classic AUTOSAR and/or Adaptive AUTOSAR.
   ix. ECUs for the “redistributable Rd-P-MCS” being connected to the Vehicle Network bus, Secure Vehicle Network bus, but not only, with its own automotive stack based on CAN, LIN, ETH, Flexy, but not only, communication, thus they are linked and communicate, control and being controlled by the other ECUs from the EV vehicle ECU topology, including the Infotainment System ECU, EV Battery (BEV) ECU system, but not only.
   x. ECUs for the “redistributable Rd-P-MCS” multi-partite split, including the “Light redistributable Rd-P-MCS” module, the “Rd-P-MCS Adapter(s)” component, the “Rd-P-MCS compatible participating electrical vehicle (EV) Infrastructure” component, but not only), that should be able to connected to the vehicle bus with its own automotive stack based on CAN, LIN, ETH, and Flexy protocols, but not only, communication, thus they are linked and can communicate, control and being controlled by the other ECUs from the EV vehicle's ECU topology, including the Infotainment System ECU, EV Battery (BEV) ECU system, but not only.
   xi. Electric Control Unit (ECU) displays, receptor and transmitter components,
   xii. Super Stationary Charging Stations (stationary—ON GRID), and Super Mobile Charging Stations (Super-MCS)—while stationary (ON GRID or OFF GRID) or while driving (OFF GRID),
   xiii. Super Mobile Charging Stations (Super-MCS) vehicles that allow OFF-Grid transportation of “redistributable Rd-P-MCS” modules in Operational state for redistribution to other Super Stationary Charging Stations (stationary—ON GRID), and Super Mobile Charging Stations (Super-MCS)—while stationary (ON GRID, in all embodiments described in the disclosure,
   xiv. Super Mobile Charging Stations (Super-MCS) vehicles that allow transportation of “redistributable Rd-P-MCS” in Operational state for redistribution to other Super Mobile Charging Stations (Super-MCS) (OFF GRID), or other Certified Partner Service vehicles, in all embodiments described in the disclosure,
   xv. Super Mobile Charging Stations (Super-MCS) vehicles that allow transportation of “redistributable Rd-P-MCS” in Operational state for redistribution to locations for Rental Delivery at meeting Order Calls by Rd-P-MCS compatible participating EV vehicles anticipating such location alongside their travel plan, in all embodiments described in the disclosure,
   xvi. Certified Partner Service vehicles that allow OFF-Grid transportation of “redistributable Rd-P-MCS” in Operational state for redistribution to other Super Stationary Charging Stations (stationary—ON GRID), and Super Mobile Charging Stations (Super-MCS)—while stationary (ON GRID, in all embodiments described in the disclosure,
   xvii. Certified Partner Service vehicles that allow transportation of “redistributable Rd-P-MCS” in Operational state for redistribution to other Super Mobile Charging Stations (Super-MCS) (OFF GRID), or other Certified Partner Service vehicles, in all embodiments described in the disclosure,
   xviii. Certified Partner Service vehicles that allow transportation of “redistributable Rd-P-MCS” in Operational state for redistribution to locations for Rental Delivery at meeting Order Calls by Rd-P-MCS compatible participating EV vehicles anticipating such location alongside their travel plan, in all embodiments described in the disclosure,
   xix. Any other technological apparatus described in the disclosure for the purpose of supporting the described business method, with any business method extensions that are normally inferred by the skilled in the art.

for all the technical embodiments described in the disclosure, such as those depicted in the figures FIG. 46 and FIG. 47, FIG. 48, FIG. 49, FIG. 50, and FIG. 51, but not limited to these embodiments, e.g., for any bi-partite or multi-partite allocation of the parts and/or subcomponents shown in the figures FIG. 78, FIG. 79, FIG. 80, FIG. 81, FIG. 82, FIG. 83, FIG. 84, FIG. 85, and in the diagrams from FIG. 86 and FIG. 87, according to the “bi-partite graph” or the “multi-partite graph” based embodiments defined further in the invention disclosure, but not only, as well as in figures and diagrams FIG. 106, FIG. 107, FIG. 108, FIG. 109, FIG. 110, FIG. 111, FIG. 112, FIG. 113, FIG. 114, FIG. 115, FIG. 116, and FIG. 117.

### Bi-Partite and Multi-Partite Embodiments of “Redistributable Rd-P-MCS” Module and the “Light Redistributable Rd-P-MCS” Module

Due to its size, the Cooling system component of the “redistributable Rd-P-MCS” module, or of the “Light redistributable Rd-P-MCS” module—defined later in the invention disclosure—could be part of the Rd-P-MCS compatible participating electrical vehicle (EV) Infrastructure component in the Rd-P-MCS compatible participating EV vehicles.

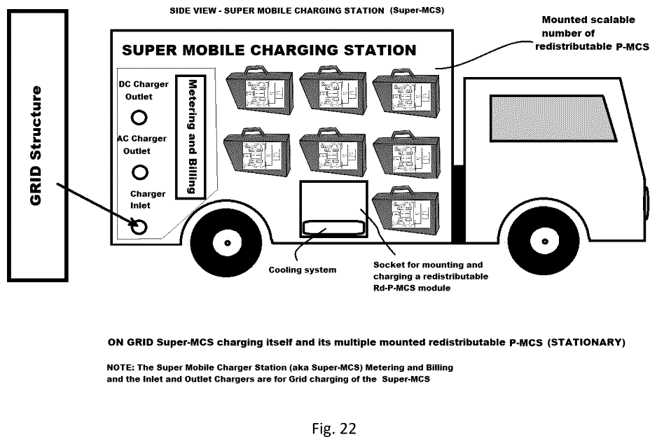

Similarly, when a “redistributable Rd-P-MCS” module, or a “Light redistributable Rd-P-MCS” module, is mounted, carried and charged in a charging station such as the Super Stationary Charging Station (stationary—ON GRID), or a Super Mobile Charging Station (Super-MCS)—while stationary (ON GRID or OFF GRID) or while driving (OFF GRID),
the Cooling system component for each such a “redistributable Rd-P-MCS” module would be mounted as part of the architecture of the above-mentioned charging station for each mount location reserved for such “redistributable Rd-P-MCS” module, see for example FIG. 22.

In graph theory, a bipartite graph, or bi-graph, is a graph whose vertices can be divided into two disjoint and independent sets U and V, that is, every edge connects a vertex in U to a vertex in V. The vertex sets U and V are usually called the parts of the graph.

In order to implement the apparatus and the business method, another embodiment could implement the present invention disclosure concept of “charging while driving” with a split of the “redistributable Rd-P-MCS” module into a partial functionality module named the “Light redistributable Rd-P-MCS” module being comprised of the following:
a. “Hardware and Software” interfaces,
b. “Battery Pack” component,
c. “Metering and Billing” component,
into the Rd-P-MCS compatible participating electrical vehicle (EV) Infrastructure component comprised of the rest of the parts and subcomponents from a complete “redistributable Rd-P-MCS” module, as follows:
a) “Ultracapacitor” component,
b) “Control and Monitoring” component,
c) “Hardware and Software” interfaces,
d) DC/DC converter,
e) DC/AC inverter,
f) AC charger,
g) AC charger outlet,
h) DC charger outlet,
i) AC charger inlet,
j) Socket connector and/or connections,
k) DC bus interfaces,
l) Cooling system,
m) Other parts,
n) NOTE: The plurality of AC charger, DC charger, AC charger outlets, DC charger outlets, AC charger inlet, and DC charger inlet, may be available either external, either internal or both external and internal to the vehicle.
see the figures FIG. 47, FIG. 48, and FIG. 49.

FIG. 47 shows how the “redistributable Rd-P-MCS” module is split into a partial functionality “redistributable Rd-P-MCS” module named the “Light redistributable Rd-P-MCS” module with the “Ultracapacitor” component and with the “Control and Monitoring” component and a Rd-P-MCS compatible participating electrical vehicle (EV) Infrastructure component comprised of the rest of the parts and subcomponents from a complete “redistributable Rd-P-MCS” module.

FIG. 48 and FIG. 49 show equivalent depictions of the “Light redistributable Rd-P-MCS” module without the “Ultracapacitor” component and without the “Control and Monitoring” component as define above.

Another embodiment of Splitting the “redistributable Rd-P-MCS” module in order to implement the present disclosure concept of “charging while driving” would have the “Light redistributable Rd-P-MCS” module being comprised of the following:
a. “Hardware and Software” interfaces,
b. “Battery Pack” component,
c. “Metering and Billing” component,
d. “Ultracapacitor” component,
e. “Control and Monitoring” component,
and the Rd-P-MCS compatible participating electrical vehicle (EV) Infrastructure component being comprised of the rest of the parts and subcomponents from a complete “redistributable Rd-P-MCS” module, as follows:
a) “Hardware and Software” interfaces,
b) DC/DC converter,
c) DC/AC inverter,
d) AC charger,
e) AC charger outlet,
f) DC charger outlet,
g) AC charger inlet,
h) Socket connector and/or connections,
i) DC bus interfaces,
j) Cooling system,
k) Other parts,
l) NOTE: The plurality of AC charger, DC charger, AC charger outlets, DC charger outlets, AC charger inlet, and DC charger inlet, may be available either external, either internal or both external and internal to the vehicle.
see the figures FIG. 50, and FIG. 51.

FIG. 50 shows how the “redistributable Rd-P-MCS” module is split into a partial functionality “redistributable Rd-P-MCS” module named the “Light redistributable Rd-P-MCS” module with the “Ultracapacitor” component and with the “Control and Monitoring” component and a Rd-P-MCS compatible participating electrical vehicle (EV) Infrastructure component comprised of the rest of the parts and subcomponents from a complete “redistributable Rd-P-MCS” module.

FIG. 51 shows an equivalent depiction of the “Light redistributable Rd-P-MCS” module without the “Ultracapacitor” component and without the “Control and Monitoring” component as define above.

The functionality of Prior art Mobile Charging Station (MCS) found in the “redistributable Rd-P-MCS” module is split between the Rd-P-MCS compatible participating electrical vehicle (EV) Infrastructure component car apparatus and the “Light redistributable Rd-P-MCS” module apparatus to be mounted/connected to the Rd-P-MCS compatible participating EV vehicle.

One of the Mobile Charging Station (MCS) functionality interfaces found in the “redistributable Rd-P-MCS” module, e.g., the interface on the left side, may be used to connect the “redistributable Rd-P-MCS” module, or the “Light redistributable Rd-P-MCS” module, to the DC bus of the EV vehicle in order to charge the EV Battery (BEV) during driving,

Another of the Mobile Charging Station (MCS) functionality interfaces found in the “redistributable Rd-P-MCS” module, e.g., the interface on the right side, may be used to charge the “redistributable Rd-P-MCS” module, or the “Light redistributable Rd-P-MCS” module, from the exterior outlet.

While not being depicted explicitly in the figures, the “redistributable Rd-P-MCS” module cooling system may be placed in the Rd-P-MCS compatible participating electrical vehicle (EV) Infrastructure component as part of the splitting the “redistributable Rd-P-MCS” module described as above.

While not being mentioned explicitly, when the usage of the “redistributable Rd-P-MCS” module in the current invention disclosure is depicted and described, one skilled in the art may see the same applicability with using the “Light redistributable Rd-P-MCS” module concept instead of the “redistributable Rd-P-MCS” module.

In figures FIG. 30, FIG. 31, FIG. 32, and FIG. 33, as well as in the embodiments of the figure FIG. 77, the present inventions disclosure shows alternate ways of depicting a “redistributable Rd-P-MCS” module in various embodiments, either with a “distributed ESS” component or without a “distributed ESS” component.

The present invention disclosure presents in figures FIG. 30, FIG. 31, FIG. 32, and FIG. 33, but not only:
i. a portable, rentable and redistributable energy package named “redistributable Rd-P-MCS” module that may be represented by a miniaturized Prior art Mobile Charging Station (MCS) image in various embodiments and representations.
ii. the “redistributable Rd-P-MCS” module that is at the core of the present invention disclosure, together with the “Rd-P-MCS compatible BEV Battery (BEV)” battery, has embedded with Prior art Mobile Charging Station (MCS) functionality, including the “metering and billing” feature,
iii. the “redistributable Rd-P-MCS” module may be abbreviated with “Rd-P-MCS” in order to be distinguished from the Prior art P-MCS portable device concept,
iv. the “redistributable Rd-P-MCS” module may be any of the depicted embodiments shown in the figures FIG. 30, FIG. 31, FIG. 32, and FIG. 33.

The present invention disclosure shows how a Prior art Mobile Charging Station (MCS) becomes an array of “redistributable Rd-P-MCS” modules in an embodiment of a mobile OFF-GRID Super Mobile Charging Station (Super-MCS) containing an array of “redistributable Rd-P-MCS” modules.

In the state of being “mobile” the Super Mobile Charging Station (Super-MCS) can drive to vehicles that need to recharge (swap) their depleted “redistributable Rd-P-MCS” modules even in areas that are away from stationary (ON-GRID) Recharging Stations, including Super Stationary Charging Stations and stationary ON-GRID Super Mobile Charging Station (Super-MCS).

When a OFF-GRID Super Mobile Charging Station (Super-MCS) arrives at an Electric Vehicle (EV) in need, the latter may choose to rapidly swap the vehicle's “redistributable Rd-P-MCS” module(s) with the same number of “redistributable Rd-P-MCS” module(s) from the Super Mobile Charging Station (Super-MCS) with almost no waiting charging time, or the vehicle may choose to be charged from a fast-charging outlet or from a “redistributable Rd-P-MCS” module mounted to the Super Mobile Charging Station (Super-MCS) depending if the vehicle has the capability to mount the P-MCS and charge while driving or if the vehicle does not have such capability.

Based on the above embodiments, the present disclosure provides a systematic way of splitting the functionality of a complete “redistributable Rd-P-MCS” module into the functionality of a portable “Light redistributable Rd-P-MCS” module and an apparatus that could be assigned to the Rd-P-MCS compatible participating electrical vehicle (EV) Infrastructure component.

FIG. 78, FIG. 79, FIG. 80, FIG. 81, FIG. 82, FIG. 83, FIG. 84, FIG. 85, and in the diagrams from FIG. 86 and FIG. 87, shows two independent sets U and V of the bipartite graph defining the allocation of the parts and the components, corresponding to the split of a complete “redistributable Rd-P-MCS” module, to either the “Light redistributable Rd-P-MCS” component (set U) or the Rd-P-MCS compatible participating electrical vehicle (EV) Infrastructure component (set V) for a “redistributable Rd-P-MCS” module consisting of the following:
a. “Battery Pack” component,
b. “Metering and Billing” component,
c. “Ultracapacitor” component,
d. “Control and Monitoring” component,
e. “Hardware and Software” interfaces,
f. DC/DC converter,
g. DC/AC inverter,
h. AC charger,
i. DC charger,
j. AC charger outlet,
k. DC charger outlet,
l. AC charger inlet,
m. DC charger inlet,
n. Socket connector and/or connections,
o. DC bus interfaces,
p. Cooling system,
q. Other parts,
NOTE: The plurality of AC charger, DC charger, AC charger outlets, DC charger outlets, AC charger inlet, and DC charger inlet, may be available either external, either internal or both external and internal to the vehicle.

There is no limitation on partitioning the above components, there is no limitation on the partitioning with the above components, the enumeration is not exhaustive.

Using only a Bi-Graph, for example, one could devise a partition of the above components between the independent sets of a Multi-Graph, or “multi-partite graph”, with multiple independent sets modeling a plurality of Hardware and Software parts supporting the business method from the disclosure, for example, between the “redistributable Rd-P-MCS”, the “EV compatible Rd-P-MCS Infrastructure” (let's say set V, as shown in a particular embodiment from the figures FIG. 78, FIG. 79, FIG. 80, FIG. 81, FIG. 82, FIG. 83, FIG. 84, FIG. 85, and in the diagrams from FIG. 86 and FIG. 87, but also other component sets participating into the implementation of the present invention disclosure technology supporting the proposed business method.

A “bi-partite split” embodiment of the allocation for the set U and set V mentioned above with the parts and subcomponents in relation to the split of a complete “redistributable Rd-P-MCS” module could be, using the Bi-Partite modelling formalization of such allocation, could be as follows:
a. Set U of parts and/or subcomponents allocated to the “Light redistributable Rd-P-MCS” component (aka “Rd-P-MCS Part #1”) comprised of the following:
   i. “Hardware and Software” interfaces,
   ii. “Battery Pack” component,
   iii. “Metering and Billing” component,
b. Set V of parts and/or subcomponents allocated to the “Rd-P-MCS compatible participating electrical vehicle (EV) Infrastructure” component (aka “Rd-P-MCS Part #2”) comprised of the following:
   i. “Ultracapacitor” component,
   ii. “Control and Monitoring” component,
   iii. “Hardware and Software” interfaces,
   iv. DC/DC converter,
   v. DC/AC inverter,
   vi. AC charger,
   vii. DC charger,
   viii. AC charger outlet,
   ix. DC charger outlet,
   x. AC charger inlet,
   xi. DC charger inlet,
   xii. Socket connector and/or connections,
   xiii. DC bus interfaces,
   xiv. Cooling system,
   xv. NOTE: The plurality of AC charger, DC charger, AC charger outlets, DC charger outlets, AC charger inlet, and DC charger inlet, may be available either external, either internal or both external and internal to the vehicle.
   xvi. Other parts

Another “bi-partite split” embodiment of the allocation for the set U and set V mentioned above with the parts and subcomponents in relation to the split of a complete “redistributable Rd-P-MCS” module could be, using the Bi-Partite modelling formalization of such allocation, could be as follows:
a. Set U of parts and/or subcomponents allocated to the “Light redistributable Rd-P-MCS” component (aka “Rd-P-MCS Part #1”) comprised of the following:
   i. “Hardware and Software” interfaces,
   ii. “Battery Pack” component,
   iii. “Metering and Billing” component,
   iv. “Ultracapacitor” component,
   v. “Control and Monitoring” component,
b. Set V of parts and/or subcomponents allocated to the “Rd-P-MCS compatible participating electrical vehicle (EV) Infrastructure” component (aka “Rd-P-MCS Part #2”) comprised of the following:
   i. “Hardware and Software” interfaces,
   ii. DC/DC converter,
   iii. DC/AC inverter,
   iv. AC charger,
   v. DC charger,
   vi. AC charger outlet,
   vii. DC charger outlet,
   viii. AC charger inlet,
   ix. DC charger inlet,
   x. Socket connector and/or connections,
   xi. DC bus interfaces,
   xii. Cooling system,
   xiii. NOTE: The plurality of AC charger, DC charger, AC charger outlets, DC charger outlets, AC charger inlet, and DC charger inlet, may be available either external, either internal or both external and internal to the vehicle.
   xiv. Other parts

A “tri-partite” embodiment of the allocation for the set U, set V, and additional set W, with the parts and subcomponents in relation to the split of a complete “redistributable Rd-P-MCS” module to either the “Light redistributable Rd-P-MCS” component (set U), to the Rd-P-MCS compatible participating electrical vehicle (EV) Infrastructure component (set V), or to a third independent component, using the Tri-Partite modelling formalization of such allocation, for a “redistributable Rd-P-MCS” module with the following components:
a. Adapter connections and interfaces at “Light redistributable Rd-P-MCS” aka “Rd-P-MCS Part #1”,
b. Adapter connections and interfaces at “Rd-P-MCS compatible participating electrical vehicle (EV) Infrastructure” aka “Rd-P-MCS Part #2”,
c. Adapter between the “Light redistributable Rd-P-MCS” component and the “Rd-P-MCS compatible participating electrical vehicle (EV) Infrastructure” component, aka “Rd-P-MCS Part #3”,
d. “Battery Pack” component,
e. “Metering and Billing” component,
f. “Ultracapacitor” component,
g. “Control and Monitoring” component,
h. DC/DC converted,
i. DC/AC inverter,
j. AC charger,
k. DC charger,
l. AC charger outlet,
m. DC charger outlet,
n. AC charger inlet,
o. DC charger inlet,
p. Socket connector and/or connections,
q. DC bus interfaces,
r. Other parts
s. Cooling system,
t. NOTE: The plurality of AC charger, DC charger, AC charger outlets, DC charger outlets, AC charger inlet, and DC charger inlet, may be available either external, either internal or both external and internal to the vehicle.
with the following set parts and subcomponents allocation as below:
   1. Set U of parts and/or subcomponents allocated to the “Light redistributable Rd-P-MCS” component (aka “Rd-P-MCS Part #1”) comprised of the following:
      a. “Hardware and Software” interfaces, e.g., adapter connections and interfaces, at “Light redistributable Rd-P-MCS” module,
      b. “Battery Pack” component,
      c. “Metering and Billing” component,
   2. Set V of parts and/or subcomponents allocated to the “Rd-P-MCS compatible participating electrical vehicle (EV) Infrastructure” component (aka “Rd-P-MCS Part #2”) comprised of the following:
      a. “Hardware and Software” interfaces, e.g., adapter connections and interfaces, at “Rd-P-MCS compatible participating electrical vehicle (EV) Infrastructure” component,
      b. “Ultracapacitor” component,
      c. “Control and Monitoring” component,
      d. DC/DC converter,
      e. DC/AC inverter,
      f. AC charger,
      g. DC charger,
      h. AC charger outlet,
      i. DC charger outlet,
      j. AC charger inlet,
      k. DC charger inlet,
      l. DC bus interfaces,
      m. Other parts,
      n. Cooling system,
      o. NOTE: The plurality of AC charger, DC charger, AC charger outlets, DC charger outlets, AC charger inlet, and DC charger inlet, may be available either external, either internal or both external and internal to the vehicle.
   3. Set W of parts and/or subcomponents allocated to the <Adapter between the “Light redistributable Rd-P-MCS” module and “Rd-P-MCS compatible participating electrical vehicle (EV) Infrastructure” component> (aka “Rd-P-MCS Part #3”) comprised of the following:
      a. Adapter between the “Light redistributable Rd-P-MCS” module and “EV compatible Rd-P-MCS Infrastructure”
   as shown in FIG. 78.

In the figures FIG. 78 and FIG. 79, the Split “Redistributable Rd-P-MCS” module is comprised of the Adapter (7), the “Light redistributable Rd-P-MCS” component (8), and the “Rd-P-MCS compatible participating electrical vehicle (EV) Infrastructure” component, that altogether compose a fully functional “redistributable Rd-P-MCS” module as shown in the present disclosure in figures FIG. 77, FIG. 30, FIG. 31, FIG. 32, and FIG. 33.

An alternate “tri-partite” embodiment of the allocation for the set U, set V, and additional set W, with the parts and subcomponents in relation to the split of a complete “redistributable Rd-P-MCS” module to either the “Light redistributable Rd-P-MCS” component (set U), to the Rd-P-MCS compatible participating electrical vehicle (EV) Infrastructure component (set V), or to a third independent component, using the Tri-Partite modelling formalization of such allocation, for a “redistributable Rd-P-MCS” module with the following components:
a. Adapter connections and interfaces at “Light redistributable Rd-P-MCS” component aka “Rd-P-MCS Part #1”,
b. Adapter connections and interfaces at “Rd-P-MCS compatible participating electrical vehicle (EV) Infrastructure” aka “Rd-P-MCS Part #2”,
c. Adapter between the “Light redistributable Rd-P-MCS” component and the “Rd-P-MCS compatible participating electrical vehicle (EV) Infrastructure” component, aka “Rd-P-MCS Part #3”,
d. “Battery Pack” component,
e. “Metering and Billing” component,
f. “Ultracapacitor” component,
g. “Control and Monitoring” component,
h. DC/DC converted,
i. DC/AC inverter,
j. AC charger,
k. DC charger,
l. AC charger outlet,
m. DC charger outlet,
n. AC charger inlet,
o. DC charger inlet,
p. Socket connector and/or connections,
q. DC bus interfaces,
r. Other parts
s. Cooling system,
t. NOTE: The plurality of AC charger, DC charger, AC charger outlets, DC charger outlets, AC charger inlet, and DC charger inlet, may be available either external, either internal or both external and internal to the vehicle.
with the following set parts and subcomponents allocation as below:
   1. Set U of parts and/or subcomponents allocated to the “Light redistributable Rd-P-MCS” component (aka “Rd-P-MCS Part #1”) comprised of the following:
      a. “Hardware and Software” interfaces, e.g., adapter connections and interfaces, at “Light redistributable Rd-P-MCS” module,
      b. “Battery Pack” component,
      c. “Metering and Billing” component,
      d. “Ultracapacitor” component,
      e. “Control and Monitoring” component,
   2. Set V of parts and/or subcomponents allocated to the “Rd-P-MCS compatible participating electrical vehicle (EV) Infrastructure” component (aka “Rd-P-MCS Part #2”) comprised of the following:
      a. “Hardware and Software” interfaces, e.g., adapter connections and interfaces, at “Rd-P-MCS compatible participating electrical vehicle (EV) Infrastructure” component,
      b. DC/DC converter,
      c. DC/AC inverter,
      d. AC charger,
      e. DC charger,
      f. AC charger outlet,
      g. DC charger outlet,
      h. AC charger inlet,
      i. DC charger inlet,
      j. DC bus interfaces,
      k. Other parts,
      l. Cooling system,
      m. NOTE: The plurality of AC charger, DC charger, AC charger outlets, DC charger outlets, AC charger inlet, and DC charger inlet, may be available either external, either internal or both external and internal to the vehicle.
   3. Set W of parts and/or subcomponents allocated to the <Adapter between the “Light redistributable Rd-P-MCS” module and “Rd-P-MCS compatible participating electrical vehicle (EV) Infrastructure” component> (aka “Rd-P-MCS Part #3”) comprised of the following:
      a. Adapter between the “Light redistributable Rd-P-MCS” module and “Rd-P-MCS compatible participating electrical vehicle (EV) Infrastructure” component,
   as shown in FIG. 79.

An alternate Tri-partite Graph formalization of the allocation of parts and/or components enumerated below as follows:
a. Adapter connections and interfaces at “redistributable Rd-P-MCS”,
b. Adapter connections and interfaces at “EV compatible Rd-P-MCS Infrastructure”
c. Adapter between at “redistributable Rd-P-MCS” and “EV compatible-MCS Infrastructure”
d. Battery Pack
e. Metering and Billing component(s),
f. Ultracapacitor,
g. DC/DC converted,
h. DC/AC inverter,
i. AC charger,
j. DC charger,
k. AC charger outlet,
l. DC charger outlet,
m. AC charger inlet,
n. DC charger inlet,
o. Socket connector and/or connections,
p. DC bus interfaces,
q. The plurality of AC charger, DC charger, AC charger outlets, DC charger outlets, AC charger inlet, and DC charger inlet, may be available either external, either internal or both external and internal to the vehicle.
r. “redistributable Rd-P-MCS” Health Monitoring circuitry component,
s. “redistributable Rd-P-MCS” Identification component,
t. “redistributable Rd-P-MCS” Geolocation Tracking System (GPS, etcetera) component,
u. Receptors, Transmitters, Controller Units, Communication and Control Buses, and Connections, but not only.
v. other parts

with the allocation as below:
1. Set U of parts and/or subcomponents allocated to the “Light redistributable Rd-P-MCS” component (aka “Rd-P-MCS Part #1”) comprised of the following:
   a. “Hardware and Software” interfaces, e.g., adapter connections and interfaces, at “Light redistributable Rd-P-MCS” module,
   b. “Battery Pack” component,
   c. “Metering and Billing” component,
   d. “Ultracapacitor” component,
   e. “Control and Monitoring” component,
   f. “Redistributable Rd-P-MCS” Health Monitoring circuitry component,
   g. “Redistributable Rd-P-MCS” Identification component,
   h. “Redistributable Rd-P-MCS” Geolocation Tracking System (GPS, etc) component,
   i. Receptors, Transmitters, Controller Units, Communication and Control Buses, and Connections,
2. Set V of parts and/or subcomponents allocated to the “Rd-P-MCS compatible participating electrical vehicle (EV) Infrastructure” component (aka “Rd-P-MCS Part #2”) comprised of the following:
   a. “Hardware and Software” interfaces, e.g., adapter connections and interfaces, at “Rd-P-MCS compatible participating electrical vehicle (EV) Infrastructure” component,
   b. “Ultracapacitor” component,
   c. DC/DC converted,
   d. DC/AC inverter,
   e. AC charger,
   f. DC charger,
   g. AC charger outlet,
   h. DC charger outlet,
   i. AC charger inlet,
   j. DC charger inlet,
   k. Socket connector and/or connections,
   l. DC bus interfaces,
   m. The plurality of AC charger, DC charger, AC charger outlets, DC charger outlets, AC charger inlet, and DC charger inlet, may be available either external, either internal or both external and internal to the vehicle.
   n. Other parts
3. Set W of parts and/or subcomponents allocated to the <Adapter between the “Light redistributable Rd-P-MCS” module and “Rd-P-MCS compatible participating electrical vehicle (EV) Infrastructure” component> (aka “Rd-P-MCS Part #3”) comprised of the following:
   a) Adapter between the “Light redistributable Rd-P-MCS” module and “Rd-P-MCS compatible participating electrical vehicle (EV) Infrastructure” component, as in the FIG. 80.

Yet another alternate “tri-partite” embodiment of the allocation for the set U, set V, and additional set W, with the parts and subcomponents in relation to the split of a complete “redistributable Rd-P-MCS” module to either the “Light redistributable Rd-P-MCS” component (set U), to the Rd-P-MCS compatible participating electrical vehicle (EV) Infrastructure component (set V), or to a third independent component, using the Tri-Partite modelling formalization of such allocation, for a “redistributable Rd-P-MCS” module with the following components:
a. Adapter connections and interfaces at “Light redistributable Rd-P-MCS” aka “Rd-P-MCS Part #1”,
b. Adapter connections and interfaces at “Rd-P-MCS compatible participating electrical vehicle (EV) Infrastructure” aka “Rd-P-MCS Part #2”,
c. Adapter between the “Light redistributable Rd-P-MCS” component and the “Rd-P-MCS compatible participating electrical vehicle (EV) Infrastructure” component, aka “Rd-P-MCS Part #3”,
d. “Battery Pack” component,
e. “Metering and Billing” component,
f. “Ultracapacitor” component,
g. “Control and Monitoring” component,
h. DC/DC converter,
i. DC/AC inverter,
j. AC charger,
k. DC charger,
l. AC charger outlet,
m. DC charger outlet,
n. AC charger inlet,
o. DC charger inlet,
p. Socket connector and/or connections,
q. DC bus interfaces,
r. Cooling system,
a. “Redistributable Rd-P-MCS” Health Monitoring component,
b. “Redistributable Rd-P-MCS” Identification component,
c. “Redistributable Rd-P-MCS” Geolocation Tracking System (GPS, etcetera) component,
d. Receptors, Transmitters, Controller Units, Communication and Control Buses, and Connections, but not only.
s. Other parts
t. NOTE: The plurality of AC charger, DC charger, AC charger outlets, DC charger outlets, AC charger inlet, and DC charger inlet, may be available either external, either internal or both external and internal to the vehicle.
with the following set parts and subcomponents allocation as below:
1. Set U of parts and/or subcomponents allocated to the “Light redistributable Rd-P-MCS” component (aka “Rd-P-MCS Part #1”) comprised of the following:
   a. “Hardware and Software” interfaces, e.g., adapter connections and interfaces, at “Light redistributable Rd-P-MCS” module,
   b. “Battery Pack” component,
   c. “Metering and Billing” component,
   d. “Redistributable Rd-P-MCS” Health Monitoring component,
   e. “Redistributable Rd-P-MCS” Identification component,
   f. “Redistributable Rd-P-MCS” Geolocation Tracking System (GPS, etcetera) component,
   g. Receptors, Transmitters, Controller Units, Communication and Control Buses, and Connections, but not only.
2. Set V of parts and/or subcomponents allocated to the “Rd-P-MCS compatible participating electrical vehicle (EV) Infrastructure” component (aka “Rd-P-MCS Part #2”) comprised of the following:
   a. “Hardware and Software” interfaces, e.g., adapter connections and interfaces, at “Rd-P-MCS compatible participating electrical vehicle (EV) Infrastructure” component,
   b. “Ultracapacitor” component,
   c. “Control and Monitoring” component,
   d. DC/DC converter,
   e. DC/AC inverter,
   f. AC charger,
   g. DC charger,
   h. AC charger outlet,
   i. DC charger outlet,
   j. AC charger inlet,
   k. DC charger inlet,
   l. DC bus interfaces,
   m. Other parts,
   n. Cooling system,
   o. NOTE: The plurality of AC charger, DC charger, AC charger outlets, DC charger outlets, AC charger inlet, and DC charger inlet, may be available either external, either internal or both external and internal to the vehicle.
3. Set W of parts and/or subcomponents allocated to the <Adapter between the “Light redistributable Rd-P-MCS” module and “Rd-P-MCS compatible participating electrical vehicle (EV) Infrastructure” component> (aka “Rd-P-MCS Part #3”) comprised of the following:
   a. Adapter between the “Light redistributable Rd-P-MCS” module and “Rd-P-MCS compatible participating electrical vehicle (EV) Infrastructure” component,
as shown in FIG. 80.

The charging architecture in a Rd-P-MCS compatible participating EV vehicle having the scope of “charging while driving” with a split “redistributable Rd-P-MCS” module where the “Light redistributable Rd-P-MCS” module (aka “Rd-P-MCS Part #1”) is without the “Ultracapacitor” component and without the “Control and Monitoring” component, as shown in the immediately above paragraph, may be further refined in such a way that all the split components, e.g., the “Light redistributable Rd-P-MCS” component (set U), the Rd-P-MCS compatible participating electrical vehicle (EV) Infrastructure component (set V), and the <Adapter between the “Light redistributable Rd-P-MCS” module and “Rd-P-MCS compatible participating electrical vehicle (EV) Infrastructure”> component (set W) are connected together but also are connected with the “EV vehicle Battery (BEV)” by the following:
d. Vehicle Network bus,
e. Secure Vehicle Network bus,
f. DC bus,
as seen in the figures FIG. 82 and FIG. 83.

Yet another alternate “tri-partite” embodiment of the allocation for the set U, set V, and additional set W, with the parts and subcomponents in relation to the split of a complete “redistributable Rd-P-MCS” module to either the “Light redistributable Rd-P-MCS” component (set U), to the Rd-P-MCS compatible participating electrical vehicle (EV) Infrastructure component (set V), or to a third independent component, using the Tri-Partite modelling formalization of such allocation, for a “redistributable Rd-P-MCS” module with the following components:
a. Adapter connections and interfaces at “Light redistributable Rd-P-MCS” aka “Rd-P-MCS Part #1”,
b. Adapter connections and interfaces at “Rd-P-MCS compatible participating electrical vehicle (EV) Infrastructure” aka “Rd-P-MCS Part #2”,
c. Adapter between the “Light redistributable Rd-P-MCS” component and the “Rd-P-MCS compatible participating electrical vehicle (EV) Infrastructure” component, aka “Rd-P-MCS Part #3”,
d. “Battery Pack” component,
e. “Metering and Billing” component,
f. “Ultracapacitor” component,
g. “Control and Monitoring” component,
h. DC/DC converter,
i. DC/AC inverter,
j. AC charger,
k. DC charger,
l. AC charger outlet,
m. DC charger outlet,
n. AC charger inlet,
o. DC charger inlet,
p. Socket connector and/or connections,
q. DC bus interfaces,
r. Cooling system,
   a. “Redistributable Rd-P-MCS” Health Monitoring component,
   b. “Redistributable Rd-P-MCS” Identification component,
   c. “Redistributable Rd-P-MCS” Geolocation Tracking System (GPS, etcetera) component,
   d. Receptors, Transmitters, Controller Units, Communication and Control Buses, and Connections, but not only.
s. Other parts
t. NOTE: The plurality of AC charger, DC charger, AC charger outlets, DC charger outlets, AC charger inlet, and DC charger inlet, may be available either external, either internal or both external and internal to the vehicle.
with the following set parts and subcomponents allocation as below:
1. Set U of parts and/or subcomponents allocated to the “Light redistributable Rd-P-MCS” (aka “Rd-P-MCS Part #1”) comprised of the following:
   a. “Hardware and Software” interfaces, e.g., adapter connections and interfaces, at “Light redistributable Rd-P-MCS” module,
   b. “Battery Pack” component,
   c. “Metering and Billing” component,
   d. “Ultracapacitor” component,
   e. “Control and Monitoring” component,
   f. “Redistributable Rd-P-MCS” Health Monitoring component,
   g. “Redistributable Rd-P-MCS” Identification component,
   h. “Redistributable Rd-P-MCS” Geolocation Tracking System (GPS, etcetera) component,
   i. Receptors, Transmitters, Controller Units, Communication and Control Buses, and Connections, but not only.
2. Set V of parts and/or subcomponents allocated to the “Rd-P-MCS compatible participating electrical vehicle (EV) Infrastructure” component (aka “Rd-P-MCS Part #2”) comprised of the following:
   a. “Hardware and Software” interfaces, e.g., adapter connections and interfaces, at “Rd-P-MCS compatible participating electrical vehicle (EV) Infrastructure” component,
   b. DC/DC converter,
   c. DC/AC inverter,
   d. AC charger,
   e. DC charger,
   f. AC charger outlet,
   g. DC charger outlet,
   h. AC charger inlet,
   i. DC charger inlet,
   j. DC bus interfaces,
   k. Other parts,
   l. Cooling system,
   m. NOTE: The plurality of AC charger, DC charger, AC charger outlets, DC charger outlets, AC charger inlet, and DC charger inlet, may be available either external, either internal or both external and internal to the vehicle.
3. Set W of parts and/or subcomponents allocated to the <Adapter between the “Light redistributable Rd-P-MCS” module and “Rd-P-MCS compatible participating electrical vehicle (EV) Infrastructure” component> (aka “Rd-P-MCS Part #3”) comprised of the following:
   a. Adapter between the “Light redistributable Rd-P-MCS” module and “Rd-P-MCS compatible participating electrical vehicle (EV) Infrastructure” component,
as shown in FIG. 81.

Using the previously mentioned split “redistributable Rd-P-MCS” module embodiments for the scope of “charging while driving”, bi-partite and tri-partite, but not only, the detailed design showing the “Control Unit” (ECU) for each such embodiment could be shown in the figures FIG. 82, FIG. 83, FIG. 84, FIG. 85, and especially in FIG. 86.

The charging architecture in a Rd-P-MCS compatible participating EV vehicle having the scope of “charging while driving” with a split “redistributable Rd-P-MCS” module where the “Light redistributable Rd-P-MCS” module (aka “Rd-P-MCS Part #1”) is with the “Ultracapacitor” component and with the “Control and Monitoring” component, as shown in the immediately above paragraph, may be further refined in such a way that all the split components, e.g., the “Light redistributable Rd-P-MCS” component (set U), the Rd-P-MCS compatible participating electrical vehicle (EV) Infrastructure component (set V), and the <Adapter between the “Light redistributable Rd-P-MCS” module and “Rd-P-MCS compatible participating electrical vehicle (EV) Infrastructure”> component (set W) are connected together but also are connected with the “EV vehicle Battery (BEV)” by the following:
a. Vehicle Network bus,
b. Secure Vehicle Network bus,
c. DC bus,

as seen in the figures FIG. 84 and FIG. 85.

Based on the previously shown embodiments of the “redistributable Rd-P-MCS” connectivity to a vehicle and to its EV vehicle Battery (BEV) for the scope of “charging while driving”, the present invention disclosure provides the detailed architecture showing the “Electric Control Unit” (ECU) for each component, when the “Light redistributable Rd-P-MCS” module (aka “Rd-P-MCS Part #1”) is with the “Ultracapacitor” component and with the “Control and Monitoring” component, as shown in FIG. 86.

In FIG. 86 all the components of a split “redistributable Rd-P-MCS” module are connected to the DC bus, Vehicle Network bus, and Secure Vehicle Network bus, in order to communicate with each other, but also to communicate with the EV vehicle Battery (BEV) and with the Infotainment ECU.

The skilled in the art may devise a similar detailed architecture as the one provided in FIG. 86, architecture showing the “redistributable Rd-P-MCS” connectivity to a vehicle and to its EV vehicle Battery (BEV) for the scope of “charging while driving”, when the “Light redistributable Rd-P-MCS” module (aka “Rd-P-MCS Part #1”) is without the “Ultracapacitor” component and without the “Control and Monitoring” component.

When the architecture depicted in FIG. 86 is referred in relation with general aspects and/or use cases of the present invention disclosure then the same aspects and/or use cases are to be referred also in relation to the architecture embodiments depicted in figures FIG. 108, FIG. 109, FIG. 110, FIG. 111, and FIG. 112.

In the present invention disclosure, the “redistributable Rd-P-MCS” module and the complete “redistributable Rd-P-MCS” module may be used interchangeably,

The following may be true in relation with the architecture depicted in FIG. 86, but in relation with the architecture from figures FIG. 108, FIG. 109, FIG. 110, FIG. 111, and FIG. 112, see below:
a. The DC Bus ECU is connected to both the vehicle network and the secure vehicle network
b. The DC Bus Control Unit is connected to the DC Bus
c. The BEV Battery ECU is connected to both the vehicle network and the secure vehicle network
d. The BEV Battery is connected to the DC Bus
e. The “redistributable Rd-P-MCS” ECU is connected to both the vehicle network and the secure vehicle network
f. The “redistributable Rd-P-MCS” is connected to the DC Bus
g. The “Light redistributable Rd-P-MCS” ECU is connected to both the vehicle network and the secure vehicle network
h. The “Light redistributable Rd-P-MCS” is connected to the DC Bus
i. The Rd-P-MCS compatible participating EV Infrastructure ECU is connected to both the vehicle network and the secure vehicle network
j. The Rd-P-MCS compatible participating EV Infrastructure is connected to the DC Bus
k. The “redistributable Rd-P-MCS” may have geolocation tracking module (GPS)
l. The “redistributable Rd-P-MCS” may have a unique identity across a plurality of Driving Circuits, based on certificates, MAC addresses, but not only.

Any of the Control Units (ECUs) involved in the architecture depicted in FIG. 86, but also involved in the architecture from figures FIG. 108, FIG. 109, FIG. 110, FIG. 111, and FIG. 112, may have a battery, separate from the standard ECU power lines, that allows a failover power supply to such ECUs.

In the present invention disclosure, the “redistributable Rd-P-MCS” module and the fully functional “redistributable Rd-P-MCS” module may be used interchangeably,

The process of splitting a “redistributable Rd-P-MCS” module into the resulting components “Light redistributable Rd-P-MCS” module (aka “Rd-P-MCS Part #1”), the Rd-P-MCS compatible participating electrical vehicle (EV) Infrastructure component, and any other components resulted as part of the split design process, is called a “redistributable Rd-P-MCS split” action, a “Rd-P-MCS split” action, or a “split Rd-P-MCS” action.

An architecture and/or design that is obtained by performing a “Rd-P-MCS split” action on an initial architecture or design that uses a “redistributable Rd-P-MCS” module is called a “Rd-P-MCS split” architecture and/or design or a “split Rd-P-MCS” architecture and/or design.

FIG. 86, depicting a general architecture embodiment, shows that the “redistributable Rd-P-MCS” module, as a complete “redistributable Rd-P-MCS” module, or as a “Light redistributable Rd-P-MCS” module, alongside the other “Rd-P-MCS split” components, may connect to the DC Bus, to the Vehicle Network bus, and to the Secure Vehicle Network bus, just as the EV vehicle Battery (BEV), and the “Infotainment ECU” component are connected to such buses.

With this architecture, the operation, controlling, and the monitoring activities, including the “Health and Monitoring” component activities, the “Metering and Billing” component activities, of the “redistributable Rd-P-MCS” module may be performed via the “Infotainment ECU” component.

The connectivity of the “redistributable Rd-P-MCS”, as a complete “redistributable Rd-P-MCS” module, or as a “Light redistributable Rd-P-MCS” module, alongside the other “Rd-P-MCS split” components, may connect to the DC Bus, to the Vehicle Network bus, and to the Secure Vehicle Network bus, using a “redistributable Rd-P-MCS” Electric Control Unit (ECU) this way:
a. A single “redistributable Rd-P-MCS” ECU for all the component parts of a “Rd-P-MCS split”.
b. Multiple “redistributable Rd-P-MCS” ECU parts, one such ECU part for each of the components obtained after performing a “Rd-P-MCS split” action on the “redistributable Rd-P-MCS” module, such as the “Light redistributable Rd-P-MCS” module, the Rd-P-MCS compatible participating electrical vehicle (EV) Infrastructure component, and any other component resulted as part of the “Rd-P-MCS split” action.
c. A single “redistributable Rd-P-MCS” ECU for the (monolithic) fully functional “redistributable Rd-P-MCS”.

The skilled in the art may notice that the present invention disclosure could devise a multi-partition of the above components between the independent sets of a Multi-Graph, or “multi-partite graph”, with multiple independent sets modeling a plurality of Hardware and Software parts supporting the business method related to the implementation of the “redistributable Rd-P-MCS” module and the use case of “charging while driving”, for example, between the “Light redistributable Rd-P-MCS” module (set U), the “Rd-P-MCS compatible participating electrical vehicle (EV) Infrastructure” component (set V), as shown above in various embodiments, but also other additional component sets participating into the implementation of the “redistributable Rd-P-MCS” and other technical apparatus supporting the proposed business method.

The “redistributable Rd-P-MCS” module, as defined in the present disclosure, but also in any other embodiment described in this disclosure or in relation to any other embodiment compatible with the scope of the disclosure's technical invention and business method and its goal of “charging while driving” and/or “powering while driving”, has also the following features:
a. A circuitry that allows the “redistributable Rd-P-MCS” to be charged by any of the compatible Super Stationary Charging Stations (OFF GRID), and Super Mobile Charging Stations (ON GRID and/or OFF GRID),
b. A circuitry that allows the “redistributable Rd-P-MCS” to charge the EV vehicle Battery (BEV) during driving,
c. A circuitry that allows the “redistributable Rd-P-MCS” to power the Electric Motor to drive the EV vehicle while also charging the EV vehicle Battery (BEV) during driving,
The present invention disclosure “charging while driving” naming may also be used interchangeably with “powering while driving”, but also with “charging and powering while driving”.

Using an “Adapter” component between the “Light redistributable Rd-P-MCS” module and the Rd-P-MCS compatible participating electrical vehicle (EV) Infrastructure component resulted as part of a “Rd-P-MCS split” action, as depicted in the figures FIG. 78, FIG. 79, FIG. 80, FIG. 81, FIG. 82, FIG. 83, FIG. 84, FIG. 85, and in the diagrams from FIG. 86 and FIG. 87, allows improved inter-operativity between different standards, versions, embodiment designs, future embodiments, future art, but not only, of both the “Light redistributable Rd-P-MCS” and Rd-P-MCS compatible participating electrical vehicle (EV) Infrastructure component, but not only.

Whenever the invention apparatus implements and uses the “Light redistributable Rd-P-MCS” modules, all the compatible apparatus that interconnects with them, such as Rd-P-MCS compatible participating electrical vehicle (EV) vehicles, the charging mounting slots for the “Light redistributable Rd-P-MCS” modules from the Super Stationary Charging Stations (Super-SCS), from the Super Mobile Charging Stations (Super-MCS), from the Charging and Powering Architecture of Rd-P-MCS participating compatible EV vehicles, from the transportation mount slots of Certified Partner Service vehicles, but not only, then all such compatible apparatus present the design choices described in the presentation of the “Light redistributable Rd-P-MCS” module variants.

### Novel Charging and Powering Architecture for Rd-P-MCS Participating Compatible EV Vehicles Using the “Redistributable Rd-P-MCS” Modules—Including the “Light Redistributable Rd-P-MCS” Modules

The Electric Control Units (ECU) supports the “redistributable Rd-P-MCS” module(s) by controlling the flow of charging in both directions between the EV vehicle Battery (BEV) and the “redistributable Rd-P-MCS” module, one applicable use case being recharging a barely used “redistributable Rd-P-MCS” module to its full charge before returning it, thus allowing a cheaper option of operating the EV vehicle, the EV vehicle Battery (BEV) and the “redistributable Rd-P-MCS” module.

One may observe that even when a fully charged, or unused, “redistributable Rd-P-MCS” module is returned, the cost related to the used time in which the device was being kept away from other possible customers will still have to be paid.

However, since returning an energy depleted “redistributable Rd-P-MCS” module would require it to be recharged and therefore it is not available immediately for further renting, as opposed to the case of returning a fully charged “redistributable Rd-P-MCS” module, the cost for recharging a depleted “redistributable Rd-P-MCS” module should be additional to the cost related to the renting time of such a module.

Considering all the parts, components, modules and methods, but not only, that provide support for the present invention disclosure business method related to the usage of “redistributable Rd-P-MCS”, within the scope of operating and executing the present invention disclosure business method with its goals (long distance mobility, “charging and/or powering while driving”, eliminating the stationary recharging times, etcetera), then any SUBSET of such parts, components and modules, methods, that allows the operation of the business method, within its complete, full operation with full attainment of the disclosure's goals and optimal performance, but also within its partly implemented operation and with partly achieved or degraded disclosure goal, limited or suboptimal performance, is a part of the present invention disclosure.

The Rd-P-MCS compatible participating EV vehicles may allow the integration of “redistributable Rd-P-MCS” supporting apparatus with owners' unofficial “redistributable Rd-P-MCS” modules that are not part of the Driving Circuit, and therefore can be used only one time during a driving session.

Such modules may have or may not have the “Metering and Billing” feature and/or the “Transferring and Swapping” rental features.

Such modules may be charged overnight, but not only, at home or at Prior art private and public sharing stations, and may be used to allow additional driving mobility when used within a Driving Circuit or when traveling between two different Driving Circuits.

The Rd-P-MCS compatible participating EV vehicles may allow the integration of “redistributable Rd-P-MCS” supporting apparatus with owners' unofficial Prior art portable P-MCS modules adapted to work without the “Metering and Billing” feature and the “Transferring and Swapping” rental features, and therefore can be used only one time during a driving session.

Such Prior art portable P-MCS modules may be charged overnight, but not only, at home or at Prior art private and public charging stations, used to allow even more mobility when driving within a Driving Circuit or when traveling between two different Driving Circuits.

The status but also other information specific to the rented “redistributable Rd-P-MCS” module(s) should be able to be read from the module and displayed on the instrument cluster of the Rd-P-MCS compatible participating EV vehicles.

The topology of the “redistributable Rd-P-MCS” module(s), EV vehicle Battery (BEV), alongside any of the other active charging devices, should be able to be displayed on the instrument cluster corresponding to the “Infotainment ECU” of the Rd-P-MCS compatible participating EV vehicles, as shown in the FIG. 86.

The topology of the “redistributable Rd-P-MCS” module(s), EV vehicle Battery (BEV), alongside any of the other active charging devices, but also the Electric Motor, or the plurality of Electric Motors, should be able to be displayed on the instrument cluster corresponding to the “Infotainment ECU” of the Rd-P-MCS compatible participating EV vehicles, as shown in the figure FIG. 86.

The instrument cluster corresponding to the “Infotainment ECU” of the Rd-P-MCS compatible participating EV vehicles should be able to send request to the Driving Circuit Dispatcher for a future projected delivery of one or more “redistributable Rd-P-MCS” modules at a delivery point between two Recharging Stations that are separated by a longer distance than a single “redistributable Rd-P-MCS” module would be able to cover.

The order to the Dispatcher would be forwarded to a network of Certified Partner Service providers, that operate Certified Partner Service vehicles to service “redistributable Rd-P-MCS” modules to the Rd-P-MCS compatible participating EV vehicle that placed the dispatch order.

Secondary features of the “redistributable Rd-P-MCS” module, besides the Metering and Billing core features, include having a unique Identity, Geolocation functionality, etcetera, supporting a business method that allows driving indefinitely without recharging waiting times, using only Rd-P-MCS exchange and transfer times, as long as the driving plan is aligned with a driving circuit that provides enough Charging Stations with available charged “redistributable Rd-P-MCS” modules as described in the present disclosure.

The present disclosure has added the concept of “charge while driving” [UUID=084] and the concept of the “redistributable Rd-P-MCS” module compatible with both the Driving Circuit Participating EV vehicles and with the Charging Stations, in the embodiments described in the present disclosure, where the charge of the “redistributable Rd-P-MCS” module seeks, as much as possible, to be comparable with the EV Battery (BEV) charge.

The “redistributable Rd-P-MCS” module is similar with the Fossil fuel used by Prior art non-Electric standard vehicles, by partitioning raw electric energy and by providing a materialization and packaging of such electric energy partition (or portion) into such “redistributable Rd-P-MCS” modules viewed as Electric Energy units for “charging to go” similarly with storing fossil fuel in the current non-EV standard vehicles' fuel tanks.

The invention solves the Electric Vehicles' long-distance driving mobility problem which is a major reticence reason towards EV acceptance with the addition of a new charging device concept, e.g., the “redistributable Rd-P-MCS” module, with a new BEV charging architecture and with a new Electric Motor powering architecture that is both flexible and general and that supports the concept of charging while driving that is at the center of the present disclosure.

Participating compatible cars may be designed “a-priori” with at least one “redistributable Rd-P-MCS” module in mind and may have a new charging system architecture for the split “redistributable Rd-P-MCS” module depicted in FIG. 82, FIG. 83, FIG. 84, FIG. 85, and FIG. 86, but also in the general charging architecture that decouples the Electric Motor, or the plurality of Electric Motors, as seen in the figures FIG. 108, FIG. 109, FIG. 110, FIG. 111, and FIG. 112, but also with embodiments supporting the described behavior and business method goals. Using “redistributable Rd-P-MCS” modules with Prior art cars may not work without extensive adaptation.

The “redistributable Rd-P-MCS” module as described in the present disclosure is not owned by the EV vehicle customers but rather business owned as part of the Driving Circuit's Pool of such modules and used as a short-term rental for charging service, with some similitudes with the rented cars, complementing the Rd-P-MCS compatible participating EV vehicles that have a design and architecture involving a mix of owned components, acquired with the vehicle purchase transaction, and rented components such as the “redistributable Rd-P-MCS.

Regarding the similitudes with renting a whole EV vehicle, rather than recharging it with Prior art charging technologies or rather than renting a whole new other EV vehicle when the EV Battery (BEV) got discharged, the present disclosure shows renting and replacing only the portable “redistributable Rd-P-MCS” module that is used to charge the BEV while driving and possibly even powering the Electric Motor during its operation.

Despite the new charging architecture that supports a mix of owned and rented components, the Rd-P-MCS compatible participating EV vehicles are able to function without any rented components but without the functionality offered by the “redistributable Rd-P-MCS” module.

The present disclosure describes the operation of Rd-P-MCS compatible participating EV vehicles in the context where the “redistributable Rd-P-MCS” modules are rented products that are part of a business method. However, customer owned variants of the “redistributable Rd-P-MCS” module may be able to operate, albeit outside of the business method, with the charging architectures proposed as depicted in figures FIG. 82, FIG. 83, FIG. 84, FIG. 85, and FIG. 86, but also in the general charging architecture that decouples the Electric Motor, or the plurality of Electric Motors, as seen in the figures FIG. 108, FIG. 109, FIG. 110, FIG. 111, and FIG. 112.

### ESSENTIAL PARTS OF THE INVENTION

The invention defines a Participating Driving Circuit, or simply a Driving Circuit, that is mapped on high density driving routes such as highways, busy roads and major cities, extended to remote areas serviced based on request as described in the disclosure, consisting of a Pool of-Redistributable P-MS” may be charged at any of the plurality of Recharging Stations such as Stationary Portable Charging Stations (Super-SCS), Stationary Super Mobile Charging Stations (Super-MCS), driving Super Mobile Charging Stations (Super-MCS) with operations as described in disclosure, Power wall from home, Participating Certified Partner Services such as ADAC, AAA, as shown in disclosure), such “redistributable Rd-P-MCS” module being shared between participating compatible vehicles and being swapped between any pairs of Recharging Stations (Stationary Portable Charging Stations, Stationary Super Mobile Charging Stations (Super-MCS), Driving Super Mobile Charging Stations (Super-MCS) with operations as described in disclosure, Power wall from home, Participating Certified Partner Service vehicles from ADAC, AAA, etcetera, as shown in disclosure) involving at most one vehicle and at most one Stationary Portable Charging Stations (Super-SCS) in such swap, the Participating Driving Circuit having a pool of “Rd-P-MCS Dispatcher coordinator” entities (human and/or automated) to distribute “redistributable Rd-P-MCS” modules using Super Mobile Charging Stations (Super-MCS), Certified Participating Partners vehicles from ADAC, AAA, but not only, the Participating Driving Circuit having a Repair Auto Stations to repair the FAULTY redistributable Rd-P-MCS, Pool of standby NEW and/or REPAIRED.

The invention defines the “redistributable Rd-P-MCS” modules that are READY to be introduced into the Driving Circuit when needed, hardware and software to implement and to support the above and the business method and a pool of Super Mobile Charging Stations (Super-MCS) and Participating Certified Partner Service vehicles that are distributing “redistributable Rd-P-MCS” modules between Recharging Stations, responding and delivering to requests from participating drivers/compatible cars, removing faulty “redistributable Rd-P-MCS” modules from the Circuit Pool of such devices, adding WORKING (NEW and/or REPAIRED) “redistributable Rd-P-MCS” modules into the Circuit Pool of such devices, hardware and software to monitor the health of the participating “redistributable Rd-P-MCS” modules and the status of such devices, to monitor the needs for “redistributable Rd-P-MCS” modules at Charging Stations, methods and apparatus for metering, billing and payment, participating certified Payment Entities such as VISA, MasterCard, etcetera, the participating compatible vehicles may have an Infotainment System to monitor and control the active “redistributable Rd-P-MCS” (full or partial) participating to the charging architecture system as in FIG. 86, and in figures FIG. 108, FIG. 109, FIG. 110, FIG. 111, and FIG. 112, please note that Regulators stand also for DC/DC converters.

The invention defines a rental method of “redistributable Rd-P-MCS” modules define a transaction that takes place between a “starting Recharge Station” and a “destination Recharge Station” with effect to metering, billing, and payment.

Billing requires two locations: starting (pick-up location) and ending (drop-off location).

As opposed to renting a vehicle, the invention renting of a “redistributable Rd-P-MCS” module is open ended, as opposed to the renting of a vehicle, in order to allow flexibility in returning the module to the pool of “redistributable Rd-P-MCS” modules available in the driving circuit for the rest of the subscribed drivers.—claim

The invention Electric Motor may avoid being charged directly only from BEV but also from other charging devices, see the architecture from figures FIG. 108, FIG. 109, FIG. 110, FIG. 111, and FIG. 112, but not only, while State of art is BEV that is charged stationary—there is no access to the Electrical Motor with bypassing the BEV by a Rd-P-MCS.

Even when the Electric Motor is still charged directly from BEV, or other Charging device such as the “redistributable Rd-P-MCS” module, the BEV may still be charged from DC Bus or other Charging devices such as “redistributable Rd-P-MCS” module(s), but not only.

The DC bus can be maintained/charged with a variety of charging technologies: Prior art BESS, Electrical Vehicle Battery (BEV), “redistributable Rd-P-MCS” module, Prior art Mobile Charging Station, Super Mobile Charging Station (Super-MCS), Super Stationary Charging Station.

The invention Electrical Motor is decoupled from the Electrical Vehicle Battery (BEV), thus being connected to a DC Bus and supporting circuitry (including a plurality of ECUs—see the figure FIG. 86, and FIG. 87, and figures FIG. 108, FIG. 109, FIG. 110, FIG. 111, and FIG. 112.

All invention charging entities may contribute at the same time to the DC Bus and its “charge reservoir” (Capacitor) to which the BEV is connected, but there is also the need of the availability of the use case when BEV is also charged while driving in order to minimize the rental time of “redistributable Rd-P-MCS” module and therefore to minimize the rental price.

The mobility of such compatible participating cars is defined by the charge of its “BEV and rented Rd-P-MCS modules. Charging is asynchronous between car needing “redistributable Rd-P-MCS” module(s) and Super Mobile Charging Stations (Super-MCS), because the “redistributable Rd-P-MCS” module is transportable. The synchronous re-charge is happening only between Super Mobile Charging Stations (Super-MCS) and its mounted “redistributable Rd-P-MCS” modules while driving.

The “redistributable Rd-P-MCS” module becomes the unit of “fueling” the new Rd-P-MCS compatible participating EV vehicles.

Metering and Billing modules/circuits could be part of the “redistributable Rd-P-MCS” module which gives flexibility and more independence from the design and implementation of the Charging Stations (Super Stationary Charging Stations and/or Super Mobile Charging Stations), but the Metering (and) Billing could be split between the Rd-P-MCS and one or more Charging Stations (Stationary and/or Super Mobile Charging Stations), e.g., the Start Charging Stations (where the pick-up happens) and the Stop Charging Station (where the drop-off happens), including in an exclusive matter with a global distributed systems and databases that register, monitor and search/find such open transactions (including partial active transactions) from any such participating Charging Stations—this way a transaction may be handled by multiple Charging Stations.

Because the “redistributable Rd-P-MCS” module may be used by several times during the same day by different EV vehicles, the “redistributable Rd-P-MCS” module needs to give an assurance of performance (both mobility and range) in order to empower the drivers' driving plans that they could count on a Guarantee MINIMUM performance.

The Super Mobile Charging Station can charge during driving its array of mounted “redistributable Rd-P-MCS” modules used as partitioned and packed energy that it intends to redistribute Rd-P-MCS modules, to reach the full performance potential, to optimize the “redistributable Rd-P-MCS” module availability, and to minimize the stationary charging waiting time.

Because exchanging a “redistributable Rd-P-MCS” module between a Rd-P-MCS compatible participating EV vehicle and a Super Mobile Charging Station takes a short time, the Super Mobile Charging Station becomes more efficient when called by EV vehicles needing a “redistributable Rd-P-MCS” module: the Super Mobile Charging Station just drops-off a “redistributable Rd-P-MCS” module and then it goes to service other dispatch orders.

The “redistributable Rd-P-MCS” could be delivered (specifically reserved/bound to the driver to pick-up it up) even in absentia to certified participating businesses, such as EDEKA, Aldi, Gas/Fuel Stations, but also Auto Service units, without any limitation, between the Super Mobile Charging Stations, Certified Partner Service vehicles, and Rd-P-MCS compatible participating EV vehicles, see figures FIG. 100, FIG. 101, FIG. 102, FIG. 103, FIG. 104, and FIG. 105.

The time between the drop-off and the pick-up, as described above, is considered to be included in the rental time, discouraging thus the drivers to be late on the “redistributable Rd-P-MCS” module pick-up location and time, with the end result of increasing the availability of the “redistributable Rd-P-MCS” modules in the Driving Circuit.

A “redistributable Rd-P-MCS” module may be self-contained with respect to supporting the “charging while driving” invention goal when using fully functional “redistributable Rd-P-MCS” module, also called complete “redistributable Rd-P-MCS” module.

The same “charging while driving” invention goal could be attained using a bipartite or a multi-partite “redistributable Rd-P-MCS” module split shown in figures FIG. 78, FIG. 79, FIG. 80, FIG. 81, FIG. 82, FIG. 83, FIG. 84, FIG. 85, and in the diagrams from FIG. 86 and FIG. 87.

The present invention disclosure adds the concept of ordering a “charging service in the future and at a certain location”, such that with the support of the Infotainment System (or other) one could plan and order a “redistributable Rd-P-MCS” module rental in the future to a location and time that could be brought to the future rental location by a Super Mobile Charging Station vehicle, or a Certified Partner Service vehicle.

In order to extend the mobility when driving in remote areas, such a “redistributable Rd-P-MCS” module may be dropped-off to certified participating local businesses such as EDEKA, Aldi, Gas and/or Fuel Stations, Auto Service units, but not only, from where they can be picked-up later without making the delivery entities to wait for the Rd-P-MCS compatible participating EV vehicle.

The Rd-P-MCS compatible participating EV vehicle may use Navigation System to compute the future needs such as picking-up, exchanging/swapping, or dropping-off at least a “redistributable Rd-P-MCS” modules alongside an established driving plan, being either alongside a highway with participating charging stations but also for forward looking service locations needed in areas where there is no coverage with Super Stationary Charging Station.

In such cases, it is useful to order in advance, at a future predetermined location and at a future time, a “redistributable Rd-P-MCS” module that can be delivered by a Super Mobile Charging Station, or by a Certified Partner Service vehicle, directly or through a participating local business certified as Rd-P-MCS Asynchronous Exchange Market as depicted in figures FIG. 100, FIG. 101, FIG. 102, FIG. 103, FIG. 104, and FIG. 105.

The Navigation System which is aware of Driving Circuit, the apparatus and the business method, will automatically propose dispatch orders for delivery of needed “redistributable Rd-P-MCS” modules at specific locations at a future time of such delivery.

If the driving plan includes an area from where the distance to the next Super Stationary Charging Station, or to the next ON-GRID Stationary Mobile Charging Station, then the driver might consider renting more than a “redistributable Rd-P-MCS” module in order to replace the eventually discharged “redistributable Rd-P-MCS” modules along the way before reaching an area serviced by Super Stationary Charging Stations, or to the next ON-GRID Stationary Mobile Charging Stations.

In the case described above, the Rd-P-MCS compatible participating EV vehicle may have at any time:
a) A set of connected and operating “redistributable Rd-P-MCS” modules,
b) A set of used and discharged “redistributable Rd-P-MCS” modules
c) A set of unused and fully charged “redistributable Rd-P-MCS” modules.

In situations when the driver of the Rd-P-MCS compatible participating EV vehicle rents more than a “redistributable Rd-P-MCS” module, if the number of such rented modules is N, then the cost of using all such N “redistributable Rd-P-MCS” modules when dropping-off all of them at the same time, after all such modules have been used entirely, is (N−1) multiplied with the cost of using only one “redistributable Rd-P-MCS” module at a time, and stopping for an exchange after each such module was used and discharged, for a trip leg lasting a total distance is equal with the N multiplied the distance covered by using only one “redistributable Rd-P-MCS” module.

Using the above analysis, if the customer rents three (3) “redistributable Rd-P-MCS” modules at once for a trip leg of a distance equal to three (3) times the distance covered by using only one “redistributable Rd-P-MCS” module, such customer would be charged (3−1)=2 time more than in the case where the customer would have stopped every time after the only one rented “redistributable Rd-P-MCS” module's energy was depleted for the same trip distance.

Penalizing customers for retaining away from other potential customers such “redistributable Rd-P-MCS” modules that are not actively used all the rental time during the trip leg is a rental policy of the payment method that incentives the customers to be active in returning such modules back into the Driving Circuit operation as soon as possible.

The abuse of the business method provided with the present invention disclosure is self-regulated by the price of renting and not using such a fully charged “redistributable Rd-P-MCS” module.

Because the Rd-P-MCS compatible participating EV vehicles that are using the present invention disclosure business method are using both the EV Battery (BEV) and the “redistributable Rd-P-MCS” module(s) to power the Electric Engine, the following may hold:
1. The EV Battery (BEV) component may be decreased in size, thus providing lighter and more nimble EV vehicles,
2. The Rd-P-MCS compatible participating EV vehicles may have better energy consumption per distance than Prior art.
3. The Rd-P-MCS compatible participating EV vehicles may create a balance between the EV Battery (BEV) and the “redistributable Rd-P-MCS” module(s), both in terms of size and in terms of charged energy contributing to the engine operation while driving.
4. The “redistributable Rd-P-MCS” module technology may evolve while being backwards compatible with the mechanical and electrical interfaces, but not only, with the Rd-P-MCS compatible participating EV vehicles

However, if the charge of a “redistributable Rd-P-MCS” module is several times less that the charge of the EV Battery (BEV), then using all such multiple “redistributable Rd-P-MCS” modules to charge BEV during driving may bring mitigation to the overcharging seen above.

In the present invention disclosure, the “redistributable Rd-P-MCS” module may hold a charging amount that may vary from a fraction of the EV vehicle Battery's charge to a full EV vehicle Battery's charge.

Considering the above, the mobility of the Rd-P-MCS compatible participating EV vehicles depends on the total charge provided by the initial charge of the EV Battery (BEV) and the total charge of the rented “redistributable Rd-P-MCS” modules.

The present invention disclosure uses a portable and rentable available “redistributable Rd-P-MCS”.

The present invention disclosure presents, independently from Prior art, the concept of a “redistributable Rd-P-MCS” module based on the concept of “packaging energy into detachable Rd-P-MCS modules” for “commercial re-distribution” of such Rd-P-MCS modules for “charging the Electrical Vehicle Battery (BEV) while driving”.

The present invention disclosure adds the following concepts:
a) charging during driving,
b) a “redistributable Rd-P-MCS” module capable to charge a partial or a full BEV charge as opposed to being just a “portable rescue power bank”,
c) continue driving without stopping for charging but rather swapping standard “redistributable Rd-P-MCS” modules,
d) avoiding recharge wait times,
e) adding metering and billing to the “redistributable Rd-P-MCS” module, but not only, which can also be split between the start and end of the rental Recharge Stations alongside a distributed software/database and multiple/bipartite and/or multi-partite GPS devices, f) cars designed with Rd-P-MCS in mind, see figures FIG. 108, FIG. 109, FIG. 110, FIG. 111, and FIG. 112.

The access of the participating vehicle's driver to the “redistributable Rd-P-MCS” modules when swapping them is “direct access” as opposed with the “sequential access” characteristic to a queue of EV vehicles waiting to obtain a spot to charge synchronously or to swap the whole prior art BEV battery hence almost instantaneous if using a self-serving “Recharging Station” or there are less (fewer) waiting vehicles than the employees.

Multiple cars may swap their “redistributable Rd-P-MCS” module(s) at the same time with the same Recharging Station. The swapping and the access allow also concurrent swapping.

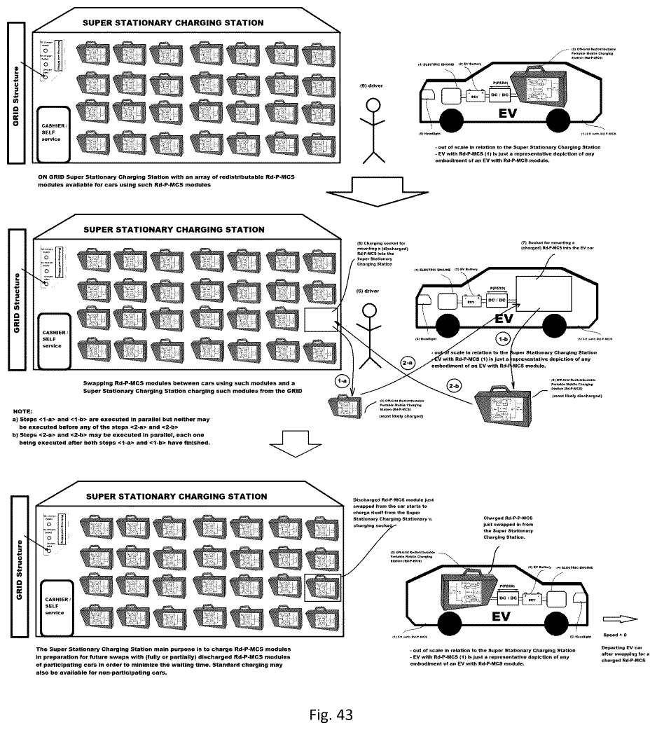

The FIG. 43 from the present invention disclosure shows how the “redistributable Rd-P-MCS” module swapping process takes place in the case of a Super Stationary Charging Station (Super-SCS) that manages an array of “redistributable Rd-P-MCS” modules.

The present invention disclosure shows in FIG. 43 the swapping/exchanging process for “redistributable Rd-P-MCS” modules between an EV vehicle and a Super Stationary Charging Station (Super-SCS).

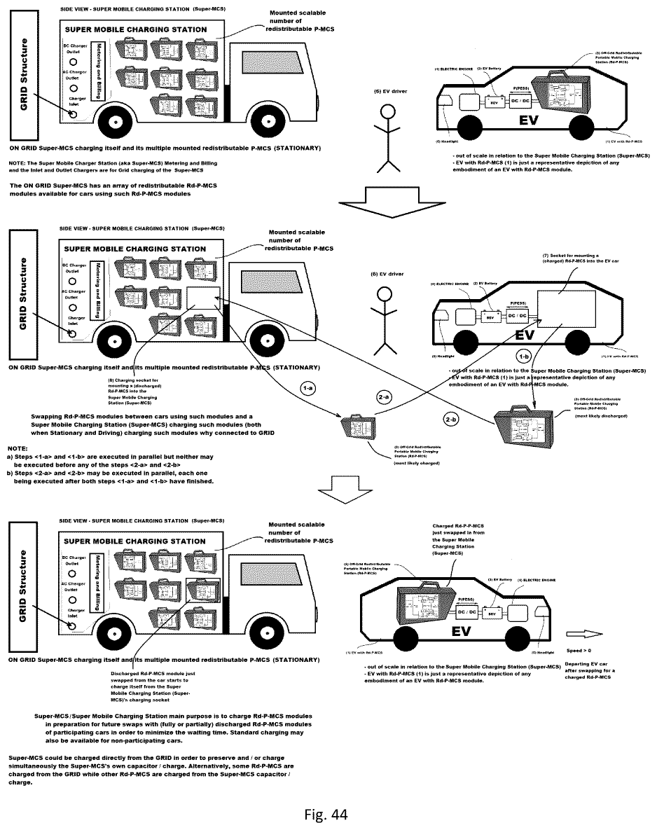

The present invention disclosure shows in FIG. 44 the swapping/exchanging process for “redistributable Rd-P-MCS” modules between an EV vehicle and an ON-GRID Super Mobile Charging Station (Super-MCS).

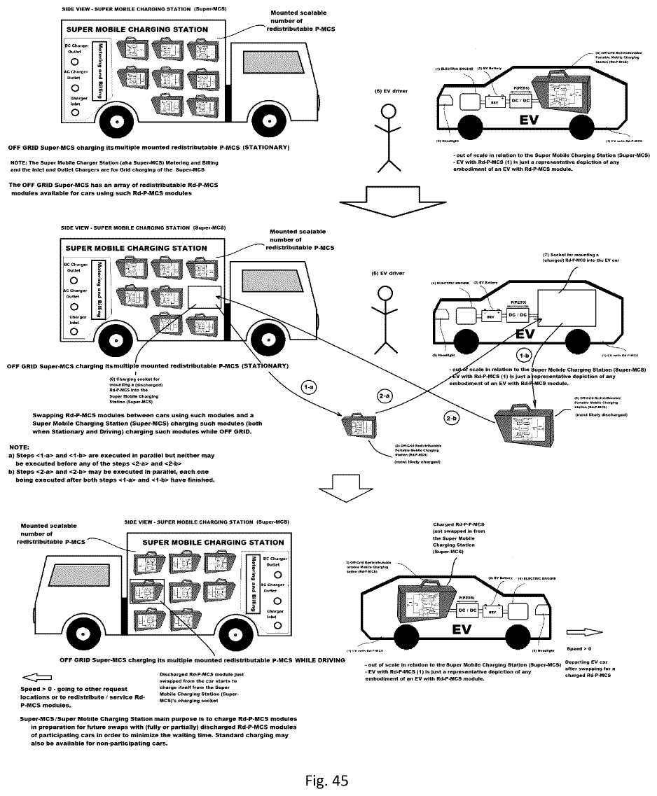

The present invention disclosure shows in FIG. 45 the swapping/exchanging process for “redistributable Rd-P-MCS” modules between an EV vehicle and an OFF-GRID Super Mobile Charging Station (Super-MCS).

If a Super Stationary Charging Station has a queue of multiple cars that need to be serviced C₁, C₂, . . . , C_{N}, each with its own “redistributable Rd-P-MCS” module swapping time SwT₁(C₁), SwT₂(C₂), . . . , SwTᵢ(Cᵢ), . . . , SwT_{N}(C_{N}), respectively, then for any such car Cᵢ, considering that all these cars are in the same location with the Super Stationary Charging Station, then the total wait recharging time aka the total Swapping Time for a car Cᵢ, for any integer i from 1 to N, e.g., the time that car Cᵢ needs to wait until it can travel again is:
Waiting-Recharging-Swapping-Time (C₁)=SwT₁(C₁)+SwT₂(C₂)+ . . . +SwTᵢ(Cᵢ)=(Σ_{k=1 to I}SwTₖ(Cₖ))~0 if SwTₖ(Cₖ)==0, for all k from 1 to i.

Please note that the recharging time is zero for any such car Cᵢ, because there are involved only swapping actions with the “redistributable Rd-P-MCS” modules.

If a Super Mobile Charging Station has a queue of multiple cars that need to be serviced C₁, C₂, . . . , C_{N}, each with its own “redistributable Rd-P-MCS” module swapping time SwT₁(C₁), SwT₂(C₂), . . . , SwTᵢ(Cᵢ), . . . , SwT_{N}(C_{N}), respectively, then for any such car Cᵢ, considering that all these cars are in the same location with the Super Mobile Charging Station, then the total wait recharging time aka the total Swapping Time for a car Cᵢ, for any integer i from 1 to N, e.g., the time that car Cᵢ needs to wait until it can travel again is:
Waiting-Recharging-Swapping-Time (C₁)=SwT₁(C₁)+SwT₂(C₂)+ . . . +SwTᵢ(Cᵢ)=(Σ_{k=1 to I}SwTₖ(Cₖ))~0 if SwTₖ(Cₖ)==0, for all k from 1 to i.

Please note the recharging time is zero for any such car Cᵢ, since there are involved only swap actions with the “redistributable Rd-P-MCS” modules.

The performance model proposed by the present invention disclosure apparatus and business method using a closed loop with enough Recharging Stations and enough loop length that leaving a depleted “redistributable Rd-P-MCS” module at a participating Recharge Station will find it fully charged when arriving at the same Recharge Station after one full loop.

Simply renting a Prior art P-MCS device is not enough, you need a network of supporting Recharging Stations (in all forms) such that the participating cars can have a series of “redistributable Rd-P-MCS” module swaps.

The business method from the disclosure uses short term rental of mostly a few hours of driving, the goal would be to optimize (instead of wasting) the time when the Rd-P-MCS is aways from the qualified locations where it can be used further by other cars.

The invention provides Rd-P-MCS participating compatible EV vehicles embodiments that have parts that are optional, exchangeable and rentable with the name of “redistribution Rd-P-MCS” modules that are certified to be subjected to meeting minimum quality parameters.

The business method from the disclosure uses the “redistributable Rd-P-MCS” modules just like one would fill fossil fuel into the tank of a fuel driven car.

The invention embodiments use the “redistributable Rd-P-MCS” modules to drive Rd-P-MCS participating compatible EV vehicles just as you would get fuel/gas to drive your gas driven vehicle.

Please note that using the “redistributable Rd-P-MCS” module does not mean that they are always swapped/exchanged, because you may also pick-up, and drop-off such “redistributable Rd-P-MCS” modules.

Spare owned after-market Rd-P-MCS module could be charged from “redistributable Rd-P-MCS” modules.

A “redistributable Rd-P-MCS” module may be rented fully charged (or if it is rented partially charged it needs to show the remaining charge so that the driver may evaluate the usefulness of renting—this use case being less useful if it will shorten the charging lifetime).

Pool of “redistributable Rd-P-MCS” modules in driving circuits, defined based on stationary recharging at ON-GRID Super Stationary Charging Stations (Super-SCS), dynamic charging in Super Mobile Charging Stations (Super-MCS), Super Mobile Charging Station (Super-MCS) with the infrastructure with BESS just as the stationary (ON-GRID) Recharging Stations.

The “redistributable Rd-P-MCS” modules are “shared” by multiple cars in short periods of time on various driving paths used by the lenders.

Note that how the “redistributable Rd-P-MCS” modules are redistributed in a good valid business method way.

The “redistributable Rd-P-MCS” modules are partitioned units of electrical charge when time is of essence or desired extending thus the active life of the driver, e.g., the driver has the option to save the Prior art charging time and use it for purposes that are considered more important.

The “redistributable Rd-P-MCS” modules may be serviced even in remote areas, extending the mobility and the range of the subscribed compatible cars, e.g., the Rd-P-MCS compatible participating EV vehicles.

Rather than charging the BEV with energy as in Prior art, the renting of a “redistributable Rd-P-MCS” module is similar with buying energy that is packed and amendable to be taken away for charge while driving, with the rented “redistributable Rd-P-MCS” module being amenable to be swapped with another rented “redistributable Rd-P-MCS” module.

The cost of a “redistributable Rd-P-MCS” module could be very high, see the reference to the reference to the high-performance battery packs used in Formula E that are rated for several hundred kWh, but such cost may be balanced and amortized by the rental of such “redistributable Rd-P-MCS” module in a participating business method—which could be franchised and/or licensed.

Prior art charging stations owned by Tesla, but not only, are where current cars are coming to charge stationary and synchronously their BEV batteries before continuing their trip, while the invention “redistributable Rd-P-MCS” modules are just swapped.

Prior art MCS charging trucks that come to an EV in need to re-charge, could serve recharging maximum two (2) cars at the same time, using a synchronous stationary charging, while in the invention Super Mobile Charging Stations (Super-MCS) delivering a plurality of “redistributable Rd-P-MCS” modules may need to stop just for a minute to distribute such a “redistributable Rd-P-MCS” module and then go to serve in short time another Rd-P-MCS compatible participating EV vehicle in need, optimizing the serving and waiting times.

One skilled in the art may note that rather than the Prior art EV vehicle waiting for a stationary charging of raw energy needed by the EV vehicle to continue its long-distance trip into EV vehicle's internal energy storage components, the business method provided by the present disclosure makes available to the Rd-P-MCS compatible participating EV cars the already charged and pre-packaged units of electrical energy embodied by the “redistributable Rd-P-MCS” modules.

ALL “charge while driving” for both the cars and the actively redistributed “redistributable Rd-P-MCS” modules themselves, use the concept of “charge while driving” across all use cases of the business method, including when a new “redistributable Rd-P-MCS” module enters the Driving Circuit pool of “redistributable Rd-P-MCS” modules when driven and transported by a Super Mobile Charging Stations (Super-MCS).

The “redistributable Rd-P-MCS” module “travels” with the car so that the “synchronous” part of charging from “redistributable Rd-P-MCS” modules connected to the EV car through its internal charging adapters is happening during driving, thus avoiding stationary charging waiting times.

The rental transactions involving “redistributable Rd-P-MCS” modules have their start/pick-up and end/drop-off locations are (mostly) different which empowers the business method. However, such condition it is not a requirement.

Because the traveled distance may be more than the direct distance between the transition end points (like driving back and forth between the endpoints), a metering system could be provided for both traveled distance and rental time with the latter counting how much time a rented “redistributable Rd-P-MCS” module cannot be used by other drivers. The traveled distance metering is less important.

The Dispatcher may run a monitoring the status of all entities involved in the Participating Driving Circuit and this includes, without an exhaustive enumeration the following:
a. Health of the charging stations such as the Super Stationary Charging Stations (Super-SCS), Super Mobile Charging Stations (Super-MCS), but not only.
b. Health of the recharging slots and their components from any of the charging stations such as the Super Stationary Charging Stations (Super-SCS), Super Mobile Charging Stations (Super-MCS), but not only.
c. Health of any of the “redistributable Rd-P-MCS” module that is mounted to any of the charging stations such as Super Stationary Charging Stations (Super-SCS), Super Mobile Charging Stations (Super-MCS), but not only.

The use of the existing available automotive clubs to supplement the availability of “redistributable Rd-P-MCS” modules in remote areas, etcetera, with already available scalable commercial infrastructure and processes, may allow a faster growth and the scalability of the business method.

The “redistributable Rd-P-MCS” module provides a scalable and distributed solution to the recharging problem even without the “charge while driving”.

The invention “Charge while driving” concept optimizes time, when the “redistributable Rd-P-MCS” modules are charged during the redistribution driving by Super Mobile Charging Stations (Super-MCS), reduces the necessary size of the pool of “redistributable Rd-P-MCS” modules because they are used more efficiently, thus reducing also the cost of operating the business method.

The invention “Charge while driving” concept saves time of the EV drivers and improves the acceptance of the new technology, solving the long-distance travel problem.

The invention allows a low cost of starting a francize that implements the invention business method due to the flexibility of the charging stations that do not need Prior art charging stations.

The most important need of the invention is the availability of the Electrical Grid Infrastructure that would power the ON-GRID Super Stationary Charging Stations (Super-SCS), the ON-GRID Super Mobile Charging Stations (Super-MCS), not only.

The driver of a Rd-P-MCS participating compatible EV vehicle that needs to recharge may see the participating charging stations, such as Super Stationary Charging Stations (Super-SCS), the Super Mobile Charging Stations (Super-MCS), Certified Partner Stations, but not only, and the availability of the “redistributable Rd-P-MCS” modules with their pricing options.

The Super Stationary Charging Stations are ON-GRID, the Super Mobile Charging Stations may be both ON-GRID and OFF-GRID, while the “redistributable Rd-P-MCS” modules may be transported while charging and powering the BEV according to the figures FIG. 108, FIG. 109, FIG. 110, FIG. 111, and FIG. 112, or while being charged itself in a Super Mobile Charging Station, or while being charged stationary (ON-GRID) while mounted to a Super Stationary Charging Station.

The “charging while driving” concept may also mean “charging BEV while driving”, “powering a driving EV”, “powering EV and charging BEV”, “powering BEV”, but not only, without excluding “charging BEV with stationary EV” from the implemented features of the Rd-P-MCS compatible and participating and EV vehicle.

Using “redistributable Rd-P-MCS” modules that are uniquely Identifiable and distributed data bases operating all the entities that are part of the apparatus and business method, the present disclosure does not allow the introduction of or non-certified “redistributable Rd-P-MCS” modules into the circuit and its Pool of “redistributable Rd-P-MCS” modules in order to guarantee a minimum standard for the operating parameters, thus maintaining the Health, Safety and Efficiency of the Pool of “redistributable Rd-P-MCS” modules.

The Transparency with respect of the availability of the “redistributable Rd-P-MCS” modules, including pricing wise, along the driving trip plans, allows the car system may plan brief stops for renting such “redistributable Rd-P-MCS” modules in order to automate the support for the driver.

Another Comparison with Prior Art, Essential Components and Invention Performance Metrics

Current state of the art in charging an EV vehicle using portable charging devices is limited in multiple ways: such portable charging devices are thought to be used in emergency only situations where the limited charge of such portable P-MCS charging modules is supposed to allow the EV vehicle reach a standard Prior art charging station.

Apart from the present invention disclosure, if a portable ESS module is used inside the EV vehicle it cannot be charged while driving as in the present invention disclosure.

Briefly, the Prior art with respect to portable P-MCS charging devices has the following characteristics:
a) The charging is using a limited charge, as opposed to the present invention disclosure where a “redistributable Rd-P-MCS” module may hold a charge of up to hundreds of KWh.
b) The Prior art portable P-MCS charging device is externally positioned in relation to the EV vehicle when it is charging the vehicle.
c) The Prior art EV vehicle in need of recharge is stationary while being charged by a state-of-the-art P-MCS emergency charging module, wherever for the present invention disclosure the recharge takes place during driving.
d) The Prior art portable P-MCS charging device is used in emergency situations only and not as a business method that gives assurances with regard to the service availability of (re)charging the EV vehicle
e) The Prior art portable P-MCS charging device is used in emergency situations and not as a business method that gives assurances with regard to the performance of the service of (re)charging the EV vehicle, with respect to the waiting time while stationary and with respect to how many times can recharge, or how much distance the EV vehicle can cover during such recharges, with the EV vehicle avoiding any significant stationary recharge waiting time.
f) The Prior art portable P-MCS charging device has no associated business method that would guarantee a reasonable performance nor that it would guarantee to avoid the degradation of such performance in time.
g) The Prior art service of charging is stationary and with significant waiting time.
h) The Prior art performance, e.g. stationary waiting time, but not only, is strongly if not entirely, by the speed of the charging the EV vehicle from a Prior art charging station, as opposed to the present invention disclosure method and apparatus where the performance is improved, to an optimal level nonetheless, regardless of the speed of the charging.
i) The Prior art Mobile Charging Station (MCS) can charge only at most two vehicles and it is stationary for the whole duration of the charging before the MCS can go and service other EV vehicles in need to be recharged.
j) The Prior art EV vehicles are sold with all their components fully owned by the vehicle owner while the present invention disclosure uses a portable, rentable, “redistributable Rd-P-MCS” module which is not owned by the EV vehicle owner and/or driver.
   While one can still own a portable, redistributable Rd-P-MCS module, the extend of the performance improvement is limited, in time and distance covered, if not using rentable Rd-P-MCS for short periods of times after which the driver is forced to relinquish/drop-off to another charging station after using its charge.
k) The Prior art EV vehicles are using either unpacked electric charge from standard charging stations using an external charging cable or with a limited usefulness a prior-art P-MCS emergency module.
l) The Prior art EV vehicles' business method is to charge in stationary mode and pay for the service before driving again, while the present invention disclosure uses the concept of charging during driving and the payment method that starts when a “redistributable Rd-P-MCS” module is picked up and/or swapped from an invention disclosure Charging Station and that ends when the Rd-P-MCS module is dropped-off and/or swapped with another Rd-P-MCS module.
m) With the exception of the prior-art Mobile Charging Stations (MCS) which have their limitations with respect to high scale charging requests, the state-of-the-art Charging Stations network is static, as opposed to the present invention disclosure where at least a part of the Charging Stations, see the Super Mobile Charging Stations (Super-MCS) and the Certified Partner Service vehicles are dynamic with respect to their location.
n) With the exception of the prior-art Mobile Charging Stations (MCS) which have their limitations with respect to high scale charging requests, the state-of-the-art Charging Stations network is static, as opposed to the present invention disclosure where the “redistributable Rd-P-MCS” module are moving continuously in order to maintain the performance guarantees.
o) The Prior art EV vehicles' Electric Motor, or the plurality of Electric Motors, are connected directly to the EV Battery (BEV), while the represent invention disclosure proposes the decoupling of the Electric Motor, or the plurality of Electric Motors, in the EV vehicle to be powered on from a plurality of charging devices, such as BEV, Rd-P-MCS, “Light Rd-P-MCS” as part of the “Split Rd-P-MCS” design, see the architectures from FIG. 86, and from figures FIG. 108, FIG. 109, FIG. 110, FIG. 111, and FIG. 112, in its multiple embodiments.

The present invention disclosure leads to the following observations:
1) No Prior art technical product and/or business methods can work with the present invention disclosure described performance with:
   a. the total driving time of a trip much longer that the range of the BEV,
   b. the no recharge waiting time from departure to destination with the present invention disclosure method and apparatus,
   c. the readiness waiting time from call to the present invention disclosure's Super Mobile Charging Stations as compared to readiness waiting time in the case of the Prior art Mobile Charging Station (MCS),
   d. the flexibility of using Mobile Charging Station (MCS) as Recharging Stations but without a big initial investment other than the cost of the Super Mobile Charging Stations (Super-MCS) and its “redistributable Rd-P-MCS” modules, participating cars' adaptations into embodiments of the Rd-P-MCS compatible participating EV vehicles, as well as the normal business costs)
2) No Prior art technical product and/or business methods can work can attain the present invention disclosure performance without using the added to the present invention disclosure concept of “redistributable Rd-P-MCS” module with “Metering and Billing” functionality added to the “redistributable Rd-P-MCS” module(s).

The concept of easy swapping “redistributable Rd-P-MCS” modules as opposed to the Prior art from Nio BEV Battery Swapping method:
a. The battery (EV BEV) swapping from Nio is complex and involved the BEV, the present invention disclosure is related to swapping the “redistributable Rd-P-MCS” which is portable and that does not require complex processes for swapping.
b. The battery (EV BEV) swapping from Nio does not take in consideration the commercial aspect of swapping “redistributable Rd-P-MCS” that may be used by multiple EV vehicles during the same day.
c. The battery (EV BEV) swapping from Nio does not have all the features that are available to the “redistributable Rd-P-MCS” module proposed in the present disclosure.
d. The battery (EV BEV) swapping from Nio does not change the design of the standard EV that uses a BEV to run the Electrical Engine.

A valid and operational business method that is better than Nio's BEV swapping method, also the existence of the Nio's swapping method patents shows that the present invention disclosure “redistributable Rd-P-MCS” module and its supporting business method is patentable, valuable and with a differentiating factor.

A “business method” in support of the claims previously asserted which is allowed to be patented and to provide a strategic advantage against the competition and its/their cars.

The present invention disclosure claims that when removing any of the main components of the present invention disclosure technical apparatus, e.g.,
a. ANY of the compatible Recharging Stations (in all its embodiments, e.g., Super Stationary Rechargeable Station, Super Mobile Charging Station (Super-MCS), and Certified Partner Service vehicle, but not only), OR
b. ANY of the vehicles (Super Mobile Charging Stations, and/Certified Partner Service vehicles, that transport the “redistributable Rd-P-MCS” modules to Recharging Stations of compatible cars in need, but not only, OR
c. The concept of “charging by driving”, OR
d. The concept of the “redistributable Rd-P-MCS” module with “metering and billing component” to allow “charging by driving”, OR
e. ANY of the Rd-P-MCS compatible participating EV vehicles that allow the use of the “redistributable Rd-P-MCS” module(s) for “charging while driving”,
then, the present invention disclosure solution and the present invention disclosure performance as described in this disclosure cannot be replicated and/or surpassed.

The immediate above claim alongside with the fact that the present invention disclosure performance cannot be replicated by Prior art, are proof that the present invention disclosure is novel with respect to the Prior art.

The present invention disclosure's proposed technical apparatus allows a Rd-P-MCS compatible participating electrical vehicle (EV) to drive indefinitely as long as the driving plan is aligned with a circuit that provides enough Recharging Stations and enough “redistributable Rd-P-MCS” modules.

The present invention disclosure's proposed technical apparatus allows an electrical vehicle (EV) to drive indefinitely as long as the driving plan is aligned with a circuit that provides enough Recharging Stations.

The present invention disclosure represents both a “technical apparatus” (named the “technology”) and a “business method” that is novel from a technical perspective, but also from the resulted performance point of view to Rd-P-MCS compatible participating EV vehicles.

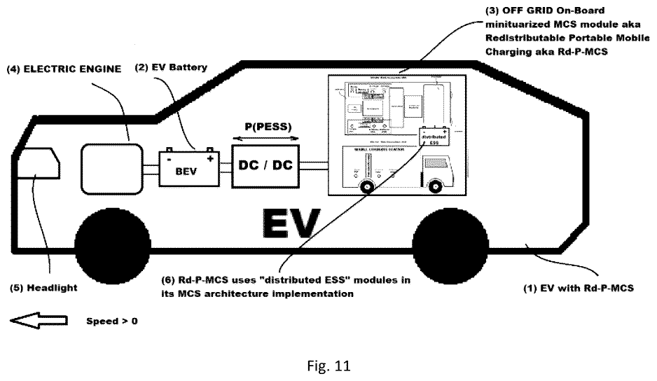

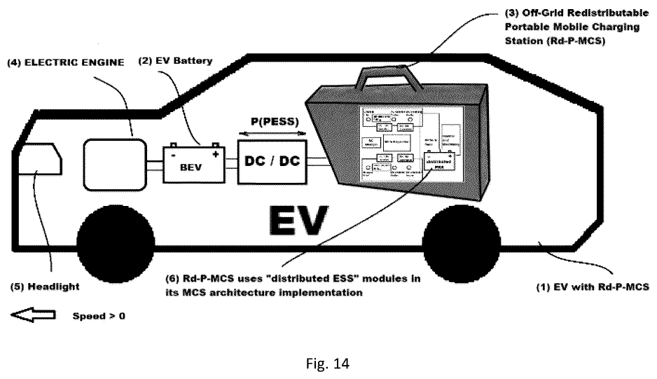

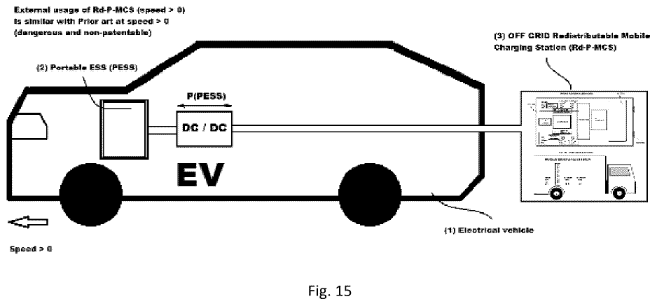

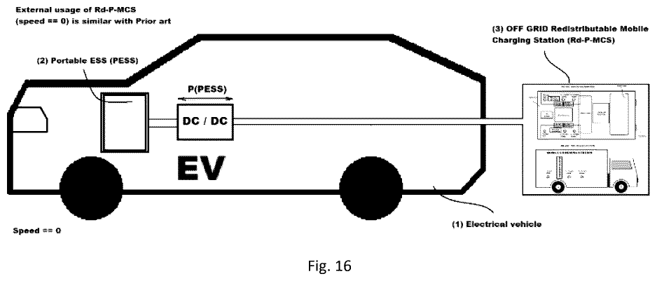

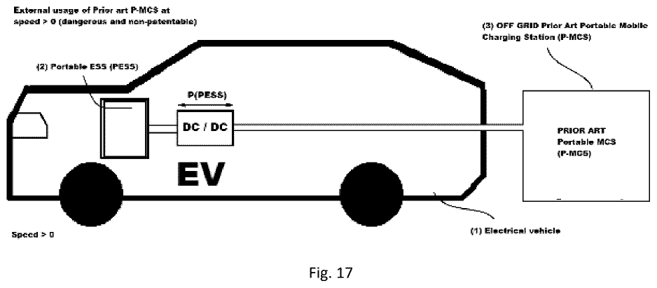

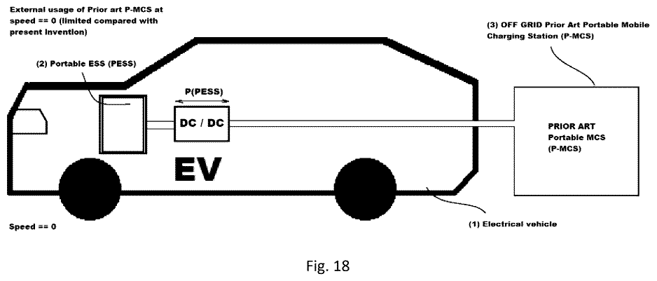

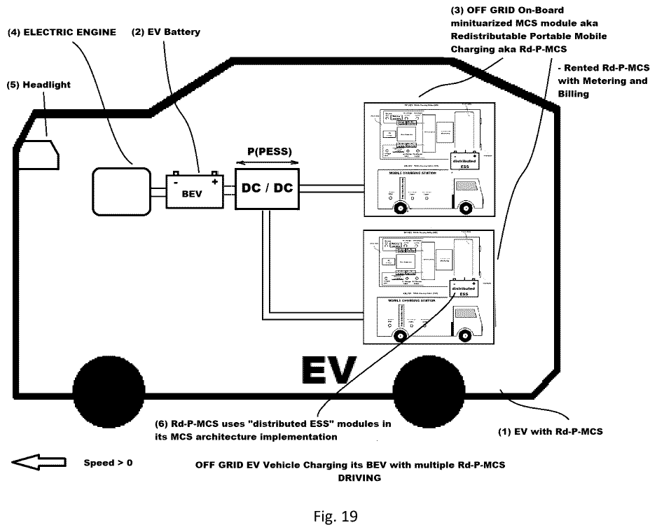

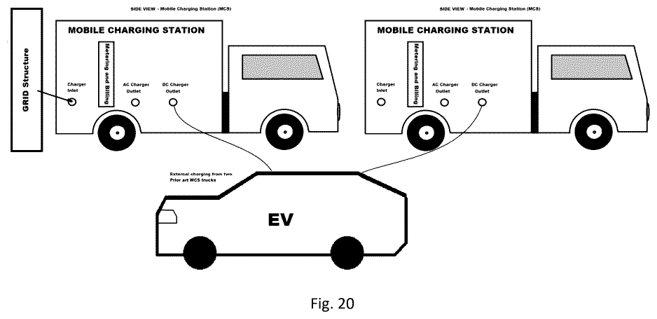

The present invention disclosure presents a solution that deviates from the Prior art Mobile Charging Station (MCS) in embodiments where:
a. The Rd-P-MCS compatible participating EV vehicle can charge its BEV battery “during driving” from a “redistributable Rd-P-MCS” modules—see figures FIG. 11 and FIG. 14. Prior art Electrical Vehicles (EV) cannot charge from a Prior art Mobile Charging Station (MCS) while driving—see figures FIG. 15 and FIG. 17 for Prior art “while-driving” dangerous non-patentable use case and respectively the figures FIG. 16 and FIG. 18 for Prior art stationary (“non-driving”) use case.
b. The Rd-P-MCS compatible participating EV vehicle can charge its BEV battery from multiple “redistributable Rd-P-MCS” modules—see the figures FIG. 19, FIG. 87 and the embodiments FIG. 82, FIG. 83, FIG. 84, FIG. 85, FIG. 86, and FIG. 108, FIG. 109, FIG. 110, FIG. 111, and FIG. 112.
   Prior art Electrical Vehicles (EV) cannot charge from multiple Prior art Mobile Charging Stations (MCSs)—see the Prior art hypothetical impossible FIG. 20.

The present invention disclosure provides solutions and embodiments where:
1. The “redistributable Rd-P-MCS” modules may be used to charge the Electrical Vehicle Battery (BEV) “during driving” rather than charging during being stationary which need undesirable waiting charging times.
2. The “redistributable Rd-P-MCS” modules may be used to operate the Electrical Vehicle and its Electrical Motor “during driving” rather charging during being stationary which need undesirable waiting charging times.

Prior art uses the concept of P-MCS portable device only to charge from an external outlet, thus the concept of charging from such P-MCS portable device “during driving” leads to the use case where such charging P-MCS portable device would be external to the Electrical Vehicle, hence such embodiment would be dangerous and therefore non-patentable.

The present invention disclosure shows steps on how Prior art concepts and apparatus are used to create novel concepts and apparatus that are part of the present invention.

The Prior art Mobile Charging System (MCS) described in the paper “Energy Storage System Using Battery and Ultracapacitor on Mobile Charging Station for Electric Vehicle”, Energy Procedia 2015, 68, 429-437, httbs://core.ac.uk/download/pdf/82774674.pdf, has the property that when such a MCS truck recharges the BEV battery of an Electric Vehicle in need, both the MCS and the Electric Vehicle are stationary until the recharge is complete as opposed to the present invention disclosure charging “while driving” concept.

For this reason, if an MCS receives several calls from multiple cars C₁, C₂, . . . , Cᵢ, . . . , C_{N}, each with its own recharging time Tᵢ, T₂, . . . , T_{N}, respectively, for an integer N>1, then for any such car Cᵢ, considering that all these cars are in the same location with the MCS, and therefore it is ignored the travel time from one car Cᵢ, to the next car with Cⱼ, with i and j are integers such that I<j and i is from 1 to N−1, then the total wait time and recharging time for a car Cᵢ, for any integer i from 1 to N, e.g. the time that car Cᵢ needs to wait for recharging until it can travel again is:

$$Waiting - Recharging - Time ( {C}_{i} ) = {C}_{1} + {C}_{2} + … + {C}_{i} = {\sum }_{k = 1 to i} ( {C}_{k} )$$

The present invention disclosure provides a solution that allows even concurrent swapping/exchanging of “redistributable P-CMS” modules by multiple Rd-P-MCS compatible participating EV vehicles at the same time, which may be even more efficient than the refueling of the non-EV vehicles.

The solution is to let a car to recharge their car through swapping/exchanging a “redistributable Rd-P-MCS” module without waiting time to access the source of charge.

If the case when multiple cars are waiting to a recharge session, since the case of Prior art Mobile Charging Station (MCS) uses two external outlets that would allow to charge two vehicles at a time, each vehicle on one of the MCS sides, the charging time computed for Prior art for each vehicle becomes:

$$Waiting - Recharging - Time ( {C}_{i} ) = \frac{1}{2} * ( {C}_{1} + {C}_{2} + … + {C}_{i} ) = \frac{1}{2} * {\sum }_{k = 1 , i} ( {C}_{k} )$$

For the present invention disclosure there is no waiting time while charging the EV Battery (BEV) because “charging while driving” from a “redistributable P-MCS” module which involves only a pick-up, a swap or an exchange, or a drop-off, or a mixture of such actions, is not considered a stationary charging waiting time.

The apparatus and business method try to minimize and even to eliminate waiting times for recharging an EV using a portable charging device “redistributable Rd-P-MCS”, that adds to the Prior art P-MCS charging module the core features of “metering” and “billing”. The “redistributable Rd-P-MCS” module is rentable, movable and billable energy packed unit, as defined in the disclosure with its secondary properties.

Other secondary features of the “redistributable Rd-P-MCS” module, besides the Metering and Billing core features, are Identity, geolocation functionality, etcetera, possibly driving indefinitely without recharging waiting times as long as the driving plan is aligned with a circuit that provides enough Recharging Stations using only Rd-P-MCS swapping times.

The present invention disclosure adds the concept of “charge while driving” and the concept of the standardized “redistributable Rd-P-MCS” module compatible with both the participating Rd-P-MCS compatible EV vehicles (also called Rd-P-MCS compatible participating EV vehicles) and the Recharging Stations (in all forms and embodiments) such that there might be an electrical charge in an amount comparable with the electrical charge of an EV Battery (BEV), but not only.

The “redistributable Rd-P-MCS” modules, similar with Gas fuel, and are an implementation of partitioning the raw electrical energy and the packaging of such partitioned electric energy into “redistributable Rd-P-MCS” modules for “charging to go” or “charging on the go” just as it happens with driving Prior art cars after pumping fossil fuel in the standard cars.

The invention solves the long-distance driving problem and the customer reticence towards EV acceptance with the new “redistributable Rd-P-MCS” module battery concept and with the new charging and powering architecture that is both flexible and general, thus allowing the concept of “charging while driving”.

The fact that the leading car companies strive for longer range of their EV Battery (BEV) charge up to 1000 Km shows that such companies put a lot of value and effort in trying to offer an experience that avoids recharging times because the car drivers, owners and/or passengers have a limited time, time resource that is very expensive.

The present invention disclosure further supports the goal of avoiding the (stationary) recharging times with a method and apparatus that differentiates from Prior art with gains in marketing, applicable business methods, advertising, customer interest and ultimately the number of sold cars in a field that is the future or automotive industry.

The present invention disclosure solves one of the most important challenges of the EV automotive industry: lack of mobility and wasted waiting time during charging related to EV vehicles, which is a blocker for mainstream EV adaption, a blocker to the industry's future business plans for All EV, see customer concerns from the following video: https://www.youtube.com/watch?v=alsZwclgpc.

The video mentioned above shows that:
a. The EV sales are slowing and the EV vehicles are piling up at dealerships in the U.S.
b. The US EV market struggles with price cuts and rising inventories
c. The people are nervous about going all EV,
d. The main customers' concern related to EV is the “long distance traveling” according to a Mercedes-Benz customer,
e. The main issue is the long-distance travel,
f. Even if the customer expectation is that EV is the future and that it will eventually replace the internal Combustion Engines the dealers' expectations are troubling and indicate a blockage for EV Adoption
g. There is a customer anxiety about Prior art EV Battery (BEV) range

From the video mentioned above one could see that that the main customer's concern related to EV vehicles is the “long distance traveling”, which is solved by the present invention disclosure with the disclosure technological claims and proposed business method.

Other sources such as the following online media article show that the EV sales are slower than expected: https://www.msn.com/de-deilifestyle/shopping/mercedes-wird-seine-autos-nicht-los-jetzt-locken-sie-mit-mega-rabatten/ar-AAliPKgo?ocid=entnewsntp&cvid=d1c737aea8864affb145ad631bbd5b78&ei=27

The present invention disclosure focuses on the problem of long trips, which is a blocker to the whole industry.

The present invention disclosure allows both the Super Stationary Charging Stations and Super Mobile Charging Station (Super-MCS) to monitor the “Health” of the hardware, software and functionality (calibration, errors, etcetera) of the “redistributable Rd-P-MCS” modules.

In case that there are such anomalies, such affected “redistributable Rd-P-MCS” modules will be disconnected from the Grid, from the DC bus of the Super Stationary Charging Stations or Super Mobile Charging Station (Super-MCS) and a replacement will be scheduled.

Specially purposed service Super Mobile Charging Station (Super-MCS), Certified Partner Service vehicle, but not only, will come and collect, in a natural way—as shown in the present disclosure
such faulty “redistributable Rd-P-MCS” modules, replacing them with working “redistributable Rd-P-MCS” modules, before driving and servicing the faulty modules to specially purposed Repair Stations.

The present invention disclosure allows swapping/exchanging “redistributable Rd-P-MCS” modules between a Super Mobile Charging Station (Super-MCS) and a Super Stationary Charging Station:
1. for the purpose of bringing new healthy “redistributable Rd-P-MCS” modules to replace the ones previously rented by other Rd-P-MCS compatible participating EV vehicles;
2. If such replacements are depleted of their electrical charge, then they will be recharged while being mounted to their corresponding Recharging Station.
3. for the purpose of bringing fully charged “redistributable Rd-P-MCS” modules to replace the depleted ones dropped off by other Rd-P-MCS compatible participating EV vehicles;
4. for the purpose of bringing new “redistributable Rd-P-MCS” modules to replace the faulty “redistributable Rd-P-MCS” modules,

Participating Rd-P-MCS compatible EV cars, otherwise called “Rd-P-MCS compatible participating EV cars”, may be designed “a-priori” with one or multiple “redistributable Rd-P-MCS” modules in mind and may have a new charging system architecture as in FIG. 87 and in FIG. 108, FIG. 109, FIG. 110, FIG. 111, and FIG. 112, but also with embodiments supporting the described behavior and/or supporting the business method goals.

A Rd-P-MCS compatible EV vehicle with a subscription associated with a performance goal and/or with a performance guarantee is named a Rd-P-MCS compatible participating EV vehicle.

The Rd-P-MCS compatible participating EV vehicles may be redesigned from start taking in consideration the existence of “redistributable Rd-P-MCS” module concept rather than considering the “redistributable Rd-P-MCS” module concept as an afterthought to be used with Prior art EV vehicles (retrofitted or not).

Instead of having an EV vehicle with a single EV Battery (BEV), where the EV Electric Motor is powered and operated only by its BEV,
with the Rd-P-MCS compatible participating EV vehicles may have an embodiment of an EV vehicle with both EV Battery (BEV) and a plurality of “redistributable Rd-P-MCS” modules, thus the EV vehicle being operated by a mix of EV Battery (BEV) and the active “redistributable Rd-P-MCS” modules.

Architectures as shown in FIG. 87 and in FIG. 108, FIG. 109, FIG. 110, FIG. 111, and FIG. 112, but not only, allow swapping automotive batteries, such as EV Battery (BEV) and “redistributable Rd-P-MCS” module(s), in a similar way provided by the Dell patents mentioned in the present disclosure, patents that describe laptops operated by multiple batteries.

The present invention disclosure concept of “EV charging while driving” could use the concept of a “laptop being used while being charged” where the EV Battery (BEV), similar to the laptop battery, is being charged from a plurality of “redistributable Rd-P-MCS” modules, just as the laptop battery is being charged from the (power) wall while operating the laptop.

For this reason, the charging architectures used in Rd-P-MCS participating compatible EV vehicles that support the “charging and operating while driving” of the EV vehicle, uses a plurality of batteries, e.g., one or more EV Battery (BEV) and one or more “redistributable Rd-P-MCS” modules—including “Light redistributable Rd-P-MCS” modules—as shown in the following figures:
a. FIG. 106 shows an embodiment for alternate powering of the Electric Motor from either BEV Battery or from the “redistributable Rd-P-MCS” module
b. FIG. 107 shows an embodiment for alternate powering of the Electric Motor from either BEV Battery or from the “redistributable Rd-P-MCS” module.
c. FIG. 113 shows an embodiment for alternate powering of the Electric Motor from two distinct BEV Batteries.
d. One BEV battery powers the Electric Motor while the other BEV battery is charged in parallel by a “Rd-P-MCS redistributable” module, that could be part of the architecture from FIG. 112 (5^{th} embodiment).
e. FIG. 115 shows an embodiment where the Electric Motor is powered from a BEV Battery that has two battery parts.
f. One battery part (part #1) powers the Electric Motor while the other battery part (part #2) is charged in parallel by a “Rd-P-MCS redistributable” module, that could be part of the architecture from FIG. 111 (4^{th} embodiment).
g. When the battery part (part #1) powering the Electric Motor becomes depleted, the roles are reversed such that battery part #1 starts to be recharged from the “Rd-P-MCS redistributable” module while the other battery part (part #2) starts powering the Electric Motor.
h. FIG. 108 shows an embodiment with the new Charging and Electric Motor Powering Architecture (1st embodiment)
i. FIG. 109 shows an embodiment with the new BEV Charging and Electric Motor Powering Architecture (2nd embodiment with multiple Electric Motors)
j. FIG. 110 shows an embodiment with the new BEV Charging and Electric Motor Powering Architecture (3rd embodiment with multiple Electric Motors and multiple “redistributable Rd-P-MCS” modules)
k. FIG. 111 shows an embodiment with the new BEV Charging and Electric Motor Powering Architecture (4^{th} embodiment with multiple Electric Motors and multiple Rd-P-MCS modules and one BEV with two parts as in FIG. 115)
l. FIG. 112 shows an embodiment with the new BEV Charging and Electric Motor Powering Architecture (5^{th} embodiment with multiple Electric Motors and multiple Rd-P-MCS modules and multiple BEVs batteries)

Using the “redistributable Rd-P-MCS” modules with the Prior art EV vehicles may not work without extensive adaptation.

The “redistributable Rd-P-MCS” modules are not owned by participating Rd-P-MCS compatible participating EV vehicle owners, although owned variants are acceptable to use outside the business method, but rather used as short term rental service, with some similarity with rented cars, thus the participating Rd-P-MCS compatible participating EV cars may have a design and architecture that may involve a mix of owned (part of vehicle purchase transaction) and rented components such as the “redistributable Rd-P-MCS” modules (claim), but they may still be able to function without such rented components.

If a driver determines that the car needs to go through an area where the distance to the next charging station, e.g., Super Stationary Charging Station and/or to the next Super Mobile Charging Station (Super-MCS) with GRID=OFF, e.g., a Super Mobile Charging Station (Super-MCS) that is assigned to a stationary location, is further away from where a single “redistributable Rd-P-MCS” module could power the vehicle, the driver might consider that renting several “redistributable Rd-P-MCS” modules at the same time in order to replace the eventual depleted “redistributable Rd-P-MCS” modules during the trip until reaching another location with a Super Stationary Charging Station or a Super Mobile Charging Station (Super-MCS) were the used/depleted “redistributable Rd-P-MCS” modules could be finally dropped off.

In a case as the one described above, the Rd-P-MCS compatible participating EV vehicle may have at any time: a set of connected, activated and functioning “redistributable Rd-P-MCS” modules, a set of already used and depleted “redistributable Rd-P-MCS” modules, and a set of fully charged “redistributable Rd-P-MCS” modules that are ready to be used when necessary.

The invention defines a Participating Driving Circuit, or simply Driving Circuit, that is mapped on high density driving routes such as highways, busy roads and major cities, extended to remote areas serviced based on request as described in the disclosure, consisting of a Pool of “redistributable Rd-P-MCS” modules that may be charged at any of the plurality of Recharging Stations (Super Stationary Charging Stations, Stationary Super Mobile Charging Station (Super-MCS), Driving Mobile Super Mobile Charging Station (Super-MCS) with operations as described in disclosure, Power wall from home, Participating Certified Partner Service vehicles from ADAC, AAA, as shown in disclosure), such “redistributable Rd-P-MCS” modules being shared between participating compatible vehicles and being swapped between any pairs of Recharging Stations (Super Stationary Charging Stations, Stationary (OFF-GRID) Super Mobile Charging Station (Super-MCS), Driving Mobile Super Mobile Charging Station (Super-MCS) with operations as described in disclosure, Power wall from home, Participating Certified Partner Service vehicles from ADAC, AAA, etcetera, as shown in disclosure) involving at most one vehicle and at most one Super Stationary Charging Station in such swap, the Participating Driving Circuit having a pool of “Rd-P-MCS Dispatcher coordinator” entities (human and/or automated) to distribute “redistributable Rd-P-MCS” module(s) using Super Mobile Charging Station (Super-MCS), participating Certified Partner Service vehicles from providers such as ADAC, AAA, but not only, the Participating Driving Circuit having a Repair Auto Stations to repair the FAULTY “redistributable Rd-P-MCS” modules, Pool of standby NEW and/or REPAIRED “redistributable Rd-P-MCS” modules.

The “Redistributable Rd-P-MCS” modules that are READY to be introduced into the Driving Circuit when needed, hardware and software to implement and to support the above and the business method and a pool of Mobile Super Mobile Charging Station (Super-MCS) and Participating Certified Partner Service vehicles that are distributing “redistributable Rd-P-MCS” modules between Recharging Stations, responding and delivering to requests from participating drivers/compatible cars, removing faulty “redistributable Rd-P-MCS” modules from the Circuit Pool of such devices, adding WORKING (NEW and/or REPAIRED) “redistributable Rd-P-MCS” modules into the Circuit Pool of such devices, hardware and software to monitor the health of the participating “redistributable Rd-P-MCS” modules and the status of such devices, to monitor the needs for “redistributable Rd-P-MCS” modules at the Recharging Stations, methods and apparatus for metering, billing and payment, participating certified Payment Entities such as VISA, MasterCard, etcetera, the participating compatible vehicles may have an Infotainment System to monitor and control the active “redistributable Rd-P-MCS” modules (fully or partially charged) participating to the charging architecture system as in FIG. 87 and in FIG. 108, FIG. 109, FIG. 110, FIG. 111, and FIG. 112, where Regulators stands also for DC/DC converters.

The business method component named the rental method of “redistributable Rd-P-MCS” defines a transaction that takes place between a “starting Recharge Station” and a “destination Recharge Station” with the effect of providing support for metering, billing, and payment.

The invention Billing is defined in relation to two locations:
c. the starting location when an open-ended payment transaction is created, and possibly a deposit is secured from the customer bank account before the “redistributable Rd-P-MCS” module is handed over, and
d. the dropping location when all the final charges are computed and/or finalized and the actual payment transaction is sent to the payment service providers.

The invention charging architecture tries to avoid that Electric Engine(s) may be charged only by BEV, but rather may also be charged, directly or indirectly, by other charging devices such as other BEV batteries, such as “redistributable Rd-P-MCS” modules, including “Light redistributable Rd-P-MCS” modules, depending on the state of the supporting circuitry, see the architectures from figures FIG. 108, FIG. 109, FIG. 110, FIG. 111, and FIG. 112, but not only.

With Prior art is BEV battery that is charged stationary there is no access to the Electrical Engine(s) with bypassing the BEV charging circuitry by a Prior art portable charging device P-MCS, or even if we would try to use a “redistributable Rd-P-MCS” module.

With the present invention disclosure, even when the Electric Engine is charged directly from the BEV, or from other Charging device such as the “redistributable Rd-P-MCS” module, the BEV may still be charged from DC Bus or from other Charging devices such as the “redistributable Rd-P-MCS” modules, but not only, see the circuit diagrams from figures FIG. 113 and FIG. 115, or using circuit diagrams based on figures FIG. 106, FIG. 103-b2-bis, FIG. 104-a, and FIG. 115, but also based on any combination available to the skilled in the art, supporting charging architectures depicted in figures FIG. 111 and FIG. 112, but not only.

The DC bus can be maintained/charged with a variety of charging technologies: BESS, BEV, Rd-P-MCS, MCS, Super Mobile Charging Stations (Super-MCS), and Super Stationary Charging Stations.

The invention Electrical Engine(s) is decoupled from the BEV battery, thus being connected to a DC Bus and supporting circuitry—including a plurality of ECUs—see FIG. 87 and FIG. 108, FIG. 109, FIG. 110, FIG. 111, and FIG. 112.

In the scope of the present invention disclosure the terms “Electrical Engine” and “Electrical Motor” are used interchangeably.

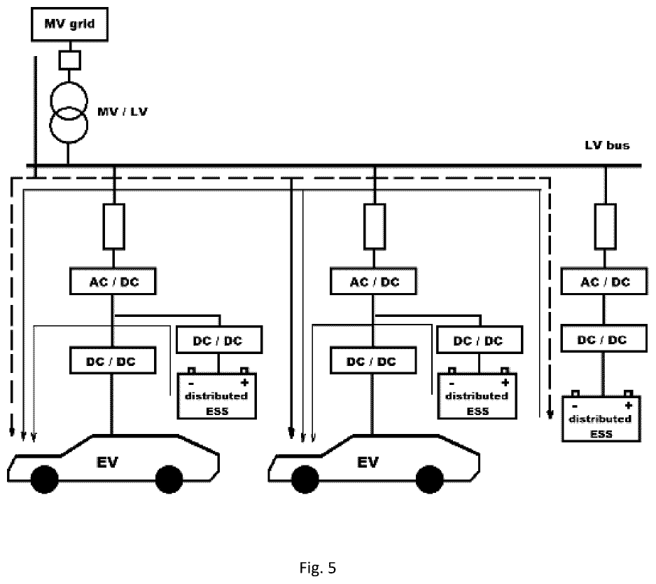

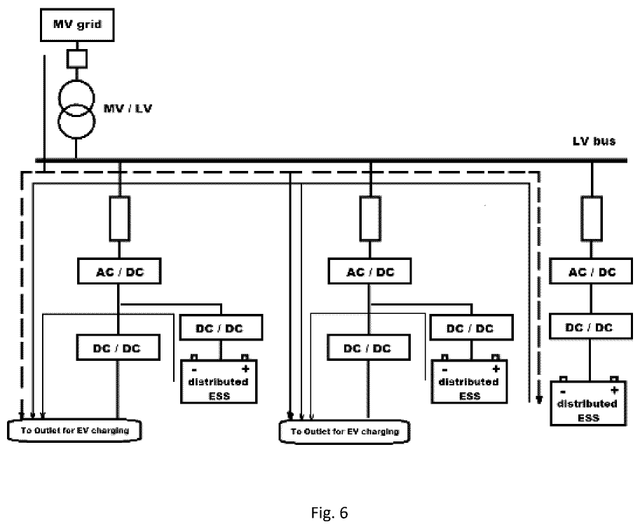

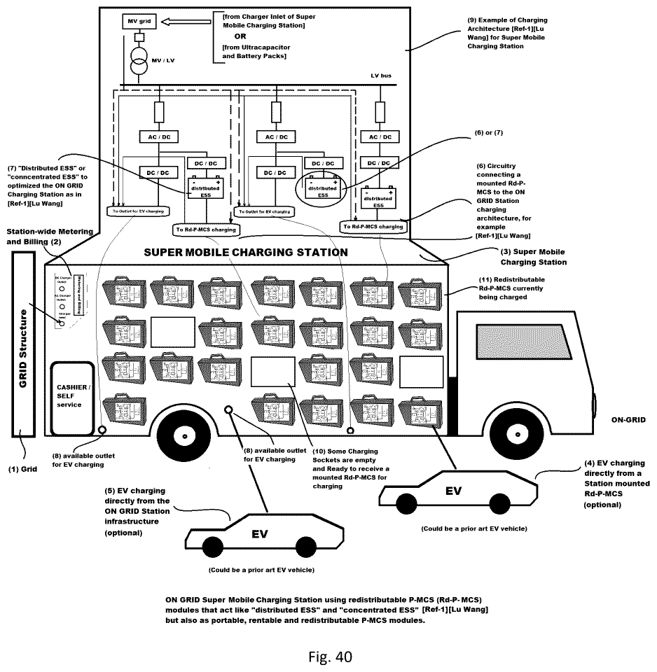

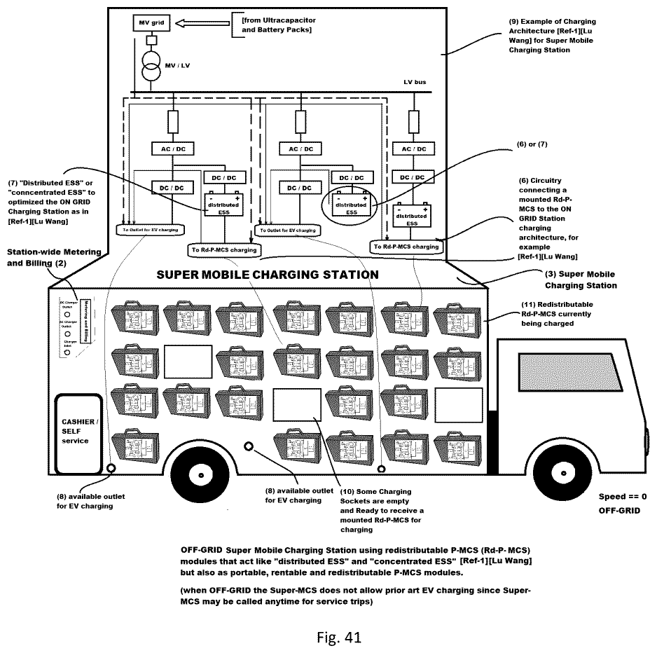

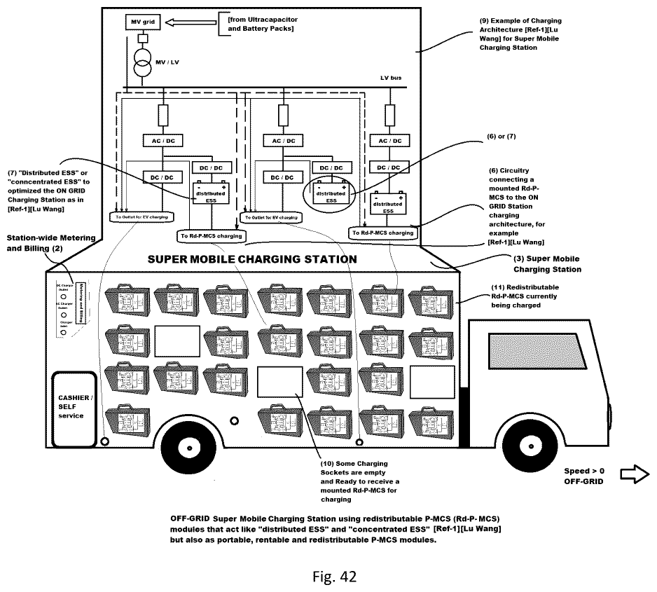

All charging entities may contribute at the same time to the DC Bus and its “charge reservoir” implemented as a Capacitor, as a Charging architectures shown in figures FIG. 5 and FIG. 6, as a Charging Architecture shown in figures FIG. 40, FIG. 41, and FIG. 42, but not only, to which the BEV is connected, alongside with the availability of the use case when the BEV is also charged while driving in order to minimize the rental time of Rd-P-MCS and therefore to minimize the rental price.

The Rd-P-MCS participating compatible EV vehicle mobility is defined by the charge of its “BEV and rented Rd-P-MCS modules”.

Charging is asynchronous between the car needing a “redistributable Rd-P-MCS” module and Super Mobile Charging Station (Super-MCS), because the “redistributable Rd-P-MCS” module is transportable.

The Synchronous re-charge is only between the EV vehicle and the “redistributable Rd-P-MCS” module while driving.

The “redistributable Rd-P-MCS” module becomes the unit of “fueling” for the new Rd-P-MCS compatible participating EV cars.

The Metering and Billing module circuitry could be part of the “redistributable Rd-P-MCS” module architecture which gives flexibility and more independence from the design and implementation of the Charging Stations, e.g., SuperStationary Charging Stations (Super-SCS) and Super Mobile Charging Stations (Super-MCS), but the Metering Billing could be split between the “redistributable Rd-P-MCS” module and one or more Charging Stations (Super Stationary Charging Stations (Super-SCS) and Super Mobile Charging Stations (Super-MCS)), e.g., the Start Charging Stations (where the pick-up happens) and the Stop Charging Stations (where the drop-off happens), including in an exclusive matter with a global distributed systems and databases that register, monitor and search and find such open transactions (including partial active transactions) from any such participating Charging Stations—this way a transaction could be handled by multiple Charging Stations.

The “redistributable Rd-P-MCS” module needs to give an assurance of performance (with respect to mobility and range) in order to guarantee a MINIMUM performance to the driver's driving planning that can be counted on.

A “redistributable Rd-P-MCS” module may be used by multiple cars during a single day.

The Super Mobile Charging Stations (Super-MCS) can charge during driving its array of connected and transported “redistributable Rd-P-MCS” modules as packed energy that it wants to redistribute, optimization of business, time and “redistributable Rd-P-MCS” module availability.

There is a short time to exchange “redistributable Rd-P-MCS” modules between a car reaching a stationary Super Mobile Charging Station (Super-MCS) or a non-stationary Super Mobile Charging Station (Super-MCS).

The Non-stationary Super Mobile Charging Stations (Super-MCS) become more efficient when they are called by vehicles needing “redistributable Rd-P-MCS” modules, they just drop-off or exchange “redistributable Rd-P-MCS” module(s) and afterwards go to other cars.

A “redistributable Rd-P-MCS” module could be delivered (specifically reserved/bound to the driver to pick-up it up) even in absentia to qualified participating businesses such as EDEKA, Aldi, etcetera, Gas/Fuel Stations, but also national and/or Auto Service units, without any limitation.

A “redistributable Rd-P-MCS” module may be self-contained with respect to supporting the “charging while driving” invention goal or it may attain such goal being part of a bipartite or multi-partite device shown in figures FIG. 77, FIG. 78, FIG. 80 and in the diagrams from FIG. 86 and FIG. 87.

The present invention disclosure has added the concept rent and charge a “charging service in the future and at a certain location”, such that with the support of the Infotainment System (or other) the driver can plan and ask to rent a “redistributable Rd-P-MCS” module in the future to a location and time that may be brought to the location by Super Mobile Charging Station (Super-MCS), Certified Participating Partners such as ADAC, AAA, etcetera, possibly dropped off to local businesses from where they can be picked-up without making the delivery entities to wait for the driver and/or participating car, in order to extend the charging range/mobility when driving in remote areas.

The mobility of the participating cars depends on the total charge of its “BEV+rented active redistributable Rd-P-MCS modules”, see the NOTE regarding the status of the “redistributable Rd-P-MCS” modules present in the car.

The “redistributable Rd-P-MCS” module could be split as shown in the invention disclosure which has no equivalent in the Prior art of P-MCS module.

The present invention disclosure provides the concept of the portable, shareable, rentable commercially “redistributable Rd-P-MCS” module as described in the disclosure.

The present invention disclosure has discovered independently from Prior art the concept of Rd-P-MCS, as an extension with more features and properties that Prior art portable charging device “P-MCS”, as the concept of “packaging energy into detachable Rd-P-MCS modules” for “commercial re-distribution of such Rd-P-MCS modules” for “charging the BEV of the electrical vehicle (EV) while driving”.

The present invention disclosure has added the following concepts:
a) Allowing the Electrical Vehicle to charge during driving from at least a “redistributable Rd-P-MCS” module.
b) The “redistributable Rd-P-MCS” module is capable to charge a full BEV Battery charge as opposed to being just a “portable rescue power bank” with limited charge,
c) The “redistributable Rd-P-MCS” module is capable to charge the BEV Battery during driving,
d) Allowing the Electrical Vehicle to continue driving without stopping for charging via swapping “redistributable P-MCS” modules,
e) Allowing the Electrical Vehicle to avoid stationary recharge wait times,
f) Adding Metering and Billing functionality to the “redistributable Rd-P-MCS” module, but not only,
g) Adding Metering and Billing functionality which can be split between the start and end of the rental Recharge Stations alongside using a distributed software and database and GPS tracking devices,
h) Cars designed with the “redistributable Rd-P-MCS” module in mind, see the figures FIG. 108, FIG. 109, FIG. 110, FIG. 111, and FIG. 112.

The access of the Rd-P-MCS compatible participating EV vehicle's driver to swapping the “redistributable Rd-P-MCS” module is in “direct access” mode rather than in “sequential access” mode characteristic to a queue, hence any such swapping is almost instantaneous if using a self-serving “Recharging Station” or if there are fewer waiting vehicles than the serving employees.

Multiple cars may swap “redistributable Rd-P-MCS” modules at the same time with the same Recharging Station.

The swapping and access allow also concurrent swapping of “redistributable Rd-P-MCS” modules with the same Recharging Station.

The present invention disclosure proposes a performance model for the apparatus and the business method using a closed loop with enough Recharging Stations and enough loop length that leaving a depleted “redistributable Rd-P-MCS” modules at a participating Recharge Station will find it fully charged when arriving at the same Recharge Station after one full loop.

Simply renting a Prior art emergency bank P-MCS is not enough, you need a network of supporting Recharging Stations (in all forms) such that the participating cars can have a series of “redistributable Rd-P-MCS” module swaps.

With short term rental of mostly a few hours of driving, the goal would be to optimize (instead of wasting) the time when the “redistributable Rd-P-MCS” module is aways from the qualified locations where it can be used further by other cars.

A part of the Rd-P-MCS participating compatible EV vehicle, e.g., the “redistributable Rd-P-MCS” module, that is replaceable needs to meet certification/quality.

Renting a “redistributable Rd-P-MCS” module is just like buying gas that stored into your fuel tank of a gas operating vehicle, but with the difference that the “redistributable Rd-P-MCS” module is already charged.

Spare owned “redistributable Rd-P-MCS” modules could be charged from “redistributable Rd-P-MCS” modules.

The “redistributable Rd-P-MCS” modules may be rented fully charged (or if it is rented partially charged it needs to show the remaining charge so that the driver may evaluate the usefulness of renting—this use case being less useful if it will shorten the charging lifetime).

The Pool of “redistributable Rd-P-MCS” modules in driving circuits, is defined based on stationary recharging nodes such as ON-GRID Super Stationary Charging Stations (Super-SCS) and ON-GRID, or OFF_GRID, Super Mobile Charging Stations (Super-MCS) while stationary, dynamic charging in OFF_GRID Super Mobile Charging Station (Super-MCS) while driving, another claim, Super Mobile Charging Stations (Super-MCS)—with the infrastructure with BESS just as the stationary (ON-GRID) Recharging Stations.

The “redistributable Rd-P-MCS” modules are “shared” by multiple cars in short periods of time on various driving paths used by the lenders.

How “redistributable Rd-P-MCS” modules are distributed in the Driving Circuit may be the difference between a good business method and a bad business method.

The “redistributable Rd-P-MCS” modules are partitioned units of electrical charge when time is of essence or desired extending thus the active life of the driver, e.g., the driver has the option to save the Prior art charging time and use it for purposes that are considered more important.

The “redistributable Rd-P-MCS” modules are distributed even in remote areas, extending the mobility and range of the subscribed compatible cars.

Rather than charging energy into the BEV at a Recharge Station, the present invention disclosure allows a Rd-P-MCS compatible participating EV vehicle to borrow a “redistributable Rd-P-MCS” module, thus buying energy that is packed and amendable to be taken away for charge while driving or amenable to swap with another “redistributable Rd-P-MCS” module.

The high cost of the “redistributable Rd-P-MCS” module is amortized by the rental revenues brought by having the “redistributable Rd-P-MCS” module participating in the business method, business method which could be franchised or license.

The “ALL charge while driving” concept for both the Rd-P-MCS compatible participating EV vehicles and the “redistributed Rd-P-MCS” modules themselves, uses the concept of “charge while driving” across all aspects of the business method, including when a new “redistributable Rd-P-MCS” module is entered into the Driving Circuit Pool of “redistributable Rd-P-MCS” modules when driven by a Super Mobile Charging Station.

The “redistributable Rd-P-MCS” module “travels” with the Rd-P-MCS compatible participating EV vehicle, hence the “synchronous” part of charging the BEV from the “redistributable Rd-P-MCS” module connected (internally) to the said EV vehicle and its charging hardware and parts is happening during driving.

Rental transactions start at their pick-up charging station and end at the drop-off charging station which are usually different. However, it is not required to be so.

The “redistributable Rd-P-MCS” module provides a scalable and distributed solution to the recharging problem even without the “charge while driving”.

The “charge while driving” concept optimizes time, when the “redistributable Rd-P-MCS” modules are charged during the redistribution driving by Super Mobile Charging Stations (Super-MCS), reduces the size of the required pool of “redistributable Rd-P-MCS” modules because they are used more efficiently, thus reducing also cost of operating the business method.

“Charge while driving” saves time of the EV drivers and improves the acceptance of the new technology, thus solving the long-distance travel problem.

The driver can see the participating Recharge Stations and the availability of “redistributable Rd-P-MCS” modules alongside with their pricing options.

The Super Stationary Charging Stations are ON-GRID, the Super Mobile Charging Stations (Super-MCS) may be both ON-GRID and OFF-GRID, while the “redistributable Rd-P-MCS” modules may be transported while charging but also powering the BEV and/or EV vehicle according to the figures, including figures FIG. 108, FIG. 109, FIG. 110, FIG. 111, and FIG. 112.

The “redistributable Rd-P-MCS” modules may be charged by a Super Mobile Charging Station (Super-MCS) that is ON-GRID or OFF-GRID, or it may be charged stationary (ON-GRID) while mounted to a Super Stationary Charging Station.

Using “redistributable Rd-P-MCS” modules that are uniquely Identifiable and distributed data bases operating all the entities that are part of the apparatus and business method, it is not allowed the introduction of fake or non-certified “redistributable Rd-P-MCS” modules into the circuit and in the Pool of “redistributable Rd-P-MCS” modules in order to guarantee certain minimum standard operating parameters, while maintaining the Health, Safety and Efficiency of the Pool of “redistributable Rd-P-MCS” modules.

Transparency with respect of the available of “redistributable Rd-P-MCS”, including pricing wise, along the driving trip, the car system may plan brief stops for such “redistributable Rd-P-MCS” module in order to automate and help/support the driver.

The present invention disclosure shows how one can design an Off-Grid Portable Mobile Charging Station, called “redistributable Rd-P-MCS” module, using a Prior art BESS module as long as the “redistributable Rd-P-MCS” module retains the “Metering and Billing” module from the Prior art “Mobile Charging Station” concept.

The present invention disclosure shows how one can transform the stationary Charging Stations connected to the recharging DC Bus as seen in the “Stationary ESS or HESS” component connected to the DC bus, but also the BESS modules connected to the DC bus, as seen in FIG. 5 from [Ref-1] [Lu Wang], by adding the functionality, software and hardware from the Mobile Charging Stations (MCS) described in the paper https://core.ac.uk/download/pdf/82774674.pdf [Ref-4] [Atmaja, T. D.], into “redistributable Rd-P-MCS” modules charging themselves as long as they are mounted to the main Recharge Station connected to the main DC bus.

The present invention disclosure shows that the newly defined “redistributable Rd-P-MCS” modules once fully charged, but not only, can be rented at cost by the customers of the main Recharge Station, allowing the customers and their EV vehicles to travel with such “redistributable Rd-P-MCS” modules connected to the vehicle's own DC bus with the following goals:
a. Being a direct or indirect source of energy for the vehicle's Electric Engine,
b. Charging the vehicle's own rechargeable source of energy, e.g., the vehicle's own EV Battery (BEV) during driving rather than waiting at the main Recharge Station location until the vehicle's own EV Battery (BEV) is enough charged to allow the trip to continue.
c. Allowing the driver of an EV vehicle to pay and rent such Portable Mobile Charging Station (“redistributable Rd-P-MCS” module) in order to avoid waiting time associated with charging an EV vehicle.
d. Rather than waiting a Prior art Mobile Charging Stations (MCS) to arrive at the driver's EV vehicle or the driver to reach a closely located Mobile Charging Stations (MCS), the driver would rent at a cost such a newly devised Portable Mobile Charging Station (“redistributable Rd-P-MCS” module) avoiding waiting charging times involved when using the service of such Mobile Charging Stations (MCS).
e. The idea is that a rented, using a subscription or payment by credit card—one would acknowledge that, initially, such Portable Mobile Charging Stations (“redistributable Rd-P-MCS” module) will be (very) expensive—will be dropped eventually at another main Recharge Station, for example at a main Recharge Station located at another Service Location on the highway, or at another main Recharge Station located in a city near the driving plan for the trip.
f. When such a rented Portable Mobile Charging Station (“redistributable Rd-P-MCS” module) is dropped at the destination Recharge Station, the Portable Mobile Charging Station (“redistributable Rd-P-MCS” module) will be connected again to the DC grid (DC bus of the destination Recharge Station) thus starting to be changed again and possibly being used to stabilize the DC bus at high/peak consuming energy times as being depicted in FIG. 5.
g. When dropping such a rented Portable Mobile Charging Station (“redistributable Rd-P-MCS” module) at the destination Recharge Station, the “Metering and Billing” module of the Portable Mobile Charging Station (“redistributable Rd-P-MCS” module) would provide information about the final cost of using and renting such a Portable Mobile Charging Station (Rd-P-MCS) and the financial transaction will be concluded and finalized with all parties, including the Credit Card provider, being informed.

The present invention disclosure envisions that such “redistributable Rd-P-MCS” module should have a size and weight as low as possible, ideally of the size of a suitcase.

The present invention disclosure envisions that, maybe more than just one, such “redistributable Rd-P-MCS” module of the size of a suitcase would be used to be mounted in, or connected to, a standard vehicle charging socket to provide the functionality and goals described above.

The most probable location to place such “redistributable Rd-P-MCS” module in an EV car would be in the EV trunk, but without limitation to such location, especially in the case of vehicles that are bigger: mini-VANs, VANs, buses, etcetera.

The present invention disclosure envisions the simultaneous use of more than such a “redistributable Rd-P-MCS” module, for example a first such “redistributable Rd-P-MCS” module could be dedicated to being used by the vehicle Electric Engine(s) and the rest of the “redistributable Rd-P-MCS” modules to recharge the vehicle's own EV Battery (BEV).

The present invention disclosure envisions that the initial Recharge Station, where the driver wants to rent the “redistributable Rd-P-MCS” modules, would have an User Interface module where the driver could enter information such as the type of vehicle would use the “redistributable Rd-P-MCS” modules, how much the driver expects to continue driving, but not only, in order to allow the Recharge Station to select for the driver the best suited “redistributable Rd-P-MCS” modules for the driver's trip plan.

The present invention disclosure envisions that in order to improve the availability of such “redistributable Rd-P-MCS” modules, because in time most, if not all, of them would be transferred to the traffic downflow Recharged Stations, a redistribution algorithm and a redistribution of them to the Recharged Stations on the opposite traffic direction, across of the traffic lanes, would be advantageous.

The present invention disclosure expects that downsizing such “redistributable Rd-P-MCS” modules from the Prior art standard (vehicle size) Mobile Charging Stations (MCS) to have also a considerable decrease from the energy provided by the Mobile Charging Stations (MCS) to possibly several vehicles.

However, the present invention disclosure goal with the “redistributable Rd-P-MCS” modules is NOT expected to serve multiple vehicles at the same time, but rather to provide enough energy for “charging during driving” or “charging while driving” to a Rd-P-MCS compatible and participating EV car; the current disclosure will show that such goal is in the realm of possibility.

The present invention disclosure envisions the design and manufacturing of such “redistributable Rd-P-MCS” modules by taking as reference the high-performance battery packs, such as those used in Formula E, that are rated for several hundred kWh, thus being enough performant to charge a normal EV vehicle's BEV, while driving.

The present invention disclosure considers further to lower the cost and the size of such high-performance battery packs to make them available to most of the customers and not only for the rich people and their expensive super-luxury cars. Mercedes-Benz EV cars (EQS model) are rated best in terms of available energy, but at least now they should not be above 250 kWh or above the already mentioned high-performance battery packs, that are lighter, that are more energy efficient, that are removable and therefore portable, and that deliverer more energy that are required for standard EV cars.

The present invention disclosure considers that there is an availability of technology to design and implement such “redistributable Rd-P-MCS” modules as a Proof of Concept. The main challenge is to make such product available for the mainstream. However, making more such products available to the public, the more such products become affordable as in a positive feedback loop.

The present invention disclosure “redistributable Rd-P-MCS” modules, have the ‘battery pack” as the only component that may need to be charged/replace/handle, the rest of the MCS's components, e.g., ultracapacitor, DC/DC converter, DC/AC inverter, AC charger, AC charger outlet, DC charger outlet and AC charger inlet, the “redistributable Rd-P-MCS” modules could be reduced to a “battery pack” since all the other “passive” components can be provided by both the main Recharge Station and by the target EV vehicle when MCS is connected to the power grid. MCS also equipped with a battery monitoring system to control and monitor the using of the energy storage. ESS should be installed in a truck type vehicle and utilize the back compartment, side panel, and the dashboard. The battery pack, ultracapacitor, DC/DC converter, DC/AC inverter, and AC Charger should be mounted in back compartment. AC charger outlet, DC charger outlet, AC charger inlet.

The Prior art Mobile Charging Station (MCS) parts mentioned in the immediate above paragraph, such as ultracapacitor, DC/DC converted, DC/AC inverter, AC charger, AC charger outlet, DC charger outlet and AC charger inlet,
could be integrated with the other vehicle's EV Battery components as long as such design/refactoring approach does not impede the description and the goals of the present invention disclosure newly devised “redistributable Rd-P-MCS” module.

The drivers can also rent and/or buy such “redistributable Rd-P-MCS” module commercially by specialized companies, other than (Re)charging Stations, providing such services and/or products to any willing driver/customer, with the possibility that such redistributable Rd-P-MCS” module may be charged from the wall, but not only.

Please note that “distributable Rd-P-MCS” module and “redistributable Rd-P-MCS” module terminology are to be used interchangeably.

The present invention disclosure shows the following:
1. the present invention disclosure proposed technological apparatus (named the “technology”) allows an electrical vehicle (EV) can drive indefinitely WITHOUT RECHARGING WAITING TIMES as long as the driving plan is aligned with a circuit that provides enough fully charged “redistributable Rd-P-MCS” module when needed.
2. the present invention disclosure, with the proposed technological apparatus (named the “technology”) and with the proposed “business method”, is novel both from a technical perspective and from the result and advantage provided to the participating vehicles and drivers.
3. the present invention disclosure proposes several methods and functions for measuring the performance of the proposed technology and business method.
4. the present invention disclosure proposes several methods and functions for measuring the performance of the proposed technology and business method in order to:
   a. Show how it differentiates from Prior art,
   b. Show how it is better that Prior art,
5. the present invention disclosure allows formal models based on Graph Theory and on Petri Nets, but not only, in order to define the core of the technological proposal but also the core of the present invention disclosure business method.
6. such present invention disclosure formal models could allow all future technologies to be able to be compared with the present invention disclosure technology proposed on a common framework for performance and efficiency comparison.
7. The above-mentioned disclosure methods and functions may allow to measure the performance of the proposed technology and business method are the following, without being limited to:
   a. The total distance an Electrical Vehicle (EV), participating in each Prior art (or future art) business method, can cover without stationary recharging time.
   b. The time total time an Electrical Vehicle (EV), participating in each Prior art (or future art) business method, can cover without stationary recharging time.
8. Please note that when any mentioning of the term “P-MCS” or “P-MCS module” without specifying “P-MCS as Prior art” or “Prior art P-MCS” refers to the present invention disclosure “redistributable Rd-P-MCS” module in its different embodiments.

Prior art may say it may charge a moving vehicle's BEV using an external outlet and a “Prior art P-MCS” module placed outside in a trailer or on the roof of the car, but such arrangements are dangerous and therefore not acceptable from a patentability point of view.

Regarding the functioning of the Mobile Charging System (MCS) described in Prior art, e.g., the paper “Energy Storage System Using Battery and Ultracapacitor on Mobile Charging Station for Electric Vehicle”, Energy Procedia 2015, 68, 429-437, httbs://core.ac.uk/download/pdf/82774674.pdf, when such a Mobile Charging System (MCS) reaches a vehicle in need to recharge their BEV battery, both the MCS and the vehicle are stationary until the recharge is complete.

Prior art discovered the P-MCS portable device concept as a way to;
a. only “store the energy for isolated emergency charging the BEV of the electrical vehicle (EV) to allow such EV to reach a charging station”, and to
b. only “one-time emergency limited charging until next recharge of the P-MCS itself” which is way more limited than the present invention disclosure discovery.
The is no supporting apparatus to integrate such emergency portable charging device into a business method as provided by the present invention disclosure.

Prior art did not reach and/or discovered the concept of “charging while driving” nor the concept of “fully charging the BEV of an electric vehicle (EV) from a P-MCS”.

Prior art “fully charging the BEV of an electric vehicle (EV) from a P-MCS” added with the “charging while driving” concept as the present invention disclosure proposes could be accomplished using modified BEVs and/or “high performance battery packs” (as used in Formula E cars) with “metering and billing” modules mentioned in the paper “Energy Storage System Using Battery and Ultracapacitor on Mobile Charging Station for Electric Vehicle”, Energy Procedia 2015, 68, 429-437, httos://core.ac.uk/download/pdf/82774674.pdf, describes Mobile Charging System (MCS) for on-grid and off-grid charging.

The present invention disclosure considers that Rechargeable MCS could be stationary or as mobile as MCS but where MCS can hold a multitude of “redistributable Rd-P-MCS” modules that can be charged either stationary Recharge Station or during driving towards another Recharge Station in need of “redistributable Rd-P-MCS” modules.

The present invention disclosure shows how the Rechargeable Station holding and charging “redistributable Rd-P-MCS” modules may itself be mobile, for example, for the purpose of redistributing such “redistributable Rd-P-MCS” modules around to the Recharging Stations depleted of “redistributable Rd-P-MCS” modules.

Such mobile Rechargeable Station holding “redistributable Rd-P-MCS” modules may charge the on-board “redistributable Rd-P-MCS” modules during their trip from one source “Rechargeable Station of Portable Mobile Charging Stations (Rd-P-MCS/Rd-P-MCS modules” to another “Rechargeable Station of Portable Mobile Charging Stations (Rd-P-MCS/Rd-P-MCS modules”.

An alternative to the above redistribution of “redistributable Rd-P-MCS” modules could be done by driving representatives using a variety of vehicles: authorized freelance drivers or commercial authorized drivers using a variety of normal commercial vehicles, vans, trucks, but not only, Uber drivers, but not only, all of which may be named as Certified Partner Service providers.

The disadvantage from the above embodiment is that the distribution of the “redistributable Rd-P-MCS” modules may not allow and/or provide the charging service to the energy depleted Rd-P-MCS during the transportation to the destination of such “redistributable Rd-P-MCS” modules. However, such business method that relies on a network of such redistributors, allows and provides flexibility of the redistribution method of the “redistributable Rd-P-MCS” modules, without the high burden of an initial investment using only Super Mobile Charging Stations (Super-MCS) for transportation and redistribution of “redistributable Rd-P-MCS” modules, see the Uber business method in its initial stages without the controversy of challenging the existing legal framework.

Considering that Prior art usage of P-MCS module is for emergency situations where the vehicle needs to go back home or to search for a charging station in order to travel more.
a. Prior art did not anticipate about using a P-MCS module capable to drive and/or charge a full BEV charge,
b. Prior art did not anticipate about charging during driving
c. They did not anticipate about continuing driving without stopping for charging rather than swapping standard P-MCS modules,
d. They did not anticipate about adding metering and billing circuits to the P-MCS module.

Looking at the patent application US 2022/0371462 A1 from Nov. 24, 2022, by Bjorn ISAKSSON, Uddevalla (SE), Ningbo Geely Automobile Research & Development Co., Ltd., Ningbo (CN); Zhejiang Geely Holding Group Co., Ltd., Zhejiang (CN), one would see the following limitations:
a. The patent does not mention anything about any “metering and billing” module and functionality, but rather they show a “charging station” and its connections to the P-MCS electric diagram, which implies that the “metering and billing” module and functionality is entirely provided and implemented by the charging station.
b. In regard to above aspect, the present invention disclosure explicitly mentions the use of a “metering and billing” hardware and functionality into the “redistributable Rd-P-MCS” module itself, as a result of the present invention disclosure discovery being based at least partly on the MCS concept, with the present invention disclosure “redistributable Rd-P-MCS” module concept being a differentiation and patentable concept in relation to MCS Prior art concept as long as the lesser portable charging device P-MCS concept mentioned above is patentable.
c. As long as the lesser Geely portable charging device P-CMS module concept is patentable then the present invention disclosure's enriched “redistributable Rd-P-MCS” module concept is also patentable.
d. The present invention disclosure's “metering and billing” module and functioning provided to the “redistributable Rd-P-MCS” module concept is a differentiation factor from the Geely P-MCS lesser concept because:
   i. Without “metering and billing” module the present invention disclosure business method of “charging while driving” cannot be accomplished when using the Geely portable charging device P-MCS instead of the present invention disclosure “redistributable Rd-P-MCS” module.

Considering that the present invention disclosure does not replace the current effort to make charging stations more efficient and faster.

The present invention disclosure with the disclosed business method would allow dominance at:
a) the business level, where only the patent holder:
   a. can use the portable “redistributable Rd-P-MCS” modules which avoids the recharge waiting time in order to charge the BEV during driving,
   b. can sell cars that would use such portable “redistributable Rd-P-MCS” modules which avoids the recharge waiting time in order to charge the BEV during driving,
b) the marketing level—imagine advertisements where one car makes a 5-minute stop to swap the Rd-P-MCS without waiting to recharge the BEV while other competitor cars with disappointed drivers are waiting to recharge their BEV or even to access a recharge station,

The present invention disclosure claims that without the present invention disclosure concept of “portable “redistributable Rd-P-MCS” module, charging during driving would be of limited usefulness because otherwise one need to dispose very expensive Prior art P-MCS or keep piling up such depleted P-MCSs (previously used to charge the BEV) inside the car if the goal would be to avoid recharging in stationary mode—this is a business method claim.

Considering that only the present invention disclosure solution can let a car to recharge their car through swapping a “redistributable Rd-P-MCS” module without waiting time to access the source of charge (if there is a queue of more than two cars to a MCS) and without waiting time while charging the car's BEV from a rescue power bank and/or rescue P-MCS.

No Prior art has claimed a network of Recharging Stations, in the form of Stationary and/or Super Mobile Charging Stations as shown above, that juxtaposed to a network of locations (standard Gas/Power Stations or locations with high(er) traffic where there is a high(er) demand for recharging the Electrical Vehicles and their BEV with the result that EVs) alongside a set of compatible cars and compatible redistributable P-MCSs can provide driving limitless without charging time.

The present invention disclosure claims that a car that is compatible (under the scope of this invention) with the above mentioned network of Recharging Stations, in the form of Stationary and/or Super Mobile Charging Stations as shown above, under certain static circumstances—such as placement of such Recharging Stations that the said car May hop from pairs (not necessarily adjacent) of such Rechargeable Stations without waiting for recharging but just with swapping the compatible “redistributable Rd-P-MCS” modules defined as above in various embodiments.
Such compatible cars may drive limitless without waiting time for charging in the following examples of scenarios, without being limited to such enumeration:
   a. Competing without waiting for recharging in an all-electric Paris-Dakkar competition, for example, where the cars need to stop only for swapping “redistributable Rd-P-MCS” modules and/or for having rest (since the competition is multi-day).
   b. Driving in a long highway circuit loop indefinitely as long as there are sufficient locations with Recharging Stations at distances that would never allow the car to deplete its BEV between successive such Recharging Stations.
   c. Driving a long circuit alongside a Super Mobile Charging Station where the car would stop only to swap a “redistributable Rd-P-MCS” modules in almost no time. The car could drive this way as long as the peer Super Mobile Charging Station would run out of charged “redistributable Rd-P-MCS” modules.
      However, during rest time the Super Mobile Charging Station could be connected to the electric grid and recharge all its mounted “redistributable Rd-P-MCS” modules during night or during times when there is a lesser requirement for driving.
   d. Having a caravan consisting of a multitude of cars tagged along by such Super Mobile Charging Station that would provide longer mobility during the driving on the circuit between locations where the Super Mobile Charging Station may be connected to the electric grid.

Adding the metering and billing module to the “redistributable Rd-P-MCS” (as a full-blown Rd-P-MCS with metering or as a split embodiment with “control module”, “battery pack” and “metering and billing module”) is important and differentiating because empowers the network of Recharging Stations for commercial and redistributable use of the present invention disclosure Rd-P-MCS in all their embodiments.

No Prior art could even think of the concept of “charging while driving”, hence their technical embodiments cannot attain this goal.

The present invention disclosure comprising of the “redistributable Rd-P-MCS” module, the network of Recharging Stations, overlapped geolocation of such network of Recharging Stations over a network of already established Gas/Power stations and/or high trafficked locations where there is enough demand for a valid business plan, as well as the compatible participating cars, provides also a “business method” that is allowed to be patented and to provide a strategic advantage against the competition and its/their cars.

The present invention disclosure has transformed the Prior art MCS concept into a multitude of “redistributable Rd-P-MCS” modules with similar design but in a portable and miniaturized form just like in the cell division biological process while maintaining the concept of mobile truck charging and distributing such “redistributable Rd-P-MCS” modules, see the Super Mobile Charging Station concept.

The present invention disclosure also added the concept of charging the “redistributable Rd-P-MCS” modules “during the driving” distribution, further eliminating waiting times for the purpose of recharging.

The present invention disclosure Super Mobile Charging Station concept is much more efficient than the Prior art MCS in servicing to the stranded EV cars with need for recharging.

The present invention disclosure added the concept of “partitioning” and “packaging” the energy provided by the MCS in Prior art and use such packaging to swap portable “redistributable Rd-P-MCS” module in order to eliminate or minimize the time readiness of EVs.

Using an array of “redistributable Rd-P-MCS” modules in the present invention disclosure' various embodiments for the Recharging Stations (Stationary and Mobile) minimizes the number of situations when there are not enough fully charged “redistributable Rd-P-MCS” modules for the Rd-P-MCS compatible and participating EV vehicles' demand. Monitoring the availability of the fully charged “redistributable Rd-P-MCS” modules with a Recharging Station and the dynamics of the demand for such “redistributable Rd-P-MCS” modules depending on season, location, time, events, should allow the Operators of such Recharging Station to minimize the downtime that would affect the scope of such a circuit and set of cars, e.g., the elimination of the stationary waiting time of charging fora quick continuation of the driving.

The present invention disclosure provides alongside the technical apparatus also a business method that takes advantage of such technical apparatus in order to attain the goal of the present invention disclosure:
“Eliminate and/or minimize the waiting time for charging the car and continue driving just as the car would have an infinite amount of energy that would allow driving to the destination without stopping (more than a few minutes)”.

Prior art has shown examples of P-MCS but only for emergency situations without further advantage when the emergency charge is also depleted. They do not have a recurrent method of continuing the trip going past a few (and/or very limited number of emergencies charges), at some point in time they will have to stop for recharging, as opposed to us).

Double or multiple batteries used in laptop have been advocated by Dell since 1990's, a similar circuitry could be used in order to add two or more such “redistributable Rd-P-MCS” modules to a car for more charging while driving. However, the present invention disclosure business method may lead to minimizing such requirement.

The present invention disclosure added the concept of never charge the car while waiting while providing a concept to minimize the stationary waiting charging time, at all levels and use cases provided:
a. Related to charging the “redistributable Rd-P-MCS” modules,
b. Related to charging the Super Mobile Charging Station's capacitor or battery pack (or any other embodiment for storing energy) and
c. Related to charging the “redistributable Rd-P-MCS” module from Super Mobile Charging Station's capacitor or battery pack (or any other embodiment for storing energy) while driving to the destination of the Super Mobile Charging Station and/or the destination of the “redistributable Rd-P-MCS” modules
   the Super Mobile Charging Station (Super-MCS) to charge the array of mounted “redistributable Rd-P-MCS” modules during transportation where they are needed

Rental and swapping such “redistributable Rd-P-MCS” modules is part of the business method proposed by the present disclosure.

As long as the network of Recharge Stations is well planned there are not limitation to the business method and to the distance that the compatible participating EV could achieve without waiting while driving.

Deployment of Super Mobile Charging Stations which are mobile do not need huge initial business investment, as they can be easily relocated according to the dynamics of the needs of the business method and plan.

The present invention disclosure may use Petri Nets and Graph Theory to model in a formal way the business method where the dots are cars, “redistributable Rd-P-MCS” modules and even Rd-P-MCS charging state, traveling alongside the proposed circuit and network of Redistributable Stations.

Rental charging cost could be dependent on rented time, the charge used, location of disposal, etcetera.

The present invention disclosure method and apparatus are distinguished from Prior art by the performance results, but also by technical advancements proposed.

The present invention disclosure apparatus and business method do not replace the efforts for making the battery and/or Prior art P-MCS charging being faster and more efficient, but rather adds an independent method and apparatus to mobility improvements, but not only.

The present invention disclosure may use Petri Nets, which unlike other “industry standards such as UML activity diagrams, Business Process Model and Notation, and event-driven process chains,” in order to provide the following:
a) “a graphical notation for stepwise processes that include choice, iteration, and concurrent execution.”
b) “an exact mathematical definition of their execution semantics, with a well-developed mathematical theory for process analysis”, see https://en.wikipedia.org/wiki/Petri net.

The present invention disclosure business method is not just the codification of a process in a language and/or model such as Petri Nets, but not only, but rather the business method is the process described with requirements and diagrams through the disclosure with an additional model in Petri Nets to provide a common ground for comparison with other possible competing disclosure/patent applications.

The core scope of the present invention disclosure can be described as follows: create a technological apparatus such that there is a method that would allow or at least try to attain the following:
a. Never wait for recharge time while undertaken a long trip
b. Recharge the “Rd-P-MCS compatible BEV Battery (BEV)” battery only “during driving”
c. Make sure that the Rd-P-MCS compatible participating EV vehicle has enough “redistributable Rd-P-MCS” module whenever needed. Such needs may be accomplished with a redistribution method.
d. Maintain a business method that allows and optimizes the above with performance goals in mind.

How can the competition replicate the present invention disclosure business method without the present invention disclosure technical apparatus? Can they still use the same business method if they create a different technical apparatus to support such business method?

It is possible that there may be both Super Stationary Charging Stations (Super-SCS) and Super Mobile Charging Stations (Super-MCS) at the same location depending on traffic and projected business method execution needs.

Note that with the present invention disclosure business method, if there is only one Rd-P-MCS compatible participating EV vehicle within the circuit of Recharging Stations, either in the form of Super Stationary Charging Stations or in the form of Super Mobile Charging Stations, such circuit being a close loop (for simplification purpose and for more intuitive illustrative purpose), with all the support apparatus described in this disclosure, then such business method should be able to allow that the Rd-P-MCS compatible participating EV vehicle to run indefinitely without any waiting times to stop for recharging other than stopping just a few minutes in order to swap the “redistributable Rd-P-MCS” module (s) and for rest time.

One generalization of the above use case and/or embodiment is to add more compatible cars to such a circuit in which they compete for the fully charged Rd-P-MCS modules, thus there is the possibility of having a possible shortage of such “redistributable Rd-P-MCS” modules at these Recharging Stations after a certain running time of this business method.
Such possible shortages should be addressed using Super Mobile Charging Station (Super-MCS) vehicles to distribute while also charging the transported “redistributable Rd-P-MCS” modules to locations where there is such need of “redistributable Rd-P-MCS” modules or by the network of Certified Partner Service providers as defined and described in the present invention disclosure.

The redistribution of “redistributable Rd-P-MCS” modules may be coordinated by “Rd-P-MCS Dispatcher coordinator” entity that would monitor what are the locations there is such need of “redistributable Rd-P-MCS” modules thus providing an optimization of routing such “redistributable Rd-P-MCS” modules to a network of locations in need.

Such “Rd-P-MCS Dispatcher coordinator” entity may be named as the “Dispatcher”.

The “Rd-P-MCS Dispatcher coordinator” entity could use the following methods to command the distribution of needed “redistributable Rd-P-MCS” modules:
a. using an ad-hoc approach of determining where there are such need-based calls by drivers in need that are unable to find available fully charged “redistributable Rd-P-MCS” modules at the Recharging Stations, either Super Stationary Charging Stations (Super-SCS) and/or Super Mobile Charging Stations (Super-MCS), they reached.
Please note that a diver that travels through an area where there are no Recharging Stations, either in the form of Super Stationary Charging Stations or in the form of Super Mobile Charging Stations (Super-MCS) that are stationary at a standard Gas/Power Station location, may project what is the area and time when it would be useful to

The Dispatcher may run a software that displays a multi-layered Dashboard monitoring the status of Stationary recharge stations and their Rd-P-MCS modules, status of mobile/OFF-GRID Super Mobile Charging Stations (Super-MCS), and the status of individual “redistributable Rd-P-MCS” modules at charge and normal operation levels, but not only, that are needed to function within the defined scope of the apparatus and business method, e.g., to allow indefinite driving, as long as there are available participating Recharge Stations, without needing stationary recharging times and having “recharging only during driving”.

The present invention disclosure is concerned also with the following:
1) Rd-P-MCS ECU with battery, GPS, Identity as MAC Address or tuple of MAC Addresses of all NIC in ECU
2) Rd-P-MCS Adapter with NCD compatible with Rd-P-MCS and NCD compatible with “EV compatible Rd-P-MCS Infrastructure”
3) Rd-P-MCS ECU has NCD (network communication interfaces) compatible with Super Mobile Charging Stations (Super-MCS), Super Stationary Charging Stations, with Light-ECU Cashier scanners.
4) Rd-P-MCS ECU may have multiple NCDs for the same specific role/feature based on the Polymorphic ECUs in order to be compatible with multiple versioned and/or providers systems designed and implemented for the business method.
5) Health monitoring—sensors and NCD interfaces just as for the BEV already Prior art.
6) Control and Monitoring->ECU(s) that can be distributed between the implementations of the “redistributable Rd-P-MCS” module and “EV compatible Rd-P-MCS Infrastructure”.
7) Define variations of Rd-P-MCS reallocation, with bindings between components and “redistributable Rd-P-MCS” and “EV compatible Rd-P-MCS Infrastructure”: Permanent binding (Rd-P-MCS ECU is located at Rd-P-MCS), Temporary Binding, and Free Binding
8) Define Serie of such variations using embodiments of bipartitions using Fiduccia-Mattheyses like algorithms, but not only, Davis Putman backtracking heuristics.
9) Petri Net reachability
10) Petri Net transitions only if car can advance without recharge waiting time->Petri Net reachability.
11) Using a business method relaying on “redistributable Rd-P-MCS” allows a EV necessary and/or available charging split between the BEV and the “redistributable Rd-P-MCS”, allowing for smaller BEV with the same mobility as Prior art as long as the “redistributable Rd-P-MCS” are available inside Rechargeable Station circuits and financially affordable.

The Certified Partner Service providers may be provided by contracts signed between the OEM company implementing the disclosure business method and existing automobile club companies such as “ADAC” in Germany, “AAA” in USA, but not only. For the purpose of the present invention disclosure, the service that distributed a “redistributable Rd-P-MCS” module is further referred as Certified Partner Service that operates “Certified Partner Service vehicles”.

Using such existing automobile club companies for the service described in this disclosure provided by Certified Partner Service drivers, is advantageous because of the following:
a) Such automobile club companies already have an existing network of service and certified providers with nationwide coverage.
b) Such automobile club companies already have millions of members with a nationwide reach to such members, including with being able to add new services such the <delivery of “redistributable Rd-P-MCS” modules at a certain location and at a certain time>.
c) Such automobile club companies do have the scope that is required for the service described in the current disclosure for the Certified Partner Service.
d) Such automobile club companies have already a nationwide reputation that the drivers that need the present invention disclosure services related to Certified Partner Service distributing “redistributable Rd-P-MCS” modules, could trust from day one.
e) Such automobile club companies would only need minor adjustments to provide support for the present invention disclosure business method as described for the Certified Partner Service” providers.
f) Such automobile club companies have a nationwide coverage that extends beyond the network of Gas Stations, EV Power Stations, and the present invention disclosure Recharging Stations from highways but not only.
g) Such automobile club companies have a nationwide coverage that extends inclusive into remote areas that might not have access, at least at the beginning, at Gas Stations, EV Power Stations, and the present invention disclosure Recharging Stations.
h) Such automobile club companies have a nationwide network of offices and/or warehouses where Super Mobile Charging Stations (Super-MCS) with an array of standby “redistributable Rd-P-MCS” modules may be easily ready to support the pick-up of “redistributable Rd-P-MCS” modules by such automobile club companies' agents to further distribute the “redistributable Rd-P-MCS” modules to vehicles in need or to “deliver in the future at specific locations and specific times” alongside driving plans of participating EV vehicles.
i) Please note that in the case of the service “deliver in the future at specific locations and specific times” such locations could be an already existing automobile club office or at existing partner businesses near the location desired by the participating driver requesting such service.

One could recharge the in-car mounted “redistributable Rd-P-MCS” modules in emergency situations when there are no available Recharging Stations, e.g., Super Stationary Charging Stations, Super Mobile Charging Stations, or Certified Partner Service vehicles, in any of their embodiments, to be driven to a requested location at a specific time.

In order to preserve the integrity of the circuit and the apparatus supporting the business method, there is a need that there are no “fake “redistributable Rd-P-MCS” modules” nor “clone redistributable Rd-P-MCS modules” accepted into the Driving Circuit to the above defined Super Stationary Charging Stations and ON-GRID Super Mobile Charging Stations assigned to a specific location), OFF-GRID Super Mobile Charging Stations and/or “Authorized and/or certified redistribution drivers”).

For this reason, the present invention disclosure “redistributable Rd-P-MCS” devices have an identity (implemented a “bar code” shown on the exterior of the module but also implemented though a “software certificate” which should be able to be monitored and read by the apparatus and/or staff accepting such a return of a previously rented “redistributable Rd-P-MCS” module.

The “redistributable Rd-P-MCS” module have a “unique identity” implemented, monitored and verified through various methods: by using a software certificate as well as through other authentication and identification methods. This allows the present invention disclosure technological apparatus and well as the present invention disclosure business method to make sure that all the present invention disclosure “redistributable Rd-P-MCS” modules that are available in the Driving Circuit are accounted for but also that the present invention disclosure pool of “certified “redistributable Rd-P-MCS” modules” are not tainted with:
a) non-functional “redistributable Rd-P-MCS” modules, or “redistributable Rd-P-MCS” modules that do not meet all the requirements specified in the present invention disclosure,
b) “Redistributable Rd-P-MCS” modules that are functioning worse than the “redistributable Rd-P-MCS” module that was actually rented and not returned,
thus, there is a guarantee for the quality and the specifications that the compatible participating cars and drivers rely during their trips but also a protection for the investment and the integrity of the business method.

The unique identity of the “redistributable Rd-P-MCS” modules that are being rented and used, as well as the “redistributable Rd-P-MCS” modules that are currently being recharged and/or fully charged, allows the business method, through the “Rd-P-MCS Dispatcher coordinator”, but not only, to monitor the “health of the circuit—apparatus and methodology” and to take proactive actions, either automatic or through human intervention, in order to keep the “health of the circuit—apparatus and methodology” in perfect condition to serve the Rd-P-MCS compatible participating cars and their drivers with the defined scope of the invention: to allow all the compatible participating cars and their drivers to drive long trips without waiting during recharging and/or replacing the “redistributable Rd-P-MCS” modules, e.g., allow always the “recharge while driving”.

The unique identity of the present invention disclosure “redistributable Rd-P-MCS” module allows the present invention disclosure business method, though its technological apparatus, to track:
a. the “redistributable Rd-P-MCS” module's geolocation position,
b. the “status of charging”,
c. the “usage status”,
d. the “payments/billing information”,
allowing the evaluation of its efficiency, etcetera, to be used by Business intelligence software for optimization of the business method.

The present invention disclosure “redistributable Rd-P-MCS” module has a “GPS apparatus” as well as its status “Rented/In Use”, “Ready for Pick-Up”, “Recharging State”, but not only, that allows the business method to identify the location of such “redistributable Rd-P-MCS” modules and to collect them for useful redistribution and reinsertion into the circuit either as fully charged “redistributable Rd-P-MCS” modules or as future rechargeable “redistributable Rd-P-MCS” modules.

Tracking the position of an In-Use rented “redistributable Rd-P-MCS” module is equivalent with the tracking of the position of the compatible participating car that is using it, therefore there are GDRP Directive, but not only, related privacy concerns. For this reason, the GPS of the “redistributable Rd-P-MCS” module may be turned off between the moment of its pickup and the moment of its drop-off.

The fact that the “redistributable Rd-P-MCS” module is not accounted, from a geolocation point of view, for all the time, e.g., during the time it is In-Use and Rented state, therefore raising concerns about the investment with it, is mitigated by the fact that the pickup of such expensive “redistributable Rd-P-MCS” module cannot be done without a credit history check, or without signing a contract with the terms of the rental, or without providing a deposit that would cover the expense of replacing it if needed.

As a consequence, no secured deposit, and no other financial method of protecting the investment related to the rented “redistributable Rd-P-MCS” module, will be released back to the participating driver that rented the said “redistributable Rd-P-MCS” module until the “redistributable Rd-P-MCS” module will be returned to a certified entity (either person or automated receiver) established with receiving such returned “redistributable Rd-P-MCS” modules.

Upon the receiving such previously rented “redistributable Rd-P-MCS” module, based on its identity and successful certificate hand shake with the receiving circuitry (scanning device handled by a certified receiving person or by Recharging Stations, e.g., Super Stationary Charging Stations, Super Mobile Charging Stations, or Certified Partner Service vehicles, in any of their embodiment), and upon the execution and/or validation of the metering and billing functions, the GPS is to be re-enabled, and all its data will synchronize with the Dispatcher entity.

One of the main goals of the business method is that when a car compatible with the scope of the invention is that such car will always find an available Rd-P-MCS ready for pickup/swap for zero waiting recharge time. In practice there may be times when such a condition may not happen, but the design and implementation of the present invention disclosure business method should strive to eliminate and/or minimize such situations.

When such unfortunate situation when a participating driver finds that there is no available “redistributable Rd-P-MCS” module to be picked up at once, the participating driver may do the following actions:
a) Wait for a “redistributable Rd-P-MCS” module to be brought to the location automatically because the “Rd-P-MCS Dispatcher coordinator” entity discovered the need and redirected participating redistribution entities, such as Super Mobile Charging Stations (Super-MCS) transporting “redistributable Rd-P-MCS” modules to locations where there is such need of “redistributable Rd-P-MCS” modules, or Certified Partner Service providers to fulfill such need.
b) Wait for a Rd-P-MCS be brought to the location after calling the “Rd-P-MCS Dispatcher coordinator”.
c) Recharge, with stationary waiting time—as an emergency fallback action—from an available standard power outlet from the Recharging Stations, either in the form of Super Stationary Charging Stations or in the form of Super Mobile Charging Stations that are stationary at a standard Gas/Power Station location.

Calling for replacement “redistributable Rd-P-MCS” modules could be done directly to the:
a) “Rd-P-MCS Dispatcher coordinator” entity that directs the transportation of “redistributable Rd-P-MCS” modules by means of:
   a. Super Mobile Charging Stations (Super-MCS) transporting “redistributable Rd-P-MCS” modules
   b. Certified Partner Service providers transporting such “redistributable Rd-P-MCS” modules, also named “Rd-P-MCS redistribution drivers” may collect fully charged “redistributable Rd-P-MCS” modules from “redistributable Rd-P-MCS collection entities” such as the Recharging Stations, e.g., Super Stationary Charging Stations, Super Mobile Charging Stations, or Certified Partner Service vehicles, in any of their embodiments.
b) Certified Partner Service providers transporting such “redistributable Rd-P-MCS” modules, named “Rd-P-MCS redistribution drivers”, may collect fully charged “redistributable Rd-P-MCS” modules from “redistributable Rd-P-MCS collection entities” such as the Recharging Stations, e.g., Super Stationary Charging Stations (Super-SCS), Super Mobile Charging Stations (Super-MCS), or Certified Partner Service vehicles, in any of their embodiments.

The “Rd-P-MCS redistribution drivers” may collect fully charged “redistributable Rd-P-MCS” modules from “redistributable Rd-P-MCS collection entities” such as the Recharging Stations, e.g., Super Stationary Charging Stations, Super Mobile Charging Stations, or Certified Partner Service vehicles, in any of their embodiments.

The “Rd-P-MCS redistribution drivers” may themselves call a nearby Super Mobile Charging Stations or the “Rd-P-MCS Dispatcher coordinator” entity in order to collect a set of “redistributable Rd-P-MCS” modules in case they anticipate a legitimate need for such service.

Please note that such use case allows more flexibility and more support with the availability of “redistributable Rd-P-MCS” modules but adds additional service fees.

The price of renting a “redistributable Rd-P-MCS” module may be dynamic also with respect to the effort to make available such “redistributable Rd-P-MCS” modules in the area of interest.

The participating car should be able to see the available prices for picking up/swapping the “redistributable Rd-P-MCS” modules at the areas of interest. For example, if the current location has more expensive rental fees for the available “redistributable Rd-P-MCS” modules but a nearby location which can be reached with the current BEV and/or available (already rented) “redistributable Rd-P-MCS” module, the driver may go to that location and rent the “redistributable Rd-P-MCS” module from there.

For the purpose of the present invention disclosure, “Recharging Stations” are in the form of either a Super Stationary Charging Station (Super-SCS) or in the form of a Super Mobile Charging Station (Super-MCS) assigned to a stationary location or called dynamically based on need at a meeting point) or in the form of available “redistributable Rd-P-MCS” modules brought by an “Authorized and/or certified redistribution drivers”) transporting such “redistributable Rd-P-MCS” module.

NOTE: the prefix “Super” used in conjunction with Super Stationary Charging Station and Super Mobile Charging Station is to show that they hold a plurality of “redistributable Rd-P-MCS” modules.

It is possible that both Super Stationary Charging Stations and Super Mobile Charging Stations may be at the same location depending on traffic and projected business method execution needs.

Besides the service fees for bringing the “redistributable Rd-P-MCS” modules to the EV vehicles in need, there might be a cost associated with the driving effort of the Certified Partner Service provides to the destination location but also there might be a cost associated with the Certified Partner Service provides waiting for the driver in need to arrive at the pickup location, in case that the driver in need has made a call with a pickup time in the future at a location alongside the driver's driving plan with an approximate pickup time.

Please note that with the present invention disclosure, the mobility of a compatible participating car is not defined anymore by its BEV but by the set of its BEV and available (already rented) “redistributable Rd-P-MCS” modules. Moreover, the mobility may also be defined depending on the future projected available such “redistributable Rd-P-MCS” modules from the Recharging Stations located along the driver's driving plan.

The present invention disclosure claims that the mobility of Rd-P-MCS compatible participating EV vehicles is defined by the electrical charge of its “BEV and rented ‘redistributable Rd-P-MCS’ modules”.

With the above embodiment, when there is a charging switch from BEV Battery to a “redistributable Rd-P-MCS” module, another available “redistributable Rd-P-MCS” module may charge the BEV Battery while the first “redistributable Rd-P-MCS” takes over module powering the Electric Motor while driving.

Another way to generalize the closed loop circuit of such Recharging Stations is by replacing the “driving plan based on a closed loop circuit” with a forest of trees (in the Graph Theory language) where the nodes of the trees of such forest are locations that have participating Recharging Stations, e.g., Super Stationary Charging Stations (Super-SCS) and Super Mobile Charging Stations (Super-MCS) assigned to a stationary location.

Such “forest of trees” (in the Graph Theory language) of locations with Recharging Stations are called “participating Recharging Stations”.

Two trees from such a “forest of trees” (in the Graph Theory language) are said to be disconnected if the distance between any of the nodes of any of such tree is too high in order to allow the driving from one such node in one of the trees to any node in the other tree using the car's fully charged BEV and/or using “redistributable Rd-P-MCS” modules.

This is called the relation of “connectivity” between any two nodes of the “forest of trees” (in the Graph Theory language) that defines also the partition of the forest in trees.

With the above definition of “forest of trees” (in the Graph Theory language) of “participating Recharging Stations” there is a challenge of driving with an EV from one such tree to another tree.

Mitigation actions for such a problem, without limiting the below enumeration, are:
a) Rent more than the strictly necessary “redistributable Rd-P-MCS” modules in order to extend the mobility distance by replacing the “redistributable Rd-P-MCS” modules whenever needed without calling to receive a replacement “redistributable Rd-P-MCS” module
b) Projecting in the future the time and location where the driver might need again a replacement “redistributable Rd-P-MCS” module and calling the Dispatcher or the participating “Authorized and/or certified redistribution drivers” to have a delivery of “redistributable Rd-P-MCS” modules at the said time and location.

This action/service will minimize the waiting time of the driver for the Super Mobile Charging Station and/or the “Authorized and/or certified redistribution drivers” to provide needed “redistributable Rd-P-MCS” modules to the “drop-off location” and/or “swap location” as opposed when the driver would have called for a “redistributable Rd-P-MCS” module only after reaching such swap location.

The driver may call in advance either the Dispatcher of the “Authorized and/or certified redistribution drivers” to have the needed “redistributable Rd-P-MCS” module being brought to a location along the driver's driving path at a time when the driver anticipate to reach in the future, location that the driver may reach with the current “BEV+Rd-P-MCS” available charging. Using such method, the participating driver minimizes the waiting time needed to replenish the recharging needs even in areas where there are no established participating Recharging Stations, e.g., Super Stationary Charging Stations (Super-SCS), Super Mobile Charging Stations (Super-MCS) that are assigned to specific locations.

Note that even if the Prior art MCS allows two simultaneous vehicles to charge from it, since the plurality of such vehicles depends on the sides and direct charging connection between the vehicles and the MCS, the cardinality of such vehicles could not be generalized by the authors in Prior art because having a large number of cars directly connected to such MCS is not practical.

Based on the above observation, since the present invention disclosure solution allows such vehicles to receive partitioned and packaged energy in the form of the present invention disclosure “redistributable Rd-P-MCS” module and because such charging is indirect via the assigned “redistributable Rd-P-MCS” module and because it does not involve a direct charging connection to the Super Mobile Charging Station but rather a charging connection with the detachable (unmounting) “redistributable Rd-P-MCS” module in an asynchronous mode during driving as opposed to the synchronous stationary recharging of Prior art, the present disclosure also claims the novelty of the mass scale of delivering “redistributable Rd-P-MCS” modules.

Please note that the “pool of certified redistributable Rd-P-MCS modules” that is present in various states and/or circulates within the present invention circuit, e.g.:
a) The “redistributable “Rd-P-MCS” modules that are fully charged and ready to be picked up from a is also a claim.

The present invention disclosure proposes several methods and functions for measuring the performance of the proposed technology and business method in order to:
a. Show how it differentiates from Prior art,
b. Show how it is better that Prior art,

The present invention disclosure allows formal models based on Graph Theory and on Petri Nets, but not only, in order to define the core of the technological proposal but also the core of the present invention disclosure business method.

The present invention disclosure formal models could allow all future technologies to be able to be compared with the present invention disclosure technology proposed on a common framework for performance and efficiency comparison.

The above-mentioned disclosure methods and functions may allow to measure the performance of the proposed technology and business method are the following, without being limited to:
a) The total distance an Electrical Vehicle (EV), participating in each Prior art (or future art) business method, can cover without stationary recharging time.
b) The time total time an Electrical Vehicle (EV), participating in each Prior art (or future art) business method, can cover without stationary recharging time.

The present invention disclosure should cover ANY PART of the present invention disclosure apparatus and/or business method THAT STILL FULFILLS the SCOPE of the invention: ALWAYS RECHARGING WHILE DRIVING (as long as it is possible) WITHOUT ANY WAITING TIME FOR RECHARGING (as long as it is possible)—this claim is for protecting also embodiments that are suboptimal but that still fulfill the scope of the present invention disclosure-see above.

Graph with nodes as locations with recharge stations such that any pair of such connected locations would not be too far aways from each other such that a freshly charged Rd-P-MCS would not be sufficient to drive from one such location to another

Please note that mentioning “P-MCS” without specifying “P-MCS as Prior art” the present invention disclosure refers to “Rd-P-MCS”, e.g., “redistributable Rd-P-MCS” module, in its different embodiments within the scope of being the “redistributable Rd-P-MCS” module.

Considering that the present invention disclosure does not replace the current effort to make charging stations more efficient and faster.

Without the present invention disclosure concept of “portable “redistributable Rd-P-MCS” module, charging during driving would be of limited usefulness because otherwise one would need to dispose very expensive Prior art portable charging devices P-MCS or keep piling up such depleted P-MCS modules (previously used to charge the BEV) inside the car if the goal would be to avoid recharging in stationary mode—this is a business method claim.

Considering that only the present invention disclosure solution can let a car to recharge their car through swapping a “redistributable Rd-P-MCS” module without waiting time to access the source of charge (if there is a queue of more than two cars to a Prior art MCS) and without waiting time while charging the car's BEV from a rescue power bank and/or Prior art rescue P-MCS.

No Prior art has claimed a network of Recharging Stations, in the form of Super Stationary Charging Stations and/or Super Mobile Charging Stations as shown above, that juxtaposed to a network of locations (standard Gas/Power Stations or locations with high(er) traffic where there is a high(er) demand for recharging the Electrical Vehicles and their BEV with the result that EVs) alongside a set of Rd-P-MCS compatible participating EV cars and compatible “redistributable Rd-P-MCS” modules can provide driving limitless without charging time.

A Rd-P-MCS compatible participating EV vehicle that is compatible with the above mentioned network of Recharging Stations, in the form of Stationary and/or Mobile (OFF-GRID) Super Mobile Charging Stations (Super-MCS) as shown above, under certain static circumstances—such as placement of such Recharging Stations that the said car may hop from pairs (not necessarily adjacent) of such Recharging Stations without waiting for recharging but just with swapping the compatible “redistributable Rd-P-MCS” modules defined as above in various embodiments.

Such compatible cars may drive limitless without waiting time for charging in the following examples of scenarios, without being limited to such enumeration:
a) Competing without waiting for recharging in an all-electric Paris-Dakkar competition, for example, where the cars need to stop only for swapping “redistributable Rd-P-MCS” modules and/or for having rest (since the competition is multi-day).
b) Driving in a long highway circuit loop indefinitely as long as there are sufficient locations with Recharging Stations at distances that would never allow the car to deplete its BEV between successive such Recharging Stations.
c) Driving a long circuit alongside a Super Mobile Charging Station where the EV car would stop only to swap a “redistributable Rd-P-MCS” module in almost no time. The car could drive this way as long as the peer Super Mobile Charging Station would run out of charged “redistributable Rd-P-MCS” modules.

However, during rest time the Super Mobile Charging Station could be connected to the electric grid and recharge all its “redistributable Rd-P-MCS” modules during night or during times when there is a lesser requirement for driving.
d) Having a caravan/multitude of cars tagged along by such Super Mobile Charging Station that would provide longer mobility during the driving on the circuit between locations where the Super Mobile Charging Station may be connected to the electric grid.

Adding the metering and billing module to the “redistributable Rd-P-MCS” (as a full-blown Rd-P-MCS with metering or as a split embodiment with “control module”, “battery pack” and “metering and billing module”) is important and differentiating because empowers the network of Recharging Stations for commercial and redistributable use of the present invention disclosure Rd-P-MCS in all their embodiments.

No Prior art could even think of the concept of “charging while driving”, hence their technical embodiments cannot attain this goal.

The present invention disclosure comprising of the “redistributable Rd-P-MCS”, the network of Recharging Stations, overlapped geolocation of such network of Recharging Stations over a network of already established Gas/Power stations and/or high trafficked locations where there is enough demand for a valid business plan, as well as the compatible participating cars, provides also a “business method” that is allowed to be patented and to provide a strategic advantage against the competition and its/their cars.

The present invention disclosure has transformed the MCS concept from Prior art into a multitude of so called “redistributable Rd-P-MCS” modules with a similar design but in a portable and miniaturized form just like in cell division while maintaining the concept of mobile truck charging and distributing such “redistributable Rd-P-MCS” modules.

The present invention disclosure has added:
a. the concept of charging the EV from “redistributable Rd-P-MCS” modules during driving thus eliminating stationary charging waiting times.
b. the concept of charging the “redistributable Rd-P-MCS” modules from the Super Mobile Charging Stations during the distribution driving again eliminating waiting times for the purpose of recharging.

The present invention disclosure shows that the Super Mobile Charging Station is much more efficient than the Prior art MCS in reaching to the stranded EV cars with depleted BEV Batteries.

The present invention disclosure has added the concept of “partitioning” and “packaging” the energy provided by the Prior art MCS and use such energy packaging to swap portable “redistributable Rd-P-MCS” modules to eliminate or minimize the time for charging waiting times.

Using an array of “redistributable Rd-P-MCS” modules in the present invention disclosure various embodiments of the Recharging Stations (Stationary and/or Mobile) the occurrence of situations when there are not enough fully charged “redistributable Rd-P-MCS” modules for the EV demand are minimized.

Monitoring the availability of the fully charged “redistributable Rd-P-MCS” modules with a Recharging Station and the dynamics of the demand for such “redistributable Rd-P-MCS” modules depending on season, location, time, events, should allow the operation personnel of such Recharging Station to minimize the downtime that would affect the scope of such a circuit and set of cars, e.g., the elimination of the stationary waiting time of charging for a quick continuation of the driving.

The present invention disclosure technical apparatus alongside with the business method takes advantage of such apparatus in order to attain the scope of the present invention disclosure: eliminate and/or minimize the waiting time for charging the EV car and continue driving just as the car would have an infinite amount of energy that allows driving to the destination without stopping (more than a few minutes needed for swapping “redistributable Rd-P-MCS” modules).

Prior art has shown examples of portable charging devices “P-MCS” but only for emergency situations without further advantage when the emergency charge is also depleted. They do not have a recurrent method of continuing the trip going past a few (and/or very limited number of emergencies charges), at some point in time they will have to stop for recharging, as opposed to us).

Double or multiple batteries used in laptop have been advocated by Dell since 1990's, a similar circuitry could be used in order to add two or more such “redistributable Rd-P-MCS” modules to a car for more charging while driving. However, the present invention disclosure business method may lead to minimizing such requirement.

Rental and swapping such “redistributable Rd-P-MCS” modules is part of the business method proposed by the disclosure.

The present invention disclosure has added the following:
a. the concept of never charge the car while waiting,
b. the concept of minimizing the “stationary charging time”, also named “charging wait time”, also named “wait charging time”,
c. the concept of charging the “redistributable Rd-P-MCS” modules from the driving Super Mobile Charging Station's capacitor and Super-Pack, thus allowing charging the “redistributable Rd-P-MCS” modules while driving to the destination of the Super Mobile Charging Station that drives to the destination of the “redistributable Rd-P-MCS” modules). Thus, the Super Mobile Charging Station charges the array of connected “redistributable Rd-P-MCS” modules during transportation wherever they are needed.

As long as the network of Recharge Stations is well planned there are not limitation to the business method and to the distance that the compatible participating EV could achieve without waiting while driving.

Business deployment of Super Mobile Charging Stations (Super-MCS) which are mobile do not need huge initial business investment, as they can be easily relocated according to the dynamics of the needs of the business method and plan.

The present invention disclosure proposes a test framework for comparing competing disclosures based on technology novelty, based on performance, but not only:
1. A recharging circuit, such as the present invention disclosure Driving Circuit in its entirety supporting the present invention disclosure business method, with the following:
   a. The recharging circuit is a Driving Circuit comprised of only a Closed Loop circuit path with several Recharging Stations along the recharging circuit providing both:
      i. Prior art Recharging Stations, and
      ii. the present disclosure Recharging Stations such as Stationary Portable Charging Stations, Stationary Super Mobile Charging Stations (Super-MCS), Driving Super Mobile Charging Stations (Super-MCS), Participating Certified Partner Service vehicles, including embodiments with incentive method and asynchronous transfer of “redistributable Rd-P-MCS” modules.
   b. The length of the whole Closed Loop is much larger than the distance range the Prior art EV vehicles can provide from the mobility point of view,
   c. The length of the whole Closed Loop is much larger than the distance range the present disclosure Rd-P-MCS compatible participating EV vehicles can provide from the mobility point of view,
   d. The distance between two adjacent Prior art Recharge Stations (in all the embodiments from Prior art) is less than the range that Prior art portable charging devices, such as the P-MCS devices (please do not confuse with the invention disclosure “redistributable Rd-P-MCS” module), but not only, can produce.
   e. The distance between two adjacent invention disclosure Recharge Stations (in all the novel embodiments from present disclosure) is less than the mobility range that the present invention disclosure “redistributable Rd-P-MCS” module can produce with a Rd-P-MCS compatible participating EV vehicle, with Recharge Stations such as Stationary Portable Charging Stations, Stationary Super Mobile Charging Stations (Super-MCS), Driving Super Mobile Charging Stations (Super-MCS), Participating Certified Partner Service vehicles, including embodiments with incentive method and asynchronous transfer of “redistributable Rd-P-MCS” modules.
   f. The circuit allows all the Prior art technological concepts,
   g. The circuit allows all the present invention disclosure technological concepts,
   h. There is either only one Prior art EV vehicle traveling along or only one invention disclosure Rd-P-MCS compatible participating EV vehicle traveling along the said recharging circuit, for simplification and illustration purpose.
      However, other more complex test frameworks allowing participation of multiple such Prior art EV vehicles and Rd-P-MCS compatible participating EV vehicles could be devised.
2. A Rd-P-MCS compatible participating EV vehicle may travel indefinitely without stationary recharge waiting times in the recharge circuit
3. A Prior art EV vehicle will eventually have to stop to make use of stationary recharge waiting times

The present disclosure apparatus and business method do not replace the efforts for making the BEV batteries charging being faster and more efficient, or for making the Prior art portable charging device P-MCS modules and the “redistributable Rd-P-MCS” modules being charged faster and more efficient. It rather adds an independent method and apparatus to mobility improvements, but not only.

1. Method and apparatus for achieving the “Charging during Driving” and “No stationary recharging waiting times” goals and the mobility reach based on the methods, goals and concepts described in the disclosure for the invention Rd-P-MCS participating compatible EV vehicle, including with rented replaceable invented components used for vehicle operation, characterized in that the invention “Rd-P-MCS compatible BEV Battery (BEV)” battery can be charged, or even bypassed, by the invention “redistributable Rd-P-MCS” module while operating the Electric Motor(s) as seen in figures FIG. 115, FIG. 116, and FIG. 111 with the “redistributable Rd-P-MCS” module having properties and features described in the disclosure—including Metering and Billing—in all presented embodiments—including the “Light redistributable Rd-P-MCS” module variant, with various charging features as described in FIG. 117, but not only,

2. Method and apparatus according to at least one of the preceding claims, characterized for decoupling the invention “Rd-P-MCS compatible BEV Battery (BEV)” battery from the Electric Motor(s) in the sense that the invention “Rd-P-MCS compatible BEV Battery (BEV)” battery is not, anymore, the only power source component (monopolizing) operating the Electric Motor(s),
thus allowing Rd-P-MCS participating compatible EV vehicle embodiments where the Electric Motor(s) may be operated by a plurality of “Rd-P-MCS compatible BEV Battery (BEV)” batteries, by a plurality of “redistributable Rd-P-MCS” modules, including the “Light redistributable Rd-P-MCS” module variants, or by a combination of them, such as those depicted in FIG. 106, FIG. 107, but not only, also possibly including complex and hierarchical compositions of various battery and “redistributable Rd-P-MCS” module embodiments, a simple example being depicted in FIG. 113, FIG. 114, and FIG. 112, also possibly including designs offering redundancy, but not only,
while operating the Rd-P-MCS participating compatible EV vehicle Electric Motor(s) as seen in figures FIG. 78, FIG. 79, FIG. 80, FIG. 81, FIG. 82, FIG. 83, FIG. 84, FIG. 85, and in the diagrams from FIG. 86 and FIG. 87, and from the figures FIG. 108, FIG. 109, FIG. 110, FIG. 111, and FIG. 112, but especially in figures FIG. 115, FIG. 116, and FIG. 111, but not only.

3. Method and apparatus according to at least one of the preceding claims, characterized for aiming to reach and to improve the goals of “Charging during Driving”, “Charging Every time” and “Never Charge when being Stationary” with the invention Support Apparatus used for the “redistribution method” with the ON-GRID Super Mobile Charging Systems (Super-MCS), the stationary OFF-GRID Super Mobile Charging Systems (Super-MCS), and the driving OFF-GRID Super Mobile Charging Systems (Super-MCS) or for the flexible support provided by Certified Partner Service providers, by the incentive method, and by the possibility of asynchronous transfers of “redistributable Rd-P-MCS” modules, with a flexible reach in underserved remote areas.

4. Method and apparatus according to at least one of the preceding claims, characterized for improving the efficiency, scalability and availability of recharged “redistributable Rd-P-MCS” modules, to be offered within a Driving Circuit to subscribed drivers of “Rd-P-MCS participating compatible EV vehicles”, through high-scale Recharging Stations such as ON-GRID Super Stationary Charging Stations (Super-SCS) and ON-GRID, OFF-GRID stationary and OFF-GRID driving Super Mobile Charging Stations (Super-MCS) which are able to recharge up to dozens (50) or even over one hundred, “redistributable Rd-P-MCS” modules at a time,
with the flexible support provided by Certified Partner Service providers, by the incentive method, and by the possibility of asynchronous transfers of “redistributable Rd-P-MCS” modules, including the “Light redistributable Rd-P-MCS” module variant, with a flexible mobility reach in underserved remote areas,
working against the degradation of the invention goals of “Charging during Driving”, “Charging Every time”, “No stationary recharging waiting times”, and “Never Charge when being Stationary”, but not only.

5. Method and apparatus according to at least one of the preceding claims, characterized by reaching the full potential of the invention Performance Goals and by achieving the Subscribers' Performance Plans, as well as by avoiding the degradation of such Performance goals and plans during the operation of the defined Driving Circuit, through the “redistribution method”, using optimization algorithms, including a test framework for performance evaluation which in ideal situations related to available resources is optimal.

6. Method and apparatus according to at least one of the preceding claims, characterized as Payment Method based on open ended rental transactions for the rentable “redistributable Rd-P-MCS” modules without a fixed rental time, based on the “Metering and Billing” feature of the “redistributable Rd-P-MCS” module that allows their rental without the need for a special software and/or distributed database, but also possibly based on the availability of distributed software and databases supporting the rental method of “redistributable Rd-P-MCS” modules, including the “Light redistributable Rd-P-MCS” module variants, with an opened payment transaction when there is a module pick-up and with a closing payment transaction when there is a module drop-off, e.g., the subscribed driver picks-up a new “redistributable Rd-P-MCS” module before the payment transaction is completed.

7. Method and apparatus according to at least one of the preceding claims, characterized for defining and improving the performance algorithms using the novel concept of Dynamic Multi-dimensional Graphs, defined based on Location Grid Graphs with bound and unbound nodes as shown in FIG. 65, which may include a time dimension, whose vertices “move” in time on a predefined virtual vertex grid introduced to service efficiently even the remote areas.

8. Method and apparatus according to at least one of the preceding claims, characterized as necessary to achieve the Business Goals of the invention for creating a commercially viable and scalable Driving Circuit, that optimizes the charging serving waiting times, that optimizes the resources necessary to achieve and to maintain the performance goals for the subscribed drivers and their Rd-P-MCS participating compatible EV vehicles, as described in the disclosure with the following components: the subscription method, the redistribution method, the performance method, the rental method, the payment method, the cost method, the order method (the order placement method), the dispatching method, the coverage method, the incentive method, the quality method, the repair method, and the decision-making methods.
